SEQUENCE LISTING (263 sequences)

SEQ ID NO: 1 - DNA, 555 bp, Homo sapiens
tatgacttagttgcgttacaccctttcttgacaaaacctaacttgcgcagaaaacaagatgagattggcatggctttatttgttttttttgttttgttttggttttttttttttttttggcttgactcaggatttaaaaactggaacggtgaaggtgacagcagtcggttggagcgagcatcccccaaagttcacaatgtggccgaggactttgattgcacattgttgtttttttaatagtcattccaaatatgagatgcattgttacaggaagtcccttgccatcctaaaagccaccccacttctctctaaggagaatggcccagtcctctcccaagtccacacaggggaggtgatagcattgctttcgtgtaaattatgtaatgcaaaatttttttaatcttcgccttaatacttttttattttgttttattttgaatgatgagccttcgtgcccccccttccccctttttgtcccccaacttgagatgtatgaaggcttttggtctccctgggagtgggtggaggcagccagggcttacctgtacactgact

SEQ ID NO: 2 - DNA, 25 bp, Artificial Sequence
  primer
tatgacttagttgcgttacaccctt

SEQ ID NO: 3 - DNA, 25 bp, Artificial Sequence
  primer
cagcagtcggttggagcgagcatcc

SEQ ID NO: 4 - DNA, 25 bp, Artificial Sequence
  primer
gcatcccccaaagttcacaatgtgg

SEQ ID NO: 5 - DNA, 25 bp, Artificial Sequence
  primer
ggccgaggactttgattgcacattg

SEQ ID NO: 6 - DNA, 25 bp, Artificial Sequence
  primer
ttgttacaggaagtcccttgccatc

SEQ ID NO: 7 - DNA, 25 bp, Artificial Sequence
  primer
taaggagaatggcccagtcctctcc

SEQ ID NO: 8 - DNA, 25 bp, Artificial Sequence
  primer
ttttgaatgatgagccttcgtgccc

SEQ ID NO: 9 - DNA, 25 bp, Artificial Sequence
  primer
tttttgtcccccaacttgagatgta

SEQ ID NO: 10 - DNA, 25 bp, Artificial Sequence
  primer
tgtatgaaggcttttggtctccctg

SEQ ID NO: 11 - DNA, 25 bp, Artificial Sequence
  primer
ggagtgggtggaggcagccagggct

SEQ ID NO: 12 - DNA, 25 bp, Artificial Sequence
  primer
gccagggcttacctgtacactgact

SEQ ID NO: 13 - DNA, 543 bp, Homo sapiens
ggtcccgaggagttcaaagcctgcctcatcagcttgggttatgatattggcaacgacccccagggagaagcagaatttgcccgcatcatgagcattgtggaccccaaccgcctgggggtagtgacattccaggccttcattgacttcatgtcccgcgagacagccgacacagatacagcagaccaagtcatggcttccttcaagatcctggctggggacaagaactacattaccatggacgagctgcgccgcgagctgccacccgaccaggctgagtactgcatcgcgcggatggccccctacaccggccccgactccgtgccaggtgctctggactacatgtccttctccacggcgctgtacggcgagagtgacctctaatccaccccgcccggccgccctcgtcttgtgcgccgtgccctgccttgcacctccgccgtcgcccatctcctgcctgggttcggtttcagctcccagcctccacccgggtgagctggggcccacgtggcatcgatcctccctgcccgcgaagtgacagtttac

SEQ ID NO: 14 - DNA, 25 bp, Artificial Sequence
  primer
ggtcccgaggagttcaaagcctgcc

SEQ ID NO: 15 - DNA, 25 bp, Artificial Sequence
  primer
gcagaatttgcccgcatcatgagca

SEQ ID NO: 16 - DNA, 25 bp, Artificial Sequence
  primer
tcatgagcattgtggaccccaaccg

SEQ ID NO: 17 - DNA, 25 bp, Artificial Sequence
  primer
tgggggtagtgacattccaggcctt

SEQ ID NO: 18 - DNA, 25 bp, Artificial Sequence
  primer
agcagaccaagtcatggcttccttc

SEQ ID NO: 19 - DNA, 25 bp, Artificial Sequence
  primer
cttccttcaagatcctggctgggga

SEQ ID NO: 20 - DNA, 25 bp, Artificial Sequence
  primer
tacattaccatggacgagctgcgcc

SEQ ID NO: 21 - DNA, 25 bp, Artificial Sequence
  primer
ccgaccaggctgagtactgcatcgc

SEQ ID NO: 22 - DNA, 25 bp, Artificial Sequence
  primer
aggtgctctggactacatgtccttc

SEQ ID NO: 23 - DNA, 25 bp, Artificial Sequence
  primer
ggcgctgtacggcgagagtgacctc

SEQ ID NO: 24 - DNA, 25 bp, Artificial Sequence
  primer
ccctgcccgcgaagtgacagtttac

SEQ ID NO: 25 - DNA, 516 bp, Homo sapiens
gttgtaatcgcagtattccttgtatggaagtcatcagatatgctgtgcaagtcttgcttaatgtatctaagtatgagaaaactacttcagcagtttatgatgtagaaaattgtatagatatactattggagcttttgcagatataccgagaaaagcctggtaataaagttgcagacaaaggcggaagcatttttacaaaaacttgttgtttgttggctattttactgaagacaacaaatagagcctctgatgtacgaagtaggtccaaagttgttgaccgtatttacagtctctacaaacttacagctcataaacataaaatgaatactgaaagaatactttacaagcaaaagaagaattcttctataagcattccttttatcccagaaacacctgtaaggaccagaatagtttcaagacttaagccagattgggttttgagaagagataacatggaagaaatcacaaatcccctgcaagctattcaaatggtgatggatacgcttggcattcctt

SEQ ID NO: 26 - DNA, 25 bp, Artificial Sequence
  primer
gttgtaatcgcagtattccttgtat

SEQ ID NO: 27 - DNA, 25 bp, Artificial Sequence
  primer
tcagatatgctgtgcaagtcttgct

SEQ ID NO: 28 - DNA, 25 bp, Artificial Sequence
  primer
ggagcttttgcagatataccgagaa

SEQ ID NO: 29 - DNA, 25 bp, Artificial Sequence
  primer
gttgtttgttggctattttactgaa

SEQ ID NO: 30 - DNA, 25 bp, Artificial Sequence
  primer
atagagcctctgatgtacgaagtag

SEQ ID NO: 31 - DNA, 25 bp, Artificial Sequence
  primer
gttgttgaccgtatttacagtctct

SEQ ID NO: 32 - DNA, 25 bp, Artificial Sequence
  primer
cagtctctacaaacttacagctcat

SEQ ID NO: 33 - DNA, 25 bp, Artificial Sequence
  primer
gcattccttttatcccagaaacacc

SEQ ID NO: 34 - DNA, 25 bp, Artificial Sequence
  primer
gaagaaatcacaaatcccctgcaag

SEQ ID NO: 35 - DNA, 25 bp, Artificial Sequence
  primer
aatcccctgcaagctattcaaatgg

SEQ ID NO: 36 - DNA, 25 bp, Artificial Sequence
  primer
gtgatggatacgcttggcattcctt

SEQ ID NO: 37 - DNA, 520 bp, Homo sapiens
aaggatcttaactgtgttcgcattttttatccaagcacttagaaaacctacaatcctaattttgatgtccattgttaagaggtggtgatagatactatttttttttcatattgtatagcggttattagaaaagttggggattttcttgatctttattgctgcttaccattgaaacttaacccagctgtgttccccaactctgttctgcgcacgaaacagtatctgtttgaggcataatcttaagtggccacacacaatgttttctcttatgttatctggcagtaactgtaacttgaattacattagcacattctgcttagctaaaattgttaaaataaactttaataaacccatgtagccctctcatttgattgacagtattttagttatttttggcattcttaaagctgggcaatgtaatgatcagatctttgtttgtctgaacaggtatttttatacatgctttttgtaaaccaaaaacttttaaatttcttcaggttttctaacatgcttaccactg

SEQ ID NO: 38 - DNA, 25 bp, Artificial Sequence
  primer
aaggatcttaactgtgttcgcattt

SEQ ID NO: 39 - DNA, 25 bp, Artificial Sequence
  primer
gttcgcattttttatccaagcactt

SEQ ID NO: 40 - DNA, 25 bp, Artificial Sequence
  primer
aatcctaattttgatgtccattgtt

SEQ ID NO: 41 - DNA, 25 bp, Artificial Sequence
  primer
gttggggattttcttgatctttatt

SEQ ID NO: 42 - DNA, 25 bp, Artificial Sequence
  primer
tattgctgcttaccattgaaactta

SEQ ID NO: 43 - DNA, 25 bp, Artificial Sequence
  primer
tgaaacttaacccagctgtgttccc

SEQ ID NO: 44 - DNA, 25 bp, Artificial Sequence
  primer
aactctgttctgcgcacgaaacagt

SEQ ID NO: 45 - DNA, 25 bp, Artificial Sequence
  primer
ttaagtggccacacacaatgttttc

SEQ ID NO: 46 - DNA, 25 bp, Artificial Sequence
  primer
gttttctcttatgttatctggcagt

SEQ ID NO: 47 - DNA, 25 bp, Artificial Sequence
  primer
gccctctcatttgattgacagtatt

SEQ ID NO: 48 - DNA, 25 bp, Artificial Sequence
  primer
aggttttctaacatgcttaccactg

SEQ ID NO: 49 - DNA, 549 bp, Homo sapiens
gaatgtgccactgtatgtcaacctcatgaagaatgaagaggtcttggtatcagcctatgccaatgatggtgctccagaccatgaaactgctagcaatcatgcaattcttcagctcttccagggagaccagatatggttacgtctgcacaggggagcaatttatggaagtagctggaaatattctacgttttcaggctatcttctttatcaagattgaaagtcagtacagtattgacaataaaaggatggtgttctaattagtgggattgaaggaaaagtagtctttgccctcatgactgattggtttaggaaaatgtttttgttcctagagggaggaggtccttacttttttgttttccttcctgaggtgaaaaatcaagctgaatgacaattagcactaatctggcactttataaattgtgatgtagcctcgctagtcaagctgtgaatgtatattgtttgcacttaatccttaactgtattaacgttcagcttactaaactgactgcctcaagtccaggcaagttacaatgccttgttgtgcctcaa

SEQ ID NO: 50 - DNA, 25 bp, Artificial Sequence
  primer
gaatgtgccactgtatgtcaacctc

SEQ ID NO: 51 - DNA, 25 bp, Artificial Sequence
  primer
agaggtcttggtatcagcctatgcc

SEQ ID NO: 52 - DNA, 25 bp, Artificial Sequence
  primer
gcctatgccaatgatggtgctccag

SEQ ID NO: 53 - DNA, 25 bp, Artificial Sequence
  primer
ggtgctccagaccatgaaactgcta

SEQ ID NO: 54 - DNA, 25 bp, Artificial Sequence
  primer
gcaatcatgcaattcttcagctctt

SEQ ID NO: 55 - DNA, 25 bp, Artificial Sequence
  primer
gatatggttacgtctgcacagggga

SEQ ID NO: 56 - DNA, 25 bp, Artificial Sequence
  primer
atattctacgttttcaggctatctt

SEQ ID NO: 57 - DNA, 25 bp, Artificial Sequence
  primer
tctttgccctcatgactgattggtt

SEQ ID NO: 58 - DNA, 25 bp, Artificial Sequence
  primer
gtagcctcgctagtcaagctgtgaa

SEQ ID NO: 59 - DNA, 25 bp, Artificial Sequence
  primer
agcttactaaactgactgcctcaag

SEQ ID NO: 60 - DNA, 25 bp, Artificial Sequence
  primer
gttacaatgccttgttgtgcctcaa

SEQ ID NO: 61 - DNA, 426 bp, Homo sapiens
aaagatacagaagaactaaagagctgtggtatacaagacatatttgttttctacaccagaggggaactgtcaaaatatagagtcccaaaccttctggatctctaccagcaatgtggaattatcacccatcatcatccaatcgcagatggagggactcctgacatagccagctgctgtgaaataatggaagagcttacaacctgccttaaaaattaccgaaaaaccttaatacactgctatggaggacttgggagatcttgtcttgtagctgcttgtctcctactatacctgtctgacacaatatcaccagagcaagccatagacagcctgcgagacctaagaggatccggggcaatacagaccatcaagcaatacaattatcttcatgagtttcgggacaaattagctgcacatctatcatcaaga

SEQ ID NO: 62 - DNA, 25 bp, Artificial Sequence
  primer
tttctcggtttatgtgctcttccag

SEQ ID NO: 63 - DNA, 25 bp, Artificial Sequence
  primer
tagagtcccaaaccttctggatctc

SEQ ID NO: 64 - DNA, 25 bp, Artificial Sequence
  primer
ggatctctaccagcaatgtggaatt

SEQ ID NO: 65 - DNA, 25 bp, Artificial Sequence
  primer
acccatcatcatccaatcgcagatg

SEQ ID NO: 66 - DNA, 25 bp, Artificial Sequence
  primer
ctcctgacatagccagctgctgtga

SEQ ID NO: 67 - DNA, 25 bp, Artificial Sequence
  primer
tggaagagcttacaacctgccttaa

SEQ ID NO: 68 - DNA, 25 bp, Artificial Sequence
  primer
ggaggacttgggagatcttgtcttg

SEQ ID NO: 69 - DNA, 25 bp, Artificial Sequence
  primer
gacacaatatcaccagagcaagcca

SEQ ID NO: 70 - DNA, 25 bp, Artificial Sequence
  primer
aagccatagacagcctgcgagacct

SEQ ID NO: 71 - DNA, 25 bp, Artificial Sequence
  primer
gaggatccggggcaatacagaccat

SEQ ID NO: 72 - DNA, 25 bp, Artificial Sequence
  primer
attagctgcacatctatcatcaaga

SEQ ID NO: 73 - DNA, 496 bp, Homo sapiens
cgctctcgtttcattttctgcagcgcgccacgaggatggcccacaagcagatctactactcggacaagtacttcgacgaacactacgagtaccggcatgttatgttacccagagaactttccaaacaagtacctaaaactcatctgatgtctgaagaggagtggaggagacttggtgtccaacagagtctaggctgggttcattacatgattcatgagccagaaccacatattcttctctttagacgacctcttccaaaagatcaacaaaaatgaagtttatctggggatcgtcaaatctttttcaaatttaatgtatatgtgtatataaggtagtattcagtgaatacttgagaaatgtacaaatctttcatccatacctgtgcatgagctgtattcttcacagcaacagagctcagttaaatgcaactgcaagtaggttactgtaagatgtttaagataaaagttcttccagtcagtttttctcttaagtgcct

SEQ ID NO: 74 - DNA, 25 bp, Artificial Sequence
  primer
cgctctcgtttcattttctgcagcg

SEQ ID NO: 75 - DNA, 25 bp, Artificial Sequence
  primer
cgacgaacactacgagtaccggcat

SEQ ID NO: 76 - DNA, 25 bp, Artificial Sequence
  primer
ttatgttacccagagaactttccaa

SEQ ID NO: 77 - DNA, 25 bp, Artificial Sequence
  primer
acttggtgtccaacagagtctaggc

SEQ ID NO: 78 - DNA, 25 bp, Artificial Sequence
  primer
tattcttctctttagacgacctctt

SEQ ID NO: 79 - DNA, 25 bp, Artificial Sequence
  primer
tctctttagacgacctcttccaaaa

SEQ ID NO: 80 - DNA, 25 bp, Artificial Sequence
  primer
acaaatctttcatccatacctgtgc

SEQ ID NO: 81 - DNA, 25 bp, Artificial Sequence
  primer
gtgcatgagctgtattcttcacagc

SEQ ID NO: 82 - DNA, 25 bp, Artificial Sequence
  primer
gcaacagagctcagttaaatgcaac

SEQ ID NO: 83 - DNA, 25 bp, Artificial Sequence
  primer
gataaaagttcttccagtcagtttt

SEQ ID NO: 84 - DNA, 25 bp, Artificial Sequence
  primer
cagtcagtttttctcttaagtgcct

SEQ ID NO: 85 - DNA, 390 bp, Homo sapiens
gaaggtgtggttttcatttctcagtcaccaacagatgaataattatgcttaataataaagtatttattaagactttcttcagagtatgaaagtacaaaaagtctagttacagtggatttagaatatatttatgttgatgtcaaacagctgagcaccgtagcatgcagatgtcaaggcagttaggaagtaaatggtgtcttgtagatatgtgcaaggtagcatgatgagcaacttgagtttgttgccactgagaagcaggcgggttgggtgggaggaggaagaaagggaagaattaggtttgaattgctttttaaaaaaaaaagaaaagaaaaagacagcatctcactatgttgccaaggctcatcttgagaagcaggcgggttgggtggg

SEQ ID NO: 86 - DNA, 25 bp, Artificial Sequence
  primer
gaaggtgtggttttcatttctcagt

SEQ ID NO: 87 - DNA, 25 bp, Artificial Sequence
  primer
atttctcagtcaccaacagatgaat

SEQ ID NO: 88 - DNA, 25 bp, Artificial Sequence
  primer
atgtcaaacagctgagcaccgtagc

SEQ ID NO: 89 - DNA, 25 bp, Artificial Sequence
  primer
gagcaccgtagcatgcagatgtcaa

SEQ ID NO: 90 - DNA, 25 bp, Artificial Sequence
  primer
gcagatgtcaaggcagttaggaagt

SEQ ID NO: 91 - DNA, 25 bp, Artificial Sequence
  primer
aatggtgtcttgtagatatgtgcaa

SEQ ID NO: 92 - DNA, 25 bp, Artificial Sequence
  primer
tgcaaggtagcatgatgagcaactt

SEQ ID NO: 93 - DNA, 25 bp, Artificial Sequence
  primer
gagcaacttgagtttgttgccactg

SEQ ID NO: 94 - DNA, 25 bp, Artificial Sequence
  primer
gccactgagaagcaggcgggttggg

SEQ ID NO: 95 - DNA, 25 bp, Artificial Sequence
  primer
tatgttgccaaggctcatcttgaga

SEQ ID NO: 96 - DNA, 25 bp, Artificial Sequence
  primer
ttgagaagcaggcgggttgggtggg

SEQ ID NO: 97 - DNA, 338 bp, Homo sapiens
  misc_feature (46)..(46): n is a, c, g, or t
ccttttcacccttgcttaatagccagagctgtttcatgcctggggnacacacaattctaatgctggactttttcctgggtcatgctgcaacactgatgtcagagcatgtttttnaatgtnctgtggncaggggcagtgattattcngggtgtggataatgtaagaagttacagcagagctccattctaaggcacttggctctcagttttctcagagtgaacatgcctcgtagcttgggtcctatggcaggagtgcaataggacatggatatgcatcacctgttctataaaactggttgctggctgggngcggtggctcaactcgtataatcccaacac

SEQ ID NO: 98 - DNA, 25 bp, Artificial Sequence
  primer
ccttttcacccttgcttaatagcca

SEQ ID NO: 99 - DNA, 25 bp, Artificial Sequence
  primer
ttaatagccagagctgtttcatgcc

SEQ ID NO: 100 - DNA, 25 bp, Artificial Sequence
  primer
cacacaattctaatgctggactttt

SEQ ID NO: 101 - DNA, 25 bp, Artificial Sequence
  primer
ctttttcctgggtcatgctgcaaca

SEQ ID NO: 102 - DNA, 25 bp, Artificial Sequence
  primer
gcagagctccattctaaggcacttg

SEQ ID NO: 103 - DNA, 25 bp, Artificial Sequence
  primer
ttctaaggcacttggctctcagttt

SEQ ID NO: 104 - DNA, 25 bp, Artificial Sequence
  primer
ggctctcagttttctcagagtgaac

SEQ ID NO: 105 - DNA, 25 bp, Artificial Sequence
  primer
agtgaacatgcctcgtagcttgggt

SEQ ID NO: 106 - DNA, 25 bp, Artificial Sequence
  primer
tcgtagcttgggtcctatggcagga

SEQ ID NO: 107 - DNA, 25 bp, Artificial Sequence
  primer
tgcatcacctgttctataaaactgg

SEQ ID NO: 108 - DNA, 25 bp, Artificial Sequence
  primer
ggctcaactcgtataatcccaacac

SEQ ID NO: 109 - DNA, 467 bp, Homo sapiens
tataggatattcccaagccgaccttccctccgccttctcccacatgaggccatctcaggagatggagggcttggcccagcgccaagtaaacagggtacctcaagccccatttcctcacactaagagggcagactgtgaacttgactgggtgagacccaaagcggtccctgtccctctagtgccttctttagaccctcgggccccatcctcatccctgactggccaaacccttgctttcctgggcctttgcaagatgcttggttgtgttgaggtttttaaatatatattttgtactttgtggagagaatgtgtgtgtgtggcagggggccccgccagggctggggacagagggtgtcaaacattcgtgagctggggactcagggaccggtgctgcaggagtgtcctgcccatgccccagtcggccccatctctcatccttttggataagtttctattctgtcagtgtt

SEQ ID NO: 110 - DNA, 25 bp, Artificial Sequence
  primer
tataggatattcccaagccgacctt

SEQ ID NO: 111 - DNA, 25 bp, Artificial Sequence
  primer
tggcccagcgccaagtaaacagggt

SEQ ID NO: 112 - DNA, 25 bp, Artificial Sequence
  primer
taaacagggtacctcaagccccatt

SEQ ID NO: 113 - DNA, 25 bp, Artificial Sequence
  primer
gggcagactgtgaacttgactgggt

SEQ ID NO: 114 - DNA, 25 bp, Artificial Sequence
  primer
ctgggtgagacccaaagcggtccct

SEQ ID NO: 115 - DNA, 25 bp, Artificial Sequence
  primer
tcctgggcctttgcaagatgcttgg

SEQ ID NO: 116 - DNA, 25 bp, Artificial Sequence
  primer
agatgcttggttgtgttgaggtttt

SEQ ID NO: 117 - DNA, 25 bp, Artificial Sequence
  primer
gggtgtcaaacattcgtgagctggg

SEQ ID NO: 118 - DNA, 25 bp, Artificial Sequence
  primer
agggaccggtgctgcaggagtgtcc

SEQ ID NO: 119 - DNA, 25 bp, Artificial Sequence
  primer
cccatctctcatccttttggataag

SEQ ID NO: 120 - DNA, 25 bp, Artificial Sequence
  primer
gataagtttctattctgtcagtgtt

SEQ ID NO: 121 - DNA, 523 bp, Homo sapiens
aacagagatgtcccccagggagcacatcaagggcaaagagaccaccccctctagcctagcagtgacccagaccatggccaccaaagctcccgagtgtgtggaggacccagatatggcaaaccagaggaagactgccctggagttctgtggagagacttggagctctctctgcacattcttcctcagcatagtgcaggacacgtcatgctaatgaggtcaaaagagaacgggttcctttaagagatgtcatgtcgtaagtccctctgtatactttaaagctctctacagtccccccaaaatatgaacttttgtgcttagtgagtgcaacgaaatatttaaacaagttttgtattttttgcttttgtgttttggaatttgccttatttttcttggatgcgatgttcagaggctgtttcctgcagcatgtatttccatggcccacacagctatgtgtttgagcagcgaagagtctttgagctgaatgagccagagtgataatttcagtgcaacgaactttctgctg

SEQ ID NO: 122 - DNA, 25 bp, Artificial Sequence
  primer
aacagagatgtcccccagggagcac

SEQ ID NO: 123 - DNA, 25 bp, Artificial Sequence
  primer
gccaccaaagctcccgagtgtgtgg

SEQ ID NO: 124 - DNA, 25 bp, Artificial Sequence
  primer
cagaggaagactgccctggagttct

SEQ ID NO: 125 - DNA, 25 bp, Artificial Sequence
  primer
cagaggaagactgccctggagttct

SEQ ID NO: 126 - DNA, 25 bp, Artificial Sequence
  primer
agtgcaggacacgtcatgctaatga

SEQ ID NO: 127 - DNA, 25 bp, Artificial Sequence
  primer
gagatgtcatgtcgtaagtccctct

SEQ ID NO: 128 - DNA, 25 bp, Artificial Sequence
  primer
tactttaaagctctctacagtcccc

SEQ ID NO: 129 - DNA, 25 bp, Artificial Sequence
  primer
tctacagtccccccaaaatatgaac

SEQ ID NO: 130 - DNA, 25 bp, Artificial Sequence
  primer
gaggctgtttcctgcagcatgtatt

SEQ ID NO: 131 - DNA, 25 bp, Artificial Sequence
  primer
tccatggcccacacagctatgtgtt

SEQ ID NO: 132 - DNA, 25 bp, Artificial Sequence
  primer
tttcagtgcaacgaactttctgctg

SEQ ID NO: 133 - DNA, 569 bp, Homo sapiens
ggaaccatggacacagtttctctcagtgggactattccagttcaaatgcttttggaaattggtttggacaaactaaagaaagattatatcagttttttcataggtcaggaacttgcatctttgaatcatttggaatacttcattgctccatcagtagatatacaagaacaggtttatcgtgtccaaaaactccaccatattctagaaatattagtcagttgcatgcctttcattaaatctcaacatgaactcctcttttctttaacacagatctgcataaagtattacaaacaaaatcctcttgatgagcaacacatttttcagctgccagtcagaccaactgctgtaaagaacttatatcaaagtgagaagccacagaaatggagagtggaaatatatagtggtcaaaagaagattaagacagtttggcaactgagtgacagctcacccataggccatctgaattttcacaaacctgatttttcggaattaacactaagcggtagcctggaagaaaggatattctttactaacatggttacctgcagccaggtgcatttcaagtgaag

SEQ ID NO: 134 - DNA, 25 bp, Artificial Sequence
  primer
ggaaccatggacacagtttctctca

SEQ ID NO: 135 - DNA, 25 bp, Artificial Sequence
  primer
cagtttctctcagtgggactattcc

SEQ ID NO: 136 - DNA, 25 bp, Artificial Sequence
  primer
cataggtcaggaacttgcatctttg

SEQ ID NO: 137 - DNA, 25 bp, Artificial Sequence
  primer
gaatacttcattgctccatcagtag

SEQ ID NO: 138 - DNA, 25 bp, Artificial Sequence
  primer
tatcgtgtccaaaaactccaccata

SEQ ID NO: 139 - DNA, 25 bp, Artificial Sequence
  primer
aatattagtcagttgcatgcctttc

SEQ ID NO: 140 - DNA, 25 bp, Artificial Sequence
  primer
gcatgcctttcattaaatctcaaca

SEQ ID NO: 141 - DNA, 25 bp, Artificial Sequence
  primer
atctcaacatgaactcctcttttct

SEQ ID NO: 142 - DNA, 25 bp, Artificial Sequence
  primer
ctgccagtcagaccaactgctgtaa

SEQ ID NO: 143 - DNA, 25 bp, Artificial Sequence
  primer
ttactaacatggttacctgcagcca

SEQ ID NO: 144 - DNA, 25 bp, Artificial Sequence
  primer
gcagccaggtgcatttcaagtgaag

SEQ ID NO: 145 - DNA, 472 bp, Homo sapiens
tcaattgacttctgttccttgcttttagttttgatagaagggaagacctgcagtgcacggtttcttccaggctgaggtacctggatcttgggttcttcactgcagggacccagacaagtggatctgcttgccagagtcctttttgcccctccctgccacctccccgtgtttccaagtcagctttcctgcaagaagaaatcctggttaaaaaagtcttttgtattgggtcaggagttgaatttggggtgggaggatggatgcaactgaagcagagtgtgggtgcccagatgtgcgctattagatgtttctctgataatgtccccaatcataccagggagactggcattgacgagaactcaggtggaggcttgagaaggccgaaagggcccctgacctgcctggcttccttagcttgcccctcagctttgcaaagagccaccctaggccccagctgaccgcatgggtgtgagcc

SEQ ID NO: 146 - DNA, 25 bp, Artificial Sequence
  primer
tcaattgacttctgttccttgcttt

SEQ ID NO: 147 - DNA, 25 bp, Artificial Sequence
  primer
aagacctgcagtgcacggtttcttc

SEQ ID NO: 148 - DNA, 25 bp, Artificial Sequence
  primer
cggtttcttccaggctgaggtacct

SEQ ID NO: 149 - DNA, 25 bp, Artificial Sequence
  primer
gaggtacctggatcttgggttcttc

SEQ ID NO: 150 - DNA, 25 bp, Artificial Sequence
  primer
tgggttcttcactgcagggacccag

SEQ ID NO: 151 - DNA, 25 bp, Artificial Sequence
  primer
aagtggatctgcttgccagagtcct

SEQ ID NO: 152 - DNA, 25 bp, Artificial Sequence
  primer
tgtttccaagtcagctttcctgcaa

SEQ ID NO: 153 - DNA, 25 bp, Artificial Sequence
  primer
gtgcccagatgtgcgctattagatg

SEQ ID NO: 154 - DNA, 25 bp, Artificial Sequence
  primer
gatgtttctctgataatgtccccaa

SEQ ID NO: 155 - DNA, 25 bp, Artificial Sequence
  primer
ttgcccctcagctttgcaaagagcc

SEQ ID NO: 156 - DNA, 25 bp, Artificial Sequence
  primer
ccagctgaccgcatgggtgtgagcc

SEQ ID NO: 157 - DNA, 353 bp, Homo sapiens
aattcgagtctatacaaaagccttgagttctttagaactcagtagccatcttgcaaaagatcttctggttctattgaatgagattctggagcaagtaaaagataggacatgtctgagagctttggagaaaatcaagattcagttagaaaaaggaaataaagaatttggtgaccaagctgaagcagcacaggatgccaccttgactacaactactttccaaaatgaagatgaaaagaataaagaagtatatatgactccactcaggggtgtaaaagcaacccaagcatcaaagtctactcagctaaagactaacagaggacagagaaaagtgacagtttcagctaggacgaaca

SEQ ID NO: 158 - DNA, 25 bp, Artificial Sequence
  primer
aattcgagtctatacaaaagccttg

SEQ ID NO: 159 - DNA, 25 bp, Artificial Sequence
  primer
agttctttagaactcagtagccatc

SEQ ID NO: 160 - DNA, 25 bp, Artificial Sequence
  primer
gtagccatcttgcaaaagatcttct

SEQ ID NO: 161 - DNA, 25 bp, Artificial Sequence
  primer
aagatcttctggttctattgaatga

SEQ ID NO: 162 - DNA, 25 bp, Artificial Sequence
  primer
aggacatgtctgagagctttggaga

SEQ ID NO: 163 - DNA, 25 bp, Artificial Sequence
  primer
atttggtgaccaagctgaagcagca

SEQ ID NO: 164 - DNA, 25 bp, Artificial Sequence
  primer
tgaagcagcacaggatgccaccttg

SEQ ID NO: 165 - DNA, 25 bp, Artificial Sequence
  primer
gaagtatatatgactccactcaggg

SEQ ID NO: 166 - DNA, 25 bp, Artificial Sequence
  primer
gactccactcaggggtgtaaaagca

SEQ ID NO: 167 - DNA, 25 bp, Artificial Sequence
  primer
ccaagcatcaaagtctactcagcta

SEQ ID NO: 168 - DNA, 25 bp, Artificial Sequence
  primer
gtgacagtttcagctaggacgaaca

SEQ ID NO: 169 - DNA, 476 bp, Homo sapiens
aaaacatgggcgcttacactgttgctgctgcctctacgttcaatggcttccagaggccgacgatctactatgtgatgtcagggcctgcgtggcaactcatgcagcaattccagaaccccgacttcccacccgaagtagaggaacaggatgccagcaccctgcctgtgtcttgtgcctgggagagtgggatgaaacgccacagagcagcctgtgcttcggctagtattaatgtgtagatagcactctggtagctgttaactgcaagtttagcttgaattaagggatttggggggaccatgtaacttaattactgctagttttgaaatgtctttgtaagagtagggtcgccatgatgcagccatatggaagactaggatatgggtcacacttatctgtgttcctatggaaactatttgaatatttgttttatatggatttttattcactcttcagacacgctactcaagagtgcccct

SEQ ID NO: 170 - DNA, 25 bp, Artificial Sequence
  primer
aaaacatgggcgcttacactgttgc

SEQ ID NO: 171 - DNA, 25 bp, Artificial Sequence
  primer
tgctgcctctacgttcaatggcttc

SEQ ID NO: 172 - DNA, 25 bp, Artificial Sequence
  primer
ccagaggccgacgatctactatgtg

SEQ ID NO: 173 - DNA, 25 bp, Artificial Sequence
  primer
tactatgtgatgtcagggcctgcgt

SEQ ID NO: 174 - skipped
  primer

SEQ ID NO: 175 - DNA, 25 bp, Artificial Sequence
  primer
gcagcctgtgcttcggctagtatta

SEQ ID NO: 176 - DNA, 25 bp, Artificial Sequence
  primer
agcactctggtagctgttaactgca

SEQ ID NO: 177 - DNA, 25 bp, Artificial Sequence
  primer
agagtagggtcgccatgatgcagcc

SEQ ID NO: 178 - DNA, 25 bp, Artificial Sequence
  primer
gggtcacacttatctgtgttcctat

SEQ ID NO: 179 - DNA, 25 bp, Artificial Sequence
  primer
ttattcactcttcagacacgctact

SEQ ID NO: 180 - DNA, 25 bp, Artificial Sequence
  primer
agacacgctactcaagagtgcccct

SEQ ID NO: 181 - DNA, 375 bp, Homo sapiens
ttttaccttggatgctgacttctaaatgaactgaagatgtgcccttacttggctgattttttttttccatctcataagaaaaatcagctgaagtgttaccaactagccacaccatgaattgtccgtaatgttcattaacagcatctttaaaactgtgtagctacctcacaaccagtcctgtctgtttatagtgctggtagtatcaccttttgccagaaggcctggctggctgtgacttaccatagcagtgacaatggcagtcttggctttaaagtgaggggtgaccctttagtgagcttagcacagcgggattaaacagtcctttaaccagcacagccagttaaaagatgcagcctcactgcttcaacgcagatt

SEQ ID NO: 182 - DNA, 25 bp, Artificial Sequence
  primer
ttttaccttggatgctgacttctaa

SEQ ID NO: 183 - DNA, 25 bp, Artificial Sequence
  primer
gaagatgtgcccttacttggctgat

SEQ ID NO: 184 - DNA, 25 bp, Artificial Sequence
  primer
gaagtgttaccaactagccacacca

SEQ ID NO: 185 - DNA, 25 bp, Artificial Sequence
  primer
ctagccacaccatgaattgtccgta

SEQ ID NO: 186 - DNA, 25 bp, Artificial Sequence
  primer
aactgtgtagctacctcacaaccag

SEQ ID NO: 187 - DNA, 25 bp, Artificial Sequence
  primer
ctcacaaccagtcctgtctgtttat

SEQ ID NO: 188 - DNA, 25 bp, Artificial Sequence
  primer
gtgctggtagtatcaccttttgcca

SEQ ID NO: 189 - DNA, 25 bp, Artificial Sequence
  primer
cctggctggctgtgacttaccatag

SEQ ID NO: 190 - DNA, 25 bp, Artificial Sequence
  primer
gaccctttagtgagcttagcacagc

SEQ ID NO: 191 - DNA, 25 bp, Artificial Sequence
  primer
taaacagtcctttaaccagcacagc

SEQ ID NO: 192 - DNA, 25 bp, Artificial Sequence
  primer
cagcctcactgcttcaacgcagatt

SEQ ID NO: 193 - DNA, 525 bp, Homo sapiens
  misc_feature (44)..(44): n is a, c, g, or t
cgatgcaagtgtttctgttctgggaggtattggagggaaaaaancaagcaggatggctggaacactgtactgaggaatgaatagaaaggcttccagatgtctaaaagattctttaaactactgaactgttacctaggttaacaaccctgttgagtatttgctgtttgtccagttcaggaatttttgttttgttttgtctatatgtgcggcttttcagaagaaatttaatcagtgtgacagaaaaaaaaatgttttatggtagcttttactttttatgaaaaaaaaattatttgccttttaaattcttttcccccatccccctccaaagtcttgatagcaagcgttattttgggggtagaaacggtgaaatctctagcctctttgtgtttttgttgttgttgttgttgttgttttatataatgcatgtattcactaaaataaaatttaaaaaactcctgtcttgctagacaaggttgctgttgtgcagtgtgcctgtcactactggtctgtactccttggatttgc

SEQ ID NO: 194 - DNA, 25 bp, Artificial Sequence
  primer
cgatgcaagtgtttctgttctggga

SEQ ID NO: 195 - DNA, 25 bp, Artificial Sequence
  primer
ggatggctggaacactgtactgagg

SEQ ID NO: 196 - DNA, 25 bp, Artificial Sequence
  primer
taaactactgaactgttacctaggt

SEQ ID NO: 197 - DNA, 25 bp, Artificial Sequence
  primer
aacaaccctgttgagtatttgctgt

SEQ ID NO: 198 - DNA, 25 bp, Artificial Sequence
  primer
gagtatttgctgtttgtccagttca

SEQ ID NO: 199 - DNA, 25 bp, Artificial Sequence
  primer
gttttgtctatatgtgcggcttttc

SEQ ID NO: 200 - DNA, 25 bp, Artificial Sequence
  primer
tccccctccaaagtcttgatagcaa

SEQ ID NO: 201 - DNA, 25 bp, Artificial Sequence
  primer
aaacggtgaaatctctagcctcttt

SEQ ID NO: 202 - DNA, 25 bp, Artificial Sequence
  primer
ttaaaaaactcctgtcttgctagac

SEQ ID NO: 203 - DNA, 25 bp, Artificial Sequence
  primer
tgttgtgcagtgtgcctgtcactac

SEQ ID NO: 204 - DNA, 25 bp, Artificial Sequence
  primer
actggtctgtactccttggatttgc

SEQ ID NO: 205 - DNA, 268 bp, Homo sapiens
tgccctgaccccgatcagttaaggagctgtgcaataaccttcctagtacctgagtgagtgtgtaacttattgggttggcgaagcctggtaaagctgttggaatgagtatgtgattctttttaagtatgaaaataaagatatatgtacagacttgtattttttctctggtggcattcctttaggaatgctgtgtgtctgtccggcaccccggtaggcctgattgggtttctagtcctccttaaccacttatctcccatatgagagtgtg

SEQ ID NO: 206 - DNA, 25 bp, Artificial Sequence
  primer
tgccctgaccccgatcagttaagga

SEQ ID NO: 207 - DNA, 25 bp, Artificial Sequence
  primer
gaccccgatcagttaaggagctgtg

SEQ ID NO: 208 - DNA, 25 bp, Artificial Sequence
  primer
gagctgtgcaataaccttcctagta

SEQ ID NO: 209 - DNA, 25 bp, Artificial Sequence
  primer
gctgtgcaataaccttcctagtacc

SEQ ID NO: 210 - DNA, 25 bp, Artificial Sequence
  primer
aaagctgttggaatgagtatgtgat

SEQ ID NO: 211 - DNA, 25 bp, Artificial Sequence
  primer
ttgtattttttctctggtggcattc

SEQ ID NO: 212 - DNA, 25 bp, Artificial Sequence
  primer
ttttttctctggtggcattccttta

SEQ ID NO: 213 - DNA, 25 bp, Artificial Sequence
  primer
ttctctggtggcattcctttaggaa

SEQ ID NO: 214 - DNA, 25 bp, Artificial Sequence
  primer
attcctttaggaatgctgtgtgtct

SEQ ID NO: 215 - DNA, 25 bp, Artificial Sequence
  primer
ttaaccacttatctcccatatgaga

SEQ ID NO: 216 - DNA, 25 bp, Artificial Sequence
  primer
cacttatctcccatatgagagtgtg

SEQ ID NO: 217 - DNA, 480 bp, Homo sapiens
gcagctccagctcagagcagtgccagccccaccgcaactgcacggccctgggcctggccctcaatgtgccaggctcttcctcccatgacaccctgtgcaccagctgcactggcttccccctcagcaccagggtaccaggagctgaggagtgtgagcgtgccgtcatcgactttgtggctttccaggacatctccatcaagaggctgcagcggctgctgcaggccctcgaggccccggagggctggggtccgacaccaagggcgggccgcgcggccttgcagctgaagctgcgtcggcggctcacggagctcctgggggcgcaggacggggcgctgctggtgcggctgctgcaggcgctgcgcgtggccaggatgcccgggctggagcggagcgtccgtgagcgcttcctccctgtgcactgatcctggccccctcttatttattctacatccttggcaccccacttgcactgaaagaggc

SEQ ID NO: 218 - DNA, 25 bp, Artificial Sequence
  primer
gcagctccagctcagagcagtgcca

SEQ ID NO: 219 - DNA, 25 bp, Artificial Sequence
  primer
gggcctggccctcaatgtgccaggc

SEQ ID NO: 220 - DNA, 25 bp, Artificial Sequence
  primer
agcaccagggtaccaggagctgagg

SEQ ID NO: 221 - DNA, 25 bp, Artificial Sequence
  primer
agctgaggagtgtgagcgtgccgtc

SEQ ID NO: 222 - DNA, 25 bp, Artificial Sequence
  primer
tgccgtcatcgactttgtggctttc

SEQ ID NO: 223 - DNA, 25 bp, Artificial Sequence
  primer
tttgtggctttccaggacatctcca

SEQ ID NO: 224 - DNA, 25 bp, Artificial Sequence
  primer
gacatctccatcaagaggctgcagc

SEQ ID NO: 225 - DNA, 25 bp, Artificial Sequence
  primer
gaggctgcagcggctgctgcaggcc

SEQ ID NO: 226 - DNA, 25 bp, Artificial Sequence
  primer
tgcagctgaagctgcgtcggcggct

SEQ ID NO: 227 - DNA, 25 bp, Artificial Sequence
  primer
ccctcttatttattctacatccttg

SEQ ID NO: 228 - DNA, 25 bp, Artificial Sequence
  primer
gcaccccacttgcactgaaagaggc

SEQ ID NO: 229 - DNA, 562 bp, Homo sapiens
gaagaaccatcgaaacctgtttgttcccagcccacccccagtggatgggatgcataatgccagcaagttttgtttaacagcaaaaaaggaagattaatgcaggtgttatagaagccagaagagaaactgtgtcaccctaaagaagcatataatcatagcattaaaaatgcacacattactccaggtggaaggtggcaattgctttctgatatcagctcgtttgatttagtgcaaaaatgttttcaagactatttaatggatgtaaaaaagcctatttctacattataccaactgagaaaaaaatggtcggtaaagtgttctttcataataaataatcaagacatggtcccatttgcaggaaaagtgcagactctgagtgttccagggaaacacatgctggacatcccttgtaacccggtatgggcgcccctgcattgctgggatgtttctgcccacggttttgtttgtgcaataacgttatcacatttctaatgaggattcacattaatataatataaaataaataggtcagttactggtctctttctgccgaatgttatgt

SEQ ID NO: 230 - DNA, 25 bp, Artificial Sequence
  primer
gaagaaccatcgaaacctgtttgtt

SEQ ID NO: 231 - DNA, 25 bp, Artificial Sequence
  primer
aaatgcacacattactccaggtgga

SEQ ID NO: 232 - DNA, 25 bp, Artificial Sequence
  primer
ggtggcaattgctttctgatatcag

SEQ ID NO: 233 - DNA, 25 bp, Artificial Sequence
  primer
atcaagacatggtcccatttgcagg

SEQ ID NO: 234 - DNA, 25 bp, Artificial Sequence
  primer
gtgcagactctgagtgttccaggga

SEQ ID NO: 235 - DNA, 25 bp, Artificial Sequence
  primer
gaaacacatgctggacatcccttgt

SEQ ID NO: 236 - DNA, 25 bp, Artificial Sequence
  primer
catcccttgtaacccggtatgggcg

SEQ ID NO: 237 - DNA, 25 bp, Artificial Sequence
  primer
ctgcattgctgggatgtttctgccc

SEQ ID NO: 238 - DNA, 25 bp, Artificial Sequence
  primer
ctgcccacggttttgtttgtgcaat

SEQ ID NO: 239 - DNA, 25 bp, Artificial Sequence
  primer
ataggtcagttactggtctctttct

SEQ ID NO: 240 - DNA, 25 bp, Artificial Sequence
  primer
ggtctctttctgccgaatgttatgt

SEQ ID NO: 241 - DNA, 329 bp, Homo sapiens
ctcttcgagagaacctgtcgccagtatgacaagctgcgtaagcgggaggccttcctggagcagttccgcaaggaggacatgttcaaggacaactttgatgagatggacacatccagggagattgtgcagcagctcatcgatgagtaccatgcggccacacggccagactacatctcctggggcacccaggagcagtgagtcccccaggacaggggaccctcatctgccttactggttggcccaagccctgcctgactgaccaccccctcagagcacagatcagggacctcacgcatctctttctcatatacatggactctctgttggcc

SEQ ID NO: 242 - DNA, 25 bp, Artificial Sequence
  primer
ctcttcgagagaacctgtcgccagt

SEQ ID NO: 243 - DNA, 25 bp, Artificial Sequence
  primer
cgagagaacctgtcgccagtatgac

SEQ ID NO: 244 - DNA, 25 bp, Artificial Sequence
  primer
gtcgccagtatgacaagctgcgtaa

SEQ ID NO: 245 - DNA, 25 bp, Artificial Sequence
  primer
gccagtatgacaagctgcgtaagcg

SEQ ID NO: 246 - DNA, 25 bp, Artificial Sequence
  primer
ccttcctggagcagttccgcaagga

SEQ ID NO: 247 - DNA, 25 bp, Artificial Sequence
  primer
gacacatccagggagattgtgcagc

SEQ ID NO: 248 - DNA, 25 bp, Artificial Sequence
  primer
gcagctcatcgatgagtaccatgcg

SEQ ID NO: 249 - DNA, 25 bp, Artificial Sequence
  primer
accccctcagagcacagatcaggga

SEQ ID NO: 250 - DNA, 25 bp, Artificial Sequence
  primer
cctcagagcacagatcagggacctc

SEQ ID NO: 251 - DNA, 25 bp, Artificial Sequence
  primer
tctctttctcatatacatggactct

SEQ ID NO: 252 - DNA, 25 bp, Artificial Sequence
  primer
catatacatggactctctgttggcc

SEQ ID NO: 253 - DNA, 25 bp, Artificial Sequence
  primer
aaattggacctcagtgttgtggaga

SEQ ID NO: 254 - DNA, 25 bp, Artificial Sequence
  primer
gaacctggtgttgaagatacggaat

SEQ ID NO: 255 - DNA, 25 bp, Artificial Sequence
  primer
gatacggaatggtcaaacacacaga

SEQ ID NO: 256 - DNA, 25 bp, Artificial Sequence
  primer
acagacagaggaggccatacagacc

SEQ ID NO: 257 - DNA, 25 bp, Artificial Sequence
  primer
ccatacagacccgttcaagaaccag

SEQ ID NO: 258 - DNA, 25 bp, Artificial Sequence
  primer
tcagatgctgtgaaccagatttcct

SEQ ID NO: 259 - DNA, 25 bp, Artificial Sequence
  primer
gtgagtcttgcgaggtggaattaat

SEQ ID NO: 260 - DNA, 25 bp, Artificial Sequence
  primer
tactccttaagttatcccaaagccg

SEQ ID NO: 261 - DNA, 25 bp, Artificial Sequence
  primer
atcccaaagccgtgtgtttgtgatg

SEQ ID NO: 262 - DNA, 25 bp, Artificial Sequence
  primer
gacacgcacttttctaatcattgta

SEQ ID NO: 263 - DNA, 25 bp, Artificial Sequence
  primer
aaatgtttgacaaagtcctcacttt

(19) United States
(12) Patent Application Publication
(10) Pub. No.: US 2014/0162887 A1
(43) Pub. Date: Jun. 12, 2014

(54) METHODS OF USING GENE EXPRESSION SIGNATURES TO SELECT A METHOD OF TREATMENT, PREDICT PROGNOSIS, SURVIVAL, AND/OR PREDICT RESPONSE TO TREATMENT

(71) Applicants: Katherine J. Martin, Belmont, MA (US); Marcia V. Fournier, Collegeville, PA (US)

(72) Inventors: Katherine J. Martin, Belmont, MA (US); Marcia V. Fournier, Collegeville, PA (US)

(73) Assignee: BIOARRAY THERAPEUTICS, INC., Collegeville, PA (US)

(21) Appl. No.: 13/983,767

(22) PCT Filed: Feb. 6, 2012
(86) PCT No.: PCT/US2012/023997

§ 371 Date: Feb. 26, 2014

Related U.S. Application Data
(60) Provisional application No. 61/439,714, filed on Feb. 4, 2011.
(60) Provisional application No. 61/543,067, filed on Oct. 4, 2011.
(60) Provisional application No. 61/547,155, filed on Oct. 14, 2011.

(51) Int. Cl. G06F 19/00

(52) U.S. Cl. CPC G06F 19/34
USPC 506/8; 506/39; 702/19

(57) ABSTRACT

Methods and compositions for determining and/or predicting a response to a therapy, prognosis of a cancer subject or survival of a cancer and kits for performing the same are described herein.

### CROSS REFERENCE

This application claims priority to U.S. Provisional Application No. 61/439,714, filed Feb. 4, 2011, U.S. Provisional Application No. 61/547,155, filed Oct. 14, 2011, and U.S. Provisional Application No. 61/543,067, filed Oct. 4, 2011, each of which is hereby incorporated by reference in its entirety.

### GOVERNMENT INTERESTS

Not Applicable

### PARTIES TO A JOINT RESEARCH AGREEMENT

Not Applicable

### INCORPORATION BY REFERENCE OF MATERIAL SUBMITTED ON A COMPACT DISC

Not Applicable

### BACKGROUND

Not Applicable

### BRIEF SUMMARY OF THE INVENTION

In some embodiments, the present invention provides methods for predicting a prognosis of a subject diagnosed with triple negative breast cancer, predicting a prognosis of a subject with breast cancer, selecting a treatment for a subject with breast cancer, or predicting a survival outcome of a subject with breast cancer. In some embodiments, the method comprises obtaining a dataset associated with a sample derived from a patient diagnosed with cancer, wherein the dataset comprises expression data for a plurality of markers selected from the group consisting of CKS2, CDKN3, FOXM1, RRM2, VRK1, TRIP13, ASPM, CEP55, ZWILCH, TUBG1, AURKA, SERPINE2, CAPRIN2, TNFRSF6B, CAPG, ACTN1, ACTB, DUSP4, EPHA2, FGFBP1, EIF4A1, ESR1, ODC1 and optionally at least one clinical factor; and determining a predictive score from the dataset using an interpretation function, wherein the predictive score is predictive of one of the following: the prognosis of a subject with triple negative breast cancer, the prognosis of a subject with breast cancer, the selection of a treatment for a subject with breast cancer, or prediction of a survival outcome of a subject with breast cancer, wherein at least one of the plurality of markers is replaced with a co-regulated gene.

In some embodiments, the present invention provides methods for predicting a prognosis of a subject diagnosed with triple negative breast cancer.

In some embodiments, the present invention provides methods of selecting a treatment or for determining a preferred treatment for a subject with cancer comprising obtaining a dataset associated with a sample derived from a subject diagnosed with cancer, wherein the dataset comprises expression data for a plurality of markers, wherein the plurality of markers is: selected from the group consisting of CKS2, CDKN3, FOXM1, RRM2, VRK1, TRIP13, ASPM, CEP55, ZWILCH, TUBG1, AURKA, SERPINE2, CAPRIN2, TNFRSF6B, CAPG, ACTN1, ACTB, DUSP4, EPHA2, FGFBP1, EIF4A1, ESR1, ODC1 and optionally at least one clinical factor; or selected from the group consisting of: AC004010, ACTB, ACTN1, APOE, ASPM, AURKA, BBOX1, BIRC5, BLM, BM039, BNIP3L, C1QDC1, C14ORF147, CDC6, CDC45L, CDK3, CDKN3, CENPA, CEP55, CKS2, COL4A2, CRYAB, DC13, DSG3, DUSP4, EFEMP1, EGR1, EIF4A1, EIF4B, EPHA2, EPHA2, FEN1, FGFBP1, FKBP1B, FLJ10036, FLJ10517, FLJ10540, FLJ10687, FLJ20701, FOSL2, FOXM1, GPNMB, H2AFZ, HCAP-G, HBP17, HPV17, ID-GAP, IGFBP2, KJAA084, KIAA092, KNSL6, KNTC2, KRTC2, KRT10, LEPL, LOC51203, LOC51659, LRP16, LRP8, MAFB, MCM6, MELK, MTB, NCAPG, NUSAP1, ODC, ODC1, PHLDA1, PITRM1, PLK1, POLQ, PPL, PRC1, RAMP, RRM2, RRM3, SEC4L, SEPT10, SERPINE2, SERPINA3, SLC20A1, SMC4L1, SNRPA1, SOX4, SRCAP, SRD5A1, STK6, SUCLG2, SUPT16H, TCF4, THBS1, TNFRSF6B, TRIP13, TUBG1, UCHL5, VRK1, WDR32, ZNF227, and ZWILICH and optionally at least one clinical factor; or selected from the group consisting of: CKS2, FOXM1, RRM2, TRIP13, ASPM, CEP55, AURKA, TUBG1, ZWILCH, CDKN3, VRK1, SERPINE2, FGFBP1, TNFRSF68, CAPG, ACTB, DUSP4, EPHA2, ACTN1, CAPRIN2, EIF4A1, ODC1, AMIGO2, PHLDA, THBS1, LRP8, MPRIP, and SLC20A1 and optionally at least one clinical factor.

In some embodiments, one or more the methods described herein comprises determining the prognosis of the subject, wherein determining the prognosis of the subject comprises: obtaining a dataset associated with a sample derived from the patient diagnosed with cancer, wherein the dataset comprises: expression data for a plurality of markers, wherein the plurality of markers is: selected from the group consisting of CKS2, CDKN3, FOXM1, RRM2, VRK1, TRIP13, ASPM, CEP55, ZWILCH, TUBG1, AURKA, SERPINE2, CAPRIN2, TNFRSF6B, CAPG, ACTN1, ACTB, DUSP4, EPHA2, FGFBP1, EIF4A1, ESR1, ODC1 and optionally at least one clinical factor; or selected from the group consisting of: AC004010, ACTB, ACTN1, APOE, ASPM, AURKA, BBOX1, BIRC5, BLM, BM039, BNIP3L, C1QDC1, C14ORF147, CDC6, CDC45L, CDK3, CDKN3, CENPA, CEP55, CKS2, COL4A2, CRYAB, DC13, DSG3, DUSP4, EFEMP1, EGR1, EIF4A1, EIF4B, EPHA2, EPHA2, FEN1, FGFBP1, FKBP1B, FLJ10036, FLJ10517, FLJ10540, FLJ10687, FLJ20701, FOSL2, FOXM1, GPNMB, H2AFZ, HCAP-G, HBP17, HPV17, ID-GAP, IGFBP2, KIAA084, KIAA092, KNSL6, KNTC2, KRTC2, KRT10, LEPL, LOC51203, LOC51659, LRP16, LRP8, MAFB, MCM6, MELK, MTB, NCAPG, NUSAP1, ODC, ODC1, PHLDA1, PITRM1, PLK1, POLQ, PPL, PRC1, RAMP, RRM2, RRM3, SEC4L, SEPT10, SERPINE2, SERPINA3, SLC20A1, SMC4L1, SNRPA1, SOX4, SRCAP, SRD5A1, STK6, SUCLG2, SUPT16H, TCF4, THBS1, TNFRSF6B, TRIP13, TUBG1, UCHL5, VRK1, WDR32, ZNF227, and ZWILICH and optionally at least one clinical factor; or selected from the group consisting of: CKS2, FOXM1, RRM2, TRIP13, ASPM, CEP55, AURKA, TUBG1, ZWILCH, CDKN3, VRK1, SERPINE2, FGFBP1, TNFRSF68, CAPG, ACTB, DUSP4, EPHA2, ACTN1, CAPRIN2, EIF4A1, ODC1, AMIGO2, PHLDA, THBS1, LRP8, MPRIP, and SLC20A1 and optionally at least one clinical factor; or selected from the group consisting of CKS2, CDKN3, FOXM1, RRM2, VRK1, TRIP13, ASPM, CEP55, ZWILCH, TUBG1, AURKA, SERPINE2, CAPRIN2, TNFRSF6B, CAPG, ACTN1, ACTB, DUSP4, EPHA2, FGFBP1, EIF4A1, ESR1, ODC1 and optionally at least one clinical factor; and determining a prognosis predictive score from the dataset using a second interpretation function, wherein the prognosis predictive score is predictive of the prognosis of a subject with cancer.

In some embodiments, the present invention provides one or methods comprising a method for predicting a response to a selected cancer treatment comprising obtaining a third dataset associated with a sample derived from the subject, wherein the dataset comprises expression data for at least one marker selected from the group or groups described herein or a at least one clinical factor; and determining a response predictive score from the dataset using a third interpretation function, wherein the response predictive score is predictive of the response to the cancer treatment.

In some embodiments, the present invention provides methods of selecting a treatment or for determining a preferred treatment for a subject with cancer. In some embodiments, the method comprises obtaining a first dataset associated with a first sample derived from a subject diagnosed with cancer. In some embodiments, the dataset comprises expression data for a plurality of markers. In some embodiments the marker is selected from the group consisting of CKS2, CDKN3, FOXM1, RRM2, VRK1, TRIP13, ASPM, CEP55, ZWILCH, TUBG1, AURKA, SERPINE2, CAPRIN2, TNFRSF6B, CAPG, ACTN1, ACTB, DUSP4, EPHA2, FGFBP1, EIF4A1, ESR1, ODC1 and optionally at least one clinical factor. In some embodiments, the methods comprise determining a selection predictive score for a plurality of treatment options from the dataset using a one or more interpretation functions. In some embodiments, the methods comprise comparing the selection predictive scores for a plurality of treatment options. In some embodiments, the methods comprise selecting a treatment or determining a preferred treatment for a subject by selecting a treatment with the best selection predictive score based upon the comparison of the selection predictive scores for the plurality of treatment options.

In some embodiments, the plurality of treatment options is selected from the group consisting of TFAC, FAC, and Cisplatin. In some embodiments, the cancer is breast cancer. In some embodiments, the cancer is triple negative breast cancer.

In some embodiments, the method further comprises determining the prognosis of the subject, wherein determining the prognosis of the subject comprises a) obtaining a second dataset associated with a second sample derived from the patient diagnosed with cancer, wherein the dataset comprises: expression data for a plurality of markers selected from the group consisting of CKS2, CDKN3, FOXM1, RRM2, VRK1, TRIP13, ASPM, CEP55, ZWILCH, TUBG1, AURKA, SERPINE2, CAPRIN2, TNFRSF6B, CAPG, ACTN1, ACTB, DUSP4, EPHA2, FGFBP1, EIF4A1, ESR1, ODC1 and optionally at least one clinical factor; and determining a prognosis predictive score from the dataset using a second interpretation function, wherein the prognosis predictive score is predictive of the prognosis of a subject with cancer.

In some embodiments, the methods comprise a method for predicting a response to the selected cancer treatment comprising: obtaining a third dataset associated with a third sample derived from the subject, wherein the dataset comprises: expression data for at least one marker selected from the group consisting of FLJ10517, HCAP-G, CDKN3, STK6, FOXM1, FLJ10540, TNFRSF6B, HBP17, C1QDC1, TUBG1, FLJ10036, RRM2, ACTB, ACTN1, EPHA2, TRIP13, CKS2, VRK1, DUSP4, EIF4A1, SERPINE2, and ODC1 or a at least one clinical factor; and determining a response predictive score from the dataset using a third interpretation function, wherein the response predictive score is predictive of the response to the cancer treatment.

In some embodiments, the present invention provides methods for predicting a prognosis of a subject diagnosed with triple negative breast cancer. In some embodiments, the method comprises obtaining a dataset associated with a sample derived from a patient diagnosed with cancer. In some embodiments, the dataset comprises expression data for a plurality of markers selected from the group consisting of CKS2, CDKN3, FOXM1, RRM2, VRK1, TRIP13, ASPM, CEP55, ZWILCH, TUBG1, AURKA, SERPINE2, CAPRIN2, TNFRSF6B, CAPG, ACTN1, ACTB, DUSP4, EPHA2, FGFBP1, EIF4A1, ESR1, ODC1 and optionally at least one clinical factor. In some embodiments, the method comprises determining a predictive score from the dataset using an interpretation function, wherein the predictive score is predictive of the prognosis of a subject with triple negative breast cancer.

In some embodiments, the method comprises comparing the predictive score to a score derived from a sample from a patient with cancer that was known to have an excellent, good, moderate or poor prognosis, wherein a sample whose score matches the predetermined predictive of sample derived from a patient that that was known to have an excellent, good, moderate or poor prognosis is predicted to have an excellent, good, moderate or poor prognosis, or wherein a sample whose score matches the predetermined predictive of sample derived from a patient that was known to have an excellent, good, moderate or poor prognosis is predicted to have an excellent, good, moderate or poor prognosis.

In some embodiments, the method comprises obtaining the first dataset associated with the sample comprises obtaining the sample and processing the sample to experimentally determine the dataset comprising the expression data. In some embodiments, obtaining the dataset associated with the sample comprises receiving the dataset from a third party that has processed the sample to experimentally determine the first dataset.

In some embodiments, the present invention provides systems for predicting prognosis of a subject with triple negative breast cancer comprising a storage memory for storing a dataset associated with a sample obtained from the subject. In some embodiments, the dataset comprises expression data for at least one marker selected from the group consisting of CKS2, CDKN3, FOXM1, RRM2, VRK1, TRIP13, ASPM, CEP55, ZWILCH, TUBG1, AURKA, SERPINE2, CAPRIN2, TNFRSF6B, CAPG, ACTN1, ACTB, DUSP4, EPHA2, FGFBP1, EIF4A1, ESR1, ODC1. In some embodiments, the system comprises a processor communicatively coupled to the storage memory for determining a score with an interpretation function wherein the score is predictive of response to a cancer treatment in a subject diagnosed with cancer.

In some embodiments, the present invention provides kits for predicting prognosis of a subject with triple negative breast cancer comprising one or more reagents for determining from a sample obtained from a subject expression data for at least one marker selected from the group consisting of CKS2, CDKN3, FOXM1, RRM2, VRK1, TRIP13, ASPM, CEP55, ZWILCH, TUBG1, AURKA, SERPINE2, CAPRIN2, TNFRSF6B, CAPG, ACTN1, ACTB, DUSP4, EPHA2, FGFBP1, EIF4A1, ESR1, ODC1. In some embodiments, the kit comprises instructions for using the one or more reagents to determine expression data from the sample, wherein the instructions include instructions for determining a score from the dataset wherein the score is predictive of prognosis of a subject with triple negative breast cancer.

In some embodiments, the present invention provides methods for predicting a prognosis of a subject with triple negative breast cancer. In some embodiments, the methods comprise isolating a sample of the cancer from the patient with the triple negative breast cancer. In some embodiments, the methods comprise obtaining a dataset associated with a sample derived from a patient diagnosed with cancer, wherein the dataset comprises expression data for at least one marker selected from the group consisting of CKS2, CDKN3, FOXM1, RRM2, VRK1, TRIP13, ASPM, CEP55, ZWILCH, TUBG1, AURKA, SERPINE2, CAPRIN2, TNFRSF6B, CAPG, ACTN1, ACTB, DUSP4, EPHA2, FGFBP1, EIF4A1, ESR1, ODC1 and optionally at least one clinical factor. In some embodiments, the methods comprise determining a predictive score from the dataset using an interpretation function. In some embodiments, the interpretation function is based upon a predictive model. In some embodiments, the predictive model is a logistical regression model. In some embodiments, the logistical regression model is applied to the dataset to interpret the dataset to produce the predictive score. In some embodiments, a predictive score above a specified cut-off value predicts a good prognosis and a predictive score below a specified cut-off predicts a poor prognosis.

### BRIEF DESCRIPTION OF THE DRAWINGS

FIG. 1 illustrates that a 3D Signature was discovered by gene expression analysis of cultured breast epithelial cells grown in a 3D model of laminin-rich extracellular matrix (lrECM). Genes down regulated during acini formation and growth arrest were identified and then tested for their ability to classify patients by long-term prognosis in three unrelated sets of breast cancer patients.

FIG. 2 shows that the 3D Signature accurately predicted clinical breast cancer outcome. In a retrospective analysis, the 3D signature was prognostic in three independent, previously published datasets that totaled 699 breast cancer patients.

FIG. 3 shows the implications of using the 3D gene Signature for breast cancer patients in responding to chemotherapy in order to assess further treatment options.

FIG. 4 illustrates that the 22 gene signature includes functional gene classes including cell cycle, motility, and angiogenesis.

FIG. 5 illustrates prediction of response to taxol combination chemotherapy by the 22 gene signature in multiple subclasses of breast cancer patients using logistic regression.

FIG. 6 illustrates comparison of taxol combination (TFAC) versus non-taxol combination (FAC) chemotherapy response in breast cancer using logistic regression with the 22 gene signature. The objective of this experiment was to test if the 22 gene signature model that predicts TFAC response also predicts FAC response. Microarray data from a randomized trial with two arms, TFAC and FAC, were collected at MD Anderson Cancer Center (Tabchy et al 2010). The 22 gene signature was optimized by sequentially omitting from the analysis genes with lowest p values. A. Discovery logistic regression results from 37 ER-negative samples from patients treated with TFAC. B. Discovery logistic regression results from 42 ER-negative samples from patients treated with FAC. These results indicate that expression levels of the 22 genes allow accurate prediction of response to both TFAC and FAC, though the optimized models differ markedly. Hence, the 22 gene signature can accurately predict response to both taxol combination chemotherapy and non taxol combination chemotherapy by using different logistic models.

FIG. 7 illustrates comparison of discovery logistic regression output results (using MedCalc software) to assess ability of the 22 gene signature to predict response to taxol combination versus single agent cisplatin chemotherapy response in breast cancer. This study used a simplified version of logistic regression, where AUCs are calculated on the training set and no test sets or cross validation is applied. The objective of this experiment was to test if the 22 gene model that predicts TFAC response also predicts cisplatin response. Microarray data for the 24 biopsy samples from patients subsequently treated with neoadjuvant cisplatin were collected at the Dana Farber Cancer Institute (Silver et al 2010). For each analysis, the 22 gene signature was optimized by sequentially omitting from the analysis genes with lowest p values. A. Discovery logistic regression results from 243 samples from patients treated with TFAC (Popovici et al 2010). Resulting AUC of 0.834 indicates a very good prediction test that is statistically significant (p<0.0001). B. Discovery logistic regression results from 24 samples from patients treated with cisplatin (Silver et al 2010). The resulting AUC of 1.0 indicates a perfect test, though the number of samples was too low to achieve statistical significance (p=0.4823). C. Discovery logistic regression analysis of the combined datasets of TFAC and cisplatin was performed to test whether the same model was applicable to both datasets. An AUC of 0.806 was obtained, which is less than 0.834 obtained for the TFAC dataset alone. Though samples number were not large enough to obtain significance, this result suggests that expression levels of the 22 genes allowed the prediction of response to both cisplatin and TFAC, but through different models.

FIG. 8 illustrates various prognosis and/or predictive models.

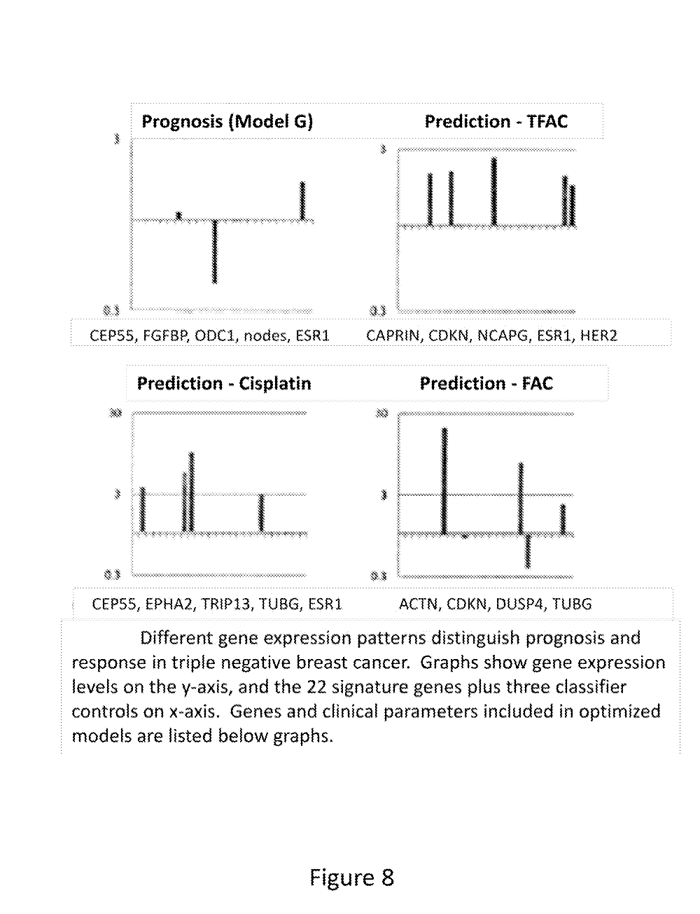

FIG. 9 illustrates Kaplan-Meier curves for certain models.

FIG. 10 illustrates Kaplan-Meier curves for certain models.

FIG. 11 illustrates cluster analysis.

FIG. 12 shows AUC values determined by using logistic regression with 3 fold cross-validation. Average of 3 validation AUC's are tabulated. The analysis used microarray data of Hess et al, 2006, obtained from fine needle aspirates from 133 breast cancer patients obtained prior to neoadjuvant treatment with TFAC. Response was evaluated post treatment by scoring pCR (pathological complete response) or RD (residual disease). Clinical parameters included ER-status, HER-status, tumor size, tumor grade, patient age, and patient race.

FIG. 13 illustrates Kaplan-Meier curves for certain models.

FIG. 14 illustrates Kaplan-Meier curves for certain models.

FIG. 15 illustrates Kaplan-Meier curves for certain models.

FIG. 16 shows the optimized prognosis model (Model G) with three predictive models, each of which predict response of triple negative breast cancer patients to a different chemotherapy

FIG. 17 shows the ability to substitute co-regulated genes in an interpretation function described herein.

FIG. 18 shows the ability to substitute co-regulated genes in an interpretation function described herein.

### DETAILED DESCRIPTION

Before compositions and methods provided herein are described, it is to be understood that this invention is not limited to the particular processes, compositions, or methodologies described, as these may vary. It is also to be understood that the terminology used in the description is for the purpose of describing some embodiments, and is not intended to limit the scope of the present invention. All publications mentioned herein are incorporated by reference in their entirety to the extent to support the present invention.

Various methods and embodiments are described herein. The methods and embodiments can be combined with one another. For example, but not limited to, methods of determining or predicting: prognosis, survival, response to a treatment, or selecting a treatment can be performed alone or in any combination and any order with one another. When the methods are combined the methods comprise independently the same sample or different samples. In some embodiments, the methods comprise independently the same or different datasets. In some embodiments, the methods comprise independently the same or different interpretation functions. Additionally, the various methods for detecting expression of a marker, gene, or protein can be used with any other method described herein. The definitions and embodiments described herein are not limited to a particular method or example unless the context clearly indicates that it should be so limited.

It must be noted that, as used herein and in the appended claims, the singular forms “a”, “an” and “the” include plural reference unless the context clearly dictates otherwise. Unless defined otherwise, all technical and scientific terms used herein have the same meanings as commonly understood by one of ordinary skill in the art. Although any methods similar or equivalent to those described herein can be used in the practice or testing of embodiments of the present invention, the preferred methods are now described. All publications and references mentioned herein are incorporated by reference. Nothing herein is to be construed as an admission that the invention is not entitled to antedate such disclosure by virtue of prior invention.

As used herein, the term “about” means plus or minus 10% of the numerical value of the number with which it is being used. Therefore, about 50% means in the range of 45%-55%. Additionally, in phrase “about X to Y,” is the same as “about X to about Y,” that is the term “about” modifies both “X” and “Y.”

“Optional” or “optionally” may be taken to mean that the subsequently described structure, event or circumstance may or may not occur, and that the description includes instances where the event occurs and instances where it does not.

“Administering” when used in conjunction with a therapeutic means to administer a therapeutic directly into or onto a target tissue or to administer a therapeutic to a patient whereby the therapeutic positively impacts the tissue to which it is targeted. “Administering” a composition may be accomplished by oral administration, injection, infusion, absorption or by any method in combination with other known techniques.

The term “target”, as used herein, refers to the material for which either deactivation, rupture, disruption or destruction or preservation, maintenance, restoration or improvement of function or state is desired. For example, diseased cells, pathogens, or infectious material may be considered undesirable material in a diseased subject and may be a target for therapy.

Generally speaking, the term “tissue” refers to any aggregation of similarly specialized cells which are united in the performance of a particular function.

The term “improves” is used to convey that the present invention changes either the appearance, form, characteristics and/or physical attributes of the tissue to which it is being provided, applied or administered. “Improves” may also refer to the overall physical state of an individual to whom an active agent has been administered. For example, the overall physical state of an individual may “improve” if one or more symptoms of a disorder or disease are alleviated by administration of an active agent.

As used herein, the term “therapeutic” or “therapeutic agent” means an agent utilized to treat, combat, ameliorate or prevent an unwanted condition or disease of a patient. In certain embodiments, a therapeutic or therapeutic agent may be a composition including at least one active ingredient, whereby the composition is amenable to investigation for a specified, efficacious outcome in a mammal (for example, without limitation, a human). Those of ordinary skill in the art will understand and appreciate the techniques appropriate for determining whether an active ingredient has a desired efficacious outcome based upon the needs of the artisan.

The terms “therapeutically effective amount” or “therapeutic dose” as used herein are interchangeable and may refer to the amount of an active agent or pharmaceutical compound or composition that elicits a biological or medicinal response in a tissue, system, animal, individual or human that is being sought by a researcher, veterinarian, medical doctor or other clinician. A biological or medicinal response may include, for example, one or more of the following: (1) preventing a disease, condition or disorder in an individual that may be predisposed to the disease, condition or disorder but does not yet experience or display pathology or symptoms of the disease, condition or disorder, (2) inhibiting a disease, condition or disorder in an individual that is experiencing or displaying the pathology or symptoms of the disease, condition or disorder or arresting further development of the pathology and/or symptoms of the disease, condition or disorder, and (3) ameliorating a disease, condition or disorder in an individual that is experiencing or exhibiting the pathology or symptoms of the disease, condition or disorder or reversing the pathology and/or symptoms experienced or exhibited by the individual.

The term “treating” may be taken to mean prophylaxis of a specific disorder, disease or condition, alleviation of the symptoms associated with a specific disorder, disease or condition and/or prevention of the symptoms associated with a specific disorder, disease or condition.

The term “patient” generally refers to any living organism to which the compounds described herein are administered and may include, but is not limited to, any non-human mammal, primate or human. Such “patients” may or may not be exhibiting the signs, symptoms or pathology of the particular diseased state. A patient may also be referred to as a subject.

As used herein, a “kit” refers to one or more diagnostic or prognostic assays or tests and instructions for their use. The instructions may consist of product insert, instructions on a package of one or more diagnostic or prognostic assays or tests, or any other instruction. In some embodiments, a kit comprises components to perform the assays or tests. For example, the kit can comprise primers or other reagents to be used in the analysis of a gene's expression. The kit can also comprise enzymes, such as polymerases or reverse transcriptases, to be used in the assays or tests.

The terms “marker” or “markers” encompass, without limitation, lipids, lipoproteins, proteins, cytokines, chemokines, growth factors, peptides, nucleic acids, genes, and oligonucleotides, together with their related complexes, metabolites, mutations, variants, polymorphisms, modifications, fragments, subunits, degradation products, elements, and other analytes or sample-derived measures. A marker can also include mutated proteins, mutated nucleic acids, variations in copy numbers, and/or transcript variants, in circumstances in which such mutations, variations in copy number and/or transcript variants are useful for generating a predictive model, or are useful in predictive models developed using related markers (e.g., non-mutated versions of the proteins or nucleic acids, alternative transcripts, etc.). In some embodiments, the “3D-signature” comprises one or more markers as disclosed herein. The “3D-Signature,” in some embodiments, comprises at least 1, 2, 3, 4, 5, 6, 7, 8, 9, 10, 11, 12, 13, 14, 15, 16, 17, 81, 19, 20, 21, 22, 10-20, 15-20, 20-22, or 1-20 markers.

As used herein the phrase “genetic expression data” can refer to genetic mutations, polymorphisms, translocations, miRNA expression, protein expression, gene expression, mRNA expression, and the like, or any combination thereof.

As used herein, the term “triple-negative” as applied to a cancer refers to a cancer that is ER (estrogen receptor)-negative, PR (progesterone receptor)-negative, and Her2-negative).

As used herein, the term “predictive score” is a score that is calculated (e.g. determined) according to a method including those methods described herein. The predictive score can be used to predict a cancer's response to a cancer treatment in general or to a specific type of treatment. The predictive score can also be for a particular type of cancer. The predictive score can be compared to a cut-off value (as, for example, described herein) to determine whether or not a cancer will respond to a treatment. In some embodiments, the predictive score can be a score predict a prognosis. In some embodiments, the predictive score can be a score to select a treatment based upon a comparison of the relative scores. In some embodiments, the predictive score can be used to predict a survival in a patient. In some embodiments, the comparison of the relative scores is performed by a method described herein. Embodiments using a predictive score are described herein. In some embodiments, the predictive score can be used in methods disclosed herein that can be used to predict a prognosis of a subject with cancer, such as triple negative breast cancer.

In some embodiments, the methods disclosed herein can be used to predict a response to a cancer treatment. The cancer treatment can be any treatment including, but not limited, to the treatments and therapies described herein. Additionally, the methods can be used to predict the response of any cancer. Examples of cancers include solid and non-solid cancer. Examples of cancers include, but are not limited to, brain (gliomas), glioblastomas, leukemias, breast, Wilm's tumor, Ewing's sarcoma, Rhabdomyosarcoma, ependymoma, medulloblastoma, colon, head and neck, kidney, lung, liver, melanoma, ovarian, pancreatic, prostate, sarcoma, osteosarcoma, giant cell tumor of bone, thyroid, Lymphoblastic T cell leukemia, Chronic myelogenous leukemia, Chronic lymphocytic leukemia, Hairy-cell leukemia, acute lymphoblastic leukemia, acute myelogenous leukemia, Chronic neutrophilic leukemia, Acute lymphoblastic T cell leukemia, Plasmacytoma, Immunoblastic large cell leukemia, Mantle cell leukemia, Multiple myeloma Megakaryoblastic leukemia, multiple myeloma, Acute megakaryocytic leukemia, promyelocytic leukemia, Erythroleukemia, malignant lymphoma, hodgkins lymphoma, non-hodgkins lymphoma, lymphoblastic T cell lymphoma, Burkitt's lymphoma, follicular lymphoma, neuroblastoma, bladder cancer, urothelial cancer, lung cancer, vulval cancer, cervical cancer, endometrial cancer, renal cancer, mesothelioma, esophageal cancer, salivary gland cancer, hepatocellular cancer, gastric cancer, nasopharangeal cancer, buccal cancer, cancer of the mouth, GIST (gastrointestinal stromal tumor), testicular cancer, any combination thereof, and the like. The cancer can also be a patient who has been diagnosed with cancer. The cancer can also refer to a patient who has had cancer and has either responded or not responded to a treatment.

As used herein, the term “sample” can refer to a single cell or multiple cells or fragments of cells or an aliquot of body fluid, taken from a subject. In some embodiments the sample is a biological sample. In some embodiments, the sample is a fixed, paraffin-embedded, fresh, or frozen tissue sample. In some embodiments, the sample is derived from a fine needle, core, or other type of biopsy. The sample can, for example, be obtained from a subject by, but not limited to, venipuncture, excretion, biopsy, needle aspirate, lavage sample, scraping, surgical incision, or, any combination thereof, and the like.

In some embodiments, the bodily fluid is blood, urine, saliva, and the like. In some embodiments, the cell is a cancerous cell or a normal cell. In some embodiments, the tissue is a cancerous tissue. In some embodiments, the tissue is a normal tissue. In some embodiments, the sample is a tumor or cells derived from a tumor. In some embodiments, the sample is a cell derived from normal tissue. In some embodiments, the sample is hair or cells that have been derived from hair. The sample is any biological product that can be tested and form which nucleic acid material can be derived from. In some embodiments, the cell is a blood cell, such as but not limited to, white blood cells. In some embodiments, the cell is a breast epithelial cell. The breast epithelial cell can be a cancerous cell or a non-cancerous cell. In some embodiments, the sample comprises cancerous and non-cancerous cells, tissues, fluids, and the like. In some embodiments, the sample is free of non-cancerous cells and tissues. In some embodiments, the sample is free of cancerous cells and tissues. A “cancerous fluid” is a fluid derived from a subject that has cancer. In some embodiments, the sample is electronic data. In some embodiments, the sample comprises expression data.

As used herein, the term “expression data” refers to expression levels of one or more markers. The expression data can comprise the expression levels of RNA, mRNA, protein, and the like. The expression levels can be quantified. The quantification can be based upon absolute amounts or be based on a comparison to a standard.

The expression data can be measured for the markers described herein or sequences that are homologous to the sequences described herein. In some embodiments, the sequence or probe is at least 85, 90, 91, 92, 93, 94, 95, 96, 97, 98, 99% identical to the sequences described herein. In some embodiments, the sequence is from about 85-99, 90-99, 92-99, 93-99, 94-99, 95-99, 96-99, 97-99, or 98-99% identical to sequence described herein. In some embodiments, the sequence comprises at least or exactly 1, 2, 3, 4, or 5 mutations. The mutation can be an insertion, silent, deletion, point mutation, or any combination thereof, and the like.

Nucleic acid molecules or sequences can also be referred to as being substantially complementary to another sequence. “Substantially complementary” refers to a nucleic acid sequence that is at least 70%, 80%, 85%, 90% or 95% complementary to at least a portion of a reference nucleic acid sequence or to the entire sequence. By “complementarity” or “complementary” is meant that a nucleic acid can form hydrogen bond(s) with another nucleic acid sequence by either traditional Watson-Crick or other non-traditional types of interaction. In reference to the nucleic molecules, the binding free energy for a nucleic acid molecule with percent complementarity indicates the percentage of contiguous residues in a nucleic acid molecule that can form hydrogen bonds (e.g., Watson-Crick base pairing) with a second nucleic acid sequence (e.g., 5, 6, 7, 8, 9, 10 out of 10 being 50%, 60%, 70%, 80%, 90%, and 100% complementary). “Perfectly complementary” means that all the contiguous residues of a nucleic acid sequence will hydrogen bond with the same number of contiguous residues in a second nucleic acid sequence.

By “substantially identical” is meant a polypeptide or nucleic acid exhibiting at least 90%, 95%, or 99% identity to a reference sequence (e.g. nucleic acid sequence). For nucleic acids, “substantially identical” can be interchanged with “substantially complementary.” For nucleic acids, the length of comparison sequences can be at least 10 15, 20, 25, 30 nucleotides. For nucleic acids, the length of comparison sequences can be about 5-30, about 10-25, about 10-20, about 15-25, about 20-30, about 20-25, about 25-20 nucleotides.

The term “identity” or is used herein to describe the relationship of the sequence of a particular nucleic acid molecule or polypeptide to the sequence of a reference molecule of the same type. For example, if a polypeptide or nucleic acid molecule has the same amino acid or nucleotide residue at a given position, compared to a reference molecule to which it is aligned, there is said to be “identity” at that position. The level of sequence identity of a nucleic acid molecule or a polypeptide to a reference molecule is typically measured using sequence analysis software with the default parameters specified therein, such as the introduction of gaps to achieve an optimal alignment. Methods to determine identity are available in publicly available computer programs. Computer program methods to determine identity between two sequences include, but are not limited to, the GCG program package (Devereux et al., Nucleic Acids Research 12(1): 387, 1984), BLASTP, BLASTN, and FASTA (Altschul et al., J. Mol. Biol. 215: 403 (1990). The well-known Smith-Waterman algorithm may also be used to determine identity. The BLAST and BLAST2 programs are publicly available from NCBI and other sources (BLAST Manual, Altschul, et al., NCBI NLM NIH Bethesda, Md. 20894). Searches can be performed in URLs such as http://www.ncbi.nlm.nih.gov/BLAST or http://www.ncbi.nlm.nih.gov/gorf/b12.html (Tatusova et al., FEMS Microbiol. Lett. 174:247-250, 1999). These software programs match similar sequences by assigning degrees of homology to various substitutions, deletions, and other modifications. Conservative substitutions typically include substitutions within the following groups: glycine, alanine; valine, isoleucine, leucine; aspartic acid, glutamic acid, asparagine, glutamine; serine, threonine; lysine, arginine; and phenylalanine, tyrosine. Alternatively, or additionally, two nucleic acid sequences are “substantially identical” if they hybridize under high stringency conditions.

Percent identity and percent complementarity can also be determined electronically, e.g., by using the MEGALIGN program (DNASTAR, Inc. Madison, Wis.). The MEGALIGN program can create alignments between two or more sequences according to different methods, for example, the clustal method. (See, for example, Higgins and Sharp (1988) Gene 73: 237-244.) The clustal algorithm groups sequences into clusters by examining the distances between all pairs. The clusters are aligned pairwise and then in groups. Other alignment algorithms or programs may be used, including FASTA, BLAST, or ENTREZ, FASTA and BLAST, and which may be used to calculate percent similarity. These are available as a part of the GCG sequence analysis package (University of Wisconsin, Madison, Wis.), and can be used with or without default settings. ENTREZ is available through the National Center for Biotechnology Information. In some embodiments, the percent identity of two sequences can be determined by the GCG program with a gap weight of 1, e.g., each nucleotide mismatch between the two sequences (see U.S. Pat. No. 6,262,333). Other techniques for alignment are described in Methods in Enzymology, vol. 266, Computer Methods for Macromolecular Sequence Analysis (1996), ed. Doolittle, Academic Press, Inc., San Diego, Calif., USA. Preferably, an alignment program that permits gaps in the sequence is utilized to align the sequences. The Smith-Waterman is one type of algorithm that permits gaps in sequence alignments (see Shpaer (1997) Methods Mol. Biol. 70: 173-187). Also, the GAP program using the Needleman and Wunsch alignment method can be utilized to align sequences. An alternative search strategy uses MPSRCH software, which runs on a MASPAR computer. MPSRCH uses a Smith-Waterman algorithm to score sequences on a massively parallel computer. This approach improves ability to pick up distantly related matches, and is especially tolerant of small gaps and nucleotide sequence errors.

A “variant” refers to a sequence that is not 100% identical to a sequence described herein. The variant may have the various mutations or levels of identity or complementarity as described herein. In some embodiments, the variant is at least 100% identical over a portion of the sequences described herein. In some embodiments, the portion is from about 10-100, 10-200, 10-300, 10-400, 10-500, 10-600, 50-100, 50-200, 50-300, 50-400, 50-500, 50-600 nucleotides in length. In some embodiments, the portion is at least 10, 20, 30, 40, 50, 60, 70, 80, 90, 100, 200, 300, 400, 500, or 600 nucleotides in length.

In some embodiments, the sequence detected and/or measure has two non-contiguous portions that are 100% identical to a sequence described herein. The non-contiguous portions can be separated by at least 1, 2, 3, 4, 5, 6, 7, 8, 9, or 10 unmatched nucleotides or by at least 1, 2, 3, 4, 5, 6, 7, 8, 9, or 10 nucleotides that create a cap when the sequences are aligned. Methods of alignment are described herein.

Early detection of cancer is vital for patient survival by increasing treatment options. For example, breast cancer ranks as the second leading cause of death among women with cancer in the U.S., and early detection of breast cancer has a significant effect on patient survival, though a portion of patients still may relapse and may develop a more aggressive form of disease. As such, methods of predicting chemotherapy response in a broad range of breast cancer subtypes has become a primary focus of cancer research. Key steps include determining which patients will benefit from standard care therapies and assessing their chances of disease progression. The present invention provides methods for predicting (e.g. determining) a tumor or cancer's chemotherapy response.

Metastasis is a multi-step process during which cancer cells disseminate from the site of primary tumors and establish secondary tumors in distant organs. While established cancer prognostic markers such as tumor size, grade, nodal, and hormone receptor status are useful in predicting survival in large populations, there is a need to develop better prognostic signatures to predict the efficacy of various forms of cancer treatment. A particular benefit would be the identification of patients with good prognoses that are being treated with chemotherapies. The advent of gene expression technologies has greatly aided the identification of molecular signatures with value for tumor classification and prognosis prediction.

Several studies have been performed to identify predictive gene-signatures for breast cancer and have been shown to be of value in evaluating the clinical prognosis in breast cancer. However, most of these gene-signatures have been selected using supervised methods applied to training sets of about 50-100 patients, and then confirmed in larger related sets ranging from 100-300 patients. Furthermore, the individual genes that make up the signatures identified in different studies show surprisingly little overlap, and investigations addressing this lack of overlap have found that predictive signatures are highly dependent on the specific set of patients that make up the training set. For example, two predictive signatures for breast cancer identified by microarray analysis have been developed into clinical multi-gene panel tests. MammaPrint® is composed of 70 genes which were identified by analyzing the large NKI dataset of van de Vijver, et al. Unfortunately, subsequent analysis found that the gene-signature used in the MammaPrint® panel did not predict outcome as well in an independent dataset, and several clinical trials are ongoing to test the utility of this prognostic gene-signature test.

Even though these gene-signatures have been helpful in identifying patients at risk of some types of cancer, they have provided limited information on which genes are particularly relevant to cancer biology since all genes included in a gene-signature cannot be key biological players in cancer progression and response to therapy. Moreover, these gene-signatures provide little information regarding which type of treatment will be most effective for treating an individual exhibiting a particular expression pattern. The present invention overcomes these deficiencies as well as others.

Various embodiments of the invention are directed to tests for therapeutic sensitivity (i.e., whether a tumor will respond to treatment, the prognosis of a subject, the survival of a subject or selecting a treatment based upon a comparison of relative scores) by identifying a number of genes whose expression patterns are modified as a result of cancer, and other embodiments of the invention are directed to methods for performing such tests. The term “tests” can also be referred to as a clinical test or other similar wording. In some embodiments, the therapeutic sensitivity or response that is predicted is a partial response. In some embodiments, the therapeutic sensitivity or response that is predicted is a pathological complete response. In some embodiments, the response is a pathological complete response. An example of a pathological complete response refers to the absence of any residual tumor upon histological exam. In some embodiments, the predicted response is at least 5, 7, or 10 year survival. In some embodiments, the survival is relapse-free. In some embodiments, the survival is not relapse free. A partial response can refer to a response where the tumor or amount of cancer in the subject has decreased but the tumor or cancer can still be detected. For example, the tumor size may shrink in size but still be detectable. This can be classified as a partial response. A non-limiting example of a pathological complete response is described in (Bonadonna et al, (1998) Primary chemotherapy in operable breast cancer: eight-year experience at the Milan Cancer Institute. J Clin Oncol 16: 93-100; Fisher et al. (1998) Effect of preoperative chemotherapy on the outcome of women with operable breast cancer. J Clin Oncol 16: 2672-2685; and Kuerer et al., (1999) Clinical course of breast cancer patients with complete pathologic primary tumour and axillary lymph node response to doxorubicin-based neoadjuvant chemotherapy. J Clin Oncol 17: 460-469), each of which is hereby incorporated by reference in its entirety.

Various embodiments of the invention are also directed to tests for determining prognosis of a subject with cancer, such as triple negative breast cancer by identifying one or more genes whose expression patterns are modified as a result of cancer, and other embodiments of the invention are directed to methods for performing such tests

Prognosis in breast cancer is a prediction of the chance that a patient will survive or recover from the disease. In breast cancer, prognosis is most commonly assessed by clinical parameters including tumor grade (a measure of the proliferation status of the tumor) tumor stage, which takes into account tumor size, whether the tumor has invaded the lymph nodes (node status), and whether it has invaded distant tissues (metastasis). High tumor grade and high tumor stage are associated with poor prognosis. Prognosis can be quantified by various methods. In some embodiments, the prognosis is a poor, moderate, good, or excellent prognosis. In some embodiments, a good prognosis predicts a three year survival, while a poor prognosis predicts the lack of a three year survival. In some embodiments, a good prognosis predicts a three year survival without a relapse, while a poor prognosis predicts the lack of a three year survival without relapse. In some embodiments, a good prognosis predicts a three year survival without a distant relapse (i.e. metastasis), while a poor prognosis predicts the lack of a three year survival without a distant relapse. In some embodiments, a good prognosis is a prognosis of at least 5, 7, or 10 year survival, while a poor prognosis is the lack of a 5, 7, or 10 year survival. In some embodiments, the survival is relapse-free, while in some embodiments, the survival is not relapse free.

Yet another embodiment of the invention is directed to predicting a chemotherapeutic response in breast cancer by identifying a number of genes whose expression patterns are modified as a result of therapy. In a some embodiments a “3D gene Signature” is used to predict the efficacy of treatment. Unlike most cancer signatures that have been selected by using supervised methods and a specific patient training set, the 3D Signature was selected using a cell culture model that accurately recapitulates the normal process of breast acini formation and growth arrest. Since this process is not linked to a particular patient set, the 3D Signature more accurately classifies diverse patient subsets than traditionally discovered signatures. The “3D signature” refers to a gene signature that is derived from a tumor or non-tumor sample that is grown in an ex vivo environment and can grow three dimensionally, as opposed to other methods of cell culture, which only allow cells to grow in two dimensions and only create a monolayer. In a 3D environment, the cells can grow to form clusters that are more representative of tissue and cell growth in vivo.

In some embodiments, the gene signature, which can also be referred to as a “3D gene Signature,” is used to predict the prognosis.

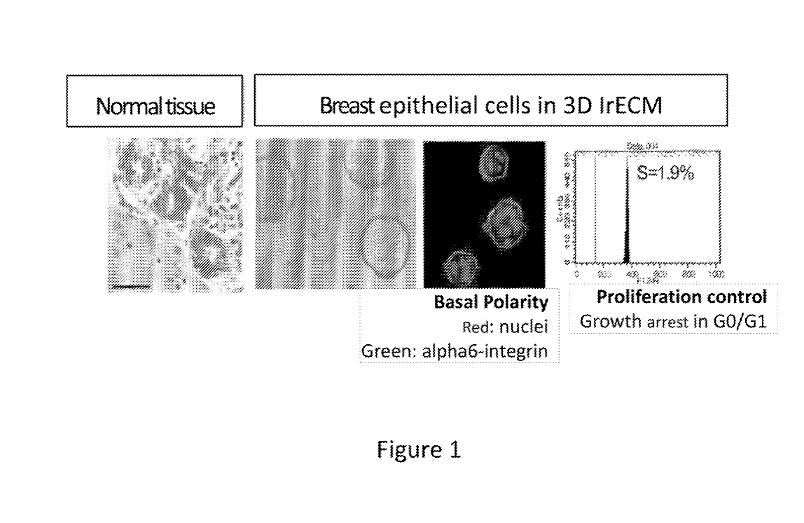

In yet another embodiment of the invention, the 3D Signature was discovered by gene expression analysis of cultured breast epithelial cells grown in a 3D model of laminin-rich extracellular matrix (lrECM). Genes down regulated during acini formation and growth arrest were identified and then tested for their ability to classify patients by long term prognosis in three unrelated sets of breast cancer patients. The different morphology of the cells in the three dimensional model can be seen in FIG. 1. The genes were identified and their expression levels were found to correlate with prognosis and/or response to treatment. For example, a gene signature from a tumor sample that is similar to the gene signature identified in normal cells is generally predicted to have a good prognosis and not to respond to chemotherapy, though accurate prediction requires the application of more complex equations that differ for different breast cancer subtypes.

In some embodiments, kits are provided that can include components necessary to perform such clinical tests for therapeutic sensitivity. For example, a kit may comprise one or more instruments for performing a biopsy to remove a tumor sample from a patient. In some embodiments, the kit does not comprise one or more instruments for performing a biopsy to remove a tumor sample from a patient. In some embodiments, the kit comprises an instrument for aspirating cancerous cells from tumor or cancerous growth. In some embodiments, the kit comprises components to extract genetic material (e.g. DNA, RNA, mRNA, and the like) from aspirated cells. In some embodiments, the kit comprises compositions that can be used to tag or label genetic material extracted from or derived from the aspirated cells. Genetic material that is derived from a tumor sample (e.g. aspirated cells) includes DNA or RNA that is producing using PCR, RT-PCR, RNA amplification, or any other suitable amplification method. The particular amplification method is not essential. In some embodiments, the amplification method comprises quantitative PCR. In some embodiments, the kit comprises a microarray (e.g. microarray chip) comprising hybridization probes that is specific for a genetic signature, such as but not limited to, a 3D signature generated from normal or cancerous breast epithelial cells. In some embodiments, the kit comprises a composition or product (e.g. device) that can be used to visualize the genetic material that is associated with the hybridization probes. In some embodiments, the kits are used before and after a treatment. The treatment can be of the cells ex vivo or in vivo.

In some embodiments, kits are provided for predicting response to a cancer treatment in a subject comprising one or more reagents for determining from a sample obtained from a subject expression data for at least one marker selected from the group consisting of FLJ10517, HCAP-G, CDKN3, STK6, FOXM1, FLJ10540, TNFRSF6B, HBP17, C1QDC1, TUBG1, FLJ10036, RRM2, ACTB, ACTN1, EPHA2, TRIP13, CKS2, VRK1, DUSP4, EIF4A1, SERPINE2, ODC1, or any combination thereof. The markers can be combined in any combination including, but not limited to, the other combinations described herein. In some embodiments, the kit comprises instructions for using the one or more reagents to determine expression data from the sample, wherein the instructions include instructions for determining a score from the dataset wherein the score is predictive of response to the cancer treatment. In some embodiments, the cancer treatment is a breast cancer treatment. In some embodiments, the breast cancer treatment is TFAC (a combination of taxol/fluorouracil/anthracycline/cyclophosphamide with or without filgrastim support). Chemotherapy treatments include TAC (taxol/anthracycline/cyclophosphamide with or without filgrastim support), ACMF (doxorubicin followed by cyclophosphamide, methotrexate, fluorouracil), ACT (doxorubicin, cyclophosphamide followed by taxol or docetaxel), A-T-C (doxorubicin followed by paclitaxel followed by cyclophosphamide), CAF/FAC (fluorouracil/doxorubicin/cyclophosphamide), CEF (cyclophosphamide/epirubicin/fluorouracil), AC (doxorubicin/cyclophosphamide), EC (epirubicin/cyclophosphamide), AT (doxorubicin/docetaxel or doxorubicin/taxol), CMF (cyclophosphamide/methotrexate/fluorouracil), cyclophosphamide (Cytoxan or Neosar), methotrexate, fluorouracil (5-FU), doxorubicin (Adriamycin), epirubicin (Ellence), gemcitabine, taxol (Paclitaxel), GT (gemcitabine/taxol), taxotere (Docetaxel), vinorelbine (Navelbine), capecitabine (Xeloda), platinum drugs (Cisplatin, Carboplatin), etoposide, and vinblastine. Other treatments include surgery, radiation, hormonal and targeted therapies. Additionally, other examples of cancer treatments are described elsewhere herein and a predictive score can also be determined for those.

In some embodiments, a test to determine or predict therapeutic sensitivity of a disease comprises determining the expression level of one or more markers (e.g. genes) from a patient, tissue, or cell exhibiting, or not exhibiting, symptoms of a diseased state. In some embodiments, the gene expression levels are compared to gene expression levels from a different patient known to be free of, or suspected to be free of, the disease. In some embodiments, the gene expression levels are compared to gene expression levels from a cell or tissue known to be free of, or suspected to be free of, the disease. In some embodiments, the tissue or cell known to be free of, or suspected to be free of, the disease is from the same subject (e.g. patient) who is suspected of having the disease or who is known to have the disease or known or suspected to be normal healthy tissue (either from the patient or from a healthy subject) or other diseased tissue samples and equating these expression levels with the efficacy of treatment for the diseased state.

Determining the expression level for any one marker gene or set of marker genes such as those identified herein and/or expression profile for any group or set of such genetic markers can be carried out by any method and may vary among embodiments of the invention. For example, in some embodiments, the expression levels of one or more markers may be measured using polymerase chain reaction (PCR), RT-PCR, enzyme-linked immunosorbent assay (ELISA), magnetic immunoassay (MIA), flow cytometry, and the like. In some embodiments, the PCR is microfluidics PCR. The expression data can also be determined using other amplification assays, such as but not limited to, LAMP, RNA amplification, single strand amplification, and the like. The specific method of determining expression data is not essential and any method can be used. In other embodiments, one or more microarray may be used to measure the expression level of one or more marker genes simultaneously. Various microarray types and configurations and methods for the production of such microarrays are known in the art and are described in, for example, U.S. patents such as: U.S. Pat. Nos. 5,445,934; 5,532,128; 5,556,752; 5,242,974; 5,384,261; 5,405,783; 5,412,087; 5,424,186; 5,429,807; 5,436,327; 5,472,672; 5,527,681; 5,529,756; 5,545,531; 5,554,501; 5,561,071; 5,571,639; 5,593,839; 5,599,695; 5,624,711; 5,658,734; and 5,700,637; the disclosures of which are hereby incorporated by reference in their entireties. Any such microarray may be useful in embodiments of the invention. For example, in some embodiments, antibodies raised against the protein product of the marker may be used as probes in microarrays of the invention such that whole cell lysate or proteins isolated from cancerous cells may be passed over the microarray and expression levels of one or more genetic marker may be reduced based on the amount of protein captured by the microarray. In other embodiments, the expression level and/or expression profile for a specific genetic marker may be carried out by extracting cellular mRNA from cancerous cells and hybridizing the mRNA directly to the array. Single-stranded antisense DNA or RNA hybridization probes specifically targeted to the mRNA marker may be used. In certain embodiments, single-stranded antisense DNA or RNA hybridization probes may be used to capture copy DNA (cDNA) or copy RNA (cRNA) that was created from mRNA extracted from cancerous cells. In some embodiments, the mRNA is amplified and/or reverse transcribed into DNA, such as cDNA. The cDNA need not be the complete coding sequence for any or all of the genes.

In some embodiments, microarray analysis may involve the measurement of an intensity of a signal received from a labeled cDNA or cRNA derived from a sample obtained from cancerous tissue that hybridizes to a known nucleic acid sequence at a specific location on a microarray. In some embodiments, the hybridization probes used in the microarrays may be nucleic acid sequences that are capable of capturing labeled cDNA or cRNA produced from the mRNA of the marker gene. In some embodiments, the intensity of the signal received and measured is proportional to the amount (e.g. quantity) of cDNA or cRNA, and thus the mRNA derived for the target gene in the cancerous tissue. Expression of the marker may occur ordinarily in a healthy subject resulting in a base steady-state level of mRNA in a healthy subject. However, in cancerous tissue, expression of the marker gene may be increased or decreased resulting in a higher level or lower level of mRNA, respectively, in diseased tissue. Alternatively, expression of a marker gene may not occur at detectable levels in normal, healthy tissue but occurs in cancerous tissue. In some embodiments, the marker is expressed at the same level in the diseased subject, tissue, or cell as compared to the healthy subject, tissue, or cell. The intensity measurements read from microarrays, as described above, may then be equated (transformed) to the degree of expression of the gene corresponding to the signal intensity of labeled cDNA or cRNA captured by the hybridization probe. Thus, the microarrays of various embodiments may detect the variability in expression by detecting differences in mRNA levels in cancerous tissue over normal tissue or standard intensities and may be used to determine a particular course of treatment for a patient whose cells or cancerous tissue is tested. The methods can be used, in some embodiments, to determine the most efficacious treatment for a patient.

In some embodiments, the methods described herein or tests described herein comprises a microarray having probes against one or more genes that exhibit a modified expression pattern or profile as a result of cancer. In some embodiments, the method or test comprises a microarray having probes against one or more genes that do not exhibit a modified expression pattern or profile as a result of cancer. The one or more genes or markers included on the array can be any one or more genes, including, for example, genes can be selected based on the likelihood that cells exhibiting the modified expression pattern or profile may be more likely to respond to a particular form of treatment. In some embodiments, the genes selected can be used to identify a cell or tumor that is less likely to respond to a particular form of treatment. For example, in some embodiments, the hybridization probes provided on the microarray may have been selected based on the ability of one or more therapeutic agents to treat tumors exhibiting an expression profile associated with such hybridization probes. Therefore, by performing the test a person can predict the efficacy of the particular form of treatment based on the gene expression pattern or profile of cells extracted from a tumor as compared to normal (e.g. non-cancerous cells).

In some embodiments, kits are provided that can include components necessary to perform such tests for prognosis. For example, a kit may comprise one or more instruments for performing a biopsy to remove a tumor sample from a patient. In some embodiments, the kit does not comprise one or more instruments for performing a biopsy to remove a tumor sample from a patient. In some embodiments, the kit comprises an instrument for aspirating cancerous cells from tumor or cancerous growth. In some embodiments, the kit comprises components to extract genetic or protein material (e.g. DNA, RNA, mRNA, and the like) from aspirated cells. In some embodiments, the kit comprises compositions that can be used to tag or label genetic material extracted from or derived from the aspirated cells. Genetic material that is derived from a tumor sample (e.g. aspirated cells) includes DNA or RNA that is producing using PCR, RT-PCR, RNA amplification, or any other suitable amplification method. The particular amplification method is not essential. In some embodiments, the amplification method comprises quantitative PCR. In some embodiments, the kit comprises a microarray (e.g. microarray chip) comprising hybridization probes that is specific for a genetic signature, such as but not limited to, a 3D signature generated from normal or cancerous breast epithelial cells. In some embodiments, the kit comprises a composition or product (e.g. device) that can be used to visualize the genetic material that is associated with the hybridization probes. In some embodiments, the kits are used before and after a treatment. The treatment can be of the cells ex vivo or in vivo.

In some embodiments, kits are provided for predicting a prognosis of a subject with triple negative breast cancer comprising one or more reagents for determining from a sample obtained from a subject expression data for at least one marker selected from the group consisting of CKS2, CDKN3, FOXM1, RRM2, VRK1, TRIP13, ASPM, CEP55, ZWILCH, TUBG1, AURKA, SERPINE2, CAPRIN2, TNFRSF6B, CAPG, ACTN1, ACTB, DUSP4, EPHA2, FGFBP1, EIF4A1, ESR1, ODC1, or any combination thereof. The markers can be combined in any combination including, but not limited to, the other combinations described herein. In some embodiments, the kit comprises instructions for using the one or more reagents to determine expression data from the sample, wherein the instructions include instructions for determining a score from the dataset wherein the score is predictive of response to the cancer treatment.

In some embodiments, a test to determine or predict prognosis comprises determining the expression level of one or more markers (e.g. genes) from a patient, tissue, or cell exhibiting, or not exhibiting, symptoms of a diseased state. The genes can be 1 of the genes described herein or any combination thereof. In some embodiments, the gene expression levels are compared to gene expression levels from a different patient known to be free of, or suspected to be free of, the disease. In some embodiments, the gene expression levels are compared to gene expression levels from a cell or tissue known to be free of, or suspected to be free of, the disease. In some embodiments, the tissue or cell known to be free of, or suspected to be free of, the disease is from the same subject (e.g. patient) who is suspected of having the disease or who is known to have the disease or known or suspected to be normal healthy tissue (either from the patient or from a healthy subject) or other diseased tissue samples and equating these expression levels with the efficacy of treatment for the diseased state. Determining the expression level for any one marker gene or set of marker genes such as those identified above and/or expression profile for any group or set of such genetic markers can be carried out by any method and may vary among embodiments.

For example, in some embodiments, the expression levels of one or more markers may be measured using polymerase chain reaction (PCR), RT-PCR, enzyme-linked immunosorbent assay (ELISA), magnetic immunoassay (MIA), flow cytometry, and the like. In some embodiments, the PCR is microfluidics PCR. In other embodiments, one or more microarray may be used to measure the expression level of one or more marker genes simultaneously. Various microarray types and configurations and methods for the production of such microarrays are known in the art and are described in, for example, U.S. patents such as: U.S. Pat. Nos. 5,445,934; 5,532,128; 5,556,752; 5,242,974; 5,384,261; 5,405,783; 5,412,087; 5,424,186; 5,429,807; 5,436,327; 5,472,672; 5,527,681; 5,529,756; 5,545,531; 5,554,501; 5,561,071; 5,571,639; 5,593,839; 5,599,695; 5,624,711; 5,658,734; and 5,700,637; the disclosures of which are hereby incorporated by reference in their entireties. Any such microarray may be useful in embodiments of the invention. For example, in some embodiments, antibodies raised against the protein product of the marker may be used as probes in microarrays of the invention such that whole cell lysate or proteins isolated from cancerous cells may be passed over the microarray and expression levels of one or more genetic marker may be reduced based on the amount of protein captured by the microarray. In other embodiments, the expression level and/or expression profile for a specific genetic marker may be carried out by extracting cellular mRNA from cancerous cells and hybridizing the mRNA directly to the array. Single-stranded antisense DNA or RNA hybridization probes specifically targeted to the mRNA marker may be used. In certain embodiments, single-stranded antisense DNA or RNA hybridization probes may be used to capture copy DNA (cDNA) or copy RNA (cRNA) that was created from mRNA extracted from cancerous cells. In some embodiments, the mRNA is amplified and/or reverse transcribed into DNA, such as cDNA. The cDNA need not be the complete coding sequence for any or all of the genes.

In some embodiments, microarray analysis may involve the measurement of an intensity of a signal received from a labeled cDNA or cRNA derived from a sample obtained from cancerous tissue that hybridizes to a known nucleic acid sequence at a specific location on a microarray. In some embodiments, the hybridization probes used in the microarrays may be nucleic acid sequences that are capable of capturing labeled cDNA or cRNA produced from the mRNA of the marker gene. In some embodiments, the intensity of the signal received and measured is proportional to the amount (e.g. quantity) of cDNA or cRNA, and thus the mRNA derived for the target gene in the cancerous tissue. Expression of the marker may occur ordinarily in a healthy subject resulting in a base steady-state level of mRNA in a healthy subject. However, in cancerous tissue, expression of the marker gene may be increased or decreased resulting in a higher level or lower level of mRNA, respectively, in diseased tissue. Alternatively, expression of a marker gene may not occur at detectable levels in normal, healthy tissue but occurs in cancerous tissue. In some embodiments, the marker is expressed at the same level in the diseased subject, tissue, or cell as compared to the healthy subject, tissue, or cell. The intensity measurements read from microarrays, as described above, may then be equated (transformed) to the degree of expression of the gene corresponding to the signal intensity of labeled cDNA or cRNA captured by the hybridization probe. Thus, the microarrays of various embodiments may detect the variability in expression by detecting differences in mRNA levels in cancerous tissue over normal tissue or standard intensities and may be used to determine prognosis of a subject with cancer. Therefore, the methods can be used, in some embodiments, to determine the most efficacious treatment for a patient based upon their prognosis.

In some embodiments, the method or test comprises a microarray having probes against one or more genes that exhibit a modified expression pattern or profile as a result of cancer. In some embodiments, the method or test comprises a microarray having probes against one or more genes that do not exhibit a modified expression pattern or profile as a result of cancer. The one or more genes or markers included on the array can be any one or more genes, such as those described herein, including, for example, genes can be selected based on the likelihood that cells exhibiting the modified expression pattern or profile may be more likely to respond to a particular form of treatment or that can be used to predict a prognosis. In some embodiments, the genes selected can be used to identify a cell or tumor that is less likely to respond to a particular form of treatment or a subject will have a poor, moderate, good, or excellent prognosis or other types of prognosis as described herein. For example, in some embodiments, the hybridization probes provided on the microarray may have been selected based on the ability of one or more therapeutic agents to treat tumors exhibiting an expression profile associated with such hybridization probes or based upon the prognosis. Therefore, by performing the test a person can predict the prognosis or the efficacy of the particular form of treatment based on the gene expression pattern or profile of cells extracted from a tumor as compared to normal (e.g. non-cancerous cells).

The specific probes to measure gene expression or expression data that are used are not essential. The probes, which can also be referred to as primers can be specific to the markers being measured and/or detected. In some embodiments, the probe comprises a sequence or a variant thereof of CKS2, CDKN3, FOXM1, RRM2, VRK1, TRIP13, ASPM, CEP55, ZWILCH, TUBG1, AURKA, SERPINE2, CAPRIN2, TNFRSF6B, CAPG, ACTN1, ACTB, DUSP4, EPHA2, FGFBP1, EIF4A1, ODC1. In some embodiments, the sequences comprise a sequence or variant of the sequences described herein, which includes, but is not limited to the sequence listing, or any combination thereof. All sequences referenced by accession number are also incorporated by reference, the sequence incorporated by reference is the sequence in the latest version, unless otherwise specified as of the filing of the present disclosure.

As used herein, “ACTB,” refers to beta-actin. In some embodiments, the beta-actin has a sequence as disclosed in GenBank Accession # NM_{—}001101 or Affymetrix Accession #200801_x_at. In some embodiments, ACTB refers to a sequence comprising SEQ ID NO: 1 or a variant thereof. In some embodiments, ACTB is detected and/or measured by a probe comprising a sequence of SEQ ID NO: 2-12 or a variant thereof or any combination thereof. In some embodiments, ACTB is detected by at least 1, 2, 3, 4, 5, 6, 7, 8, 9, or 10 probes comprising a sequence selected from the group consisting of SEQ ID NO: 2-12 or a variant thereof. In some embodiments, ACTB is detected using 11 probes, each having a different sequence and each sequence selected from the group consisting of SEQ ID NO: 2-12 or a variant thereof.

As used herein, “ACTN1” refers to alpha-1 actinin. In some embodiments, the alpha-1 actinin has a sequence as disclosed in GenBank Accession # NM_{—}001102 or Affymetrix \ Accession #208637_x_at. In some embodiments, ACTN1 refers to a sequence comprising SEQ ID NO: 13 or a variant thereof. In some embodiments, ACTN1 is detected and/or measured by a probe comprising a sequence of SEQ ID NO: 14-24 or a variant thereof or any combination thereof. In some embodiments, ACTN1 is detected by at least 1, 2, 3, 4, 5, 6, 7, 8, 9, or 10 probes comprising a sequence selected from the group consisting of SEQ ID NO: 14-24 or a variant thereof. In some embodiments, ACTN1 is detected using 11 probes, each having a different sequence and each sequence selected from the group consisting of SEQ ID NO: 14-24 or a variant thereof.

As used herein, “ASPM,”, which can also be referred to as “FLJ10517” refers to asp (abnormal spindle) homolog, microcephaly associated (Drosophila). In some embodiments, ASPM has a sequence as disclosed in GenBank Accession # NM_{—}018136 or Affymetrix Accession #219918_s_at. In some embodiments, ASPM refers to a sequence comprising SEQ ID NO: 25 or a variant thereof. In some embodiments, ASPM is detected and/or measured by a probe comprising a sequence of SEQ ID NO: 26-36 or a variant thereof or any combination thereof. In some embodiments, ASPM is detected by at least 1, 2, 3, 4, 5, 6, 7, 8, 9, or 10 probes comprising a sequence selected from the group consisting of SEQ ID NO: 26-36 or a variant thereof. In some embodiments, ASPM is detected using 11 probes, each having a different sequence and each sequence selected from the group consisting of SEQ ID NO: 26-36 or a variant thereof.

As used herein, “CEP55,”, which can also be referred to as “FLJ10540” refers to centrosomal protein 55 kDa. In some embodiments, CEP55 has a sequence as disclosed in GenBank Accession # NM_{—}001127182 or Affymetrix Accession #218542_at. In some embodiments, CEP55 refers to a sequence comprising SEQ ID NO: 37 or a variant thereof. In some embodiments, CEP55 is detected and/or measured by a probe comprising a sequence of SEQ ID NO: 38-48 or a variant thereof or any combination thereof. In some embodiments, CEP55 is detected by at least 1, 2, 3, 4, 5, 6, 7, 8, 9, or 10 probes comprising a sequence selected from the group consisting of SEQ ID NO: 38-48 or a variant thereof. In some embodiments, CEP55 is detected using 11 probes, each having a different sequence and each sequence selected from the group consisting of SEQ ID NO: 38-48 or a variant thereof.

As used herein, “CAPRIN2”, which can also be referred to as “C1QDC1” refers to caprin family member 2. In some embodiments, CAPRIN2 has a sequence as disclosed in GenBank Accession # NM_{—}001002259 or Affymetrix Accession #218456_at. In some embodiments, CAPRIN2 refers to a sequence comprising SEQ ID NO: 49 or a variant thereof. In some embodiments, CAPRIN2 is detected and/or measured by a probe comprising a sequence of SEQ ID NO: 50-60 or a variant thereof or any combination thereof. In some embodiments, CAPRIN2 is detected by at least 1, 2, 3, 4, 5, 6, 7, 8, 9, or 10 probes comprising a sequence selected from the group consisting of SEQ ID NO: 50-60 or a variant thereof. In some embodiments, CAPRIN2 is detected using 11 probes, each having a different sequence and each sequence selected from the group consisting of SEQ ID NO: 50-60 or a variant thereof.

As used herein, “CDKN3,” refers to cyclin-dependent kinase inhibitor 3. In some embodiments, CDKN3 has a sequence as disclosed in GenBank Accession # NM_{—}001130851 or Affymetrix Accession #209714_s_at. In some embodiments, CDKN3 refers to a sequence comprising SEQ ID NO: 61 or a variant thereof. In some embodiments, CDKN3 is detected and/or measured by a probe comprising a sequence of SEQ ID NO: 62-72 or a variant thereof or any combination thereof. In some embodiments, CDKN3 is detected by at least 1, 2, 3, 4, 5, 6, 7, 8, 9, or 10 probes comprising a sequence selected from the group consisting of SEQ ID NO: 62-72 or a variant thereof. In some embodiments, CDKN3 is detected using 11 probes, each having a different sequence and each sequence selected from the group consisting of SEQ ID NO: 62-72 or a variant thereof.

As used herein, “CKS2,” refers to CDC28 protein kinase regulatory subunit 2. In some embodiments, CKS2 has a sequence as disclosed in GenBank Accession # NM_{—}001827 or Affymetrix Accession #204170_s_at. In some embodiments, CKS2 refers to a sequence comprising SEQ ID NO: 73 or a variant thereof. In some embodiments, CKS2 is detected and/or measured by a probe comprising a sequence of SEQ ID NO: 74-84 or a variant thereof or any combination thereof. In some embodiments, CKS2 is detected by at least 1, 2, 3, 4, 5, 6, 7, 8, 9, or 10 probes comprising a sequence selected from the group consisting of SEQ ID NO: 74-84 or a variant thereof. In some embodiments, CKS2 is detected using 11 probes, each having a different sequence and each sequence selected from the group consisting of SEQ ID NO: 74-84 or a variant thereof.

As used herein, “DUSP4,” refers to dual specificity phosphatase 4. In some embodiments, DUSP4 has a sequence as disclosed in GenBank Accession # NM_{—}001394 or Affymetrix Accession #204014_at. In some embodiments, DUSP4 refers to a sequence comprising SEQ ID NO: 85 or a variant thereof. In some embodiments, DUSP4 is detected and/or measured by a probe comprising a sequence of SEQ ID NO: 86-96 or a variant thereof or any combination thereof. In some embodiments, DUSP4 is detected by at least 1, 2, 3, 4, 5, 6, 7, 8, 9, or 10 probes comprising a sequence selected from the group consisting of SEQ ID NO: 86-96 or a variant thereof. In some embodiments, DUSP4 is detected using 11 probes, each having a different sequence and each sequence selected from the group consisting of SEQ ID NO: 86-96 or a variant thereof.

As used herein, “EIF4A1,” refers to Eukaryotic translation initiation factor 4A 1. In some embodiments, EIF4A 1 has a sequence as disclosed in GenBank Accession # NM_{—}001416 or Affymetrix Accession #214805_at. In some embodiments, EIF4A1 refers to a sequence comprising SEQ ID NO: 97 or a variant thereof. In some embodiments, EIF4A1 is detected and/or measured by a probe comprising a sequence of SEQ ID NO: 98-108 or a variant thereof or any combination thereof. In some embodiments, EIF4A 1 is detected by at least 1, 2, 3, 4, 5, 6, 7, 8, 9, or 10 probes comprising a sequence selected from the group consisting of SEQ ID NO: 98-108 or a variant thereof. In some embodiments, EIF4A1 is detected using 11 probes, each having a different sequence and each sequence selected from the group consisting of SEQ ID NO: 98-108 or a variant thereof.

As used herein, “EPHA2,” refers to EPH receptor A2. In some embodiments, EPHA2 has a sequence as disclosed in GenBank Accession # NM_{—}004431 or Affymetrix Accession #203499_at. In some embodiments, EPHA2 refers to a sequence comprising SEQ ID NO: 109 or a variant thereof. In some embodiments, EPHA2 is detected and/or measured by a probe comprising a sequence of SEQ ID NO: 110-120 or a variant thereof or any combination thereof. In some embodiments, EPHA2 is detected by at least 1, 2, 3, 4, 5, 6, 7, 8, 9, or 10 probes comprising a sequence selected from the group consisting of SEQ ID NO: 110-120 or a variant thereof. In some embodiments, EPHA2 is detected using 11 probes, each having a different sequence and each sequence selected from the group consisting of SEQ ID NO: 110-120 or a variant thereof.

As used herein, “FGFBP1”, which can also be referred to as “HBP17” refers to fibroblast growth factor binding protein 1. In some embodiments, FGFBP1 has a sequence as disclosed in GenBank Accession # NM_{—}005130 or Affymetrix Accession #205014_at. In some embodiments, FGFBP1 refers to a sequence comprising SEQ ID NO: 121 or a variant thereof. In some embodiments, FGFBP1 is detected and/or measured by a probe comprising a sequence of SEQ ID NO: 122-132 or a variant thereof or any combination thereof. In some embodiments, FGFBP1 is detected by at least 1, 2, 3, 4, 5, 6, 7, 8, 9, or 10 probes comprising a sequence selected from the group consisting of SEQ ID NO: 122-132 or a variant thereof. In some embodiments, FGFBP1 is detected using 11 probes, each having a different sequence and each sequence selected from the group consisting of SEQ ID NO: 122-132 or a variant thereof.

As used herein, “ZWILCH”, which can also be referred to as “FLJ10036” refers to Zwilch, kinetochore associated, homolog (Drosophila). In some embodiments, ZWILCH has a sequence as disclosed in GenBank Accession # NM_{—}017975 or Affymetrix Accession #218349_s_at. In some embodiments, ZWILCH refers to a sequence comprising SEQ ID NO: 133 or a variant thereof. In some embodiments, ZWILCH is detected and/or measured by a probe comprising a sequence of SEQ ID NO: 134-144 or a variant thereof or any combination thereof. In some embodiments, ZWILCH is detected by at least 1, 2, 3, 4, 5, 6, 7, 8, 9, or 10 probes comprising a sequence selected from the group consisting of SEQ ID NO: 134-144 or a variant thereof. In some embodiments, ZWILCH is detected using 11 probes, each having a different sequence and each sequence selected from the group consisting of SEQ ID NO: 134-144 or a variant thereof.

As used herein, “FOXM1,” refers to forkhead box M1. In some embodiments, FOXM1 has a sequence as disclosed in GenBank Accession # NM_{—}021953 or Affymetrix Accession #202580_x_at. In some embodiments, FOXM1 refers to a sequence comprising SEQ ID NO: 145 or a variant thereof. In some embodiments, FOXM1 is detected and/or measured by a probe comprising a sequence of SEQ ID NO: 146-156 or a variant thereof or any combination thereof. In some embodiments, FOXM1 is detected by at least 1, 2, 3, 4, 5, 6, 7, 8, 9, or 10 probes comprising a sequence selected from the group consisting of SEQ ID NO: 146-156 or a variant thereof. In some embodiments, FOXM1 is detected using 11 probes, each having a different sequence and each sequence selected from the group consisting of SEQ ID NO: 146-156 or a variant thereof.

As used herein, “NCAPG,” which can also be referred to as “hCAP-G” refers to non-SMC condensin I complex, subunit G. In some embodiments, NCAPG has a sequence as disclosed in GenBank Accession # NM_{—}022346 or Affymetrix Accession #218663_at. In some embodiments, NCAPG refers to a sequence comprising SEQ ID NO: 157 or a variant thereof. In some embodiments, NCAPG is detected and/or measured by a probe comprising a sequence of SEQ ID NO: 158-168 or a variant thereof or any combination thereof. In some embodiments, NCAPG is detected by at least 1, 2, 3, 4, 5, 6, 7, 8, 9, or 10 probes comprising a sequence selected from the group consisting of SEQ ID NO: 158-168 or a variant thereof. In some embodiments, NCAPG is detected using 11 probes, each having a different sequence and each sequence selected from the group consisting of SEQ ID NO: 158-168 or a variant thereof.

As used herein, “ODC1,” refers to ornithine decarboxylase 1. In some embodiments, ODC1 has a sequence as disclosed in GenBank Accession # NM_{—}002539 or Affymetrix Accession #200790_at. In some embodiments, ODC 1 refers to a sequence comprising SEQ ID NO: 169 or a variant thereof. In some embodiments, ODC1 is detected and/or measured by a probe comprising a sequence of SEQ ID NO: 170-180 or a variant thereof or any combination thereof. In some embodiments, ODC1 is detected by at least 1, 2, 3, 4, 5, 6, 7, 8, 9, or 10 probes comprising a sequence selected from the group consisting of SEQ ID NO: 170-180 or a variant thereof. In some embodiments, ODC1 is detected using 11 probes, each having a different sequence and each sequence selected from the group consisting of SEQ ID NO: 170-180 or a variant thereof.

As used herein, “RRM2,” refers to ribonucleotide reductase M2. In some embodiments, RRM2 has a sequence as disclosed in GenBank Accession # NM_{—}001034 or Affymetrix Accession #209773_s_at. In some embodiments, RRM2 refers to a sequence comprising SEQ ID NO: 181 or a variant thereof. In some embodiments, RRM2 is detected and/or measured by a probe comprising a sequence of SEQ ID NO: 182-192 or a variant thereof or any combination thereof. In some embodiments, RRM2 is detected by at least 1, 2, 3, 4, 5, 6, 7, 8, 9, or 10 probes comprising a sequence selected from the group consisting of SEQ ID NO: 182-192 or a variant thereof. In some embodiments, RRM2 is detected using 11 probes, each having a different sequence and each sequence selected from the group consisting of SEQ ID NO: 182-192 or a variant thereof.

As used herein, “SERPINE2,” serpin peptidase inhibitor, Glade E (nexin, plasminogen activator inhibitor type 1), member 2. In some embodiments, SERPINE2 has a sequence as disclosed in GenBank Accession # NM_{—}001136528 or Affymetrix Accession #212190_at. In some embodiments, SERPINE2 refers to a sequence comprising SEQ ID NO: 193 or a variant thereof. In some embodiments, SERPINE2 is detected and/or measured by a probe comprising a sequence of SEQ ID NO: 194-204 or a variant thereof or any combination thereof. In some embodiments, SERPINE2 is detected by at least 1, 2, 3, 4, 5, 6, 7, 8, 9, or 10 probes comprising a sequence selected from the group consisting of SEQ ID NO: 194-204 or a variant thereof. In some embodiments, SERPINE2 is detected using 11 probes, each having a different sequence and each sequence selected from the group consisting of SEQ ID NO: 194-204 or a variant thereof.

As used herein, “AURKA” which can also be referred to as “STK6 refers to aurora kinase A. In some embodiments, AURKA has a sequence as disclosed in GenBank Accession # NM_{—}003600 or Affymetrix Accession #204092_s_at. In some embodiments, AURKA refers to a sequence comprising SEQ ID NO: 205 or a variant thereof. In some embodiments, AURKA is detected and/or measured by a probe comprising a sequence of SEQ ID NO: 206-216 or a variant thereof or any combination thereof. In some embodiments, AURKA is detected by at least 1, 2, 3, 4, 5, 6, 7, 8, 9, or 10 probes comprising a sequence selected from the group consisting of SEQ ID NO: 206-216 or a variant thereof. In some embodiments, AURKA is detected using 11 probes, each having a different sequence and each sequence selected from the group consisting of SEQ ID NO: 206-216 or a variant thereof.

As used herein, “RTEL1/TNFRSF6B” refers to regulator of telomere elongation helicase 1/tumor necrosis factor receptor superfamily, member 6b, decoy. In some embodiments, RTEL1/TNFRSF6B has a sequence as disclosed in GenBank Accession # NM_{—}003823 or Affymetrix Accession #206467_x_at. In some embodiments, RTEL1/TNFRSF6B refers to a sequence comprising SEQ ID NO: 217 or a variant thereof. In some embodiments, RTEL1/TNFRSF6B is detected and/or measured by a probe comprising a sequence of SEQ ID NO: 218-228 or a variant thereof or any combination thereof. In some embodiments, RTEL1/TNFRSF6B is detected by at least 1, 2, 3, 4, 5, 6, 7, 8, 9, or 10 probes comprising a sequence selected from the group consisting of SEQ ID NO: 218-228 or a variant thereof. In some embodiments, RTEL1/TNFRSF6B is detected using 11 probes, each having a different sequence and each sequence selected from the group consisting of SEQ ID NO: 218-228 or a variant thereof.

As used herein, “TRIP13” refers to thyroid hormone receptor interactor 13. In some embodiments, TRIP13 has a sequence as disclosed in GenBank Accession # NM_{—}001166260 or Affymetrix Accession #204033_at. In some embodiments, TRIP13 refers to a sequence comprising SEQ ID NO: 229 or a variant thereof. In some embodiments, TRIP13 is detected and/or measured by a probe comprising a sequence of SEQ ID NO: 230-240 or a variant thereof or any combination thereof. In some embodiments, TRIP13 is detected by at least 1, 2, 3, 4, 5, 6, 7, 8, 9, or 10 probes comprising a sequence selected from the group consisting of SEQ ID NO: 230-240 or a variant thereof. In some embodiments, TRIP13 is detected using 11 probes, each having a different sequence and each sequence selected from the group consisting of SEQ ID NO: 230-240 or a variant thereof.

As used herein, “TUBG1” refers to tubulin, gamma 1. In some embodiments, TUBG1 has a sequence as disclosed in GenBank Accession # NM_{—}001070 or Affymetrix Accession #201714_at. In some embodiments, TUBG1 refers to a sequence comprising SEQ ID NO: 241 or a variant thereof. In some embodiments, TUBG1 is detected and/or measured by a probe comprising a sequence of SEQ ID NO: 242-252 or a variant thereof or any combination thereof. In some embodiments, TUBG1 is detected by at least 1, 2, 3, 4, 5, 6, 7, 8, 9, or 10 probes comprising a sequence selected from the group consisting of SEQ ID NO: 242-252 or a variant thereof. In some embodiments, TUBG1 is detected using 11 probes, each having a different sequence and each sequence selected from the group consisting of SEQ ID NO: 242-252 or a variant thereof.

As used herein, “VRK1” refers to vaccinia related kinase 1. In some embodiments, VRK1 has a sequence as disclosed in GenBank Accession # NM_{—}003384 or Affymetrix Accession #203856_at. In some embodiments, VRK1 refers to a sequence comprising SEQ ID NO: 253 or a variant thereof. In some embodiments, VRK1 is detected and/or measured by a probe comprising a sequence of SEQ ID NO: 254-264 or a variant thereof or any combination thereof. In some embodiments, VRK1 is detected by at least 1, 2, 3, 4, 5, 6, 7, 8, 9, or 10 probes comprising a sequence selected from the group consisting of SEQ ID NO: 254-264 or a variant thereof. In some embodiments, VRK1 is detected using 11 probes, each having a different sequence and each sequence selected from the group consisting of SEQ ID NO: 254-264 or a variant thereof.

The sequences referred to in the section above are described in the sequence listing and in the following table (Table 28). The sequences can also be the reverse (3′-5′) orientation or a variant thereof.

| | Affymetrix | GenBank | |
|---|---|---|---|
| Gene | accession | Accession | |
| symbol | number | No. | Probe Sequences |
| ACTB | 200801_x_at | NM_001101 | TATGACTTAGTTGCGTTACACCCTT (SEQ ID NO: 2) |
| | | | CAGCAGTCGGTTGGAGCGAGCATCC (SEQ ID NO: 3) |
| | | | GCATCCCCCAAAGTTCACAATGTGG (SEQ ID NO: 4) |
| | | | GGCCGAGGACTTTGATTGCACATTG(SEQ ID NO: 5) |
| | | | TTGTTACAGGAAGTCCCTTGCCATC(SEQ ID NO: 6) |
| | | | TAAGGAGAATGGCCCAGTCCTCTCC(SEQ ID NO: 7) |
| | | | TTTTGAATGATGAGCCTTCGTGCCC(SEQ ID NO: 8) |
| | | | TTTTTGTCCCCCAACTTGAGATGTA (SEQ ID NO: 9) |
| | | | TGTATGAAGGCTTTTGGTCTCCCTG (SEQ ID NO: 10) |
| | | | GGAGTGGGTGGAGGCAGCCAGGGCT (SEQ ID NO: 11) |
| | | | GCCAGGGCTTACCTGTACACTGACT(SEQ ID NO: 12) |
| ACTN1 | 208637_x_at | NM_001102 | GGTCCCGAGGAGTTCAAAGCCTGCC (SEQ ID NO: 14) |
| | | | GCAGAATTTGCCCGCATCATGAGCA (SEQ ID NO: 15) |
| | | | TCATGAGCATTGTGGACCCCAACCG (SEQ ID NO: 16) |
| | | | TGGGGGTAGTGACATTCCAGGCCTT (SEQ ID NO: 17) |
| | | | AGCAGACCAAGTCATGGCTTCCTTC (SEQ ID NO: 18) |
| | | | CTTCCTTCAAGATCCTGGCTGGGGA (SEQ ID NO: 19) |
| | | | TACATTACCATGGACGAGCTGCGCC (SEQ ID NO: 20) |
| | | | CCGACCAGGCTGAGTACTGCATCGC (SEQ ID NO: 21) |
| | | | AGGTGCTCTGGACTACATGTCCTTC (SEQ ID NO: 22) |
| | | | GGCGCTGTACGGCGAGAGTGACCTC (SEQ ID NO: 23) |
| | | | CCCTGCCCGCGAAGTGACAGTTTAC (SEQ ID NO: 24) |
| ASPM | 219918_s_at | NM_018136 | GTTGTAATCGCAGTATTCCTTGTAT (SEQ ID NO: 26) |
| | | | TCAGATATGCTGTGCAAGTCTTGCT(SEQ ID NO: 27) |
| | | | GGAGCTTTTGCAGATATACCGAGAA (SEQ ID NO: 28) |
| | | | GTTGTTTGTTGGCTATTTTACTGAA (SEQ ID NO: 29) |
| | | | ATAGAGCCTCTGATGTACGAAGTAG (SEQ ID NO: 30) |
| | | | GTTGTTGACCGTATTTACAGTCTCT (SEQ ID NO: 31) |
| | | | CAGTCTCTACAAACTTACAGCTCAT (SEQ ID NO: 32) |
| | | | GCATTCCTTTTATCCCAGAAACACC (SEQ ID NO: 33) |
| | | | GAAGAAATCACAAATCCCCTGCAAG (SEQ ID NO: 34) |
| | | | AATCCCCTGCAAGCTATTCAAATGG (SEQ ID NO: 35) |
| | | | GTGATGGATACGCTTGGCATTCCTT (SEQ ID NO: 36) |
| CEP55 | 218542_at | NM_001127182 | AAGGATCTTAACTGTGTTCGCATTT (SEQ ID NO: 38) |
| | | | GTTCGCATTTTTTATCCAAGCACTT (SEQ ID NO: 39) |
| | | | AATCCTAATTTTGATGTCCATTGTT (SEQ ID NO: 40) |
| | | | GTTGGGGATTTTCTTGATCTTTATT (SEQ ID NO: 41) |
| | | | TATTGCTGCTTACCATTGAAACTTA (SEQ ID NO: 42) |
| | | | TGAAACTTAACCCAGCTGTGTTCCC (SEQ ID NO: 43) |
| | | | AACTCTGTTCTGCGCACGAAACAGT (SEQ ID NO: 44) |
| | | | TTAAGTGGCCACACACAATGTTTTC (SEQ ID NO: 45) |
| | | | GTTTTCTCTTATGTTATCTGGCAGT (SEQ ID NO: 46) |
| | | | GCCCTCTCATTTGATTGACAGTATT (SEQ ID NO: 47) |
| | | | AGGTTTTCTAACATGCTTACCACTG (SEQ ID NO: 48) |
| CAPRIN2 | 218456_at | NM_001002259 | GAATGTGCCACTGTATGTCAACCTC (SEQ ID NO: 50) |
| | | | AGAGGTCTTGGTATCAGCCTATGCC (SEQ ID NO: 51) |
| | | | GCCTATGCCAATGATGGTGCTCCAG (SEQ ID NO: 52) |
| | | | GGTGCTCCAGACCATGAAACTGCTA (SEQ ID NO: 53) |
| | | | GCAATCATGCAATTCTTCAGCTCTT (SEQ ID NO: 54) |
| | | | GATATGGTTACGTCTGCACAGGGGA (SEQ ID NO: 55) |
| | | | ATATTCTACGTTTTCAGGCTATCTT (SEQ ID NO: 56) |
| | | | TCTTTGCCCTCATGACTGATTGGTT (SEQ ID NO: 57) |
| | | | GTAGCCTCGCTAGTCAAGCTGTGAA (SEQ ID NO: 58) |
| | | | AGCTTACTAAACTGACTGCCTCAAG (SEQ ID NO: 59) |
| | | | GTTACAATGCCTTGTTGTGCCTCAA (SEQ ID NO: 60) |
| CDKN3 | 209714_s_at | NM_001130851 | TTTCTCGGTTTATGTGCTCTTCCAG (SEQ ID NO: 62) |
| | | | TAGAGTCCCAAACCTTCTGGATCTC (SEQ ID NO: 63) |
| | | | GGATCTCTACCAGCAATGTGGAATT (SEQ ID NO: 64) |
| | | | ACCCATCATCATCCAATCGCAGATG (SEQ ID NO: 65) |
| | | | CTCCTGACATAGCCAGCTGCTGTGA (SEQ ID NO: 66) |
| | | | TGGAAGAGCTTACAACCTGCCTTAA (SEQ ID NO: 67) |
| | | | GGAGGACTTGGGAGATCTTGTCTTG (SEQ ID NO: 68) |
| | | | GACACAATATCACCAGAGCAAGCCA (SEQ ID NO: 69) |
| | | | AAGCCATAGACAGCCTGCGAGACCT (SEQ ID NO: 70) |
| | | | GAGGATCCGGGGCAATACAGACCAT (SEQ ID NO: 71) |
| | | | ATTAGCTGCACATCTATCATCAAGA (SEQ ID NO: 72) |
| CKS2 | 204170_s_at | NM_001827 | CGCTCTCGTTTCATTTTCTGCAGCG (SEQ ID NO: 74) |
| | | | CGACGAACACTACGAGTACCGGCAT (SEQ ID NO: 75) |
| | | | TTATGTTACCCAGAGAACTTTCCAA (SEQ ID NO: 76) |
| | | | ACTTGGTGTCCAACAGAGTCTAGGC (SEQ ID NO: 77) |
| | | | TATTCTTCTCTTTAGACGACCTCTT (SEQ ID NO: 78) |
| | | | TCTCTTTAGACGACCTCTTCCAAAA (SEQ ID NO: 79) |
| | | | ACAAATCTTTCATCCATACCTGTGC (SEQ ID NO: 80) |
| | | | GTGCATGAGCTGTATTCTTCACAGC (SEQ ID NO: 81) |
| | | | GCAACAGAGCTCAGTTAAATGCAAC (SEQ ID NO: 82) |
| | | | GATAAAAGTTCTTCCAGTCAGTTTT (SEQ ID NO: 83) |
| | | | CAGTCAGTTTTTCTCTTAAGTGCCT(SEQ ID NO: 84) |
| DUSP4 | 204014_at | NM_001394 | GAAGGTGTGGTTTTCATTTCTCAGT (SEQ ID NO: 86) |
| | | | ATTTCTCAGTCACCAACAGATGAAT (SEQ ID NO: 87) |
| | | | ATGTCAAACAGCTGAGCACCGTAGC (SEQ ID NO: 88) |
| | | | GAGCACCGTAGCATGCAGATGTCAA (SEQ ID NO: 89) |
| | | | GCAGATGTCAAGGCAGTTAGGAAGT (SEQ ID NO: 90) |
| | | | AATGGTGTCTTGTAGATATGTGCAA (SEQ ID NO: 91) |
| | | | TGCAAGGTAGCATGATGAGCAACTT (SEQ ID NO: 92) |
| | | | GAGCAACTTGAGTTTGTTGCCACTG (SEQ ID NO: 93) |
| | | | GCCACTGAGAAGCAGGCGGGTTGGG (SEQ ID NO: 94) |
| | | | TATGTTGCCAAGGCTCATCTTGAGA(SEQ ID NO: 95) |
| | | | TTGAGAAGCAGGCGGGTTGGGTGGG (SEQ ID NO: 96) |
| EIF4A1 | 214805_at | NM_001416 | CCTTTTCACCCTTGCTTAATAGCCA (SEQ ID NO: 98) |
| | | | TTAATAGCCAGAGCTGTTTCATGCC (SEQ ID NO: 99) |
| | | | CACACAATTCTAATGCTGGACTTTT (SEQ ID NO: 100) |
| | | | CTTTTTCCTGGGTCATGCTGCAACA (SEQ ID NO: 101) |
| | | | GCAGAGCTCCATTCTAAGGCACTTG (SEQ ID NO: 102) |
| | | | TTCTAAGGCACTTGGCTCTCAGTTT (SEQ ID NO: 103) |
| | | | GGCTCTCAGTTTTCTCAGAGTGAAC (SEQ ID NO: 104) |
| | | | AGTGAACATGCCTCGTAGCTTGGGT (SEQ ID NO: 105) |
| | | | TCGTAGCTTGGGTCCTATGGCAGGA (SEQ ID NO: 106) |
| | | | TGCATCACCTGTTCTATAAAACTGG (SEQ ID NO: 107) |
| | | | GGCTCAACTCGTATAATCCCAACAC (SEQ ID NO: 108) |
| EPHA2 | 203499_at | NM_004431 | TATAGGATATTCCCAAGCCGACCTT (SEQ ID NO: 110) |
| | | | TGGCCCAGCGCCAAGTAAACAGGGT (SEQ ID NO: 111) |
| | | | TAAACAGGGTACCTCAAGCCCCATT (SEQ ID NO: 112) |
| | | | GGGCAGACTGTGAACTTGACTGGGT (SEQ ID NO: 113) |
| | | | CTGGGTGAGACCCAAAGCGGTCCCT (SEQ ID NO: 114) |
| | | | TCCTGGGCCTTTGCAAGATGCTTGG (SEQ ID NO: 115) |
| | | | AGATGCTTGGTTGTGTTGAGGTTTT (SEQ ID NO: 116) |
| | | | GGGTGTCAAACATTCGTGAGCTGGG (SEQ ID NO: 117) |
| | | | AGGGACCGGTGCTGCAGGAGTGTCC (SEQ ID NO: 118) |
| | | | CCCATCTCTCATCCTTTTGGATAAG (SEQ ID NO: 119) |
| | | | GATAAGTTTCTATTCTGTCAGTGTT (SEQ ID NO: 120) |
| FGFBP1 | 205014_at | NM_005130 | AACAGAGATGTCCCCCAGGGAGCAC (SEQ ID NO: 122) |
| | | | GCCACCAAAGCTCCCGAGTGTGTGG (SEQ ID NO: 123) |
| | | | CAGAGGAAGACTGCCCTGGAGTTCT (SEQ ID NO: 124) |
| | | | CAGAGGAAGACTGCCCTGGAGTTCT (SEQ ID NO: 125) |
| | | | AGTGCAGGACACGTCATGCTAATGA (SEQ ID NO: 126) |
| | | | GAGATGTCATGTCGTAAGTCCCTCT (SEQ ID NO: 127) |
| | | | TACTTTAAAGCTCTCTACAGTCCCC (SEQ ID NO: 128) |
| | | | TCTACAGTCCCCCCAAAATATGAAC (SEQ ID NO: 129) |
| | | | GAGGCTGTTTCCTGCAGCATGTATT (SEQ ID NO: 130) |
| | | | TCCATGGCCCACACAGCTATGTGTT (SEQ ID NO: 131) |
| | | | TTTCAGTGCAACGAACTTTCTGCTG (SEQ ID NO: 132) |
| ZWILCH | 218349_s_at | NM_017975 | GGAACCATGGACACAGTTTCTCTCA (SEQ ID NO: 134) |
| | | | CAGTTTCTCTCAGTGGGACTATTCC (SEQ ID NO: 135) |
| | | | CATAGGTCAGGAACTTGCATCTTTG (SEQ ID NO: 136) |
| | | | GAATACTTCATTGCTCCATCAGTAG (SEQ ID NO: 137) |
| | | | TATCGTGTCCAAAAACTCCACCATA (SEQ ID NO: 138) |
| | | | AATATTAGTCAGTTGCATGCCTTTC (SEQ ID NO: 139) |
| | | | GCATGCCTTTCATTAAATCTCAACA (SEQ ID NO: 140) |
| | | | ATCTCAACATGAACTCCTCTTTTCT (SEQ ID NO: 141) |
| | | | CTGCCAGTCAGACCAACTGCTGTAA (SEQ ID NO: 142) |
| | | | TTACTAACATGGTTACCTGCAGCCA (SEQ ID NO: 143) |
| | | | GCAGCCAGGTGCATTTCAAGTGAAG (SEQ ID NO: 144) |
| FOXM1 | 202580_x_at | NM_021953 | TCAATTGACTTCTGTTCCTTGCTTT (SEQ ID NO: 146) |
| | | | AAGACCTGCAGTGCACGGTTTCTTC (SEQ ID NO: 147) |
| | | | CGGTTTCTTCCAGGCTGAGGTACCT (SEQ ID NO: 148) |
| | | | GAGGTACCTGGATCTTGGGTTCTTC (SEQ ID NO: 149) |
| | | | TGGGTTCTTCACTGCAGGGACCCAG (SEQ ID NO: 150) |
| | | | AAGTGGATCTGCTTGCCAGAGTCCT (SEQ ID NO: 151) |
| | | | TGTTTCCAAGTCAGCTTTCCTGCAA (SEQ ID NO: 152) |
| | | | GTGCCCAGATGTGCGCTATTAGATG (SEQ ID NO: 153) |
| | | | GATGTTTCTCTGATAATGTCCCCAA (SEQ ID NO: 154) |
| | | | TTGCCCCTCAGCTTTGCAAAGAGCC (SEQ ID NO: 155) |
| | | | CCAGCTGACCGCATGGGTGTGAGCC (SEQ ID NO: 156) |
| NCAPG | 218663_at | NM_022346 | AATTCGAGTCTATACAAAAGCCTTG (SEQ ID NO: 158) |
| | | | AGTTCTTTAGAACTCAGTAGCCATC (SEQ ID NO: 159) |
| | | | GTAGCCATCTTGCAAAAGATCTTCT (SEQ ID NO: 160) |
| | | | AAGATCTTCTGGTTCTATTGAATGA (SEQ ID NO: 161) |
| | | | AGGACATGTCTGAGAGCTTTGGAGA (SEQ ID NO: 162) |
| | | | ATTTGGTGACCAAGCTGAAGCAGCA (SEQ ID NO: 163) |
| | | | TGAAGCAGCACAGGATGCCACCTTG (SEQ ID NO: 164) |
| | | | GAAGTATATATGACTCCACTCAGGG (SEQ ID NO: 165) |
| | | | GACTCCACTCAGGGGTGTAAAAGCA (SEQ ID NO: 166) |
| | | | CCAAGCATCAAAGTCTACTCAGCTA (SEQ ID NO: 167) |
| | | | GTGACAGTTTCAGCTAGGACGAACA (SEQ ID NO: 168) |
| ODC1 | 200790_at | NM_002539 | AAAACATGGGCGCTTACACTGTTGC (SEQ ID NO: 170) |
| | | | TGCTGCCTCTACGTTCAATGGCTTC (SEQ ID NO: 171) |
| | | | CCAGAGGCCGACGATCTACTATGTG (SEQ ID NO: 172) |
| | | | TACTATGTGATGTCAGGGCCTGCGT (SEQ ID NO: 173) |
| | | | GCCTGCGTGGCAACTCATGCAGCAA (SEQ ID NO: 174) |
| | | | GCAGCCTGTGCTTCGGCTAGTATTA (SEQ ID NO: 175) |
| | | | AGCACTCTGGTAGCTGTTAACTGCA (SEQ ID NO: 176) |
| | | | AGAGTAGGGTCGCCATGATGCAGCC (SEQ ID NO: 177) |
| | | | GGGTCACACTTATCTGTGTTCCTAT (SEQ ID NO: 178) |
| | | | TTATTCACTCTTCAGACACGCTACT (SEQ ID NO: 179) |
| | | | AGACACGCTACTCAAGAGTGCCCCT (SEQ ID NO: 180) |
| RRM2 | 209773_s_at | NM_001034 | TTTTACCTTGGATGCTGACTTCTAA (SEQ ID NO: 182) |
| | | | GAAGATGTGCCCTTACTTGGCTGAT (SEQ ID NO: 183) |
| | | | GAAGTGTTACCAACTAGCCACACCA (SEQ ID NO: 184) |
| | | | CTAGCCACACCATGAATTGTCCGTA (SEQ ID NO: 185) |
| | | | AACTGTGTAGCTACCTCACAACCAG (SEQ ID NO: 186) |
| | | | CTCACAACCAGTCCTGTCTGTTTAT (SEQ ID NO: 187) |
| | | | GTGCTGGTAGTATCACCTTTTGCCA (SEQ ID NO: 188) |
| | | | CCTGGCTGGCTGTGACTTACCATAG (SEQ ID NO: 189) |
| | | | GACCCTTTAGTGAGCTTAGCACAGC (SEQ ID NO: 190) |
| | | | TAAACAGTCCTTTAACCAGCACAGC (SEQ ID NO: 191) |
| | | | CAGCCTCACTGCTTCAACGCAGATT (SEQ ID NO: 192) |
| SERPINE2 | 212190_at | NM_001136528 | CGATGCAAGTGTTTCTGTTCTGGGA (SEQ ID NO: 194) |
| | | | GGATGGCTGGAACACTGTACTGAGG (SEQ ID NO: 195) |
| | | | TAAACTACTGAACTGTTACCTAGGT (SEQ ID NO: 196) |
| | | | AACAACCCTGTTGAGTATTTGCTGT (SEQ ID NO: 197) |
| | | | GAGTATTTGCTGTTTGTCCAGTTCA (SEQ ID NO: 198) |
| | | | GTTTTGTCTATATGTGCGGCTTTTC (SEQ ID NO: 199) |
| | | | TCCCCCTCCAAAGTCTTGATAGCAA (SEQ ID NO: 200) |
| | | | AAACGGTGAAATCTCTAGCCTCTTT (SEQ ID NO: 201) |
| | | | TTAAAAAACTCCTGTCTTGCTAGAC (SEQ ID NO: 202) |
| | | | TGTTGTGCAGTGTGCCTGTCACTAC (SEQ ID NO: 203) |
| | | | ACTGGTCTGTACTCCTTGGATTTGC (SEQ ID NO: 204) |
| AURKA | 204092_s_at | NM_003600 | TGCCCTGACCCCGATCAGTTAAGGA (SEQ ID NO: 206) |
| | | | GACCCCGATCAGTTAAGGAGCTGTG (SEQ ID NO: 207) |
| | | | GAGCTGTGCAATAACCTTCCTAGTA (SEQ ID NO: 208) |
| | | | GCTGTGCAATAACCTTCCTAGTACC (SEQ ID NO: 209) |
| | | | AAAGCTGTTGGAATGAGTATGTGAT (SEQ ID NO: 210) |
| | | | TTGTATTTTTTCTCTGGTGGCATTC (SEQ ID NO: 211) |
| | | | TTTTTTCTCTGGTGGCATTCCTTTA (SEQ ID NO: 212) |
| | | | TTCTCTGGTGGCATTCCTTTAGGAA (SEQ ID NO: 213) |
| | | | ATTCCTTTAGGAATGCTGTGTGTCT (SEQ ID NO: 214) |
| | | | TTAACCACTTATCTCCCATATGAGA (SEQ ID NO: 215) |
| | | | CACTTATCTCCCATATGAGAGTGTG (SEQ ID NO: 216) |
| RTEL1/ | 206467_x_at | NM_003823 | GCAGCTCCAGCTCAGAGCAGTGCCA (SEQ ID NO: 218) |
| TNFRSF6B | | | GGGCCTGGCCCTCAATGTGCCAGGC (SEQ ID NO: 219) |
| | | | AGCACCAGGGTACCAGGAGCTGAGG (SEQ ID NO: 220) |
| | | | AGCTGAGGAGTGTGAGCGTGCCGTC (SEQ ID NO: 221) |
| | | | TGCCGTCATCGACTTTGTGGCTTTC (SEQ ID NO: 222) |
| | | | TTTGTGGCTTTCCAGGACATCTCCA (SEQ ID NO: 223) |
| | | | GACATCTCCATCAAGAGGCTGCAGC (SEQ ID NO: 224) |
| | | | GAGGCTGCAGCGGCTGCTGCAGGCC (SEQ ID NO: 225) |
| | | | TGCAGCTGAAGCTGCGTCGGCGGCT (SEQ ID NO: 226) |
| | | | CCCTCTTATTTATTCTACATCCTTG (SEQ ID NO: 227) |
| | | | GCACCCCACTTGCACTGAAAGAGGC (SEQ ID NO: 228) |
| TRIP13 | 204033_at | NM_001166260 | GAAGAACCATCGAAACCTGTTTGTT (SEQ ID NO: 230) |
| | | | AAATGCACACATTACTCCAGGTGGA (SEQ ID NO: 231) |
| | | | GGTGGCAATTGCTTTCTGATATCAG (SEQ ID NO: 232) |
| | | | ATCAAGACATGGTCCCATTTGCAGG (SEQ ID NO: 233) |
| | | | GTGCAGACTCTGAGTGTTCCAGGGA (SEQ ID NO: 234) |
| | | | GAAACACATGCTGGACATCCCTTGT (SEQ ID NO: 235) |
| | | | CATCCCTTGTAACCCGGTATGGGCG (SEQ ID NO: 236) |
| | | | CTGCATTGCTGGGATGTTTCTGCCC (SEQ ID NO: 237) |
| | | | CTGCCCACGGTTTTGTTTGTGCAAT (SEQ ID NO: 238) |
| | | | ATAGGTCAGTTACTGGTCTCTTTCT (SEQ ID NO: 239) |
| | | | GGTCTCTTTCTGCCGAATGTTATGT (SEQ ID NO: 240) |
| TUBG1 | 201714_at | NM_001070 | CTCTTCGAGAGAACCTGTCGCCAGT (SEQ ID NO: 242) |
| | | | CGAGAGAACCTGTCGCCAGTATGAC (SEQ ID NO: 243) |
| | | | GTCGCCAGTATGACAAGCTGCGTAA (SEQ ID NO: 244) |
| | | | GCCAGTATGACAAGCTGCGTAAGCG (SEQ ID NO: 245) |
| | | | CCTTCCTGGAGCAGTTCCGCAAGGA (SEQ ID NO: 246) |
| | | | GACACATCCAGGGAGATTGTGCAGC (SEQ ID NO: 247) |
| | | | GCAGCTCATCGATGAGTACCATGCG (SEQ ID NO: 248) |
| | | | ACCCCCTCAGAGCACAGATCAGGGA (SEQ ID NO: 249) |
| | | | CCTCAGAGCACAGATCAGGGACCTC (SEQ ID NO: 250) |
| | | | TCTCTTTCTCATATACATGGACTCT (SEQ ID NO: 251) |
| | | | CATATACATGGACTCTCTGTTGGCC (SEQ ID NO: 252) |
| VRK1 | 203856_at | NM_003384 | AAATTGGACCTCAGTGTTGTGGAGA (SEQ ID NO: 254) |
| | | | GAACCTGGTGTTGAAGATACGGAAT (SEQ ID NO: 255) |
| | | | GATACGGAATGGTCAAACACACAGA (SEQ ID NO: 256) |
| | | | ACAGACAGAGGAGGCCATACAGACC (SEQ ID NO: 257) |
| | | | CCATACAGACCCGTTCAAGAACCAG (SEQ ID NO: 258) |
| | | | TCAGATGCTGTGAACCAGATTTCCT (SEQ ID NO: 259) |
| | | | GTGAGTCTTGCGAGGTGGAATTAAT (SEQ ID NO: 260) |
| | | | TACTCCTTAAGTTATCCCAAAGCCG (SEQ ID NO: 261) |
| | | | ATCCCAAAGCCGTGTGTTTGTGATG (SEQ ID NO: 262) |
| | | | GACACGCACTTTTCTAATCATTGTA (SEQ ID NO: 263) |
| | | | AAATGTTTGACAAAGTCCTCACTTT (SEQ ID NO: 264) |

Embodiments are not limited based on the number of genes or the specific genes whose expression may be assessed or the type of treatment or therapeutic whose efficacy can be tested using the clinical test. For example, in some embodiments, the microarray may include probes for from 1 to greater than 500 genes whose expression patterns are modified in tumors or cancerous cells. In other embodiments, the microarray may include hybridization probes for from 2 to about 300, from about 5 to about 100, from about 10 to about 50, or from about 10 to about 25 genes. Without wishing to be bound by theory, microarrays including a larger number of hybridization probes such as, for example, 100 or more, 200 or more, 300 or more, or 500 or more may be capable to test for the efficacy of a greater number of therapeutic agents in a single test, whereas a microarray including a limited number of hybridization probes such as, for example, up to 5, up to 10, up to 15, up to 20, up to 25, up to 30, or up to 50, may be capable of more definitively testing the efficacy of a particular form of treatment. In some embodiments, the microarray may include probes for from 15 to 30 genes such as 15, 16, 17, 18, 19, 20, 21, 22, 23, 24, 25, 26, 27, 28, 29, or 30 probes.

Similarly, the microarray may be prepared to test the expression level of any known gene or any gene that may be discovered that exhibits a change in expression in tumorigenic cells as compared to normal cells and which change in expression may be indicative of cells that respond to a specific form of treatment. In some embodiments, non-limiting examples of genes associated with various types of cancer, i.e., “genetic markers” or “marker genes”, whose expression can be tested using the tests and microarrays may include, but are not limited to, AC004010, ACTB, ACTN1, APOE, ASPM, AURKA, BBOX1, BIRC5, BLM, BM039, BNIP3L, C1QDC1, C14ORF147, CDC6, CDC45L, CDK3, CDKN3, CENPA, CEP55, CKS2, COL4A2, CRYAB, DC13, DSG3, DUSP4, EFEMP1, EGR1, EIF4A1, EIF4B, EPHA2, EPHA2, FEN1, FGFBP1, FKBP1B, FLJ10036, FLJ10517, FLJ10540, FLJ10687, FLJ20701, FOSL2, FOXM1, GPNMB, H2AFZ, HCAP-G, HBP17, HPV17, ID-GAP, IGFBP2, KIAA084, KIAA092, KNSL6, KNTC2, KRTC2, KRT10, LEPL, LOC51203, LOC51659, LRP16, LRP8, MAFB, MCM6, MELK, MTB, NCAPG, NUSAP1, ODC, ODC1, PHLDA1, PITRM1, PLK1, POLQ, PPL, PRC1, RAMP, RRM2, RRM3, SEC4L, SEPT10, SERPINE2, SERPINA3, SLC20A1, SMC4L1, SNRPA1, SOX4, SRCAP, SRD5A1, STK6, SUCLG2, SUPT16H, TCF4, THBS1, TNFRSF6B, TRIP13, TUBG1, UCHL5, VRK1, WDR32, ZNF227, ZWILICH, and the like and combinations thereof. In some embodiments, the marker genes whose expression levels can be tested, measured, quantified, or determined are FLJ10517, HCAP-G, CDKN3, STK6, FOXM1, FLJ10540, TNFRSF6B, HBP17, C1QDC1, TUBG1, FLJ10036, RRM2, ACTB, ACTN1, EPHA2, TRIP13, CKS2, VRK1, DUSP4, EIF4A1, SERPINE2, ODC1, and the like and any combinations thereof. For example any marker can be combined with any other marker or any other multiple markers. The hybridization probes selected for the microarray may include any number and type of marker genes necessary to assure accurate and precise results, and in some embodiments, the number of hybridization probes may be economized to include, for example, a subset of genes whose expression profile is indicative of a particular type of cancer and/or treatment for which the microarray is designed to test.

Numerous techniques and methods are available for detecting intensity changes and making intensity measurements from microarrays to determine levels gene expression including, for example, the methods found in U.S. Pat. Nos. 6,271,002; 6,218,122; 6,218,114; and 6,004,755, the disclosure of each of which are hereby incorporated by reference in their entireties. In some embodiments, expression levels of one or more genetic markers may be conducted by comparing the intensity measurements derived from the microarrays. For example, in some embodiments, intensity measurement comparisons may be used to generate a ratio matrix of the expression intensities of genes in a test sample taken from cancerous tissue versus those in a control sample from normal tissue of the same type or of a previously collected sample of diseased tissue. The ratio of these expression intensities may indicate a change in gene expression between the test and control samples and may be used to determine, for example, the progression of the cancer, the likelihood that a particular form of therapy will be effective, and/or the effect a particular form of treatment has had on the patient.

In various embodiments, modulated genes may be defined as those genes that are differentially expressed in cancerous tissue as being either up regulated or down regulated. Up regulation and down regulation are relative terms meaning that a detectable difference, beyond the contribution of noise in the system used to measure it, may be found in the amount of expression of genes relative to some baseline. In some embodiments, a baseline expression level may be measured from the amount of mRNA for a particular genetic marker in a normal cell or other standard cell (i.e. positive or negative control). The one or more genetic markers in the cancerous tissue may be either up regulated or down regulated relative to the baseline level using the same measurement method. Distinctions between expression of a genetic marker in healthy tissue versus cancerous tissue may be made through the use of mathematical/statistical values that are related to each other. For example, in some embodiments, distinctions may be derived from a mean signal indicative of gene expression in normal, healthy tissue and variation from this mean signal may be interpreted as being indicative of cancerous tissue. In other embodiments, distinctions may be made by use of the mean signal ratios between different groups of readings, i.e. intensity measurements, and the standard deviations of the signal ratio measurements. A great number of such mathematical/statistical values can be used in their place such as return at a given percentile. Regardless of the purpose, the expression of one or more markers can be determined using a microarray. These values can then be used to determine whether a cancer or tumor will likely respond to a treatment. The expression levels can be also be determined by using PCR, RT-PCR, RNA amplification, or any other method suitable for determining expression levels of one or more markers. A standard can be used in conjunction with the one or more markers to determine the expression level of the one or more markers. The expression levels are then used in an equation or algorithm and the expression levels are transformed into a predictive number. The predictive number can indicate that the tumor or cancer will likely respond to treatment or that the cancer or tumor will not likely respond to treatment. The predictive number can also be used to predict prognosis as described herein. The predictive number can also be used on a relative basis to select a treatment for a subject. Such methods and uses of predictive numbers are described herein.

By determining the expression levels of genes that exhibit modulated expression in diseased, or cancerous tissue, an expression profile or genetic signature for particular diseased states may be determined. Accordingly, in some embodiments, the expression profile for various disease types and various patients may vary, patients who are more likely to respond to specific types of therapy can be identified. For example, in some embodiments, the tests may include a microarray configured to identify patients who will respond to a specific form of therapy based on their particular genetic profile, such as, but not limited to, the 3-D signature. For example, in some embodiments, the microarray may include a set of genes specifically associated with the diseased state. For example, in some embodiments, the microarray of the test may comprise a set of 10-30 markers (e.g. genes) associated with cancer, and in some embodiments, the cancer tested using a test may be breast cancer.

In some embodiments, a test or method as described herein for use in conjunction with a method related to prognosis, response to treatment, survival prediction, or any method described herein involving breast cancer may comprise a microarray that comprises probes for FLJ10517, HCAP-G, CDKN3, STK6, FOXM1, FLJ10540, TNFRSF6B, HBP17, C1QDC1, TUBG1, FLJ10036, RRM2, ACTB, ACTN1, EPHA2, TRIP13, CKS2, VRK1, DUSP4, EIF4A1, SERPINE2, or ODC1, and any combination thereof. In some embodiments, the microarray comprises FLJ10517, HCAP-G, CDKN3, STK6, FOXM1, FLJ10540, TNFRSF6B, HBP17, C1QDC1, TUBG1, FLJ10036, RRM2, ACTB, ACTN1, EPHA2, TRIP13, CKS2, VRK1, DUSP4, EIF4A1, SERPINE2, and ODC1. In some embodiments, the microarray comprises FLJ10517 and HCAP-G. In some embodiments, the microarray comprises FLJ10517, HCAP-G, and CDKN3. In some embodiments, the microarray comprises FLJ10517, HCAP-G, CDKN3, and STK6. In some embodiments, the microarray comprises FLJ10517, HCAP-G, CDKN3, STK6, and FOXM1. In some embodiments, the microarray comprises FLJ10517, HCAP-G, CDKN3, STK6, FOXM1, and FLJ10540. In some embodiments, the microarray comprises FLJ10517, HCAP-G, CDKN3, STK6, FOXM1, FLJ10540, and TNFRSF6B. In some embodiments, the microarray comprises FLJ10517, HCAP-G, CDKN3, STK6, FOXM1, FLJ10540, TNFRSF6B, and HBP17. In some embodiments, the microarray comprises FLJ10517, HCAP-G, CDKN3, STK6, FOXM1, FLJ10540, TNFRSF6B, HBP17, and C1QDC1. In some embodiments, the microarray comprises FLJ10517, HCAP-G, CDKN3, STK6, FOXM1, FLJ10540, TNFRSF6B, HBP17, C1QDC1, and TUBG1. In some embodiments, the microarray comprises FLJ10517, HCAP-G, CDKN3, STK6, FOXM1, FLJ10540, TNFRSF6B, HBP17, C1QDC1, TUBG1, and FLJ10036. In some embodiments, the microarray comprises FLJ10517, HCAP-G, CDKN3, STK6, FOXM1, FLJ10540, TNFRSF6B, HBP17, C1QDC1, TUBG1, FLJ10036, and RRM2. In some embodiments, the microarray comprises FLJ10517, HCAP-G, CDKN3, STK6, FOXM1, FLJ10540, TNFRSF6B, HBP17, C1QDC1, TUBG1, FLJ10036, RRM2, and ACTB. In some embodiments, the microarray comprises FLJ10517, HCAP-G, CDKN3, STK6, FOXM1, FLJ10540, TNFRSF6B, HBP17, C1QDC1, TUBG1, FLJ10036, RRM2, ACTB, and ACTN1. In some embodiments, the microarray comprises FLJ10517, HCAP-G, CDKN3, STK6, FOXM1, FLJ10540, TNFRSF6B, HBP17, C1QDC1, TUBG1, FLJ10036, RRM2, ACTB, ACTN1, and EPHA2. In some embodiments, the microarray comprises FLJ10517, HCAP-G, CDKN3, STK6, FOXM1, FLJ10540, TNFRSF6B, HBP17, C1QDC1, TUBG1, FLJ10036, RRM2, ACTB, ACTN1, EPHA2, and TRIP13. In some embodiments, the microarray comprises FLJ10517, HCAP-G, CDKN3, STK6, FOXM1, FLJ10540, TNFRSF6B, HBP17, C1QDC1, TUBG1, FLJ10036, RRM2, ACTB, ACTN1, EPHA2, TRIP13, and CKS2. In some embodiments, the microarray comprises FLJ10517, HCAP-G, CDKN3, STK6, FOXM1, FLJ10540, TNFRSF6B, HBP17, C1QDC1, TUBG1, FLJ10036, RRM2, ACTB, ACTN1, EPHA2, TRIP13, CKS2, and VRK1. In some embodiments, the microarray comprises FLJ10517, HCAP-G, CDKN3, STK6, FOXM1, FLJ10540, TNFRSF6B, HBP17, C1QDC1, TUBG1, FLJ10036, RRM2, ACTB, ACTN1, EPHA2, TRIP13, CKS2, VRK1, and DUSP4. In some embodiments, the microarray comprises FLJ10517, HCAP-G, CDKN3, STK6, FOXM1, FLJ10540, TNFRSF6B, HBP17, C1QDC1, TUBG1, FLJ10036, RRM2, ACTB, ACTN1, EPHA2, TRIP13, CKS2, VRK1, DUSP4, and EIF4A1. In some embodiments, the microarray comprises FLJ10517, HCAP-G, CDKN3, STK6, FOXM1, FLJ10540, TNFRSF6B, HBP17, C1QDC1, TUBG1, FLJ10036, RRM2, ACTB, ACTN1, EPHA2, TRIP13, CKS2, VRK1, DUSP4, EIF4A1, and SERPINE2.

In some embodiments, a microarray comprises probes for CKS2, CDKN3, FOXM1, RRM2, VRK1, TRIP13, ASPM, CEP55, ZWILCH, TUBG1, AURKA, SERPINE2, CAPRIN2, TNFRSF6B, CAPG, ACTN1, ACTB, DUSP4, EPHA2, FGFBP1, EIF4A1, ESR1, ODC1, and any combination thereof. In some embodiments, the microarray comprises CKS2, DUSP4, FGFBP, and TNFRSF6B. In some embodiments, the microarray comprises ESR1, CDH3, and HER2. In some embodiments, the microarray comprises FGFBP, ODC1 and CKS2. In some embodiments, the microarray comprises CEP55, FGFBP, ESR1, and ODC1. In some embodiments, the microarray comprises FLJ10517, HCAP-G, and CDKN3. In some embodiments, the microarray comprises FLJ10517, HCAP-G, CDKN3, and STK6. In some embodiments, the microarray comprises FLJ10517, HCAP-G, CDKN3, STK6, and FOXM1. In some embodiments, the microarray comprises FLJ10517, HCAP-G, CDKN3, STK6, FOXM1, and FLJ10540. In some embodiments, the microarray comprises FLJ10517, HCAP-G, CDKN3, STK6, FOXM1, FLJ10540, and TNFRSF6B. In some embodiments, the microarray comprises FLJ10517, HCAP-G, CDKN3, STK6, FOXM1, FLJ10540, TNFRSF6B, and HBP17. In some embodiments, the microarray comprises FLJ10517, HCAP-G, CDKN3, STK6, FOXM1, FLJ10540, TNFRSF6B, HBP17, and C1QDC1. In some embodiments, the microarray comprises FLJ10517, HCAP-G, CDKN3, STK6, FOXM1, FLJ10540, TNFRSF6B, HBP17, C1QDC1, and TUBG1. In some embodiments, the microarray comprises FLJ10517, HCAP-G, CDKN3, STK6, FOXM1, FLJ10540, TNFRSF6B, HBP17, C1QDC1, TUBG1, and FLJ10036. In some embodiments, the microarray comprises FLJ10517, HCAP-G, CDKN3, STK6, FOXM1, FLJ10540, TNFRSF6B, HBP17, C1QDC1, TUBG1, FLJ10036, and RRM2. In some embodiments, the microarray comprises FLJ10517, HCAP-G, CDKN3, STK6, FOXM1, FLJ10540, TNFRSF6B, HBP17, C1QDC1, TUBG1, FLJ10036, RRM2, and ACTB. In some embodiments, the microarray comprises FLJ10517, HCAP-G, CDKN3, STK6, FOXM1, FLJ10540, TNFRSF6B, HBP17, C1QDC1, TUBG1, FLJ10036, RRM2, ACTB, and ACTN1. In some embodiments, the microarray comprises FLJ10517, HCAP-G, CDKN3, STK6, FOXM1, FLJ10540, TNFRSF6B, HBP17, C1QDC1, TUBG1, FLJ10036, RRM2, ACTB, ACTN1, and EPHA2. In some embodiments, the microarray comprises FLJ10517, HCAP-G, CDKN3, STK6, FOXM1, FLJ10540, TNFRSF6B, HBP17, C1QDC1, TUBG1, FLJ10036, RRM2, ACTB, ACTN1, EPHA2, and TRIP13. In some embodiments, the microarray comprises FLJ10517, HCAP-G, CDKN3, STK6, FOXM1, FLJ10540, TNFRSF6B, HBP17, C1QDC1, TUBG1, FLJ10036, RRM2, ACTB, ACTN1, EPHA2, TRIP13, and CKS2. In some embodiments, the microarray comprises FLJ10517, HCAP-G, CDKN3, STK6, FOXM1, FLJ10540, TNFRSF6B, HBP17, C1QDC1, TUBG1, FLJ10036, RRM2, ACTB, ACTN1, EPHA2, TRIP13, CKS2, and VRK1. In some embodiments, the microarray comprises FLJ10517, HCAP-G, CDKN3, STK6, FOXM1, FLJ10540, TNFRSF6B, HBP17, C1QDC1, TUBG1, FLJ10036, RRM2, ACTB, ACTN1, EPHA2, TRIP13, CKS2, VRK1, and DUSP4. In some embodiments, the microarray comprises FLJ10517, HCAP-G, CDKN3, STK6, FOXM1, FLJ10540, TNFRSF6B, HBP17, C1QDC1, TUBG1, FLJ10036, RRM2, ACTB, ACTN1, EPHA2, TRIP13, CKS2, VRK1, DUSP4, and EIF4A1. In some embodiments, the microarray comprises FLJ10517, HCAP-G, CDKN3, STK6, FOXM1, FLJ10540, TNFRSF6B, HBP17, C1QDC1, TUBG1, FLJ10036, RRM2, ACTB, ACTN1, EPHA2, TRIP13, CKS2, VRK1, DUSP4, EIF4A1, and SERPINE2.

In some embodiments, the expression profile of one or more genes or a set of genes may allow an individual to determine the prognosis of the patient and/or the likelihood that an individual patient to whom the clinical test is administered will respond to a specific form of therapy, such as, for example, chemotherapy. In some embodiments, the pattern may be different for different chemotherapy regimens. These distinctions, which distinguish a patient who will respond to chemotherapy from those who will not, may be observed regardless of the prognosis of the patient, and may be particularly useful in identifying patients with a poor prognosis, late stage, or aggressive form of breast cancer who will respond to chemotherapy from those who will not. Identification or prediction of a patient's specific prognosis may be carried out using the tests and methods described herein.

Identification of patients who will respond to various forms of chemotherapy may be carried out using the tests and methods described herein. For example, in some embodiments, the test may identify patients who will respond to alkylating agents including for example, nitrogen mustards such as mechlorethamine (nitrogen mustard), chlorambucil, cyclophosphamide (Cytoxan®), ifosfamide, and melphalan; nitrosoureas such as streptozocin, carmustine (BCNU), and lomustine; alkyl sulfonates such as busulfan; triazines such as dacarbazine (DTIC) and temozolomide (Temodar®); and ethylenimines, such as, thiotepa and altretamine (hexamethylmelamine); and the like. In other embodiments, a patient's response to antimetabolites including but not limited to 5-fluorouracil (5-FU), capecitabine (Xeloda®), 6-mercaptopurine (6-MP), methotrexate, gemcitabine (Gemzar®), cytarabine (Ara-C®), fludarabine, and pemetrexed (Alimta®) and the like may be tested, and in still other embodiments, efficacy of anthracyclines such as, for example, daunorubicin, doxorubicin (Adriamycin®), epirubicin, and idarubicin and other anti-tumor antibiotics including, for example, actinomycin-D, bleomycin, and mitomycin-C may be tested. In yet other embodiments, the clinical test may be directed to identifying patients who will respond to topoisomerase I inhibitors such as topotecan and irinotecan (CPT-11) or topoisomerase II inhibitors such as etoposide (VP-16), teniposide, and mitoxantrone, and in further embodiments, the clinical test may be configured to determine the patients response to corticosteroids such as, but not limited to, prednisone, methylprednisolone (Solumedrol®) and dexamethasone (Decadron®). In some embodiments, the test may be configured to indentify patients who will respond to mitotic inhibitors including, for example, taxanes such as paclitaxel (Taxol®) and docetaxel (Taxotere®); epothilones such as ixabepilone (Ixempra®); vinca alkaloids such as vinblastine (Velban®), vincristine (Oncovin®), and vinorelbine (Navelbine®); and estramustine (Emcyt®). Without wishing to be bound by theory, a clinician may be capable of determining the efficacy of any or all of the chemotherapy agents identified above or known or developed in the future based on the expression profile derived from a microarray having probes for same marker genes, and in certain embodiments, a clinician may be capable of distinguishing the efficacy of individual forms of chemotherapy based on microarrays having probes for the same marker genes.

Some embodiments of the methods described herein are also directed to methods for using the tests of the embodiments described above. For example, various embodiments, may include the steps of obtaining tissue samples from a patient. In some embodiments the methods described herein comprise isolating genetic material and/or proteins from the tissue samples. In some embodiments a method comprises determining the expression levels of one or more markers from the isolated or non-isolated genetic material. In some embodiments, a method comprises determining a genetic profile (e.g. 3D-signature) from the expression levels of the one or more markers. In some embodiments, a method comprises providing treatment to patients whose expression profile matches or nearly matches a predetermined expression profile that indicates that a patient will respond to the treatment. Determining the expression levels of one or more marker genes may be carried out by any method such as, but not limited to, the methods described herein. For example, in some embodiments, the expression levels of one or more marker genes may be measured using polymerase chain reaction (PCR), enzyme-linked immunosorbent assay (ELISA), magnetic immunoassay (MIA), flow cytometry, microarrays, or any such methods known in the art. In some embodiments, one or more microarray may be used to measure the expression level of one or more marker genes, and in some embodiments, the method may further include the steps of labeling the isolated genetic material or proteins and applying the labeled isolated genetic material or proteins to a microarray configured to identify patients who will respond to a form of treatment.

The steps and methods described herein and throughout can be used either alone or in combination with any other step or method described herein. In some embodiments, the steps are performed by the same entity or individual or by different entities or individuals. In some embodiments, one individual or entity will perform a step and transmit the information to another individual or entity that will perform the other steps. The transmission can be done electronically (e.g. electronic mail, telephone, facsimile, videoconferencing, and the like), written (e.g. via mail or post), or orally.

In some embodiments, the step of obtaining tissue samples from a patient may be carried out by any method. For example, in some embodiments, the tissue sample may be obtained by excising tissue from the patient during surgery, and in other embodiments, the tissue sample may be obtained by aspirating tissue or cells from a patient prior to surgery such as a tumor. In some embodiments, the tissue extracted may be tumor tissue excised during a tumorectomy or an invasive biopsy of a tumor, or aspirated from a tumor as a less invasive means to biopsy the tumor. In some embodiments, the tissue sample may be of diseased tissue. In some embodiments, the tissue sample may be from normal healthy tissue, and in some embodiments, the tissue sample may include one or more tissue samples from diseased or tumor tissue and normal healthy tissue.

Similarly, the step of isolating genetic material and/or protein may be carried out by any method known in the art. For example, numerous methods for extracting proteins from a tissue sample are known in the art, and any such method may be used in embodiments of the invention. Similarly, numerous methods and kits for extracting DNA and/or RNA (e.g. mRNA) from a tissue sample are known in the art and may be used to isolate genetic material or any portion thereof from the tissue sample. In some embodiments, the step of isolating genetic material from the tissue sample may further include the step of amplifying the genetic material. For example, in some embodiments, mRNA may be isolated from the tissue sample using a known method, and the isolated mRNA may be amplified using PCR or RT-PCR to produce cDNA or cRNA. Methods for amplifying mRNA using such methods are well known in the art and any such method may be used.

Having isolated the proteins and/or genetic material from the tissue sample and, in some embodiments, having amplified the isolated genetic material or a portion thereof, the resulting protein or genetic material may be labeled using any method. For example, in some embodiments, genetic material may be labeled using biotin, and in other embodiments, the genetic material may be labeled using radio-labeled nucleotides or fluorescent label such as a fluorescent nanoparticles or quantum dots. Proteins can be labeled using similar techniques. As above, methods for labeling genetic materials and proteins are well known in the art and any such methods may be used in embodiments of the invention.

The step of applying the labeled proteins or genetic material to a microarray may be carried by any method known in the art. In general, such methods may include the steps of preparing a solution containing the labeled protein or genetic material, contacting the microarray with the solution containing the labeled protein or genetic material, and allowing the labeled protein or genetic material to bind or hybridize to probes associated with the microarray. The various steps associated with applying the labeled proteins or genetic materials to a microarray are well known in the art and can be carried out using any such method. Additionally, in some embodiments, the step of allowing the labeled protein or genetic material to bind or hybridize to probes associated with the microarray may include an incubation step wherein the microarray is immersed in the solution for a period of time from, for example, 15 minutes to 3, 4, 5, or 6 to 12 hours to allow adequate hybridization. In certain embodiments, the incubation step may be carried out at room temperature, and in other embodiments, the incubation step may be carried out at a reduced temperature or an increased temperature as compared to room temperature which may facilitate binding or hybridization.

The step of developing the genetic profile from the microarray may include any number of steps necessary to observe the label associated with labeled protein or genetic material and quantify the intensity of the signal derived from the labeled protein or genetic material. For example, in some embodiments in which biotin is used to label genetic material, the step of developing the genetic profile of the microarray may include the step of washing the microarray with streptavidin, and/or in some embodiments, additionally washing the microarray with an anti-streptavidin biotinylated antibody to stain the microarray, or any combination thereof. The hybridized labeled genetic material may then be observed and the intensity of the signal quantified using fluormetric scanning. In some embodiments in which the protein or genetic material is labeled with a radio-nucleotide, observing and quantifying the intensity can be carried out using emulsion films such as X-ray film or any manner of scintillation counter or phosphorimager. Numerous methods for performing such techniques are known in the art and may be used. In some embodiments, nanoparticles or quantum dots may be observed and quantified by exciting the quantum dot under light of a specific wavelength and viewing the microarray using, for example, a CCD camera. The intensity of signal derived from images of the microarrays can then be determined using a computer and imaging software. Such methods are well known and can be carried out using numerous techniques.

In some embodiments, developing the genetic profile may further include comparing the intensities of the signal from one or more probes for genetic markers on the microarray with microarrays derived from normal healthy tissue which may or may not be from the same patient or standard intensities which reflect compiled genetic profiles data from similar clinical tests for numerous individuals having the subject disease such as cancer or breast cancer. In such embodiments, modulated expression of a particular gene may be evident by an increase or a decrease in signal from a probe associated with the particular gene, and an increase or a decrease in a specific gene may by indicative of a genetic profile for a patient who will respond well to a specific form of treatment. For example, a patient whose expression profile exhibits an increase in expression in the RRM2 (ribonucleotide reductase M2 polypeptide) gene over the median intensity for that gene of all patients having breast cancer whose expression profile was determined using the same clinical test or microarray may have a greater likelihood of responding to treatment using chemotherapy, such as, taxane therapy. In some embodiments, the change in intensity may be significant and obvious, for example, a dramatic change (10-fold) in intensity for one or more genetic marker may be observed based on the average expression profile. In some embodiments, a change in intensity may be reflected in about 10% to about 20% reduction in intensity for one or more genetic markers. Without wishing to be bound by theory, detecting this change in intensity and correlating it with a therapeutic sensitivity of an individual, may provide a sensitive, fast, and reproducible means for identifying therapeutic agents that will effectively treat the disease and/or tailoring specific therapeutic regimens for individual patients that increase their chances of alleviating or curing the diseased state. For example, in some embodiments, markers in tests for breast cancer may accurately identify individuals that will respond to taxane treatment over breast cancer patients who will not respond to such treatment by detecting a difference in intensity for one or more genetic markers with a p-value from about 0.001 to about 0.00001, and in other embodiments about 0.0001. In some embodiments, markers in tests for breast cancer can accurately identify individuals with triple negative breast cancer who will experience a better prognosis than other breast cancer patients who will not experience a good prognosis by detecting a difference in intensity for one or more genetic markers. While p-values for individual markers may range from about 0.1278 to about 0.6551, and in other embodiments about 0.9363, the p-values for an algorithm using a set of markers may range from 0.04387 to 0.0211. Addition of other factors to the algorithm, including clinical parameters or control genes, may further reduce p-values to 0.0039, 0.0006, or 0.0003.

Having developed the expression profile of a patient based on the microarray of the clinical test and having determined the therapeutic sensitivity of the patient, the patient may be treated using the appropriate therapeutic agent such as one or more of the chemotherapy agents described above. In some embodiments, the therapeutic agent identified may be administered alone. In some embodiments, the therapeutic agent identified may be administered as part of a course of treatment that may include one or more other forms of treatment. For example, in some embodiments, a therapeutic agent identified using the methods of embodiments of the invention may be provided as a form of neoadjuvant therapy for cancer. In some embodiments, the identified therapeutic agent may be administered to the patient before radiation or surgery to reduce the size of a tumor, and reducing the size of the tumor may reduce the amount of tissue removed during surgery. For example, in breast cancer, neoadjuvant therapy has been shown to increase the likelihood of a successful lumpectomy, which conserves breast tissue while removing the tumor reducing the need for a mastectomy in which one or both breasts are completely removed. Thus, embodiments of the method may include the steps of administering a therapeutic agent identified using the clinical test alone or in combination with one or more other forms of therapy, and/or the step of administering the therapeutic agent identified as a form of neoadjuvant therapy for cancer, such as but not limited to breast cancer.

In some embodiments, kits are provided for determining an appropriate therapeutic agent to treat a disease that includes the clinical test of embodiments described above, and one or more additional elements for preparing an expression profile from a tissue sample using the clinical test. In some embodiments, kits are provided for determining prognosis that includes the clinical test of embodiments described above, and one or more additional elements for preparing an expression profile from a tissue sample using the clinical test. For example, in some embodiments, a kit may include an apparatus for collecting a tissue sample, components for determining the expression levels of one or more genes associated with the disease, labels, reagents, other materials necessary to determine the expression profile, instructions for identifying a therapeutic agent based on the expression profile, or any combination thereof. Determining the expression levels of one or more marker genes may be carried out by any method such as polymerase chain reaction (PCR), enzyme-linked immunosorbent assay (ELISA), magnetic immunoassay (MIA), microarrays, or any such methods known in the art, and the contents of the kits of various embodiments may vary based on the method utilized. For example, in some embodiments PCR may be the method for determining the expression level of one or more marker genes, and the kit may include single-stranded DNA primers which facilitate amplification of a marker gene. In some embodiments, ELISA or MIA based kits may include antibodies directed to a specific protein and/or fluorescent or magnetic probes. In some embodiments, one or more microarray may be used to measure the expression level of one or more marker genes, and such kits may include one or more microarrays having probes to specific marker genes.

Any apparatus for collecting a tissue sample may be used. For example, in some embodiments, the apparatus may be a needle and/or syringe used to aspirate cells or tissue from diseased tissue such as a tumor. In some embodiments, the kit may be include a scalpel or other instrument for obtaining a tissue sample. In some embodiments, the kit may include a combination of apparatuses that may be used to obtain a tissue sample. In further embodiments, the kit may include an instruction describing the use of another commercially available apparatus to obtain a tissue sample.

In some embodiments, one or more labels for the protein or genetic material may also be provided in the kit. For example, kits of various embodiments may include a label, such as biotin, the reagents and materials necessary to perform biotinylation, a radio-label or radio-labeled nucleotide, reagents and materials necessary to incorporate a radioactive label into isolated protein or genetic materials, fluorescent label and reagents, materials necessary to fluorescently label the isolated protein or genetic material, nanoparticles, nanocrystals, or quantum dots, reagents and materials necessary to label the isolated protein or genetic material with nanoparticles, nanocrystals, or quantum dots, or any combination thereof.

Numerous reagents may be provided in the kits of embodiments of the invention including, for example, reagents necessary for tissue sample acquisition and storage, reagents necessary for protein and/or genetic material isolation, reagents necessary for labeling, reagents necessary to perform PCR, ELISA, MIA, or using a microarray, reagents for producing a solution used to apply labeled protein or genetic material to the microarray, reagents necessary for developing the microarray, reagents used in conjunction with observing, analyzing or quantifying the expression levels, the expression profile, reagents for the storage of the microarray following processing, and the like and any combination thereof. In some embodiments, the kit may include vials of such reagents in solution arranged and labeled to allow ease of use. In some embodiments, the kit may include the component parts of the various reagents which may be combined with a solvent such as, for example, water to create the reagent. The component parts of some embodiments may be in solid or liquid form where such liquids are concentrated to reduce the size and/or weight of the kit thereby improving portability. In some embodiments, the various reagents necessary to use the clinical test of various embodiments may be supplied by providing the recipe and or instructions for making the reagents or exemplary reagents that may be substituted by other commonly used similar reagents.

In some embodiments, the kits of the invention may include materials necessary to develop a microarray. For example, in some embodiments, the kit may include an apparatus for holding the microarray and/or sealing at least an area surrounding the microarray to ensure that solutions containing labeled proteins or genetic material remain in contact with the microarray for a sufficient period of time to allow adequate binding or hybridization. In some embodiments, the kit may include apparatuses for ease of handling the microarray during development. In some embodiments, the kits of the invention may include a device for observing the labeled protein or genetic material on the microarray and/or quantifying the intensity of the signal generated by the labeled protein or genetic material. In some embodiments, the kit may include exemplary data, charts, and intensity comparison markers. In some embodiments, these or other similar materials may be provided in written form, and in other such embodiments, these or other similar materials may be provided on a computer readable medium, such as, but not limited, a flash drive, CD, DVD, Blue-Ray disc, and the like. In some embodiments, various materials may be provided through an internet website accessible to kit purchasers. Similarly, instructions for using the kit and any materials supplied with the kit may be provided with purchase of the kit in written form, on a computer readable medium, or on a similar internet website.

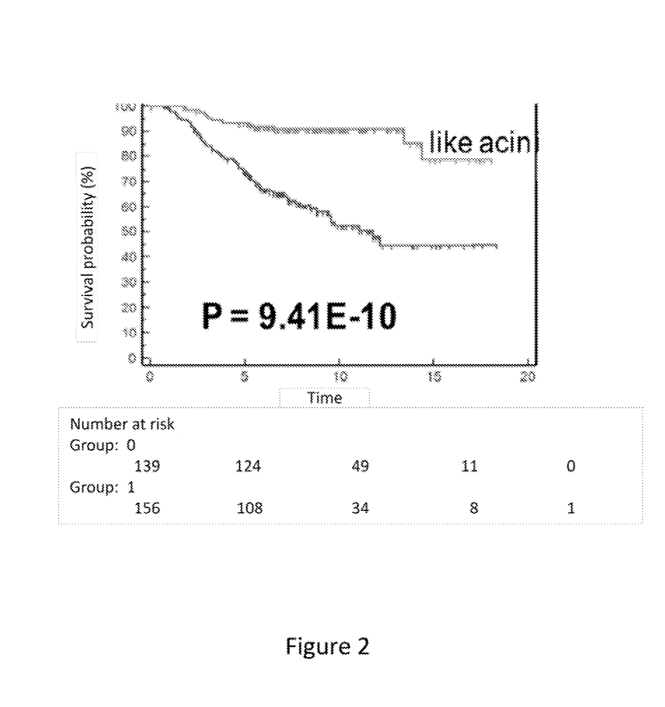

In some embodiments, embodiments of the present invention are directed to a 3D gene signature that accurately predicts the chemotherapeutic response outcome in breast cancer. In addition, the 3D signature can be an indicator for breast cancer prognosis. An example of this was seen in the 3 independent datasets with over 700 breast cancer patients (see, for example, FIG. 2). The 3D signature can be created by analyzing the expression of the one or more markers or any combination thereof described herein.

Table 1 shows a multivariable proportional-hazards analysis of 10-year survival risk. It indicates that the 3D signature is a strong independent factor to predict breast cancer clinical outcome. Results calculated using dataset of van de Vijver, et al., using overall survival as endpoint.

TABLE 1

| | Hazard ratio | |
|---|---|---|
| | (95% CI)^{a} | P-value |
| Age (per 10 year increment) | 0.62 (0.44 to 0.88) | 0.008 |
| Tumor diameter (per cm) | 1.33 (1.04 to 1.69) | 0.023 |
| ER (positive vs negative) | 0.55 (0.34 to 0.90) | 0.018 |
| Lymph node status (per | 1.07 (0.96 to 1.20) | 0.234 |
| positive node) | | |
| Chemotherapy | 0.69 (0.38 to 1.26) | 0.234 |
| Mastectomy | 1.05 (0.63 to 1.73) | 0.864 |
| BIOARRAY signature | 4.43 (2.32 to 8.46) | <0.00001 |

Martin et al. PLoS One 2008

In some embodiments, methods for predicting therapeutic response to breast cancer are provided. In some embodiments, the method comprises isolating genetic material from the diseased tissue samples of a patient with breast cancer. In some embodiments, the method comprises developing a genetic profile from the marker genes. In some embodiments, the method comprises determining the subtype of breast cancer in the patient based on the genetic profile. In some embodiments, the method comprises providing treatment to patients whose expression profile matches or nearly matches a predetermined subtype profile that indicates that a patient will respond to the treatment.

In some embodiments, the genetic profile comprises determining the expression levels of one or more markers. The expression levels can be determined as described herein or with another method. In some embodiments, the genetic profile and the related expression levels are transformed into a predictive score. In some embodiments, the predictive score is used to predict response to therapy. The response can be where the cancer is responsive or non-responsive to a therapy. In some embodiments, the predictive score is used to predict prognosis of a subject.

In some embodiments, the genetic profile from the marker genes is referred to as a 3D Signature. In certain embodiment, the 3D signature is simply referred to as “signature”. Unlike most cancer signatures that have been selected by using supervised methods and a specific patient training set, the 3D Signature was selected using a cell culture model that accurately recapitulates the normal process of breast acini formation and growth arrest. Since it is not linked to a particular patient set, the signature more accurately classifies diverse patient subsets than traditionally discovered signatures. This advantage makes the 3D signature a favored signature for predictive response to therapy and/or prognosis.

Throughout the present application, the 3-D signature described herein for breast tissue can also referred to as the Bioarray signature, which is the 22 genes described herein as such or as context dictates.

In some embodiments a kit is provided for testing therapeutic sensitivity of diseased tissue. In some embodiments, the method comprises components for identifying the expression profile of a tissue sample having probes to a specific set of genes or proteins associated with the disease; labels, reagents, other materials or instructions for labeling and preparing reagents and other materials necessary to develop an expression profile of one or more marker genes, or any combination thereof.

In some embodiments, the 3D signature, which includes the expression levels of one or more markers is interpreted by using logistic regression. Logistic regression is a form of regression which is used when the dependent is a dichotomy and the independents are of any type. Logistic regression can be used to predict a dependent variable on the basis of continuous and/or categorical independents and to determine the effect size of the independent variables on the dependent; to rank the relative importance of independents; to assess interaction effects; and to understand the impact of covariate control variables. The impact of predictor variables is usually explained in terms of odds ratios. Logistic regression applies maximum likelihood estimation after transforming the dependent into a logit variable (the natural log of the odds of the dependent occurring or not). In this way, logistic regression estimates the odds of a certain event occurring. Note that logistic regression calculates changes in the log odds of the dependent, not changes in the dependent itself.

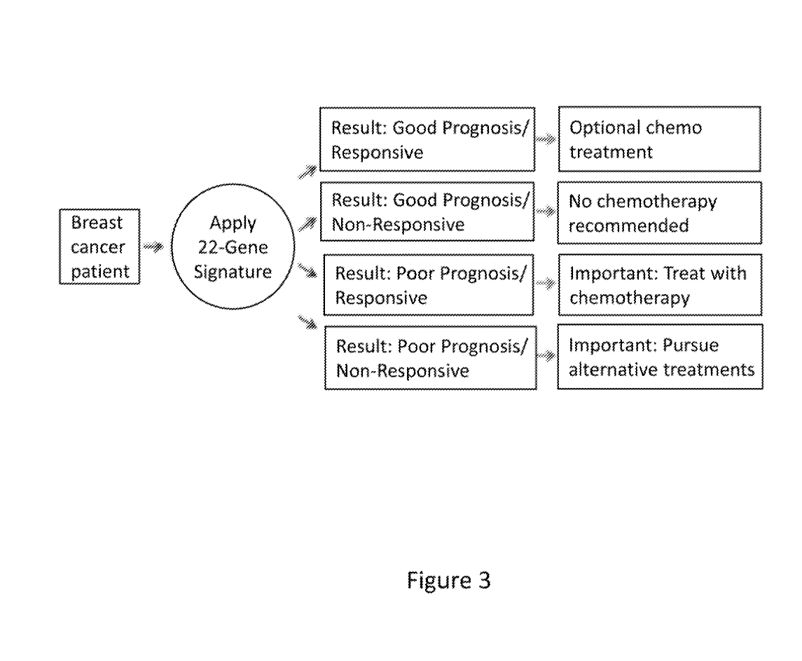

In some embodiments, the gene expression levels of 3D-signature can be successfully used to classify breast cancer patients by disease prognosis. Embodiments of the present invention are directed to the ability of the 3D signature to predict response to chemotherapy in breast cancer. While prognosis divides patients into two classes, chemotherapy response is expected to subdivide each of these two classes into an additional two classes resulting in a total of 4 classes: 1-good prognosis/chemo responsive, 2-good prognosis/chemo non-responsive; 3-poor prognosis/chemo responsive and 4-good prognosis/chemo non-responsive (see, for example, FIG. 3).

In some embodiments, the method comprises transforming the 3D signature into a predictive score. In some embodiments, the kit comprises components for receiving a sample. In some embodiments, the sample can then be processed.

In some embodiments, the present invention provides a computer implemented method for scoring a first sample obtained from a subject. In some embodiments, the method comprises obtaining a first dataset associated with a first sample. In some embodiments, the dataset comprises expression data for at least one marker set. The marker set can be any marker set described herein. In some embodiments, the marker set comprises expression data for FLJ10517, HCAP-G, CDKN3, STK6, FOXM1, FLJ10540, TNFRSF6B, HBP17, C1QDC1, TUBG1, FLJ10036, RRM2, ACTB, ACTN1, EPHA2, TRIP13, CKS2, VRK1, DUSP4, EIF4A1, SERPINE2, or ODC1, and any combination thereof. In some embodiments, the marker set comprises expression data for FLJ10517, HCAP-G, CDKN3, STK6, FOXM1, FLJ10540, TNFRSF6B, HBP17, C1QDC1, TUBG1, FLJ10036, RRM2, ACTB, ACTN1, EPHA2, TRIP13, CKS2, VRK1, DUSP4, EIF4A1, SERPINE2, and ODC 1. In some embodiments, the marker set comprises expression data for FLJ10517 and HCAP-G. In some embodiments, the marker set comprises expression data for FLJ10517, HCAP-G, and CDKN3. In some embodiments, the marker set comprises expression data for FLJ10517, HCAP-G, CDKN3, and STK6. In some embodiments, the marker set comprises expression data for FLJ10517, HCAP-G, CDKN3, STK6, and FOXM1. In some embodiments, the marker set comprises expression data for FLJ10517, HCAP-G, CDKN3, STK6, FOXM1, and FLJ10540. In some embodiments, the marker set comprises expression data for FLJ10517, HCAP-G, CDKN3, STK6, FOXM1, FLJ10540, and TNFRSF6B. In some embodiments, the marker set comprises expression data for FLJ10517, HCAP-G, CDKN3, STK6, FOXM1, FLJ10540, TNFRSF6B, and HBP17. In some embodiments, the marker set comprises expression data for FLJ10517, HCAP-G, CDKN3, STK6, FOXM1, FLJ10540, TNFRSF6B, HBP17, and C1QDC1. In some embodiments, the marker set comprises expression data for FLJ10517, HCAP-G, CDKN3, STK6, FOXM1, FLJ10540, TNFRSF6B, HBP17, C1QDC1, and TUBG1. In some embodiments, the marker set comprises expression data for FLJ10517, HCAP-G, CDKN3, STK6, FOXM1, FLJ10540, TNFRSF6B, HBP17, C1QDC1, TUBG1, and FLJ10036. In some embodiments, the marker set comprises expression data for FLJ10517, HCAP-G, CDKN3, STK6, FOXM1, FLJ10540, TNFRSF6B, HBP17, C1QDC1, TUBG1, FLJ10036, and RRM2. In some embodiments, the marker set comprises expression data for FLJ10517, HCAP-G, CDKN3, STK6, FOXM1, FLJ10540, TNFRSF6B, HBP17, C1QDC1, TUBG1, FLJ10036, RRM2, and ACTB. In some embodiments, the marker set comprises expression data for FLY 10517, HCAP-G, CDKN3, STK6, FOXM1, FLJ10540, TNFRSF6B, HBP17, C1QDC1, TUBG1, FLJ10036, RRM2, ACTB, and ACTN1. In some embodiments, the marker set comprises expression data for FLJ10517, HCAP-G, CDKN3, STK6, FOXM1, FLJ10540, TNFRSF6B, HBP17, C1QDC1, TUBG1, FLJ10036, RRM2, ACTB, ACTN1, and EPHA2. In some embodiments, the marker set comprises expression data for FLJ10517, HCAP-G, CDKN3, STK6, FOXM1, FLJ10540, TNFRSF6B, HBP17, C1QDC1, TUBG1, FLJ10036, RRM2, ACTB, ACTN1, EPHA2, and TRIP13. In some embodiments, the marker set comprises expression data for FLJ10517, HCAP-G, CDKN3, STK6, FOXM1, FLJ10540, TNFRSF6B, HBP17, C1QDC1, TUBG1, FLJ10036, RRM2, ACTB, ACTN1, EPHA2, TRIP13, and CKS2. In some embodiments, the marker set comprises expression data for FLJ10517, HCAP-G, CDKN3, STK6, FOXM1, FLJ10540, TNFRSF6B, HBP17, C1QDC1, TUBG1, FLJ10036, RRM2, ACTB, ACTN1, EPHA2, TRIP13, CKS2, and VRK1. In some embodiments, the marker set comprises expression data for FLJ10517, HCAP-G, CDKN3, STK6, FOXM1, FLJ10540, TNFRSF6B, HBP17, C1QDC1, TUBG1, FLJ10036, RRM2, ACTB, ACTN1, EPHA2, TRIP13, CKS2, VRK1, and DUSP4. In some embodiments, the marker set comprises expression data for FLJ10517, HCAP-G, CDKN3, STK6, FOXM1, FLJ10540, TNFRSF6B, HBP17, C1QDC1, TUBG1, FLJ10036, RRM2, ACTB, ACTN1, EPHA2, TRIP13, CKS2, VRK1, DUSP4, and EIF4A1. In some embodiments, the marker set comprises expression data for FLJ10517, HCAP-G, CDKN3, STK6, FOXM1, FLJ10540, TNFRSF6B, HBP17, C1QDC1, TUBG1, FLJ10036, RRM2, ACTB, ACTN1, EPHA2, TRIP13, CKS2, VRK1, DUSP4, EIF4A1, and SERPINE2.

In some embodiments, embodiments of the present invention are directed to a 3D gene signature that predicts the prognosis and/or survival for a subject with breast cancer, such as, but not limited to, triple negative breast cancer. The 3D signature can be created by analyzing the expression of the one or more markers or any combination thereof described herein.

In some embodiments, methods for predicting prognosis of a subject with breast cancer are provided. In some embodiments, the method for predicting prognosis comprises isolating genetic or protein material from the diseased tissue samples of a patient with breast cancer. In some embodiments, the method for predicting prognosis comprises developing a genetic or protein profile from the marker genes. In some embodiments, the method for predicting prognosis comprises determining the subtype of breast cancer in the patient based on the genetic profile. In some embodiments, the method for predicting prognosis comprises providing treatment to patients whose expression profile matches or nearly matches a predetermined subtype profile that indicates that a patient will have a particular prognosis. In some embodiments, the genetic profile comprises determining the expression levels of one or more markers. The expression levels can be determined as described herein or with another method. In some embodiments, the genetic profile and the related expression levels are transformed into a predictive score. In some embodiments, the predictive score is used to predict a prognosis.

In some embodiments for predicting prognosis, the genetic profile from the marker genes is referred to as a 3D Signature. In certain embodiment, the 3D signature is simply referred to as “signature”. Unlike most cancer signatures that have been selected by using supervised methods and a specific patient training set, the 3D Signature was selected using a cell culture model that accurately recapitulates the normal process of breast acini formation and growth arrest. Since it is not linked to a particular patient set, the signature more accurately classifies diverse patient subsets than traditionally discovered signatures. This advantage makes the 3D signature a favored signature for predictive response to therapy and/or prognosis.

In some embodiments a kit is provided for determining prognosis of a subject. In some embodiments, the kit comprises components for identifying the expression profile of a sample having probes to a specific set of genes or proteins associated with the disease; labels, reagents, other materials or instructions for labeling and preparing reagents and other materials necessary to develop an expression profile of one or more marker genes, or any combination thereof.

In some embodiments for predicting prognosis, the 3D signature, which includes the expression levels of one or more markers is interpreted by using logistic regression. Logistic regression is a form of regression which is used when the dependent is a dichotomy and the independents are of any type. Logistic regression can be used to predict a dependent variable on the basis of continuous and/or categorical independents and to determine the effect size of the independent variables on the dependent; to rank the relative importance of independents; to assess interaction effects; and to understand the impact of covariate control variables. The impact of predictor variables is usually explained in terms of odds ratios. Logistic regression applies maximum likelihood estimation after transforming the dependent into a logit variable (the natural log of the odds of the dependent occurring or not). In this way, logistic regression estimates the odds of a certain event occurring. Note that logistic regression calculates changes in the log odds of the dependent, not changes in the dependent itself.

In some embodiments for predicting prognosis, the gene expression levels of 3D-signature can be successfully used to classify breast cancer patients by disease prognosis. Prognosis can be classified as described herein.

In some embodiments for predicting prognosis, the method comprises transforming the 3D signature into a predictive score. In some embodiments, the kit comprises components for receiving a sample. In some embodiments, the sample can then be processed.

In some embodiments for predicting prognosis, the present invention provides a computer implemented method for scoring a first sample obtained from a subject. In some embodiments, the method comprises obtaining a first dataset associated with a first sample. In some embodiments, the dataset comprises expression data for at least one marker set. The marker set can be any marker set described herein. In some embodiments, the marker set comprises expression data for F CKS2, CDKN3, FOXM1, RRM2, VRK1, TRIP13, ASPM, CEP55, ZWILCH, TUBG1, AURKA, SERPINE2, CAPRIN2, TNFRSF6B, CAPG, ACTN1, ACTB, DUSP4, EPHA2, FGFBP1, EIF4A1, ESR1, ODC1, and any combination thereof. In some embodiments, the marker set comprises expression data for CKS2, CDKN3, FOXM1, RRM2, VRK1, TRIP13, ASPM, CEP55, ZWILCH, TUBG1, AURKA, SERPINE2, CAPRIN2, TNFRSF6B, CAPG, ACTN1, ACTB, DUSP4, EPHA2, FGFBP1, EIF4A1, ESR1, ODC1. In some embodiments, the microarray comprises CKS2, DUSP4, FGFBP, and TNFRSF6B. In some embodiments, the microarray comprises ESR1, CDH3, and HER2. In some embodiments, the microarray comprises FGFBP, ODC1 and CKS2. In some embodiments, the microarray comprises CEP55, FGFBP, ESR1, and ODC1. In some embodiments, the microarray comprises FLJ10517, HCAP-G, and CDKN3. In some embodiments, the microarray comprises FLJ10517, HCAP-G, CDKN3, and STK6. In some embodiments, the microarray comprises FLJ10517, HCAP-G, CDKN3, STK6, and FOXM1. In some embodiments, the microarray comprises FLJ10517, HCAP-G, CDKN3, STK6, FOXM1, and FLJ10540. In some embodiments, the microarray comprises FLJ10517, HCAP-G, CDKN3, STK6, FOXM1, FLJ10540, and TNFRSF6B. In some embodiments, the microarray comprises FLJ10517, HCAP-G, CDKN3, STK6, FOXM1, FLJ10540, TNFRSF6B, and HBP17. In some embodiments, the microarray comprises FLJ10517, HCAP-G, CDKN3, STK6, FOXM1, FLJ10540, TNFRSF6B, HBP17, and C1QDC1. In some embodiments, the microarray comprises FLJ10517, HCAP-G, CDKN3, STK6, FOXM1, FLJ10540, TNFRSF6B, HBP17, C1QDC1, and TUBG1. In some embodiments, the microarray comprises FLJ10517, HCAP-G, CDKN3, STK6, FOXM1, FLJ10540, TNFRSF6B, HBP17, C1QDC1, TUBG1, and FLJ10036. In some embodiments, the microarray comprises FLJ10517, HCAP-G, CDKN3, STK6, FOXM1, FLJ10540, TNFRSF6B, HBP17, C1QDC1, TUBG1, FLJ10036, and RRM2. In some embodiments, the microarray comprises FLJ10517, HCAP-G, CDKN3, STK6, FOXM1, FLJ10540, TNFRSF6B, HBP17, C1QDC1, TUBG1, FLJ10036, RRM2, and ACTB. In some embodiments, the microarray comprises FLJ10517, HCAP-G, CDKN3, STK6, FOXM1, FLJ10540, TNFRSF6B, HBP17, C1QDC1, TUBG1, FLJ10036, RRM2, ACTB, and ACTN1. In some embodiments, the microarray comprises FLJ10517, HCAP-G, CDKN3, STK6, FOXM1, FLJ10540, TNFRSF6B, HBP17, C1QDC1, TUBG1, FLJ10036, RRM2, ACTB, ACTN1, and EPHA2. In some embodiments, the microarray comprises FLJ10517, HCAP-G, CDKN3, STK6, FOXM1, FLJ10540, TNFRSF6B, HBP17, C1QDC1, TUBG1, FLJ10036, RRM2, ACTB, ACTN1, EPHA2, and TRIP13. In some embodiments, the microarray comprises FLJ10517, HCAP-G, CDKN3, STK6, FOXM1, FLJ10540, TNFRSF6B, HBP17, C1QDC1, TUBG1, FLJ10036, RRM2, ACTB, ACTN1, EPHA2, TRIP13, and CKS2. In some embodiments, the microarray comprises FLJ10517, HCAP-G, CDKN3, STK6, FOXM1, FLJ10540, TNFRSF6B, HBP17, C1QDC1, TUBG1, FLJ10036, RRM2, ACTB, ACTN1, EPHA2, TRIP13, CKS2, and VRK1. In some embodiments, the microarray comprises FLJ10517, HCAP-G, CDKN3, STK6, FOXM1, FLJ10540, TNFRSF6B, HBP17, C1QDC1, TUBG1, FLJ10036, RRM2, ACTB, ACTN1, EPHA2, TRIP13, CKS2, VRK1, and DUSP4. In some embodiments, the microarray comprises FLJ10517, HCAP-G, CDKN3, STK6, FOXM1, FLJ10540, TNFRSF6B, HBP17, C1QDC1, TUBG1, FLJ10036, RRM2, ACTB, ACTN1, EPHA2, TRIP13, CKS2, VRK1, DUSP4, and EIF4A1. In some embodiments, the microarray comprises FLJ10517, HCAP-G, CDKN3, STK6, FOXM1, FLJ10540, TNFRSF6B, HBP17, C1QDC1, TUBG1, FLJ10036, RRM2, ACTB, ACTN1, EPHA2, TRIP13, CKS2, VRK1, DUSP4, EIF4A1, and SERPINE2.

In some embodiments, the each or all of the methods described herein comprises determining, by a computer processor, a first score from the first dataset that comprises the market set expression data using an interpretation function, wherein the first score is predictive of response to therapy in a subject and/or the prognosis of the subject. In some embodiments, the interpretation function is based upon a predictive model. The predictive model can be predict response to a treatment or the prognosis of a subject.

In some embodiments, a computer comprises at least one processor coupled to a chipset. In some embodiments, also coupled to the chipset are a memory, a storage device, a keyboard, a graphics adapter, a pointing device, and/or a network adapter. A display can also be coupled to the graphics adapter. In some embodiments, the functionality of the chipset is provided by a memory controller hub and an I/O controller hub. In some embodiments, the memory is coupled directly to the processor instead of the chipset.

The storage device can be any device capable of holding data, like a hard drive, compact disk read-only memory (CD-ROM), DVD, Blue-Ray, RD Disc, or a solid-state memory device. The memory holds instructions and data used by the processor. The pointing device may be a mouse, track ball, or other type of pointing device, and is used in combination with the keyboard to input data into the computer system. The graphics adapter displays images and other information on the display. The network adapter couples the computer system to a local or wide area network.

Additionally, a computer can have different and/or other components than those described herein. In addition, the computer can lack certain components. Moreover, the storage device can be local and/or remote from the computer (such as embodied within a storage area network (SAN)). In some embodiments, the computer is adapted to execute computer program modules for providing the functionality described herein. As used herein, the term “module” refers to computer program logic utilized to provide the specified functionality. Thus, a module can be implemented in hardware, firmware, and/or software. In one embodiment, program modules are stored on the storage device, loaded into the memory, and executed by the processor. The computer can be adapted to, for example, determine the expression data process the data in conjunction with algorithm's described herein. The computer can also provide a predictive score utilizing the expression data and other clinical factors as described herein.

In some embodiments, the independently each or all of the datasets described herein comprise a clinical factor. The clinical factor can be for example, but not limited to, age, gender, neutrophil count, ethnicity, race, disease duration, diastolic blood pressure, systolic blood pressure, a family history parameter, a medical history parameter, a medical symptom parameter, height, weight, a body-mass index, resting heart rate, and smoker/non-smoker status, subtype of breast cancer, and the like. In some embodiments, the dataset comprises other clinical factors including, but not limited, ER status, HER2 status, tumor size, tumor grade, and patient node status.

In some embodiments, the dataset comprises a least one clinical factor. In some embodiments, the dataset comprises 1, 2, 3, 4, 5, 6, 7, 8, 9, or 10 clinical factors. In some embodiments, the dataset comprises at least 1, 2, 3, 4, 5, 6, 7, 8, 9, or 10 clinical factors. As discussed above, the clinical factor can be for example, but not limited to, age, gender, neutrophil count, ethnicity, race, disease duration, diastolic blood pressure, systolic blood pressure, a family history parameter, a medical history parameter, a medical symptom parameter, height, weight, a body-mass index, resting heart rate, and smoker/non-smoker status, subtype of breast cancer, and the like. In some embodiments, the dataset comprises other clinical factors including, but not limited to, tumor ER status, tumor HER2 status, tumor size, tumor grade, tumor histology, molecular class (including luminal A, luminal B, HER2-positive, basal-like, or normal-like), cancer treatment protocol, or the patient's or tumor mutation status of one or more genes.

In some embodiments, the patient's or tumor mutation status refers to 1, 2, 3, 4, 5, 6, 7, 8, 9, or 10 different genes. In some embodiments, the patient's or tumor mutation status refers to at least 1, 2, 3, 4, 5, 6, 7, 8, 9, or 10 different genes. A patient's or tumor mutation status of genes refers to whether the tumor or the patient harbors a mutation in a gene. Examples of genes that can be mutated include, but are not limited to, tumor suppressors and oncogenes. Examples of tumor suppressors or oncogenes include, but are not limited to, BRCA1, p53, p21(WAF1/CIP1), ras, src, 53BP1, p27Kip1, Rb, ATM, BRCA2, CDH1, CDKN2B, CDKN3, E2F1, FHIT, FOXD3, HIC1, IGF2R, MEN1, MGMT, MLH1, NF1, NF2, RASSF1, RUNX3, S100A4, SERPINB5, SMAD4, STK11, TP73, TSC1, VHL, WT1, WWOX, XRCC1, BCR, EGF, ERBB2, ESR1, FOS, HRAS, JUN, KRAS, MDM2, MYC, MYON, NFKB1, PIK3C2A, RB1, RET, SH3PXD2A, TGFB1, TNF, BAX, BCL2L1, CASP8, CDK4, ELK1, ETS1, HGF, JAK2, JUNB, JUND, KIT, KITLG, MCL1, MET, MOS, MYB, NFKBIA, NRAS, PIK3CA, PML, PRKCA, RAF1, RARA, REL, ROS1, RUNX1, SRC, STAT3, ZHX2, and the like.

Other examples of clinical factors include, but are not limited to, whether the subject has diabetes, whether the subject has an inflammatory condition, whether the subject has an infectious condition, whether the subject is taking a steroid, whether the subject is taking an immunosuppressive agent, and/or whether the subject is taking a chemotherapeutic agent or has previously been treated with a cancer therapeutic or other chemotherapeutic agent.

In some embodiments, the clinical factor(s) can be determined by a clinician (e.g. physician). For example, the age can be the patient age before chemotherapy treatment. The tumor grade can be referred to as tumor BMN grade (1, 2 or 3) before chemotherapy treatment. The ER-status can be clinically determined status and, can be for example, ER-negative=0 or ER-positive=1. The node status can be, for example, number of positive nodes before chemotherapy treatment. In some embodiments, the tumor-size can be the size (e.g. mm or cm) before chemotherapy treatment. As discussed herein, in some embodiments, the expression data were measured by microarray gene expression levels.

In some embodiments, the predictive model is a logistic regression model. The model can be a model that in conjunction with the markers and combinations thereof, as for example, described herein, used to predict a prognosis, response to treatment or to select a treatment based upon a comparison of the predictive models.

In some embodiments, obtaining the dataset comprises obtaining the sample and processing the sample to experimentally determine the first dataset. The dataset that can comprise the expression data of the marker set or sets described herein. The data set can be experimentally determined by, for example, using a microarray or quantitative amplification method such as, but not limited to, those described herein. In some embodiments, obtaining a dataset associated with a sample comprises receiving the dataset from a third party that has processed the sample to experimentally determine the dataset.

In some embodiments, the method comprises classifying the sample according to the predictive score that is determined. The sample can be classified as responsive, non-responsive, poor prognosis, good prognosis, undeterminable prognosis, and the like. In some embodiments, wherein the sample comprises RNA extracted from peripheral blood cells or circulating breast epithelial cells. In some embodiments, the expression data are derived from hybridization data (e.g. using a microarray). In some embodiments, the expression data are derived from polymerase chain reaction data. In some embodiments, the expression data are derived from RT-PCR data.

In some embodiments, the present invention provides a system for predicting response to therapy and/or prognosis. In some embodiments, the system comprises a storage memory for storing a dataset derived from or associated with a sample obtained from a subject. As described herein, the dataset can comprise expression data. The expression data can comprise one or more markers, marker sets, or combinations of markers as described herein. In some embodiments, the system comprises a processor. In some embodiments, the processor can be communicatively coupled to the storage memory for determining a score with an interpretation function wherein the score is predictive response to therapy and/or prognosis of the subject.

In some embodiments, the present invention provides a system for predicting prognosis. In some embodiments, the system comprises a storage memory for storing a dataset derived from or associated with a sample obtained from a subject. As described herein, the dataset can comprise expression data. The expression data can comprise one or more markers, marker sets, or combinations of markers as described herein. In some embodiments, the system comprises a processor. In some embodiments, the processor can be communicatively coupled to the storage memory for determining a score with an interpretation function wherein the score is predictive response to therapy and/or prognosis of the subject.

In some embodiments, the interpretation function can be a function produced by a predictive model. The predictive model can be, for example, a logistic regression model. An interpretation function can created by more than one predictive model.

In some embodiments, the predictive model performance can be characterized by an area under the curve (AUC). In some embodiments, the predictive model performance is characterized by an AUC ranging from 0.68 to 0.70. In some embodiments, the predictive model performance is characterized by an AUC ranging from 0.70 to 0.79. In some embodiments, the predictive model performance is characterized by an AUC ranging from 0.80 to 0.89. In some embodiments, the predictive model performance is characterized by an AUC ranging from 0.90 to 0.99. In some embodiments, the AUC is about 0.680, 0.572, 0.741, 0.724, 0.738, or 0.756. In some embodiments, the AUC is greater than or equal to 0.680, 0.572, 0.741, 0.724, 0.738, or 0.756.

In some embodiments, the p-value of an interpretation function is less than or equal to about 0.0078, 0.4618, 0.0003, 0.0034, 0.0041, or 0.0004. In some embodiments, the p-value is less than about 0.0015, 0.0010, or 0.0005.

In some embodiments, the interpretation function comprises an algorithm to produce the predictive score. In some embodiments, the interpretation function comprises at least one of an age term, a grade term, an ER-status term, node-status term, tumor-size term, and one or more gene marker terms including, but not limited to the genes described herein.

In some embodiments, the interpretation function comprises an algorithm where the predictive score is determined according to a predictive model, such as but not limited to logistical regression. In some embodiments, the predictive score (e.g. score) is determined by the following interpretation functions:

score=P=1/(1+e^{-0.2266+0.0295*age-0.5074*grade+0.0248*ER-status+0.0114*node-status+0.2352*tumor-size+0.2577*CDH3+0.0551*ESR1-0.0876*HER2-0.5976*ODC1-0.2474*TRIP13-0.1695*SERPINE2+0.8003*FGFBP});

score=P=1/(1+e^{-0.850+1.215*EPHA2+2.070*ER-status-0.356*HER2-status-0.462*OCD1-0.196*SERPINE2});

score=P=1/(1+e^{-7.399-4.143*EPHA2+3.168*FGFBP1-1.264*tumor grade-0.347*HER2-status+0.947*node-status});

score=P=1/(1+e^{2.518-18.864*ESR1+0.997*tumor size+1.556*TUBG}); or

score=P=1/(1+e^{-1.441+2.036*ESR1-0.716*ODC1});

In some embodiments, the scores are determined depending upon the cancer subtype or physical characteristics of the cancer. In some embodiments, the score that determined using any of the algorithms described herein is based upon ER status, Luminal B status, or the cancer is characterized as basal like. In some embodiments, the predictive score is an average of one or more scores as determined herein.

In some embodiments, the score for an ER-positive cancer is selected from the group consisting of:

Score=1/(1+e^{-0.2266+0.0295*age-0.5074*grade+0.0248*ER-status+0.0114*node-status+0.2352*tumor-size+0.2577*CDH3+0.0551*ESR1-0.0876*HER2-0.5976*ODC1-0.2474*TRIP13-0.1695*SERPINE2+08003*FGFBP}); Score=1/(1+e^{-0.850+1.215*EPHA2+2.070*ER-status-0.356*HER2-status-0.462*OCD1-0.196*SERPINE2}); or

score=1/(1+e^{-7.399-4.143*EPHA2+3.168*FGFBP1-1.264*tumor grade-0.347*HER2-status+0.947*node-status}).

In some embodiments, the score for an ER-negative cancer is selected from the group consisting of: Score=1/(1+e^{-0.2266+0.0295*age-0.5074*grade+0.0248*ER-status+0.0114*node-status+0.2352*tumor-size+0.2577*CDH3+0.0551*ESR1-0.0876*HER2-0.5976*ODC1-0.2474*TRIP13-0.1695*SERPINE2+0.8003*FGFBP}); Score=1/(1+e^{-0.850+1.215*EPHA2+2.070*ER-status-0.356*HER2-status-0.462*OCD1-0.196*SERPINE2}).

In some embodiments, the score for a luminal B cancer is selected from the group consisting of Score=1/(1+e^{-0.2266+0.0295*age-0.5074*grade+0.0248*ER-status+0.0114*node-status+0.2352*tumor-size+0.2577*CDH3+0.0551*ESR1-0.0876*HER2-0.5976*ODC1-0.2474*TRIP13-0.1695*SERPINE2+0.8003*FGFBP}); Score=1/(1+e^{-0.850+1.215*EPHA2+2.070*ER-status-0.356*HER2-status-0.462*OCD1-0.196*SERPINE2}).

In some embodiments, the score for a basal like cancer is selected from the group consisting of: Score=1/(1+e^{-0.2266+0.0295*age-0.5074*grade+0.0248*ER-status+0.0114*node-status+0.2352*tumor-size+0.2577*CDH3+0.0551*ESR1-0.0876*HER2-0.5976*ODC1-0.2474*TRIP13-0.1695*SERPINE2+0.8003*FGFBP}).

In some embodiments, the score for a HER2-positive cancer is selected from the group consisting of: score=P=1/(1+e^{-0.2266+0.0295*age-0.5074*grade+0.0248*ER-status+0.0114*node-status+0.2352*tumor-size+0.2577*CDH3+0.0551*ESR1-0.0876*HER2-0.5976*ODC1-0.2474*TRIP13-0.1695*SERPINE2+0.8003*FGFBP}); or score=P=1/(1+e^{2.518-18.864*ESR1+0.997*tumor size+1.556*TUBG}).

In some embodiments, the score for a triple negative breast cancer is selected from the group consisting of: score=P=1/(1+e^{-0.2266+0.0295*age-0.5074*grade+0.0248*ER-status+0.0114*node-status+0.2352*tumor-size+0.2577*CDH3+0.0551*ESR1-0.0876*HER2-0.5976*ODC1-0.2474*TRIP13-0.1695*SERPINE2+0.8003*FGFBP}); or score=P=1/(1+e^{-1.441+2.036*ESR1-0.716*ODC1}).

In some embodiments, the score for any cancer is selected from the group consisting of: score=P=1/(1+e^{-0.2266+0.0295*age-0.5074*grade+0.0248*ER-status+0.0114*node-status+0.2352*tumor-size+0.2577*CDH3+0.0551*ESR1-0.0876*HER2-0.5976*ODC1-0.2474*TRIP13-0.1695*SERPINE2+0.8003*FGFBP}); Score=1/(1+e^{-0.850+1.215*EPHA2+2.070*ER-status-0.356*HER2-status-0.462*OCD1-0.196*SERPINE2}).

The score can be determined using any of the interpretation functions described herein. In the functions described herein, the term “CDH3” refers to cadherin 3, “ESR1” refers to estrogen receptor 1, “HER2” refers to Human Epidermal growth factor Receptor 2.

In some embodiments, the score is determined by analyzing markers that are down regulated (expression is lower) during acini formation in 3D culture. Tumors that have a similar gene signature were found to be associated with a prediction that they would respond to treatment. In some embodiments, the response is a response to paclitaxel (Taxol®), 5-fluoruracil, doxorubicin (Adriamycin™) and cyclophosphamide (TFAC) chemotherapy. In some embodiments, the ability to predict response and prognosis in breast cancer are overlapping but not synonymous. As shown in the examples, a 22-gene signature (down-regulated late in acini formation) accurately predicted TFAC response across a broad range of breast cancer subtypes and outperformed clinical parameters.

In some embodiments, the score, which can also be referred to as the predictive score has a cut-off value. The cut-off value is a value where when the predictive score is below the cut-off value the predictive score predicts that the cancer will not respond to a treatment or where the predictive score is above the cut-off value the predictive score predicts that the cancer will respond to a treatment. In some embodiments, a cancer is predicted to respond to a treatment when the predictive score is greater than or greater than or equal to the cut-off value. In some embodiments, a cancer is predicted to not to respond to a treatment when the predictive score is less than or less than or equal to the cut-off value. In some embodiments, a cancer is predicted to respond to a treatment when the predictive score is equal to the cut-off value. In some embodiments, a cancer is predicted to not to respond to a treatment when the predictive score is equal to the cut-off value. In some embodiments, the cut-off value is specified. In some embodiments, the specified cut-off value is from about 0.1 to about 0.9, about 0.2 to about 0.8, about 0.3 to about 0.7, about 0.4 to about 0.8, about 0.4 to about 0.7, about 0.4 to about 0.9, about 0.5 to about 0.9, about 0.5 to about 0.7, about 0.5 to about 0.6. In some embodiments, the specified cut-off value is about or exactly 0.1, 0.2, 0.3, 0.4, 0.5, 0.6, 0.7, 0.8, or 0.9. In some embodiments, the specified cut-off value is at least 0.1, 0.2, 0.3, 0.4, 0.5, 0.6, 0.7, 0.8, or 0.9. In some embodiments, the specified cut-off can be different for different types of cancers. The cut-off value can also be used to determine prognosis according to methods described herein.

In some embodiments, a method for predicting a response to a treatment as described herein comprises transforming the predictive score into an output that is communicated to a user. The output can be as simple as a message stating that the cancer should be responsive or not responsive. In some embodiments, the output is a statistical analysis of the probability of response to a treatment, which is based upon the predictive score. The output can be communicated by a machine orally, electronically in a message, or on printed matter. In some embodiments, the output is displayed on a screen. Accordingly, in some embodiments, the systems described herein also can comprise a display unit that is communicatively connected to the processor such that the display unit can display the output.

In some embodiments, the interpretation function comprises: Score=1/(1+e^{-0.850+1.215*EPHA2+2.070*ER-status-0.356*HER2-status-0.462*OCD1-0.196*SERPINE2}); score=breast cancers version 2: Score=1/(1+e^{-0.850+1.215*EPHA2+2.070*ER-status-0.356*HER2-status-0.462*OCD1-0.196*SERPINE2}); score=P=1/(1+e^{-7.399-4.143*EPHA2+3.168*FGFBP1-1.264*tumor grade-0.347*HER2-status+0.947*node-status}); score=P=1/(1+e^{2.518-18.864*ESR1+0.997*tumor size+1.556*TUBG}); score=P=1/(1+e^{-1.441+2.036*ESR1-0.716*ODC1}).

In some embodiments, a sample can be characterized as Luminal A when it has high ESR1 and low AURKA; Luminal B when it has high ESR1 and high AURKA; HER2+ when it has high ERBB; Basal-like when it has low ESR1 and high KRT5. The levels are compared to a normal tissue to determine if it is high or low. If the values are greater than found in a normal sample or a matched pair sample it is said to be high. If the values are lower than found in a normal sample or a matched pair sample it is said to be low.

In some embodiments, the present invention provides methods for predicting a prognosis of a subject diagnosed with triple negative breast cancer. In some embodiments, the method comprises obtaining a dataset associated with a sample derived from a patient diagnosed with cancer. In some embodiments, the dataset comprises expression data for a plurality of markers selected from the group consisting of CKS2, CDKN3, FOXM1, RRM2, VRK1, TRIP13, ASPM, CEP55, ZWILCH, TUBG1, AURKA, SERPINE2, CAPRIN2, TNFRSF6B, CAPG, ACTN1, ACTB, DUSP4, EPHA2, FGFBP1, EIF4A1, ESR1, ODC1 and optionally at least one clinical factor. In some embodiments, the method comprises determining a predictive score from the dataset using an interpretation function, wherein the predictive score is predictive of the prognosis of a subject with triple negative breast cancer.

In some embodiments, the method comprises comparing the predictive score to a score derived from a sample from a patient with cancer that was known to have an excellent, good, moderate or poor prognosis, wherein a sample whose score matches the predetermined predictive of sample derived from a patient that that was known to have an excellent, good, moderate or poor prognosis is predicted to have an excellent, good, moderate or poor prognosis, or wherein a sample whose score matches the predetermined predictive of sample derived from a patient that was known to have an excellent, good, moderate or poor prognosis is predicted to have an excellent, good, moderate or poor prognosis.

In some embodiments, the method comprises obtaining the first dataset associated with the sample comprises obtaining the sample and processing the sample to experimentally determine the dataset comprising the expression data. In some embodiments, obtaining the dataset associated with the sample comprises receiving the dataset from a third party that has processed the sample to experimentally determine the first dataset.

In some embodiments, the present invention provides systems for predicting prognosis of a subject with triple negative breast cancer comprising a storage memory for storing a dataset associated with a sample obtained from the subject. In some embodiments, the dataset comprises expression data for at least one marker selected from the group consisting of CKS2, CDKN3, FOXM1, RRM2, VRK1, TRIP13, ASPM, CEP55, ZWILCH, TUBG1, AURKA, SERPINE2, CAPRIN2, TNFRSF6B, CAPG, ACTN1, ACTB, DUSP4, EPHA2, FGFBP1, EIF4A1, ESR1, ODC1. In some embodiments, the system comprises a processor communicatively coupled to the storage memory for determining a score with an interpretation function wherein the score is predictive of response to a cancer treatment in a subject diagnosed with cancer.

In some embodiments, the present invention provides kits for predicting prognosis of a subject with triple negative breast cancer comprising one or more reagents for determining from a sample obtained from a subject expression data for at least one marker selected from the group consisting of CKS2, CDKN3, FOXM1, RRM2, VRK1, TRIP13, ASPM, CEP55, ZWILCH, TUBG1, AURKA, SERPINE2, CAPRIN2, TNFRSF6B, CAPG, ACTN1, ACTB, DUSP4, EPHA2, FGFBP1, EIF4A1, ESR1, ODC1. In some embodiments, the kit comprises instructions for using the one or more reagents to determine expression data from the sample, wherein the instructions include instructions for determining a score from the dataset wherein the score is predictive of prognosis of a subject with triple negative breast cancer.

In some embodiments, the present invention provides methods for predicting a prognosis of a subject with triple negative breast cancer. In some embodiments, the methods comprise isolating a sample of the cancer from the patient with the triple negative breast cancer. In some embodiments, the methods comprise obtaining a dataset associated with a sample derived from a patient diagnosed with cancer, wherein the dataset comprises expression data for at least one marker selected from the group consisting of CKS2, CDKN3, FOXM1, RRM2, VRK1, TRIP13, ASPM, CEP55, ZWILCH, TUBG1, AURKA, SERPINE2, CAPRIN2, TNFRSF6B, CAPG, ACTN1, ACTB, DUSP4, EPHA2, FGFBP1, EIF4A1, ESR1, ODC1 and optionally at least one clinical factor. In some embodiments, the methods comprise determining a predictive score from the dataset using an interpretation function. In some embodiments, the interpretation function is based upon a predictive model. In some embodiments, the predictive model is a logistical regression model. In some embodiments, the logistical regression model is applied to the dataset to interpret the dataset to produce the predictive score. In some embodiments, a predictive score above a specified cut-off value predicts a good prognosis and a predictive score below a specified cut-off predicts a poor prognosis.

Various embodiments are directed to tests for determining prognosis of a subject with cancer, such as triple negative breast cancer by identifying one or more genes whose expression patterns are modified as a result of cancer, and other embodiments of the invention are directed to methods for performing such tests.

Prognosis in breast cancer is a prediction of the chance that a patient will survive or recover from the disease. In breast cancer, prognosis is most commonly assessed by clinical parameters including tumor grade (a measure of the proliferation status of the tumor) tumor stage, which takes into account tumor size, whether the tumor has invaded the lymph nodes (node status), and whether it has invaded distant tissues (metastasis). High tumor grade and high tumor stage are associated with poor prognosis. Prognosis can be quantified by various methods. In some embodiments, the prognosis is a poor, moderate, good, or excellent prognosis. In some embodiments, a good prognosis predicts a three year survival, while a poor prognosis predicts the lack of a three year survival. In some embodiments, a good prognosis predicts a three year survival without a relapse, while a poor prognosis predicts the lack of a three year survival without relapse. In some embodiments, a good prognosis predicts a three year survival without a distant relapse (i.e. metastasis), while a poor prognosis predicts the lack of a three year survival without a distant relapse. In some embodiments, a good prognosis is a prognosis of at least 5, 7, or 10 year survival, while a poor prognosis is the lack of a 5, 7, or 10 year survival. In some embodiments, the survival is relapse-free, while in some embodiments, the survival is not relapse free.

In some embodiments, a gene signature, which can be referred to as a “3D gene Signature,” is used to predict the prognosis.

In some embodiments, kits are provided that can include components necessary to perform such tests for prognosis. For example, a kit may comprise one or more instruments for performing a biopsy to remove a tumor sample from a patient. In some embodiments, the kit does not comprise one or more instruments for performing a biopsy to remove a tumor sample from a patient. In some embodiments, the kit comprises an instrument for aspirating cancerous cells from tumor or cancerous growth. In some embodiments, the kit comprises components to extract genetic or protein material (e.g. DNA, RNA, mRNA, and the like) from aspirated cells. In some embodiments, the kit comprises compositions that can be used to tag or label genetic material extracted from or derived from the aspirated cells. Genetic material that is derived from a tumor sample (e.g. aspirated cells) includes DNA or RNA that is producing using PCR, RT-PCR, RNA amplification, or any other suitable amplification method. The particular amplification method is not essential. In some embodiments, the amplification method comprises quantitative PCR. In some embodiments, the kit comprises a microarray (e.g. microarray chip) comprising hybridization probes that is specific for a genetic signature, such as but not limited to, a 3D signature generated from normal or cancerous breast epithelial cells. In some embodiments, the kit comprises a composition or product (e.g. device) that can be used to visualize the genetic material that is associated with the hybridization probes. In some embodiments, the kits are used before and after a treatment. The treatment can be of the cells ex vivo or in vivo.

In some embodiments, kits are provided for predicting a prognosis of a subject with triple negative breast cancer comprising one or more reagents for determining from a sample obtained from a subject expression data for at least one marker selected from the group consisting of CKS2, CDKN3, FOXM1, RRM2, VRK1, TRIP13, ASPM, CEP55, ZWILCH, TUBG1, AURKA, SERPINE2, CAPRIN2, TNFRSF6B, CAPG, ACTN1, ACTB, DUSP4, EPHA2, FGFBP1, EIF4A1, ESR1, ODC1, or any combination thereof. The markers can be combined in any combination including, but not limited to, the other combinations described herein. In some embodiments, the kit comprises instructions for using the one or more reagents to determine expression data from the sample, wherein the instructions include instructions for determining a score from the dataset wherein the score is predictive of response to the cancer treatment.

In some embodiments, a test to determine or predict prognosis comprises determining the expression level of one or more markers (e.g. genes) from a patient, tissue, or cell exhibiting, or not exhibiting, symptoms of a diseased state. The genes can be 1 of the genes described herein or any combination thereof. In some embodiments, the gene expression levels are compared to gene expression levels from a different patient known to be free of, or suspected to be free of, the disease. In some embodiments, the gene expression levels are compared to gene expression levels from a cell or tissue known to be free of, or suspected to be free of, the disease. In some embodiments, the tissue or cell known to be free of, or suspected to be free of, the disease is from the same subject (e.g. patient) who is suspected of having the disease or who is known to have the disease or known or suspected to be normal healthy tissue (either from the patient or from a healthy subject) or other diseased tissue samples and equating these expression levels with the efficacy of treatment for the diseased state. Determining the expression level for any one marker gene or set of marker genes such as those identified above and/or expression profile for any group or set of such genetic markers can be carried out by any method and may vary among embodiments, such as but not limited to, the methods described herein.

In some embodiments, the method or test comprises a microarray having probes against one or more genes that exhibit a modified expression pattern or profile as a result of cancer. In some embodiments, the method or test comprises a microarray having probes against one or more genes that do not exhibit a modified expression pattern or profile as a result of cancer. The one or more genes or markers included on the array can be any one or more genes, such as those described herein, including, for example, genes can be selected based on the likelihood that cells exhibiting the modified expression pattern or profile may be more likely to respond to a particular form of treatment or that can be used to predict a prognosis. In some embodiments, the genes selected can be used to identify a cell or tumor that is less likely to respond to a particular form of treatment or a subject will have a poor, moderate, good, or excellent prognosis or other types of prognosis as described herein. For example, in some embodiments, the hybridization probes provided on the microarray may have been selected based on the ability of one or more therapeutic agents to treat tumors exhibiting an expression profile associated with such hybridization probes or based upon the prognosis. Therefore, by performing the test a person can predict the prognosis or the efficacy of the particular form of treatment based on the gene expression pattern or profile of cells extracted from a tumor as compared to normal (e.g. non-cancerous cells).

The specific probes that are used are not essential. The probes, which can also be referred to as primers can be specific to the markers being measured and/or detected. In some embodiments, in a method for determining prognosis the probe comprises a sequence or a variant thereof of CKS2, CDKN3, FOXM1, RRM2, VRK1, TRIP13, ASPM, CEP55, ZWILCH, TUBG1, AURKA, SERPINE2, CAPRIN2, TNFRSF6B, CAPG, ACTN1, ACTB, DUSP4, EPHA2, FGFBP1, EIF4A1, ODC1. In some embodiments, the sequences comprise a sequence or variant of the sequences described herein, which includes, but is not limited to the sequence listing, or any combination thereof. All sequences referenced by accession number are also incorporated by reference, the sequence incorporated by reference is the sequence in the latest version, unless otherwise specified as of the filing of the present disclosure.

By determining the expression levels of genes that exhibit modulated expression in diseased, or cancerous tissue, an expression profile or genetic signature for particular diseased states may be determined. Accordingly, in some embodiments, the expression profile for various disease types and various patients may vary, patients who different prognoses can be determined. For example, in some embodiments, the tests may include a microarray configured to identify patients who will have a good or excellent prognosis or a poor or moderate prognosis based on their particular genetic profile, such as, but not limited to, the 3-D signature. For example, in some embodiments, the microarray may include a set of genes specifically associated with the specific prognosis. For example, in some embodiments, the microarray of the test may comprise a set of 10-30 markers (e.g. genes) associated with cancer, such as but not limited to triple negative breast cancer.

In some embodiments, a test for breast cancer comprises a microarray may comprise probes for CKS2, CDKN3, FOXM1, RRM2, VRK1, TRIP13, ASPM, CEP55, ZWILCH, TUBG1, AURKA, SERPINE2, CAPRIN2, TNFRSF6B, CAPG, ACTN1, ACTB, DUSP4, EPHA2, FGFBP1, EIF4A1, ESR1, ODC1, and any combination thereof. In some embodiments, the microarray comprises CKS2, DUSP4, FGFBP, and TNFRSF6B. In some embodiments, the microarray comprises ESR1, CDH3, and HER2. In some embodiments, the microarray comprises FGFBP, ODC1 and CKS2. In some embodiments, the microarray comprises CEP55, FGFBP, ESR1, and ODC1. In some embodiments, the microarray comprises FLJ10517, HCAP-G, and CDKN3. In some embodiments, the microarray comprises FLJ10517, HCAP-G, CDKN3, and STK6. In some embodiments, the microarray comprises FLJ10517, HCAP-G, CDKN3, STK6, and FOXM1. In some embodiments, the microarray comprises FLJ10517, HCAP-G, CDKN3, STK6, FOXM1, and FLJ10540. In some embodiments, the microarray comprises FLJ10517, HCAP-G, CDKN3, STK6, FOXM1, FLJ10540, and TNFRSF6B. In some embodiments, the microarray comprises FLJ10517, HCAP-G, CDKN3, STK6, FOXM1, FLJ10540, TNFRSF6B, and HBP17. In some embodiments, the microarray comprises FLJ10517, HCAP-G, CDKN3, STK6, FOXM1, FLJ10540, TNFRSF6B, HBP17, and C1QDC1. In some embodiments, the microarray comprises FLJ10517, HCAP-G, CDKN3, STK6, FOXM1, FLJ10540, TNFRSF6B, HBP17, C1QDC1, and TUBG1. In some embodiments, the microarray comprises FLJ10517, HCAP-G, CDKN3, STK6, FOXM1, FLJ10540, TNFRSF6B, HBP17, C1QDC1, TUBG1, and FLJ10036. In some embodiments, the microarray comprises FLJ10517, HCAP-G, CDKN3, STK6, FOXM1, FLJ10540, TNFRSF6B, HBP17, C1QDC1, TUBG1, FLJ10036, and RRM2. In some embodiments, the microarray comprises FLJ10517, HCAP-G, CDKN3, STK6, FOXM1, FLJ10540, TNFRSF6B, HBP17, C1QDC1, TUBG1, FLJ10036, RRM2, and ACTB. In some embodiments, the microarray comprises FLJ10517, HCAP-G, CDKN3, STK6, FOXM1, FLJ10540, TNFRSF6B, HBP17, C1QDC1, TUBG1, FLJ10036, RRM2, ACTB, and ACTN1. In some embodiments, the microarray comprises FLJ10517, HCAP-G, CDKN3, STK6, FOXM1, FLJ10540, TNFRSF6B, HBP17, C1QDC1, TUBG1, FLJ10036, RRM2, ACTB, ACTN1, and EPHA2. In some embodiments, the microarray comprises FLJ10517, HCAP-G, CDKN3, STK6, FOXM1, FLJ10540, TNFRSF6B, HBP17, C1QDC1, TUBG1, FLJ10036, RRM2, ACTB, ACTN1, EPHA2, and TRIP13. In some embodiments, the microarray comprises FLJ10517, HCAP-G, CDKN3, STK6, FOXM1, FLJ10540, TNFRSF6B, HBP17, C1QDC1, TUBG1, FLJ10036, RRM2, ACTB, ACTN1, EPHA2, TRIP13, and CKS2. In some embodiments, the microarray comprises FLJ10517, HCAP-G, CDKN3, STK6, FOXM1, FLJ10540, TNFRSF6B, HBP17, C1QDC1, TUBG1, FLJ10036, RRM2, ACTB, ACTN1, EPHA2, TRIP13, CKS2, and VRK1. In some embodiments, the microarray comprises FLJ10517, HCAP-G, CDKN3, STK6, FOXM1, FLJ10540, TNFRSF6B, HBP17, C1QDC1, TUBG1, FLJ10036, RRM2, ACTB, ACTN1, EPHA2, TRIP13, CKS2, VRK1, and DUSP4. In some embodiments, the microarray comprises FLJ10517, HCAP-G, CDKN3, STK6, FOXM1, FLJ10540, TNFRSF6B, HBP17, C1QDC1, TUBG1, FLJ10036, RRM2, ACTB, ACTN1, EPHA2, TRIP13, CKS2, VRK1, DUSP4, and EIF4A1. In some embodiments, the microarray comprises FLJ10517, HCAP-G, CDKN3, STK6, FOXM1, FLJ10540, TNFRSF6B, HBP17, C1QDC1, TUBG1, FLJ10036, RRM2, ACTB, ACTN1, EPHA2, TRIP13, CKS2, VRK1, DUSP4, EIF4A1, and SERPINE2.

In some embodiments, the expression profile of one or more genes or a set of genes may allow an individual to determine the prognosis of the patient. Identification of a patient's specific prognosis may be carried out using the tests and methods described herein.

In some embodiments a kit is provided for determining prognosis of a subject. In some embodiments, the method comprises components for identifying the expression profile of a sample having probes to a specific set of genes or proteins associated with the disease; labels, reagents, other materials or instructions for labeling and preparing reagents and other materials necessary to develop an expression profile of one or more marker genes, or any combination thereof.

In some embodiments, the 3D signature, which includes the expression levels of one or more markers is interpreted by using logistic regression. Logistic regression is a form of regression which is used when the dependent is a dichotomy and the independents are of any type. Logistic regression can be used to predict a dependent variable on the basis of continuous and/or categorical independents and to determine the effect size of the independent variables on the dependent; to rank the relative importance of independents; to assess interaction effects; and to understand the impact of covariate control variables. The impact of predictor variables is usually explained in terms of odds ratios. Logistic regression applies maximum likelihood estimation after transforming the dependent into a logit variable (the natural log of the odds of the dependent occurring or not). In this way, logistic regression estimates the odds of a certain event occurring. Note that logistic regression calculates changes in the log odds of the dependent, not changes in the dependent itself.

In some embodiments, the gene expression levels of 3D-signature can be successfully used to classify breast cancer patients by disease prognosis. Prognosis can be classified as described herein.

In some embodiments, the method comprises transforming the 3D signature into a predictive score. In some embodiments, the kit comprises components for receiving a sample. In some embodiments, the sample can then be processed.

In some embodiments, the present invention provides a computer implemented method for scoring a first sample obtained from a subject. In some embodiments, the method comprises obtaining a first dataset associated with a first sample. In some embodiments, the dataset comprises expression data for at least one marker set. The marker set can be any marker set described herein. In some embodiments, the marker set comprises expression data for CKS2, CDKN3, FOXM1, RRM2, VRK1, TRIP13, ASPM, CEP55, ZWILCH, TUBG1, AURKA, SERPINE2, CAPRIN2, TNFRSF6B, CAPG, ACTN1, ACTB, DUSP4, EPHA2, FGFBP1, EIF4A1, ESR1, ODC1, and any combination thereof. In some embodiments, the marker set comprises expression data for CKS2, CDKN3, FOXM1, RRM2, VRK1, TRIP13, ASPM, CEP55, ZWILCH, TUBG1, AURKA, SERPINE2, CAPRIN2, TNFRSF6B, CAPG, ACTN1, ACTB, DUSP4, EPHA2, FGFBP1, EIF4A1, ESR1, ODC1. In some embodiments, the microarray comprises CKS2, DUSP4, FGFBP, and TNFRSF6B. In some embodiments, the microarray comprises ESR1, CDH3, and HER2. In some embodiments, the microarray comprises FGFBP, ODC1 and CKS2. In some embodiments, the microarray comprises CEP55, FGFBP, ESR1, and ODC1. In some embodiments, the microarray comprises FLJ10517, HCAP-G, and CDKN3. In some embodiments, the microarray comprises FLJ10517, HCAP-G, CDKN3, and STK6. In some embodiments, the microarray comprises FLJ10517, HCAP-G, CDKN3, STK6, and FOXM1. In some embodiments, the microarray comprises FLJ10517, HCAP-G, CDKN3, STK6, FOXM1, and FLJ10540. In some embodiments, the microarray comprises FLJ10517, HCAP-G, CDKN3, STK6, FOXM1, FLJ10540, and TNFRSF6B. In some embodiments, the microarray comprises FLJ10517, HCAP-G, CDKN3, STK6, FOXM1, FLJ10540, TNFRSF6B, and HBP17. In some embodiments, the microarray comprises FLJ10517, HCAP-G, CDKN3, STK6, FOXM1, FLJ10540, TNFRSF6B, HBP17, and C1QDC1. In some embodiments, the microarray comprises FLJ10517, HCAP-G, CDKN3, STK6, FOXM1, FLJ10540, TNFRSF6B, HBP17, C1QDC1, and TUBG1. In some embodiments, the microarray comprises FLJ10517, HCAP-G, CDKN3, STK6, FOXM1, FLJ10540, TNFRSF6B, HBP17, C1QDC1, TUBG1, and FLJ10036. In some embodiments, the microarray comprises FLJ10517, HCAP-G, CDKN3, STK6, FOXM1, FLJ10540, TNFRSF6B, HBP17, C1QDC1, TUBG1, FLJ10036, and RRM2. In some embodiments, the microarray comprises FLJ10517, HCAP-G, CDKN3, STK6, FOXM1, FLJ10540, TNFRSF6B, HBP17, C1QDC1, TUBG1, FLJ10036, RRM2, and ACTB. In some embodiments, the microarray comprises FLJ10517, HCAP-G, CDKN3, STK6, FOXM1, FLJ10540, TNFRSF6B, HBP17, C1QDC1, TUBG1, FLJ10036, RRM2, ACTB, and ACTN1. In some embodiments, the microarray comprises FLJ10517, HCAP-G, CDKN3, STK6, FOXM1, FLJ10540, TNFRSF6B, HBP17, C1QDC1, TUBG1, FLJ10036, RRM2, ACTB, ACTN1, and EPHA2. In some embodiments, the microarray comprises FLJ10517, HCAP-G, CDKN3, STK6, FOXM1, FLJ10540, TNFRSF6B, HBP17, C1QDC1, TUBG1, FLJ10036, RRM2, ACTB, ACTN1, EPHA2, and TRIP13. In some embodiments, the microarray comprises FLJ10517, HCAP-G, CDKN3, STK6, FOXM1, FLJ10540, TNFRSF6B, HBP17, C1QDC1, TUBG1, FLJ10036, RRM2, ACTB, ACTN1, EPHA2, TRIP13, and CKS2. In some embodiments, the microarray comprises FLJ10517, HCAP-G, CDKN3, STK6, FOXM1, FLJ10540, TNFRSF6B, HBP17, C1QDC1, TUBG1, FLJ10036, RRM2, ACTB, ACTN1, EPHA2, TRIP13, CKS2, and VRK1. In some embodiments, the microarray comprises FLJ10517, HCAP-G, CDKN3, STK6, FOXM1, FLJ10540, TNFRSF6B, HBP17, C1QDC1, TUBG1, FLJ10036, RRM2, ACTB, ACTN1, EPHA2, TRIP13, CKS2, VRK1, and DUSP4. In some embodiments, the microarray comprises FLJ10517, HCAP-G, CDKN3, STK6, FOXM1, FLJ10540, TNFRSF6B, HBP17, C1QDC1, TUBG1, FLJ10036, RRM2, ACTB, ACTN1, EPHA2, TRIP13, CKS2, VRK1, DUSP4, and EIF4A1. In some embodiments, the microarray comprises FLJ10517, HCAP-G, CDKN3, STK6, FOXM1, FLJ10540, TNFRSF6B, HBP17, C1QDC1, TUBG1, FLJ10036, RRM2, ACTB, ACTN1, EPHA2, TRIP13, CKS2, VRK1, DUSP4, EIF4A1, and SERPINE2.

In some embodiments, the method comprises determining, by a computer processor, a first score from the first dataset that comprises the market set expression data using an interpretation function, wherein the first score is predictive of prognosis of the subject. In some embodiments, the interpretation function is based upon a predictive model. The predictive model can be used to predict the prognosis of a subject.

In some embodiments, the method comprises classifying the sample according to the predictive score that is determined. The sample can be classified as having a particular prognosis, such as, but not limited to the types of prognoses described herein. In some embodiments, wherein the sample comprises RNA extracted from peripheral blood cells or circulating breast epithelial cells. In some embodiments, the expression data are derived from hybridization data (e.g. using a microarray). In some embodiments, the expression data are derived from polymerase chain reaction data. In some embodiments, the expression data are derived from RT-PCR data.

In some embodiments, the present invention provides a system for predicting prognosis. In some embodiments, the system comprises a storage memory for storing a dataset derived from or associated with a sample obtained from a subject. As described herein, the dataset can comprise expression data. The expression data can comprise one or more markers, marker sets, or combinations of markers as described herein. In some embodiments, the system comprises a processor. In some embodiments, the processor can be communicatively coupled to the storage memory for determining a score with an interpretation function wherein the score is predictive response to therapy and/or prognosis of the subject.

In some embodiments, the predictive model performance for a method of predicting prognosis can be characterized by an area under the curve (AUC). In some embodiments, the predictive model performance is characterized by an AUC ranging from 0.68 to 0.70. In some embodiments, the predictive model performance is characterized by an AUC ranging from 0.70 to 0.79. In some embodiments, the predictive model performance is characterized by an AUC ranging from 0.80 to 0.89. In some embodiments, the predictive model performance is characterized by an AUC ranging from 0.90 to 0.99. In some embodiments, the AUC is about 0.680, 0.572, 0.741, 0.724, 0.738, or 0.756. In some embodiments, the AUC is greater than or equal to 0.680, 0.572, 0.741, 0.724, 0.738, or 0.756. In some embodiments, the p-value of an interpretation function is less than or equal to about 0.0078, 0.4618, 0.0003, 0.0034, 0.0041, or 0.0004. In some embodiments, the p-value is less than about 0.0015, 0.0010, or 0.0005.

In some embodiments, the prognosis interpretation function comprises an algorithm to produce the prognosis predictive score. In some embodiments, the interpretation function comprises at least one of an age term, a grade term, an ER-status term, node-status term, tumor-size term, and one or more gene marker terms including, but not limited to the genes described herein.

In some embodiments, the prognosis interpretation function comprises an algorithm where the predictive score is determined according to a predictive model, such as but not limited to logistical regression. In some embodiments, the predictive score (e.g. score) is determined by the following:

In some embodiments, the interpretation function comprises an algorithm where the predictive score is determined according to a predictive model, such as but not limited to logistical regression. In some embodiments, the predictive score (e.g. score) is determined by the following:

score=p, where log(p/1−p)=2.633+CKS2*−0.7056+DUSP4*−0.2883+FGFBP*−0.9329+TNFRSF6B*0.501;

score=p, where log(p/1−p)=2.633+CKS2*−0.7056+DUSP4*−0.2883+FGFBP*−0.9329+TNFRSF6B*0.501;

score=p, where log(p/1−p)=0.02882+ESR1*−0.2282+CDH3*−0.2072+HER2*0.339;

score=p, where log(p/1−p)=4.4749+FGFBP*−0.9043+nodes*−0.7416+ODC1*−0.4822+CKS2*−0.555;

score=p, where log(p/1−p)=0.4512+grade*0.5186+nodes*−0.7361+Ki67*−0.6195;

score=p, where log(p/1−p)=1.2624+grade*0.5654+nodes*−0.7786+ESR1*−0.3874+Ki67*−0.6872; or

score=p, where log(p/1−p)=5.4837+CEP55*−0.5585+FGFBP*−0.8835+ESR1*−0.4478+ODC1*−0.5632+nodes*−0.7473

In some embodiments, the predictive score (e.g. score) is determined by the following:

score=p, where log(p/1−p)=AA+CEP55*BB+FGFBP*CC+ESR1*DD+ODC1*EE+nodes*FF;

score=p, where log(p/1−p)=AA+grade*BB+nodes*CC+ESR1*DD+Ki67*EE;

score=p, where log(p/1−p)=AA+CKS2*BB+DUSP4*CC+FGFBP*DD+TNFRSF6B*EE;

score=p, where log(p/1−p)=AA+CKS2*BB+DUSP4*CC+FGFBP*DD+TNFRSF6B*EE;

score=p, where log(p/1−p)=AA+ESR1*BB+CDH3*CC+HER2*DD;

score=p, where log(p/1−p)=AA+FGFBP*BB+nodes*CC+ODC1*DD+CKS2*−EE; or

score=p, where log(p/1−p)=AA+grade*BB+nodes*CC+Ki67*DD;

wherein AA, BB, CC, DD, EE, or FF are each independently coefficients or values used to determine the score, the coefficients values can be different for each interpretation function.

In some embodiments, the prognosis interpretation function interprets the expression of one or more markers, including but not limited to, CKS2, CDKN3, FOXM1, RRM2, VRK1, TRIP13, ASPM, CEP55, ZWILCH, TUBG1, AURKA, SERPINE2, CAPRIN2, TNFRSF6B, CAPG, ACTN1, ACTB, DUSP4, EPHA2, FGFBP1, EIF4A1, ESR1, or ODC 1 and other combinations described herein.

In some embodiments, the prognosis scores are determined depending upon the cancer subtype or physical characteristics of the cancer. In some embodiments, the predictive score is an average of one or more scores as determined herein.

The score can be determined using any of the interpretation functions described herein. In the functions described herein, the term “CDH3” refers to cadherin 3, “ESR1” refers to estrogen receptor 1, “HER2” refers to Human Epidermal growth factor Receptor 2.

In some embodiments, the prognosis score is determined by analyzing markers that are down regulated (expression is lower) during acini formation in 3D culture. Tumors that have a similar gene signature were found to be associated with a prediction that they would have a particular prognosis. As shown in the examples, a 3D-signature accurately predicted prognosis in triple negative breast cancer subjects.

In some embodiments, the prognosis score, which can also be referred to as the prognosis predictive score has a cut-off value. The cut-off value is a value where when the predictive score is below the cut-off value the prognosis predictive score predicts that the cancer will have a poor prognosis or where the prognosis predictive score is above the cut-off value the prognosis predictive score predicts that the cancer will have a good prognosis. In some embodiments, a cancer is predicted to have a good prognosis when the prognosis predictive score is greater than or greater than or equal to the cut-off value. In some embodiments, a cancer is predicted to have a poor prognosis when the prognosis predictive score is less than or less than or equal to the cut-off value. In some embodiments, a cancer is predicted to have a good prognosis when the prognosis predictive score is equal to the cut-off value. In some embodiments, a cancer is predicted to have a poor prognosis when the prognosis predictive score is equal to the cut-off value. In some embodiments, the cut-off value is specified. In some embodiments, the specified cut-off value is from about 0.1 to about 0.9, about 0.2 to about 0.8, about 0.3 to about 0.7, about 0.4 to about 0.8, about 0.4 to about 0.7, about 0.4 to about 0.9, about 0.5 to about 0.9, about 0.5 to about 0.7, about 0.5 to about 0.6. In some embodiments, the specified cut-off value is about or exactly 0.1, 0.2, 0.3, 0.4, 0.5, 0.6, 0.7, 0.8, or 0.9. In some embodiments, the specified cut-off value is at least 0.1, 0.2, 0.3, 0.4, 0.5, 0.6, 0.7, 0.8, or 0.9. In some embodiments, the specified cut-off can be different for different types of cancers.

In some embodiments, a method for predicting prognosis as described herein comprises transforming the predictive score into an output that is communicated to a user. The output can be as simple as a message stating a particular prognosis. In some embodiments, the output is a statistical analysis of the probability of a particular prognosis, which is based upon the predictive score. The output can be communicated by a machine orally, electronically in a message, or on printed matter. In some embodiments, the output is displayed on a screen. Accordingly, in some embodiments, the systems described herein also can comprise a display unit that is communicatively connected to the processor such that the display unit can display the output. These embodiments can also be applied to other methods described herein, including, but not limited to, predicting response to a treatment or selecting a treatment for subject.

In some embodiments, the prognosis interpretation function comprises a function as described herein. In some embodiments, the sample that is analyzed is a triple negative breast cancer sample (e.g. derived from a subject with breast cancer and characterized as a triple negative breast cancer).

In some embodiments, methods are provided for determining or selecting a treatment for a subject having cancer, such as breast cancer. The type of breast cancer can be any breast cancer, such as those described herein. In some embodiments, the method comprises comparing a score obtained from a gene expression profile. The scores that are compared are scores for a subject's response predictive score to a particular treatment. These scores can be absolute numbers and not transformed to a cut-off value. In some embodiments, the treatment is TFAC, FAC, or cisplatin. In some embodiments, the cancer is a triple negative breast cancer. Prior to the present methods, clinical predictive tests are used to predict the risk of an adverse future event. The results were used by clinicians to make judgments about disease prognoses and treatment options. Molecular predictive tests are generally biologically based methods that incorporate measurements of biomarkers to produce a numerical result or “score”. Some test results are binary (2 mutually exclusive categories such as “present” or “absent”), but many other test results are reported as a score on an ordinal or continuous scale. Scores for a given test may have range that is broad, for example 1 to 100, or the score range may be less broad, for example 1 to 5.

In some embodiments, once a score is determined, the method may comprise determining whether the score (e.g. test score) is sufficiently high to confirm the prediction and treat a patient, sufficiently low to exclude treatment of the patient, or intermediate and requiring an additional test or interpretation by the clinician. In some embodiments, the method of interpreting a test score can be referred to as decision analysis. In some embodiments, the score is determined mathematically. Methods of decision analysis are described herein, for example, for determining prognosis or predicting a response to a specific treatment option. The score can be determined based upon a genetic expression profile of the subject or the tumor present in the subject. In some embodiments, ordinal and continuous scores can be used interpret the score. In some embodiments, by setting and applying a numerical cutoff, the scores that exceed the cutoff are placed in one category and scores than do not the cutoff are placed in a different category. Cut-off values and the uses thereof are described herein. The categories can be, for example, response to treatment, prognosis of the patient, and the like. In some embodiments, a breast cancer prognosis prediction test, scores can be from 1 to 100, 10-100, 20-100, 30-100, 40-100, 50,-100, 60-100, 70-100, 80-100, or 90, 100. In some embodiments, the cutoff is 10, 20, 30, 40, 50, 60, 70, 80, 90 or 100.

As a non-limiting example, in some embodiments, the cutoff is set at 50, then a patient with a score that exceeds 50 is predicted to have a poor prognosis and those with scores that do not exceed 50 is predicted to have a good prognosis. Although cut-off values can be less than 1 as described herein, the cut-off value can be any number determined by the interpretation function to be significant. In some embodiments, for some predictive tests, multiple cutoffs are set, such that scores above one cutoff have one interpretation, scores less than another cutoff have another interpretation and scores that fall in between the two cutoffs have a third or an intermediate interpretation.

Although the cutoff approach to interpret test scores may be necessary for the calculation of metrics that include sensitivity, specificity, positive predictive value (PPV), and negative predictive value (NPV) an individual is forced to dichotomize the results of ordinal and continuous measures. Dichotomizing test results can involve the loss of some of the information that could be available from the test. In addition, the selection of a cutoff involves a number of considerations and the actual choice of the cutoff point influences the sensitivity, specificity, positive predictive value, and negative predictive value.

Therefore, in some embodiments of the present invention provide a method of selecting a treatment for a patient that does not use or set a cut-off value. In some embodiments, this can be referred to as a “relative score system.” In some embodiments, the relative score system does not comprise decision analysis and/or setting of a threshold or cutoff value. In some embodiments, the relative score system comprises comparing (e.g. directly) scores from a set (e.g. two or more, 2, 3, 4, 5, 6, 7, 8, 9, or 10 or at least the number indicated herein) of predictors (for example, but not limited to, the results of a plurality of different chemotherapy response prediction algorithms). In some embodiments, the method comprises using the best score (highest or lowest) to indicate the preferred option for the patient. In some embodiments, the preferred option is the treatment that is selected. Therefore, in some embodiments, the relative scores are more important than the actual scores of the individual predictors.

In some embodiments, a score is determined for a subject for a response to TFAC, FAC, cisplatin, or any combination thereof. The scores can then be compared on a relative basis. In some embodiments, the high score indicates the preferred treatment option. In some embodiments, the low score indicates the preferred treatment option. In some embodiments, the score does not indicate prognosis or predicted response to the treatment, but rather the scores are used only to determine the preferred treatment option. In some embodiments, the preferred treatment option does not mean that the treatment will lead to a complete response or remission of the disease.

In some embodiments, the scores for a response to a treatment are determined by an interpretation function. In some embodiments, the interpretation is selected from the following Table, Table 30:

| Treat- | |
|---|---|
| ment | Interpretation Function |
| TFAC | Score = P = 1/(1 + e^{-1.441 +} ^{2.036}* ^{ESR1 - 0.716}*^{ODC1}) |
| FAC | Score = P = 1/(1 + e^{-6.176 +} ^{2.3339}* ^{CEP55 - 10.9738}*^{EPHA2}) |
| cisplatin | Score = P = 1/(1 + |
| | e^{156 +} ⁴⁷*^{ACTN +} ²¹*^{CEP55 +} ⁵⁵ *^{HER2 +} ³⁶*^{TRIP13 +} ²⁴*^{VRK1}) |

The scores can then be compared to one another to determine the relative score. In these equations, P is defined as the probability of response to the chemotherapy, e is defined as a mathematical constant is the unique real number such that the value of the derivative (slope of the tangent line) of the function f(x)=e^{x} at the point x=0 is equal to 1.

Accordingly, in some embodiments, methods are provided for selecting a treatment for a subject with cancer. In some embodiments, the method comprises obtaining a dataset associated with a sample derived from a patient diagnosed with cancer. In some embodiments, the dataset comprises expression data for a plurality of markers selected from the group consisting of CKS2, CDKN3, FOXM1, RRM2, VRK1, TRIP13, ASPM, CEP55, ZWILCH, TUBG1, AURKA, SERPINE2, CAPRIN2, TNFRSF6B, CAPG, ACTN1, ACTB, DUSP4, EPHA2, FGFBP1, EIF4A1, ESR1, ODC1 and optionally at least one clinical factor. In some embodiments, the dataset comprises expression data for ESR1, ODC1, CEP55, EPHA2, ACTN, HER2, TRIP13, VRK1, or any combination thereof. In some embodiments, the dataset comprises expression data ESR1 and ODC1. In some embodiments, the dataset comprises expression data CEP55 and EPHA2. In some embodiments, the dataset comprises expression data CEP55, ACTN, HER2, TRIP13, and VRK1.

In some embodiments, the methods comprise determining a selection predictive score for a plurality of treatment options from the dataset using a one or more interpretation functions. In some embodiments, the interpretation function is Score=P=1/(1+e^{-1.441+2.036*ESR1-0.716*ODC1}); Score=P=1/(1+e^{-6.176+2.3339*CEP55-10.9738*EPHA2}); Score=P=1/(1+e^{156+47*ACTN+21*CEP55+55*HER2+36*TRIP13+24*VRK1}). In some embodiments, the interpretation function is a function for predicting a response to a specific treatment option. In some embodiments, the treatment option is a treatment described herein. In some embodiments, the treatment option is TFAC, FAC, or cisplatin. In some embodiments, the method comprises comparing the selection predictive scores for a plurality of treatment options. In some embodiments, the method comprises selecting a treatment or determining a preferred treatment for a subject by selecting a treatment with the best selection predictive score based upon the comparison of the selection predictive scores for the plurality of treatment options. In some embodiments, the selected treatment can also be presented to a subject as a preferred treatment option.

In some embodiments, the plurality of treatment options is selected from the group consisting of TFAC, FAC, and Cisplatin. In some embodiments, the method of selecting a treatment option for a subject, the subject has breast cancer. The breast cancer can be any type, including those described herein. One non-limiting example is triple negative breast cancer.

In some embodiments, the one or more interpretation functions for determining the predictive score for TFAC comprises expression data for ESR1 and ODC1. In some embodiments, the one or more interpretation functions for determining the predictive score for FAC comprises expression data for CEP55 and EPHA2. In some embodiments, the one or more interpretation functions for determining the predictive score for cisplatin comprises expression data for ACTN, CEP55, HER2, TRIP13, VRK1. In some embodiments, the one or more interpretation functions for determining the predictive score for TFAC is Score=P=1/(1+e^{-1.441+2.036*ESR1-0.716*ODC1}). In some embodiments, the one or more interpretation functions for determining the predictive score for FAC is Score=P=1/(1+e^{-6.176+2.3339*CEP55-10.9738*EPHA2}). In some embodiments, the one or more interpretation functions for determining the predictive score for Cisplatin is Score=P=1/(1+e^{156+47*ACTN+21*CEP55+55*HER2+36*TRIP13+24*VRK1}). In some embodiments, the best selection score is the highest relative numerical score. In some embodiments the best selection score is the lowest relative numerical score.

In some embodiments, a method of selecting a treatment the selection predictive score is not used to predict prognosis.

In some embodiments, one or more genes in the 3D-signature is substituted with a co-regulated gene. A co-regulated gene is a gene whose expression correlates with one or more other genes. Examples of co-regulated genes that can be used in the methods described herein, include but are not limited to, Tables 26A and 26B. Therefore, although in some embodiments, gene expression profiles are generated based upon the gene expression of genes that regulate acini organization, the methods can also use expression data from co-regulated genes. In some embodiments, the gene expression profile comprises one or more genes regulating acini organization. In some embodiments, the genes that are predicted to regulate the expression of the gene expression signature genes are identified by using pathway analysis or relevance networks. In some embodiments, these regulatory genes comprise, but are not limited to those described in Tables 26A and 26B or Table 28. In some embodiments, the subset of the regulatory genes that are mutated, and the types of mutations included, in a particular cancer, is a mutation signature for that cancer. In some embodiments, the signature for genes described herein including, but not limited to those described herein, is interpreted by the application of an algorithm described herein to predict the likelihood of response to a chemotherapy or cancer treatment. In some embodiments, a gene marker used in any interpretation function or any method described herein can be replaced with a co-regulated gene such as those listed in Tables 26A or 26B. In some embodiments, each of the genes is replaced with a co-regulated gene. In some embodiments, 1, 2, 3, 4, 5, 6, 7, 8, 9, 10, 11, 12, 13, 14, 15, 16, 17, 18, 19, 20, or 21 genes are replaced with a co-regulated gene.

In some embodiments, the sample is derived from a breast cancer. In some embodiments, the breast cancer is a ER negative, ER positive, HER negative, HER positive, progesterone receptor negative, progesterone receptor positive, or any combination thereof. In some embodiments, the cancer is negative for ER, HER and progesterone receptors (triple negative). That sample can also be identified by its Luminal A or Luminal B status.

In some embodiments described herein and throughout, the phrase “responded to treatment” includes, but is not limited to, a complete response. In some embodiments, the response can be measured in terms of tumor size or the amount of tumor remaining at a pathological examination. In some embodiments, response is where the tumor size is reduced by at least 10, 20, 30, 40, 50, 60, 70, 80, 90, 95 or 100%. In some embodiments, the response predicted is the amount of tumor remaining at a pathological examination, where the tumor remaining is 0, or less than 10, 20, 30, 40, 50, 60, 70, 80, 90, or 95%. In some embodiments, the response is where the cancer is determined to be in remission. In some embodiments, the response is where the cancer is determined to be in remission and remains in remission with no relapse for about or at least 2, 3, 5 or 10 years. In some embodiments, the response is where the cancer growth is inhibited, but the tumor size is not reduced. In some embodiments, a predicted response is a response other than a complete response. In some embodiments, the predicted response includes, but is not limited to, a partial response, a less than a partial response, or no response. In some embodiments, the predicted response is a response where the tumor or the indications of a tumor do not change, the tumor continues to progress, or if tumor cells are detected in a pathological exam after treatment, or any combination thereof.

In some embodiments, the cancer treatment is a breast cancer treatment. In addition to the treatments described herein, in some embodiments, the breast cancer treatment is TFAC (a combination of taxol/fluorouracil/anthracycline/cyclophosphamide with or without filgrastim support). Chemotherapy treatments include TAC (taxol/anthracycline/cyclophosphamide with or without filgrastim support), ACMF (doxorubicin followed by cyclophosphamide, methotrexate, fluorouracil), ACT (doxorubicin, cyclophosphamide followed by taxol or docetaxel), A-T-C (doxorubicin followed by paclitaxel followed by cyclophosphamide), CAF/FAC (fluorouracil/doxorubicin/cyclophosphamide), CEF (cyclophosphamide/epirubicin/fluorouracil), AC (doxorubicin/cyclophosphamide), EC (epirubicin/cyclophosphamide), AT (doxorubicin/docetaxel or doxorubicin/taxol), CMF (cyclophosphamide/methotrexate/fluorouracil), cyclophosphamide (Cytoxan or Neosar), methotrexate, fluorouracil (5-FU), doxorubicin (Adriamycin), epirubicin (Ellence), gemcitabine, taxol (Paclitaxel), GT (gemcitabine/taxol), taxotere (Docetaxel), vinorelbine (Navelbine), capecitabine (Xeloda), platinum drugs (Cisplatin, Carboplatin), etoposide, and vinblastine. Other treatments include surgery, radiation, hormonal and targeted therapies. Additionally, other examples of cancer treatments are described elsewhere herein and a predictive score can also be determined for those.

Embodiments of the present invention are directed to methods for predicting the efficacy of a chemotherapeutic treatment of breast cancer comprising analyzing an expression profile of marker genes from a cancerous breast tissue and predicting the efficacy of treatment if the expression profile from the cancerous breast tissue matches a predetermined expression profile that indicates a patient will respond to the treatment. In yet another embodiment, the marker gene may comprise one or more of CKS2, FOXM1, RRM2, TRIP13, ASPM, CEP55, AURKA, TUBG1, ZWILCH, CDKN3, VRK1, SERPINE2, FGFBP1, TNFRSF68, CAPG, ACTB, DUSP4, EPHA2, ACTN1, CAPRIN2, EIF4A1, ODC1, AMIGO2, PHLDA, THBS1, LRP8, MPRIP, SLC20A1 and combinations thereof. In yet another embodiment, an expression profile may be developed from the marker genes. In some embodiments, the gene signature is derived from the one or more of the genes described in Table 28.

In some embodiments, the present invention provides methods of determining a 3-D signature profile for a tissue type that can be used, for example, to identify a gene signature profile for a cancer. Tissues are a three-dimensional organization of cells. The process of forming a tissue or a specialized group of cells is tightly regulated. The tight regulation of this process is controlled by gene expression and/or gene regulation. Accordingly, the present invention provides methods of determining a genetic signature profile for a tissue. In some embodiments, the method comprises growing cells under conditions that are suitable for formation of a tissue. The conditions can be any conditions that mimic the formation of a tissue in a subject or organism. In some embodiments, the conditions are ex vivo. Tissues are not the same as a monolayer of cells grown in a cell culture dish or well. Rather the tissues are formed by growing cells in a three-dimensional environment. Thus, any conditions suitable for the formation of a tissue are suitable for the presently described methods. In some embodiments the cells are grown in a microenvironment that recapitulates the normal tissue microenvironment, for example using three-dimensional (3D) gels of laminin-rich (1r) extracellular matrix (ECM). Micro beads and other structural supports can replace gels and other components can make up the ECM. During the process of the tissue formation the genes of the cells taking part in the tissue formation can be measured and quantified. The signature profile can then be determined based upon the expression data. The signature profile can change over time. That is, when a tissue is initially forming a certain set of genes may be expressed at different levels that when the tissue is in its mature form.

Thus, in some embodiments, a method of identifying a 3-D signature comprises growing cells under conditions suitable for tissue formation, such as conditions that mimic in vivo tissue formation. In some embodiments, gene expression data is obtained during the tissue formation. In some embodiments, the gene expression data is obtained at multiple time points during the tissue formation. In some embodiments, gene expression data is obtained at time zero (t₀) (when the cells are seeded to begin tissue formation), time t_{1/2} (when half the tissue if formed) and time tₘ (when the tissue is in its mature form). Other time points can also be used. The different expression data can then be analyzed to determine the 3-D signature profile for the particular tissue type being examined. The 3-D signature profile will contain genes that play a role in the normal tissue formation. These genes can be then be used to identify interpretation functions for related cancer types to determine prognosis, response to treatment, or survival, such as is exemplified herein with breast cancer.

The gene expression data to determine the 3-D signature can be determined by any method including, but not limited to the methods described herein. These methods include, for example, PCR, microarrays, and the like. Therefore, by determining the expression levels of genes that exhibit modulated expression in diseased, or cancerous tissue, an expression profile or genetic signature for particular diseased states may be determined, and because the expression profile for various disease types and various patients may vary, patients who are more likely to respond to specific types of therapy can be identified. For example, in some embodiments, the method may include a microarray configured to measure genes that are involved in tissue formation. As such, the microarray may include a set of genes specifically associated with the tissue formation. For example, in some embodiments, the microarray data may include a set of 10-30 genes associated with tissue formation and, thus with the related cancer type In some embodiments, the 3-D signature is determined from a microarray of other gene expression approach that measures the expression levels of all human genes or genes from another organism. The genes whose expression is altered during the process of tissue formation comprise the 3D signature. To select a signature that applies across different individuals, the signature can be derived from cells obtained from a number of different individuals and a common signature that includes genes that are differentially expression during tissue formation in all individuals is identified. Any tissue type can be studied according to the presently described method to determine a 3-D signature. In addition to breast tissue, non-limiting examples of tissues include, colon, lung, brain, pancreas, prostate, ovarian, skin, retina, bladder, stomach, esophageal, lymph node, liver, and the like.

As discussed herein, once a 3-D signature is determined, a the 3-D signature can be used to predict a response to a treatment of a tumor derived from that tissue type. Non-limiting examples of treatments include those that are described herein. For example, a response to the following treatments may be determined as applicable to the tissue type and related cancer: alkylating agents including for example, nitrogen mustards such as mechlorethamine (nitrogen mustard), chlorambucil, cyclophosphamide (Cytoxan®), ifosfamide, and melphalan; nitrosoureas such as streptozocin, carmustine (BCNU), and lomustine; alkyl sulfonates such as busulfan; triazines such as dacarbazine (DTIC) and temozolomide (Temodar®); and ethylenimines, such as, thiotepa and altretamine (hexamethylmelamine); and the like. In other embodiments, a patient's response to antimetabolites including but not limited to 5-fluorouracil (5-FU), capecitabine (Xeloda®), 6-mercaptopurine (6-MP), methotrexate, gemcitabine (Gemzar®), cytarabine (Ara-C®), fludarabine, and pemetrexed (Alimta®) and the like may be tested, and in still other embodiments, efficacy of anthracyclines such as, for example, daunorubicin, doxorubicin (Adriamycin®), epirubicin, and idarubicin and other anti-tumor antibiotics including, for example, actinomycin-D, bleomycin, and mitomycin-C may be tested. In yet other embodiments, the clinical test may be directed to identifying patients who will respond to topoisomerase I inhibitors such as topotecan and irinotecan (CPT-11) or topoisomerase II inhibitors such as etoposide (VP-16), teniposide, and mitoxantrone, and in further embodiments, the clinical test may be configured to determine the patients response to corticosteroids such as, but not limited to, prednisone, methylprednisolone (Solumedrol®) and dexamethasone (Decadron®). In particular embodiments, the clinical test may be configured to indentify patients who will respond to mitotic inhibitors including, for example, taxanes such as paclitaxel (Taxol®) and docetaxel (Taxotere®); epothilones such as ixabepilone (Ixempra®); vinca alkaloids such as vinblastine (Velban®), vincristine (Oncovin®), and vinorelbine (Navelbine®); and estramustine (Emcyt®).

Although the present invention has been described in considerable detail with reference to certain preferred embodiments thereof, other versions are possible. Therefore the spirit and scope of the appended claims should not be limited to the description and the preferred versions contained within this specification. Various aspects of the present invention will be illustrated with reference to the following non-limiting examples.

### EXAMPLES

### Example 1

All results in this study were obtained from the microarray dataset of Hess K R, Anderson K, Symmans W F, et al. Journal of Clinical Oncology 24(26): 4236-44, 2006, contents of which are incorporated by reference herein. In summary, fine-needle aspirates from patients with stage I-III breast cancer were obtained before neoadjuvant combination treatment and response was assessed after chemotherapy. Aspirates were analyzed on Affymetrix HG-U133A microarrays. An additional 145 samples for a total of 278 samples were added to the Gene Expression Omnibus (GEO) resource in 2010 and were also used in this study. Affymetrix Excel files were downloaded from GEO, preprocessed by RMA using GeneSpring, and then genes were normalized to the median expression level. RMA is used to compute gene expression summary values for Affymetrix data by using the Robust Multichip Average expression summary and to carry out quality assessment using probe-level metrics. Replicate and poor quality samples (normalized gene expression standard deviation >0.75) were omitted.

Molecular classes were determined using the intrinsic gene set of 300 genes (Hu et al, 2007). 263 were translated onto Affymetrix HG-U133A GeneChips and expression values organized by hierarchical clustering with a Pearson metric resulting in sample clustering into five classes. Clusters were identified as: Luminal A=high ESR1, low AURKA; Luminal B=high ESR1, high AURKA; HER2+=high ERBB; Basal-like=low ESR1, high KRT5; and Unclassified which was the remaining cluster (data not shown).

In this study, the 3D signature is applied using a logistic regression. Logistic regression is used to predict the probability of occurrence of an event by fitting data to a logistic curve, i.e. a common sigmoid (S-shaped) curve. Analyses were performed using SAS software. Results are presented as area under the curve (AUC) statistics, which is a summary statistic that combines sensitivity and specificity into a single measure. AUC=1.0 is a perfect test, 0.9-1.0 is an excellent test, 0.8-0.9 is a very good test, 0.7-0.8 is a good test.

The number of samples for molecular class and response categories of expanded microarray dataset of Hess, et al., 2006 is shown in Table 2.

TABLE 2

| | Actual numbers | | | Percentages | | |
|---|---|---|---|---|---|---|
| | no pCR | pCR | Total | no pCR | pCR | Total |
| Basal-like | 42 | 27 | 69 | 17% | 11% | 29% |
| HER2+ | 8 | 11 | 19 | 3% | 5% | 8% |
| Luminal A | 55 | 1 | 56 | 23% | 0% | 23% |
| Luminal B | 43 | 7 | 50 | 18% | 3% | 21% |
| Unclassified | 43 | 5 | 48 | 18% | 2% | 20% |
| Total | 191 | 51 | 242 | 79% | 21% | 100% |
| ER Negative | 54 | 43 | 97 | 22% | 18% | 40% |
| ER Positive | 137 | 8 | 145 | 57% | 3% | 60% |
| Total | 191 | 51 | 242 | 79% | 21% | 100% |

Table 3 illustrates the results of models built using expression levels of the 22 3D-signature genes. Logistic regression allows for an accurate prediction of response to chemotherapy for a broad range of subtypes of breast cancer. The gray highlighted numbers show the best condition AUC statistic for each tumor classification group listed at the left. For example, for the group “All types”, the best AUC obtained was 0.875, which was obtained with model M5. This model included the following variables: expression levels of the 22 3D-signature genes, breast tumor subtype information, and ER status information. In this case, the model was trained over all tumor subtypes.

TABLE 3

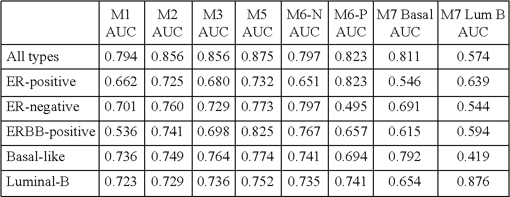

M1: model gene variables (trained over all types)
M2: model includes genes + subtype variable (trained over all types)
M3: model includes genes + ER variable (trained over all types)
M5: model includes genes + subtype and ER variables (trained over all types)
M6: model includes genes + subtype (trained over all ER pos and ER neg separately)
M7: train over subtypes seperately include genes + ER

Models were trained using the criteria indicated above on 80% (194 of 242) samples. The tabulated AUC's are from a standard 5-fold cross validation of the remaining 20% (48 of 242) samples where the 20% hold out was rotated to be different for each validation.

Eight different models were built and tested (Table 3). These models included the 3D signature genes plus clinical parameters indicated. Results showed that a different model produced the optimum discrimination for each of the five subtypes tested. To assess which of the 3D genes were optimum predictors for each subtype, we performed univariate analysis. Table 4 shows that the 3D signature includes a combination of different genes that accurately predict chemotherapy response in specific breast cancer subtypes.

TABLE 4

| | Gene | | PREDICTION of Chemotherapy Response | | | | | | PROGNOSIS | |
|---|---|---|---|---|---|---|---|---|---|---|
| | Symbol | Description | ER+ | ER− | Lum A | Lum B | ERBB+ | Basal | (Kaplan p) | Functional Pathway |
| 1 | EPHA2 | EPH receptor A2 | 0.196 | 0.079 | 0.839 | 0.437 | 0.140 | 0.314 | 0.01 | anglogenesis |
| 2 | FGFBP1 | fibroblast growth factor | 0.272 | 0.060 | 0.564 | 0.055 | 0.895 | 0.087 | >0.05 | anglogenesis |
| | | binding protein 1 | | | | | | | | |
| 3 | TNFRSF6B | TNF receptor family, 6b, decoy | 0.603 | 0.100 | 0.452 | 0.201 | 0.180 | 0.167 | >0.05 | anti-apoptosis |
| 4 | FOXM1 | forkhead box M1 | 0.077 | 0.739 | 0.897 | 0.680 | 0.079 | 0.951 | 0.002 | cell cycle |
| 5 | CDKN3 | cyclin-dependent kinase | 0.678 | 0.560 | 0.199 | 0.950 | 0.523 | 0.978 | 0.002 | cell cycle: G1 |
| | | inhibitor 3 | | | | | | | | progression |
| 6 | RRM2 | ribonucleotide reductase M2 | 0.020 | 0.088 | 0.105 | 0.023 | 0.383 | 0.196 | 0.005 | cell cycle: G1/S |
| 7 | CKS2 | CDC28 protein kinase regulatory | 0.084 | 1.000 | 0.014 | 0.773 | 0.025 | 0.635 | 0.02 | cell cycle: G2 |
| | | subunit 2 | | | | | | | | progression |
| 8 | ASPM | abnormal spindle homolog | 0.018 | 0.227 | 0.239 | 0.036 | 0.547 | 0.165 | 0.003 | cell cycle: mitotic |
| | | | | | | | | | | spindle function |
| 9 | AURKA | aurora kinase A | 0.167 | 0.939 | 0.564 | 0.899 | 0.736 | 0.480 | 0.001 | cell cycle: mitotic |
| | | | | | | | | | | spindle function |
| 10 | CEP55 | centrosomal protein 55 kDa | 0.745 | 0.380 | 0.851 | 0.397 | 0.611 | 0.881 | 0.002 | cell cycle: mitotic |
| | | | | | | | | | | spindle function |
| 11 | TRIP13 | thyroid hormone receptor | 0.025 | 0.828 | 0.668 | 0.069 | 0.204 | 0.875 | 0.003 | cell cycle: mitotic |
| | | interactor 13 | | | | | | | | spindle function |
| 12 | TUBG1 | tubulin, gamma 1 | 0.178 | 0.876 | 0.017 | 0.168 | 0.201 | 0.778 | >0.05 | cell cycle: mitotic |
| | | | | | | | | | | spindle function |
| 13 | ZWILCH | Zwilch, kinetochore associated, | 0.783 | 0.854 | 0.278 | 0.648 | 0.145 | 0.954 | >0.05 | cell cycle: mitotic |
| | | homolog | | | | | | | | spindle function |
| 14 | VRK1 | vaccine related kinase 1 | 0.527 | 0.623 | 0.537 | 0.972 | 0.119 | 0.429 | 0.001 | cell cycle: S-phase |
| | | | | | | | | | | progression |
| 15 | SERPINE2 | serpin peptidase inhibitor | 0.372 | 0.221 | 1.000 | 0.448 | 0.065 | 0.484 | >0.05 | ECM/metastasis |
| | | (nexin) 2 | | | | | | | | |
| 16 | ODC1 | ornithine decarboxylase 1 | 0.451 | 0.078 | 0.038 | 0.080 | 0.675 | 0.138 | >0.05 | polyamine biosynthesis |
| 17 | CAPRIN2 | caprin family member 2 | 0.426 | 0.517 | 0.653 | 0.870 | 0.954 | 0.312 | >0.05 | signaling pathway: WNT |
| 18 | ACTB | actin, beta | 0.437 | 0.030 | 0.558 | 0.378 | 0.019 | 0.085 | 0.007 | signaling pathways: |
| | | | | | | | | | | e-cad/b-catenin |
| 19 | ACTN1 | actinin, alpha 1 | 0.583 | 0.239 | 0.569 | 0.741 | 0.200 | 0.553 | 0.01 | signaling pathways: |
| | | | | | | | | | | e-cad/b-catenin |
| 20 | CAPG | capping protein (actin), gelsolin- | 0.623 | 0.906 | 0.445 | 0.309 | 0.093 | 0.618 | >0.05 | signaling pathways: |
| | | like | | | | | | | | e-cad/b-catenin |
| 21 | DUSP4 | dual specificity phosphatase 4 | 0.896 | 0.002 | 0.570 | 0.028 | 0.012 | 0.030 | 0.004 | signaling pathways: |
| | | | | | | | | | | EGFR and ERK |
| 22 | EIF4A1 | eukaryotic translation initiation | 0.386 | 0.431 | 0.784 | 0.426 | 0.040 | 0.779 | >0.05 | translation |
| | | factor 4A1 | | | | | | | | |

Table 4 provides a list of 3D Signature genes grouped by functional pathway with results of univariate logistic regression analysis in breast cancer subtypes. Results show that different combinations of genes discriminate chemotherapy response in each breast cancer subtype. Univariate analysis p-values are shown.

The 3D Signature provides accurate and personalized information to predict response to chemotherapy in breast cancer. In addition, the Signature predicts response in a broad range of molecular subtypes of breast cancer, including ER+, ER−, luminal A and B, basal-like and HER2+. Broad applicability of this Signature is due to a broad range of functional pathways among the signature genes. This novel approach to signature discovery is a powerful approach that can enhance the range of applicability of resulting signatures. Accurate prediction of chemotherapy response is greatly improved by including molecular class information. This gene signature has the potential to fill the existing need for an in vitro diagnostic to provide accurate and personalized information to guide chemotherapy decisions.

Combination chemotherapy regimens for breast cancer provide significant improvements in disease-free survival. Accurate stratification of patients prior to treatment may allow non-responders to receive an alternative treatment in a timely manner and potentially increase rates of complete response.

Embodiments of the present disclosure are directed to a 22-gene signature that accurately predicts response to antimitotic combination chemotherapy for breast cancer. This signature was determined based on a disruption in one of the key steps of tumorigenesis, namely disruption of the formation of spatially accurate mammary ductal units by breast epithelial cells. Hence, the 22 genes represent a biological process that is independent of any specific patient set or predefined clinical classification.

### Example 2

To determine whether genes with differential expression during human mammary acinar morphogenesis predict response to combination chemotherapy in breast cancer, results from two published microarray datasets (Fournier, et al., 2006; Popovici et al., 2010) were analyzed. Expression levels of the majority of genes that were coordinately down regulated during acini formation were significantly associated with response to combination chemotherapy treatment. A 22-gene signature representing the down regulated genes was evaluated independently in each of three breast cancer clinical subgroups, ER-positive (n=146), HER2-positive (n=41), and triple negative (n=90) using two methods of analysis, hierarchical clustering and logistic regression.

Hierarchical cluster analysis results showed that the 22 genes accurately stratified patients in each of the three subgroups by response to chemotherapy (Fisher's Exact p<0.05). Logistic regression with 3-fold cross validation demonstrated that different models accurately predicted response in these subgroups (AUC≧0.7).

Embodiments of the present disclosure demonstrate that the 22-gene signature is broadly effective across independent patient clinical subgroups in its ability to stratify patients according to chemotherapy response in breast cancer.

In one embodiment, the 22-gene signature may provide patients, early in the care process, with accurate and personalized information to predict response to combination chemotherapy.

Cluster analysis is the assignment of a set of observations into subsets (called clusters) so that observations in the same cluster are similar in some sense. It is a discovery approach generally applied to find patterns of gene expression in the absence of any prior information on the groups that one expects to find in the dataset. The method is unsupervised, meaning that it requires no pre-existing clinical information in order to separate a dataset into subgroups. Statistically, it is an approach based on correlation coefficients. In contrast to cluster analysis, logistic regression is a predictive modeling tool and a rigorous statistical approach. Logistic regression fits data to an S-shaped curve and finds the best equation (i.e. algorithm or model) to apply the expression levels of a set of genes to predict a given clinical outcome.

To predict response to chemotherapy in breast cancer, logistic regression analysis is performed by using SAS software. A model is generated based on the expression levels of the 22 genes. An “area under the curve” (AUC) is calculated and used for statistics from receiver operating curves (ROC) using three-fold cross-validation. Cross-validation, sometimes called rotation estimation, is a technique for assessing how the results of a statistical analysis will generalize to an independent data set. This method is used to estimate how accurately the predictive models will perform in practice. One round of cross-validation involves partitioning the dataset into three subsets, performing the analysis on two combined subsets (called the training set), and validating the analysis on the third subset (called the validation set or testing set). To reduce variability, three rounds of cross-validation are performed by rotating through all combination of the three subsets, and finally the validation results (AUC values) are averaged over the rounds.

The AUC value can be interpreted as the probability that the test result from a randomly chosen responsive patient is more likely to respond to chemotherapy than that from a randomly chosen nonresponsive individual. So, it can be thought of as a nonparametric distance between responsive and nonresponsive test results. AUC values are generally interpreted as follows: 0.5 to 0.6 is a poor test, 0.6 to 0.7 is a fair test, 0.7 to 0.8 is a good test, 0.8-0.9 is a very good test, and above 0.9 is an excellent test. For comparison, the AUC value for the currently marketed PSA test (prostate serum antigen) used as an early detection screen for prostate cancer is 0.57.

### Example 3

Logistic regression results for two datasets (referred to here as datasets A and B) and specific subtypes of breast cancer are presented as AUC statistics (Table 5). Both of these datasets include microarray data collected from a set of fine needle aspirate tumor biopsy samples obtained from women with breast cancer prior to neoadjuvant combination chemotherapy with TFAC (taxol, 5-fluorouracil, cyclophosphamide, and doxorubicin).

TABLE 5
The 22-gene signature accurately predicted response to chemotherapy
in two breast cancer datasets

| | Dataset | |
|---|---|---|
| Dataset A | B | |
| (n = 243) | (n = 454) | Genes included in model |
| 0.701 | 0.722 | ODC1 TRIP13 DUSP4 SERPINE2 VRK1 FGFBP1 |
| | | TUBG EPHA2 |
| 0.741 | 0.763 | ODC1 TRIP13 SERPINE2 FGFBP1 TUBG |
| 0.733 | 0.726 | ODC1 TRIP13 DUSP4 SERPINE2 VRK1 EPHA2 |
| 0.748 | 0.761 | ODC1 TRIP13 SERPINE2 TUBG |
| 0.748 | 0.774 | ODC1 TRIP13 SERPINE2 FGFBP1 |
| 0.722 | 0.742 | ODC1 TRIP13 SERPINE2 FGFBP1 DUSP4 VRK1 |
| 0.740 | 0.761 | ODC1 TRIP13 SERPINE2 FGFBP1 DUSP4 |
| 0.758 | 0.775 | ODC1 TRIP13 SERPINE2 |
| 0.662 | 0.713 | All 22 genes |

Dataset A (n = 133), Hesss et al.
Dataset B (n = 454), Popovici et al; Tabchy et al.

Dataset A included data from 133 patients (Hess et al., 2006), while dataset B included data from an overlapping dataset of 243 patients (Popovici et al., 2010). Dataset A is a subset of the dataset B samples. For each dataset, a variety of combinations and subsets of the 22 genes were tested for predictive accuracy using logistic regression.

The first example shows results for all subtypes of breast cancer samples considered together. Results for a series of eight different subsets of the 22 genes as well as all 22 genes are listed (Table 5). AUC values range from 0.662 to 0.775. These results show that the 22-gene signature accurately predicted response to chemotherapy in both datasets.

Additional examples show logistic regression results for different subtypes of breast cancer considered independently. For example, such data demonstrates results for breast cancer molecular subtypes including ER-positive, ER-negative, luminal B and basal-like. (The luminal B subtype is a subset of ER-positive breast cancers and basal-like is subset of ER-negative breast cancers.) The latter class predominantly includes patients of the triple negative treatment group. ER status was determined by standard clinical testing. The assignment of luminal B and basal-like molecular class of tumor samples in the extended dataset of Hess et al. was performed using the intrinsic gene set of 300 genes. 263 of these genes were translated onto Affymetrix HG-UI 33A GeneChips and expression profiles were organized by hierarchical clustering with Pearson metric. Clusters were identified as: Luminal A=high ESR1, low AURKA; Luminal B=high ESR1, high AURKA; HER2+=high ERBB; Basal-like=low ESR1, high KRT5.

Table 6 shows results of logistic regression using expression levels of genes of the 22-gene signature to predict response to chemotherapy in 243 patients of Popovichi et al. In this example, the model (which is referred to as Model 1 or M1) was trained on all 243 patient samples and then tested on the specific subtypes listed. The model that resulted in the best results across patient subgroups is highlighted in yellow.

TABLE 6
Results of logistic regression using expression levels of genes of the 22 genes
trained on the set of all patients (M1) to predict response to chemotherapy in patients of
Dataset A (Popovichi et al.).

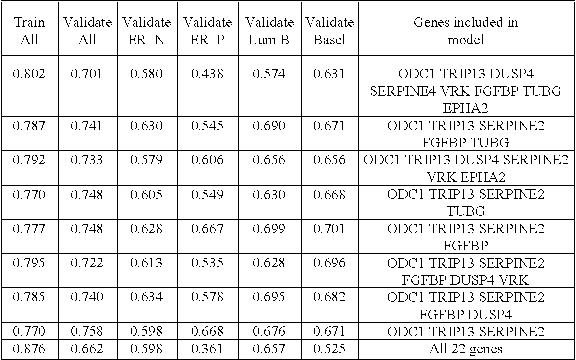

Subsequently it was tested whether adding subtype information to the 22 gene expression levels would improve response prediction (M2). To add subtype information, it was specified whether the sample was classified as ER-positive, ER-negative, luminal B or basal-like. Results showed that the inclusion of subtype information improved the prediction of response for the class of all tumors, but had no impact on any of the subclasses (Table 7). Inclusion of subtype information increased the AUC for prediction of all tumors from 0.748 (Table 6) to 0.825 (Table 7). For all other classes tested, the inclusion of subtype did not markedly increase ADC's. The model that resulted in the best results across all subtypes is highlighted in yellow.

TABLE 7
Results of logistic regression using expression levels of the 22 genes plus subtype
information trained on the set of all patients (M2) to predict response to chemotherapy in
patients of dataset A (Popovichi et al.).

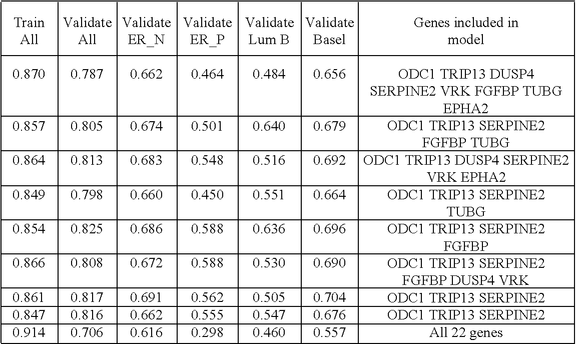

It was subsequently tested whether training the model on a specific subtype of patients would affect predictive outcome. The model M6-N was first trained on data for patients with ER-negative tumors. Results are tabulated (Table 8) and show that for each gene set tested training on ER-negative patients improved AUC in comparison to training on all patients for predictions on ER-negative patients. Surprisingly, these results showed that training on ER-negative patient's samples also improved the predictions for ER-positive patients for the gene combination of ODC1, TRIP13, SERPINE2, and FGFBP.

TABLE 8
Results of logistic regression using expression levels of the 22 genes trained on ER-
negative patients of Dataset B (M6-N) to predict response to chemotherapy in Dataset A
(Popovichi et al.).

| Train | All | ER_N | ER_P | Lum B | Basel | Genes included in model |
|---|---|---|---|---|---|---|
| 0.748 | 0.620 | 0.622 | 0.453 | 0.600 | 0.623 | ODC1 TRIP13 DUSP4 SERPINE2 |
| | | | | | | VRK FGFBP TUBG EPHA2 |
| 0.690 | 0.735 | 0.661 | 0.571 | 0.727 | 0.661 | ODC1 TRIP13 SERPINE2 FGFBP |
| | | | | | | TUBG |
| 0.744 | 0.640 | 0.657 | 0.534 | 0.647 | 0.661 | ODC1 TRIP13 DUSP4 SERPINE2 |
| | | | | | | VRK EPHA2 |
| 0.655 | 0.756 | 0.632 | 0.531 | 0.693 | 0.677 | ODC1 TRIP13 SERPINE2 TUBG |
| 0.685 | 0.721 | 0.665 | 0.714 | 0.756 | 0.682 | ODC1 TRIP13 SERPINE2 FGFBP |
| 0.730 | 0.645 | 0.637 | 0.555 | 0.685 | 0.655 | ODC1 TRIP13 SERPINE2 FGFBP |
| | | | | | | DUSP4 VRK |
| 0.714 | 0.691 | 0.693 | 0.588 | 0.700 | 0.698 | ODC1 TRIP13 SERPINE2 FGFBP |
| | | | | | | DUSP4 |
| 0.659 | 0.765 | 0.632 | 0.624 | 0.736 | 0.689 | ODC1 TRIP13 SERPINE2 |
| 0.901 | 0.543 | 0.527 | 0.390 | 0.299 | 0.517 | 22 genes |

Subsequently the outcome of training the model on patients with ER-positive tumors (M6-P) was tested. Results are tabulated (Table 9) and show that for each gene set tested, training on ER-positive patients did not improve predictions in comparison to training on all patients. This unexpected result may reflect the small number of responsive patients in this breast cancer subset. The model that resulted in the best prediction results for each subtype is highlighted.

TABLE 9
Results of logistic regression using expression levels of the 22 genes trained on ER-
positive patients of Dataset B (M6-P) to predict response to chemotherapy in Dataset A
(Popovichi et al.).

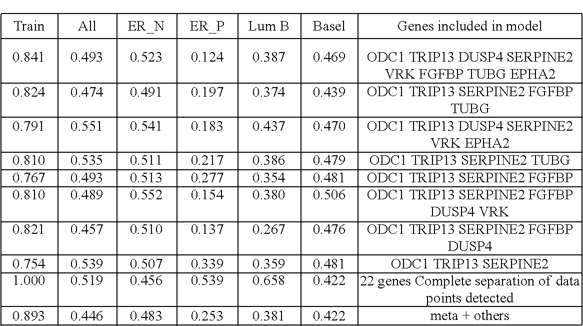

Since our results for the inclusion of subtype information improved the prediction of response for the class of all tumors, we next tested the outcome of adding expression levels of three molecular subtype classifier genes, ESR1, HER2, and CAD3 to expression levels of the 22 genes to train models (M9) was tested. The objective here was to test whether gene expression parameters could be included within the test such that externally provided parameters, such as clinical ER-status or HER2 status, would not need to be taken into account to predict chemotherapy response. The three molecular classifier genes were selected from the intrinsic gene set of Hu et al., as they represented the center genes for the major gene clusters in our cluster analysis of the TFAC dataset of Popovici et al (Dataset B). Hence these expression levels of these genes distinguish between the molecular subtypes luminal AB, Her2+ and basal-like. Results of logistic regression are tabulated (Table 10) and show modest increases for several subsets. The model that resulted in the best AUC results for each subtype is highlighted in gray. Significantly, the additional of the three classifier genes improved performance of the 22 gene signature as well as the addition clinical subtype information. Hence addition of these genes to the 22 genes provides a method where externally provided parameters, such as clinical ER-status or HER2 status, would not need to be taken into account to predict chemotherapy response.

TABLE 10
Results of logistic regression using expression levels of the 22 genes trained on all
patients of Dataset A with expression data for 3 classifier genes added (M9) to predict
response to chemotherapy in Dataset B (Popovichi et al.).

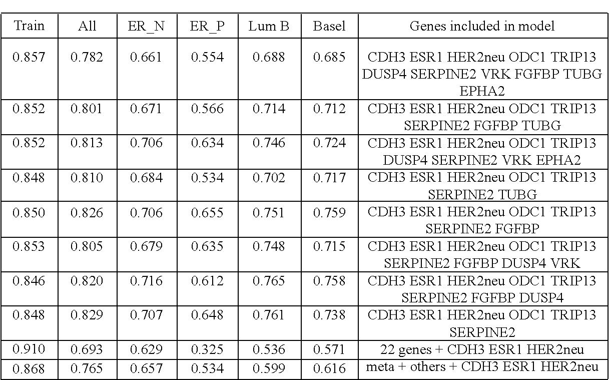

Finally the outcome of adding clinical parameters (including ER status, HER2 status, tumor size, tumor grade, patient age, patient node status, and patient race) to expression levels of 22 genes and three molecular subtype classifier genes to models to train response prediction (M10, M11, and M12) was tested. Results for all models are tabulated for comparison (Table 11). The model that resulted in the best AUC results (+/−0.02) for each subtype is highlighted.

TABLE 11
Results of logistic regression comparing the specified models to predict
response to chemotherapy in Dataset A
(Popovichi et al.).

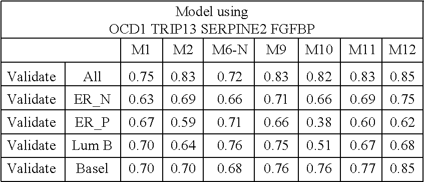

M1: 22 gene signature
M2: M1 + subtype
M6-N: M1 trained over ER negative only
M9: classifier genes CDH3, ESR1, and HER2/neu added
M10: clinical data
M11: clinical plus 22 genes plus subtype
M12: add 3 classifier genes to M11

In summary, the optimum prediction of response by the 22 signature in different subsets of patients required the application of different logistic regression models. Also, results for model 2 (M2), which tested the addition of the three molecular subtype classifier genes, ESR1, HER2, and CAD3 to the 22 gene signature, showed that these genes specifically improved response prediction when all breast cancer subtypes are considered together. These genes did not improve prediction when homogenous subtypes were considered. The addition of the three classifier genes to the 22 genes provides a method where externally provided parameters would not need to be taken into account to predict chemotherapy response. And finally, while a subset of the 22 genes including the four genes ODC1, TRIP13, SERPINE2, and FGFBP generally worked optimally for all patient subtypes and models, some specific models and subtypes performed optimally with different subsets of the 22 genes.

In one embodiment, adding classifier genes to the signature genes improved the predictive ability of the signature.

In yet another embodiment, clinical parameters may predict response well in the heterogeneous set of all patients but not in subsets, especially ER-positive and luminal B patients.

In yet another embodiment, Model M12, which included the 22 genes, clinical parameters, and three classifier genes, was highly predictive for ER-negative and basal-like tumors (0.75 and 0.85, respectively).

### Example 4

A chemotherapy response test to guide the selection of one chemotherapy regimen over another based a 22 gene signature: A critical challenge of breast cancer research is to reduce the impact of current aggressive therapies on the quality of life and to provide individualized treatment options. Invasive breast cancer affects an estimated 182,460 women annually in the United States and 1.3 million women worldwide. Embodiments of the present disclosure are directed to developing a chemotherapy response test for breast cancer patients with the ability to guide the selection of one chemotherapy regimen over another based on the prediction of a patient's responsiveness. This test is based on expression levels of a signature of 22 genes.

Key aspects of this project include the identification of a series of different algorithms or models through which the 22 gene signature can be applied to determine a patient's responsiveness to different chemotherapies (Multiple models), and the establishment of the range of chemotherapies to which each of these different algorithms can predict response (Chemotherapy specificity).

Multiple models: In the case where different tests (i.e. algorithms or models) can determine response to different chemotherapies, these tests can then be used together to identify the optimum method of treatment for a given patient. For example, if a test predicts response to Taxol, another test predicts response to Cisplatin and a third test predicts response to Anthracycline, then the application of all three of these tests together will allow the guidance of optimum treatment selection.

Embodiments of the present disclosure are directed to a novel approach that a single gene signature may be applied in multiple ways to predict different outcomes by using different algorithms or models. A 22 gene signature may accurately predict response to taxol-based combination chemotherapy in multiple breast cancer clinical subgroups, including ER-positive, ER-negative, luminal B and basal-like. It has further been shown that different models accurately predict response in the different subtypes. The optimized models for each subtype are different and neither can accurately predict response for the other subgroup.

Chemotherapy specificity: The chemotherapy specificity of a given chemotherapy response test is the full list of chemotherapy agents for which that test predicts response. If a patient is predicted to be non-responsive by one chemotherapy response test, in order to know what treatment to recommend to that patient as an alternative treatment, one needs to either have a prediction of chemotherapy responsive to a different chemotherapy or needs to define the chemotherapy specify of the response prediction test. Knowledge of the range of chemotherapies whose response is predicted by a given test will allow the recommendation of alternatives that are not included with in this group of chemotherapies. Since knowledge of the chemotherapy specificity of the test will assist in defining its clinical utility, methods to test the feasibility of applying the 22-gene signature to predict response to nontaxol cytotoxic chemotherapies are described herein. It is proposed to collect a dataset of estrogen receptor-negative (ER-negative) patients treated with platinum-based combination chemotherapy and to test the accuracy of the signature using quantitative RT-PCR (qRT-PCR). ER-negative breast cancer constitutes 40% of all breast cancer patients and there is currently no in vitro diagnostic on the market to assist in guiding chemotherapy treatment decisions for these patients.

### Example 5

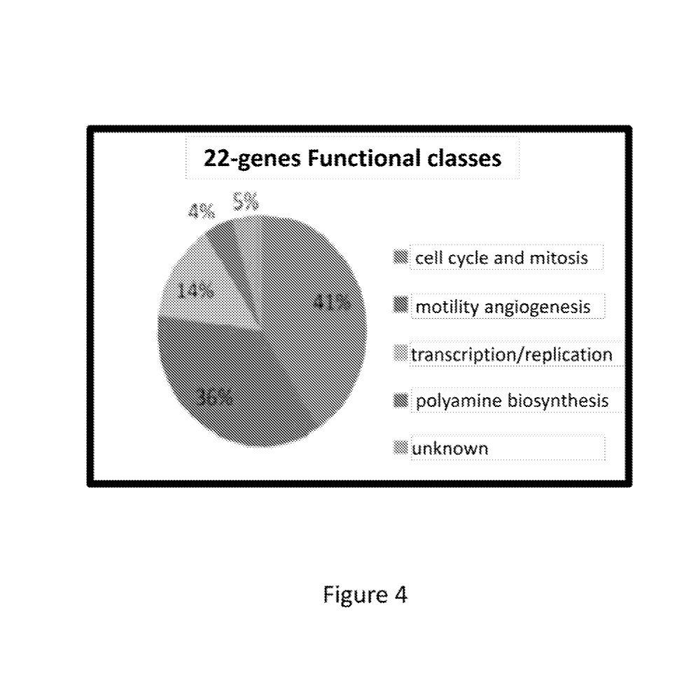

Different logistic regression models predict taxol-based chemotherapy response in different clinical subgroups: The 22-gene signature was selected in a well-defined cell culture model of nonmalignant human mammary epithelial cell morphogenesis in three dimensional laminin-rich matrix (3D lrECM) (Fournier, Martin et al. 2006). This system recapitulates key characteristics of the formation and maintenance of normal human breast ductal units (Barcellos-Hoff, Aggeler et al. 1989). Formation and maintenance of these units are disrupted in breast cancer. Genes whose expression changed during a time course of growth arrest and acquisition of basal polarity in two different isolates of human mammary epithelial cells in lrECM were identified using Affymetrix microarrays. Of 65 differentially expressed genes, 22 were down regulated and associated with breast cancer prognosis. Prognosis association was validated in 699 patients from three independent datasets (Martin, Patrick et al. 2008). This unsupervised method of signature discovery distinguishes the BIOARRAY signature from most other cancer signatures, which have been selected by supervised methods and specific patient training sets. We hypothesize that this signature has potential to more accurately classify across independent patient sets. The 22 genes signature includes functional gene classes including cell cycle, motility, and angiogenesis (see, for example, FIG. 4). Identities include: EPHA2, FGFBP1, TNFRSF6B, FOXM1, CDKN3, RRM2, CKS2, ASPM, AURKA, CEP55, TRIP13, TUBG1, ZWILCH, VRK1, SERPINE2, ODC1, CAPRIN2, ACTB, ACTN1, CAPG, DUSP4, EIF4A1.

It is hypothesized that breast tumors with high expression levels of the 22 genes, which were down regulated during breast ductal units morphogenesis, were high proliferative tumors and therefore more likely to respond to antimitotics such as taxanes. To assess ability of the 22-gene signature to predict response to taxane-based chemotherapy in breast cancer, expression levels in 243 breast cancer patients treated with neoadjuvant taxane-based chemotherapy were studied in a published microarray dataset (Hess, Anderson et al. 2006). This dataset was assembled at MD Anderson Breast Cancer Center from fine-needle aspirates obtained from patients with stage I-III breast cancer. Biopsies obtained before chemotherapy with paclitaxol (most patients received an anthracycline combination regimen FAC or FEC in addition to taxol) were assessed for pathological complete response (pCR) after surgery. We assigned breast cancer subtypes by hierarchical clustering using published genes (Perou, Sorlie et al. 2000; Hu, Fan et al. 2006; Parker, Mullins et al. 2009). Clusters were identified as Luminal A=high ESR1, low AURKA; Luminal B=high ESR1, high AURKA; Her2-positive=high HER2; Basal-like=low ESR1, high KRT5.

To predict the probability of response to chemotherapy, logistic regression was applied, a robust approach that fits data to an S shaped curve. Analyses performed using SAS software generated models based on expression levels of the 22 genes using three-fold cross-validation. Results for all datasets and specific subtypes of breast cancer are presented as area under the curve (AUC) statistics (Table 6). Statistically significant results show that the 22-gene signature accurately predicted response to chemotherapy in all breast cancer subtypes tested. The 22 gene signature is a particularly good predictor of response in the subclasses of ER-negative (0.75) and triple negative (0.85) breast cancer. Prediction among ER-negative breast cancers has previously been described as a challenge; even among classifiers specifically selected from the same dataset used here, validation AUCs for ER-negative cancers only ranged from 0.34 to 0.62 (Popovici, Chen et al, 2010).

In addition to studying the 22 gene signature as a set, univariate analysis was also performed. The ability of individual genes to discriminate responders and non-responders in different subtypes of breast cancer was assessed. Results showed interesting differences. Signature genes that function to regulate cell cycle and cell proliferation were generally significant discriminators of response in ER-positive cancers, while signature genes that involved in signal transduction were generally significant discriminators of response in ER-negative cancers.

### Example 6

Results showing different logistic regression models applied to the 22 gene: Results presented herein demonstrate that different logistic regression models can be applied to the 22 gene signature to accurately predict taxol-based chemotherapy response in different clinical subgroups. It is a novel finding that a single gene signature can be applied in multiple ways to predict different outcomes.

It is shown that the 22 gene signature can accurately predict response to taxol-based combination chemotherapy in multiple breast cancer clinical subgroups, including ER-positive, ER-negative, luminal B and basal-like. A series of 12 different logistic regression models using the 22 gene signature are developed and tested for their ability to predict response to chemotherapy in a series of breast cancer subtypes. These results are summarized (Table 11).

For the subtype of ER-negative breast cancers, model M12 was most accurate. This model was trained over all samples using expression levels of the 22 genes plus clinical data plus expression levels of three classifier genes.

For the subtype of ER-positive breast cancers, model M6-N was most accurate. This model was trained over ER-negative breast cancer samples and using expression levels of the 22 genes.

For the subtype of luminal B breast cancers, models M6-N and M9 were most accurate. Model M6-N was trained over ER-negative breast cancer samples and using expression levels of the 22 genes. Model M9 was trained over all samples using expression levels of the 22 genes plus expression levels of three classifier genes.

For the subtype of basal-like breast cancers, model M12 was most accurate. This model was trained over all samples using expression levels of the 22 genes plus clinical data plus expression levels of three classifier genes.

For the combined set of breast cancers from all subclasses, several models showed similar accuracy, including M2, M9, M10, M11 and M12.

Hence, the optimized models for each subtype tend to be different and do not accurately predict response for other subgroups.

### Example 7

Chemo specificity of the 22 gene response prediction signature: The example studies the ability of the 22-gene signature to predict response to platinum-based combination chemotherapy for ER-negative breast cancer by using microfluidic quantitative RT-PCR. The criterion for positive outcome is an assay that significantly outperforms clinical parameters in terms of AUC, sensitivity, and specificity (ROC analysis; p<0.05). This example includes the following steps:

Obtain 50 biopsy samples: These are retrospective, formalin-fixed, paraffin-embedded tissue biopsies obtained before any treatment from ER-negative breast cancer patients in a neoadjuvant treatment setting. Patients will have been treated with platinum-based combination chemotherapy. All samples are annotated with information of pathological complete response information and clinical parameters. Expression levels of the 22-genes in the 50 samples are measured using microfluidic qRT-PCR. The results are analyzed using logistic regression and ROC curves to determine the ability of the signature to predict response to platinum-based combination chemotherapy treatment using pathological complete response as the end point. The method is used to predict respond to platinum-based combination chemotherapy treatment using pathological complete response as the end point.

The 22-gene signature is used to accurately predict response to non-taxol chemotherapy in ER-negative breast cancer patients. For these patients, systemic chemotherapy improves the odds of disease-free and overall survival whereas hormonal therapy is not helpful. For the subgroup of Her2-positive patients, therapies that target Her2 are highly effective. But for triple negative cancers, (ER-negative, PR-negative, Her2-negative), which lack a target for therapy, systemic chemotherapy with a standard cytotoxic agent is the single major treatment option (Schneider, Winer et al. 2008). Ongoing clinical trials indicate that new therapies that target PARP, src, EGFR and VEGF may add more options for ER-negative patients in the future (Carey, Winer et al. 2010; Silver, Richardson et al. 2010). Since studies have found that patients with triple-negative cancers experience shorter disease-free and overall survival times than patients with other types of breast cancer, guiding effective treatment options is highly important. Neoadjuvant studies indicate ER-negative tumors respond well to anthracycline-based or anthracycline and taxane-based chemotherapy. Other agents studied include DNA-damaging agents (i.e. platinum compounds), because a large percentage of ER-negative patients carry germ line mutations in BRCA1, which plays an important role in DNA-damage repair. These compounds include cisplatin, carboplatin and irinitecan. While ER-negative tumors have been found to have a higher likelihood of response to cytotoxic chemotherapy than ER-positive tumors, a complete response to chemotherapy is more important in this group where there is no targeted therapy available. Patients must experience a pathological complete response (pCR) to chemotherapy with no residual tumor cells remaining for a long relapse free survival (Rouzier, Perou et al. 2005). For women with ER-negative cancer, strategies to maximize chemotherapy effectiveness have the potential to reduce relapse and mortality, and, by avoiding ineffective treatments, to increase quality of life and reduce health care costs. The predicted response is determined based upon a multivariate gene expression signature that accurately predicts response to chemotherapy in ER-negative breast cancer.

### Example 8

### Prediction of Taxol Combination (TFAC) Versus Non-Taxol Combination (FAC)

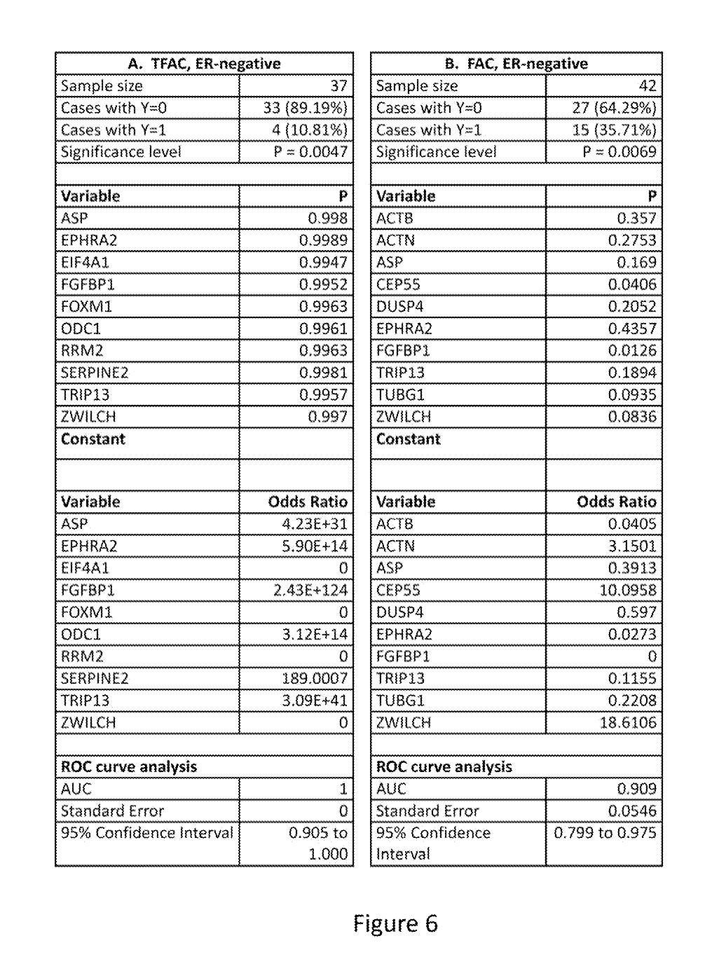

A comparison logistic regression output results was performed by using MedCalc software to assess the ability of the 22 gene signature to predict response to taxol combination (TFAC) versus non-taxol combination (FAC) chemotherapy response in breast cancer using logistic regression. This study used a simplified version of logistic regression, where AUCs were calculated on the training set and no test sets or cross validation is applied. The objective of this experiment was to test if the 22 gene model that predicts TFAC response also predicts FAC response. Microarray data from a randomized trial with two arms, TFAC and FAC, were collected at MD Anderson Cancer Center (Tabchy et al 2010). The gene signature was optimized by sequentially omitting from the analysis genes with lowest p values. Discovery logistic regression results from 37 ER-negative samples from patients treated with TFAC are shown (FIG. 6, panel A). Resulting perfect AUC of 1.00 indicates an ideal prediction test that is statistically significant (p<0.0047). Discovery logistic regression results from 42 ER-negative samples from patients treated with FAC are shown (FIG. 6, panel B). The resulting AUC of 0.909 indicates an excellent test that is statistically significant (p=0.0069). The results indicate that expression levels of the 22 genes allow accurate prediction of response to both TFAC and FAC. Interestingly; however, the optimized models differ markedly. Only 50% of optimized genes are overlapping and for these overlapping genes, odds ratio vary greatly between the two datasets. Hence, it is concluded that the 22 gene signature has the potential to accurately predict response to both taxol combination chemotherapy and non taxol combination chemotherapy by using logistic regression different models.

### Example 9

### Prediction of Taxol Combination (TFAC) Versus Cisplatin

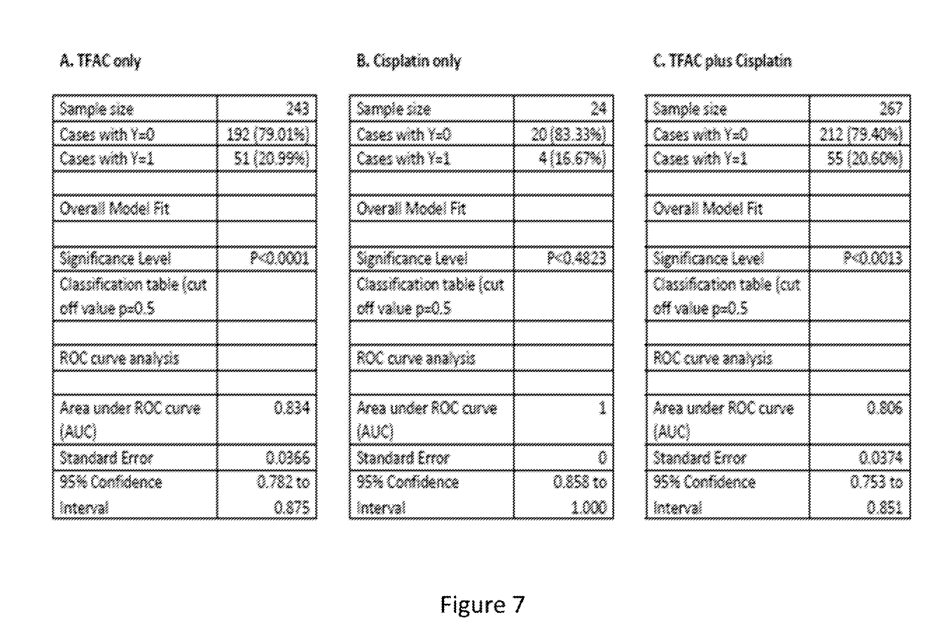

We have compared the ability of the 22 gene signature to predict response to taxol combination is compared to a single agent cisplatin chemotherapy response in breast cancer using logistic regression. This study used a simplified version of logistic regression, where AUCs are calculated on the training set and no test sets or cross validation is applied. The objective of this experiment was to test if the same 22 gene model that that predicts TFAC response also predicts cisplatin response. Microarray data for the 24 biopsy samples from patients subsequently treated with neoadjuvant cisplatin were collected at the Dana Farber Cancer Institute (Silver et al 2010). Discovery logistic regression results from 243 samples from patients treated with TFAC (Popovici et al 2010) are shown (FIG. 7, panel A). The resulting AUC of 0.834 indicates a very good prediction test that is statistically significant (p<0.0001). Discovery logistic regression results from 24 samples from patients treated with cisplatin (Silver et al 2010) are shown (FIG. 7, panel B). The resulting AUC of 1.0 indicates a perfect test, though the number of samples was too low to achieve statistical significance (p=0.4823). Discovery logistic regression analysis of the combined datasets of TFAC and cisplatin was performed to test whether the same model was applicable to both datasets. An AUC of 0.806 was obtained (FIG. 7, panel C), which is less than the results of 0.834 obtained for the TFAC dataset alone, though it is not outside of the 95% confidence limits. In summary, though samples numbers were not large enough to obtain significance, these results appear to suggest that expression levels of the 22 genes allowed the prediction of response to both cisplatin and TFAC. Importantly, these predictions appeared to use different models. Hence, if a patient were responsive to one chemotherapy treatment but nonresponsive to the other, it appears that the 22 genes could potentially distinguish between these options and identify the better treatment for the patient.

### Example 10

### Methods

22-gene signature is evaluated to predict response to cytotoxic chemotherapies for breast cancer using microfluidic quantitative RT-PCR. The criterion for acceptance is an assay that significantly outperforms clinical parameters in terms of AUC, sensitivity, and specificity (ROC analysis; p<0.05). Approximately 50 biopsy samples are obtained. The samples are retrospective, formalin-fixed, paraffin-embedded tissue biopsies obtained before treatment of ER-negative breast cancer patients in a neoadjuvant treatment setting. Patients will have been treated with a platinum-based combination chemotherapy regimen. All samples are annotated with response information and data on clinical parameters.

Expression levels of the 22-genes in the 50 samples are measured using microfluidic qRT-PCR. RT-PCR results are analyzed using logistic regression and ROC curves to determine ability of the signature to predict response to platinum-based chemotherapy using pCR as an end point. using qRT-PCR shows that the 22-gene signature accurately predicts response to platinum-based combination chemotherapy for ER-negative breast cancer patients.

Breast cancer biopsies are analyzed by microfluidic quantitative RT-PCR using validated probes and primers. Reverse transcription and PCR reactions are performed as recommended. Logistic regression is used to predict the probability of response. Analyses is performed using SAS software and results presented as AUC statistics. Microfluidic RT-PCR. RT-PCR is the most sensitive technique for mRNA detection and quantification currently available. It is a robust sensitive tool used for routine clinical diagnostics. It is faster, cheaper, and more sensitive than cDNA microarrays. RT-PCR is often used to validate microarray results. Concordance of the microarray with RT-PCR results has been reported to be high (Espinosa, Sanchez-Navarro et al. 2009). Applied Biosystems (Foster City, Calif.) TaqMan Low-Density Arrays (TLDA) is a medium-throughput method for real-time RT-PCR that uses micro fluidics. TLDA cards allow simultaneous measurement of RNA expression for up to 384 genes per card. Wells are custom prepared to include forward and reverse primers (900 nM concentrations) and TaqMan MGB probe (6-FAM dye-labeled, 250 nM). Assays use TLDA cards designed to include probes for each of the 22 genes, 8-10 control reference genes, 4 replicates per gene (standard replicate level for TLDA cards), in 384-well format. Standard, commercial primers are used. Reference controls include tyrosine 3/tryptophan 5-monooxygenase activation protein (YMHAZ), TATAA-box binding protein (TBP), beta-glucuronidase (GUSB) and additional genes. The delta [Ct] method is used to quantify gene expression levels. Inclusion of multiple reference genes (5-10 genes) helps to assure that the mean reference value is consistent across all samples. Relative copy number for two samples (experimental and control) is determined by the difference between Ct values. Relative gene expression quantities (delta delta [Ct] values) are obtained by normalization against reference genes. Non-responding control patients are integral to the dataset. TLDA cards are used and micro fluidic qRT-PCR is performed. Cards are initially evaluated with control samples. Cell line RNAs obtained from the ATCC are used as controls to standardize results over time. All samples are run in triplicate.

Perform RT-PCR of 50 ER-Negative Breast Cancer Samples.

Core biopsies are collected from women age 70 or younger with ER-negative stage I-III breast cancer, independent of lymph node status. Biopsy samples are collected before starting preoperative chemotherapy with a platinum-based combination chemotherapy regimen. All patients will sign an informed consent for voluntary participation. Samples are selected without regard to outcome. Pathological complete response (pCR) is used as the study end point and is defined as no residual invasive cancer in breast or lymph nodes as assessed by pathology evaluation. Residual in situ carcinoma without an invasive component is considered a pCR.

Yields of greater than 100 ug total RNA are required for microfluidic RT-PCR. Previous studies report yields of at least 1 g from most tumor samples (Hess, Anderson et al. 2006). Samples are assessed by a pathologist to determine percent tumor and only those containing at least 50% neoplastic cells are included in the study. RNA is purified by standard methods. Total RNA is extracted by RNAeasy Mini Kit (Qiagen, Hilden, Germany) and quality checked by Bioanalyzer 2100 (Agilent Technologies, Palo Alto, Calif.).

A priori power analysis allows calculation of sample size required for a two group study. Power analysis based on expression levels and response prediction by the 22 genes in the microarray dataset of Chang, et al. (Chang, Wooten et al. 2003) indicates a requirement for a minimum of 49 samples for significance at the 95% confidence level. Though this study included patients who had received docetaxel chemotherapy (data not shown), it is hypothesized similar sample variability will apply to response prediction in a cross set of non-taxane treated patients. Hence, this example uses 50 samples. Samples are purchased through Analytical Biosciences Inc. (ABS). All samples will have complete annotated clinical information including chemotherapy response. All information is compliant with Health Information Privacy Act of 1999 (HIPA).

Statistical tests are applied to the RT-PCR determined expression levels of the 22 genes and control genes. Performance of the assay is evaluated by ROC analysis and logistic regression using a model that will be defined from a subset of 80% of patients (training set; 40 patients). AUC's are determined by a standard 5-fold cross validation of the remaining 20% of samples (test set; 10 samples) where the hold out is rotated to be different for each validation. The AUC will reflect the quality of the assay and a minimum value of 0.60 and a p-value of <0.05 will be required.

### Example 11

### Microarray Datasets

This study used at total of five microarray datasets from a total of 610 patients. Gene discovery: A time course of acini formation in 3D culture was used for discovery of the 22 genes (Fournier, et al., 2006 Cancer Res, 66:7095). Microarrays were Affymetrix HG-U133A and have been publicly archived at GEO GSE8096. Evaluation of response prediction: Three overlapping datasets were used to evaluate the ability of the signature to predict chemotherapy response. All were obtained at MD Anderson Medical Center from fine-needle tumor aspirates from patients with stage I-III breast cancer obtained before neoadjuvant combination treatment with paclitaxel, 5-fluorouracil, cyclophosphamide and doxorubicin (TFAC) followed by surgical resection. Response was categorized as pathological complete response (pCR, i.e. no residual invasive cancer in breast or nodes) or residual disease (RD). Microarrays were Affymetrix HG-U133A. The dataset of Hess, et al., 2006 J Clin Oncol, 24:4236 included 133 patients, while datasets of Popovici, et al., 2010 Breast Cancer Res 12:R5 included 243 patients (GEO GSE20194) and Tabchy, et al., 2010, Clin Cancer Res 16: 5351-5361 included 79 patients (GEO GSE20271). Evaluation of prognosis: Prognosis evaluation used a dataset of 286 lymph node negative patients with 5 year relapse as an endpoint (Wang et al., 2005, Lancet 365:671-679) (GEO GSE2034). Molecular classes for tumors in dataset of Popovici 2010, were determined using the intrinsic gene set of 300 genes (Hu, et al., 2006). Expression values were organized by hierarchical clustering with Pearson metric. Clusters were identified as: Luminal A=high ESR1, low AURKA; Luminal B=high ESR1, high AURKA; HER2+=high ERBB; Basal-like=low ESR1, high KRT5.

Results: Gene sets down-regulated during acini formation are enriched in genes associated with response to TFAC chemo. Gene sets were selected that were differentially regulated during a time course of morphogenesis of non-malignant breast epithelial cells in laminin-rich 3-dimensional culture. These gene sets are tabulated below and include down regulated early, down regulated late, up regulated early, up regulated late, down regulated, up regulated, early, late, all differentials and all genome. Data for 840 random lists of 22 genes are also tabulated. The total number of genes (n) in each set are listed. Also listed are the number of genes in each set that were significantly associated with response to TFAC chemotherapy using pathological complete response (pCR) as an endpoint. The set with the highest proportion of response associated genes is the down late gene set for which 55% of genes were associated with response (t-test<0.05). For 840 random gene sets of 22 genes each, an average of only 17% of genes were significantly associated with response. Hence, the gene sets down regulated during morphogenesis of breast epithelial cells in 3D culture were significantly enriched in chemotherapy response associated genes. The results are shown in the following table.

| | | | | Ability to stratify | |
|---|---|---|---|---|---|
| Temporal | Total | Genes significantly* | | by response** | |
| expression | genes | associated with pCR | | (Chi² | |
| pattern | (N) | (N) | (%) | coefficient) | (p-value) |
| Down early | 6 | 3 | 50% | 0.248 | 0.0005 |
| Down late | 22 | 12 | 55% | 0.364 | <0.000001 |
| Up early | 21 | | 5% | — | — |
| Up late | 11 | 2 | 18% | — | — |
| Down | 28 | 15 | 54% | 0.241 | 0.00059 |
| Up | 32 | 3 | 9% | — | — |
| Early | 27 | 6 | 22% | — | — |
| Late | 33 | 14 | 42% | 0.344 | <0.000001 |
| All differentials | 60 | 22 | 37% | 0.283 | <0.000001 |
| All genome | 22282 | 3766 | 17% | — | — |
| 840 random lists | 22 | 3.73 | 17% | — | — |
| | | (max 6, min 0) | | | |

*t-Test, p < 0.05, was used to evaluate genes associated with response (pCR) in the TFAC response microarray dataset of Popovici et al. 2010 (243 patients);
**Hierarchical clustering was used to stratify patients from the TFAC response microarray dataset of Hess et al. 2006 (133 patients). Chi2 coefficient and Fisher's Exact p-values are tabulated.

22-gene signature stratified breast cancer subtypes by response to TFAC chemotherapy and outperformed clinical parameters. For six breast cancer subtypes, logistic regression was used to assess the ability of the 22 gene signature to predict response to TFAC chemotherapy. AUC values are listed below. Comparison values are listed for five clinical parameters. For each subtype, the 22 gene signature outperformed all clinical parameters.

AUC Value* (n)

| Breast Cancer | | | Node | ER | Tumor | Tumor | |
|---|---|---|---|---|---|---|---|
| Subtype | 22-genes | | status | status | size | grade | KI67 |
| ER Positive | 0.723 | (208) | 0.490 | — | 0.475 | 0.689 | 0.650 |
| ER Negative | 0.744 | (145) | 0.481 | — | 0.525 | 0.689 | 0.635 |
| HER2 Positive | 0.772 | (42) | 0.513 | — | 0.525 | 0.316 | 0.350 |
| Triple Negative | 0.718 | (95) | 0.490 | — | 0.525 | 0.689 | 0.650 |
| (ER, PR, HER2 | | | | | | | |
| negative) | | | | | | | |
| Luminal B | 0.75 | (50) | — | — | — | — | — |
| Basal-like | 0.85 | (69) | — | — | — | — | — |
| All subtypes | 0.830 | (353) | 0.478 | 0.760 | 0.525 | 0.689 | 0.650 |

*AUC values for 22-gene signature test and clinical parameters were determined by logistic regression with 3-fold cross validation using the datasets of Popovici et al. 2010 and Tabchy et al. 2010.

### Example 12

### Selecting a Treatment Based Upon Relative Scores

This example shows results of a chemotherapy response prediction test (RPT) applied to 24 triple negative breast cancer patients from a clinical study reported by Silver et al (2010) and performed at the Dana Farber Cancer Institute (Example 12, Table 1). Using the reported microarray-measured gene expression levels, we applied the RPT, which includes a series of algorithms each of which predict response to a different chemotherapy agent or regimen in the context of triple negative breast cancer. The algorithms predict response to a taxol combination regimen (TFAC), an anthracycline combination regimen (FAC), and a platinum agent (cisplatin). The output of the RPT is a series of predictive scores from each algorithm. These are listed in rows for each of the 24 patients.

TABLE 1
Results of the BIOARRAY chemotherapy response
prediction test (RPT) applied to 24 triple
negative breast cancer patients from a clinical study
reported by Silver et al (2010).

| | | TFAC | FAC | Cisplatin | Cisplatin |
|---|---|---|---|---|---|
| Patient | Age | Score | Score | Score | response |
| 1 | 59 | 75 | 85 | 5 | RD |
| 2 | 49 | 94 | 12 | 7 | RD |
| 3 | 39 | 72 | 100 | 87 | pCR |
| 4 | 68 | 96 | 3 | 6 | RD |
| 5 | 44 | 98 | 2 | 25 | RD |
| 6 | 62 | 97 | 9 | 60 | pCR |
| 7 | 39 | 40 | 48 | 4 | RD |
| 8 | 51 | 62 | 62 | 3 | RD |
| 9 | 43 | 88 | 4 | 3 | RD |
| 10 | 41 | 91 | 0 | 8 | RD |
| 11 | 53 | 98 | 38 | 8 | RD |
| 12 | 43 | 30 | 90 | 5 | RD |
| 13 | 57 | 74 | 8 | 2 | RD |
| 14 | 45 | 84 | 2 | 8 | RD |
| 15 | 52 | 87 | 62 | 10 | RD |
| 16 | 59 | 67 | 19 | 3 | RD |
| 17 | 67 | 89 | 2 | 5 | RD |
| 18 | 29 | 25 | 4 | 4 | RD |
| 19 | 50 | 98 | 100 | 39 | pCR |
| 20 | 40 | 67 | 44 | 3 | RD |
| 21 | 39 | 100 | 0 | 2 | RD |
| 22 | 63 | 66 | 9 | 5 | RD |
| 23 | 60 | 84 | 4 | 3 | RD |
| 24 | 44 | 26 | 1 | 95 | pCR |

RPT scores run from 1 to 100, with 100 being the best predicted response.
RD = residual disease;
pCR = pathological complete response
TFAC = taxol, fluorouracil, anthracycline, and cyclophosphamide;
FAC = fluorouracil, anthracycline, and cyclophosphamide

The three algorithms used to generate scores in the example shown in Example 12, Table 1 are tabulated (Example 12, Table 2). These algorithms were developed by applying logistic regression to the training set for variables including expression values for a set of 22 genes, a series of specified clinical parameters, and expression values of three classification control genes. Logistic regression for the TFAC and FAC algorithms used the genome-wide microarray dataset of Tabchy et al (2). Logistic regression for the cisplatin algorithm used the genome-wide microarray dataset of Silver et al (3). All algorithms were convergent. AUC values were 0.746, 0.939, and 0.950, for TFAC, FAC and cisplatin respectively. AUCs and dataset parameters are tabulated (Example 12, Table 3).

Example 12, Table 2. Algorithms used to generate the scores of Table 1.

| | Breast | |
|---|---|---|
| | cancer | |
| Treatment | subtype | Interpretation Function |
| TFAC | Triple | Score = P = 1/(1 + e^{-1.441+2.036*ESR1-0.716*ODC1}) |
| | negative | |
| FAC | Triple | Score = P = |
| | negative | 1/(1 + e^{-6.176+2.3339*CEP55-10.9738*EPHA2}) |
| cisplatin | Triple | Score = P = |
| | negative | 1/(1 + e^{156+47*ACTN+21*CEP55+55*HER2+36*TRIP13+24*VRK1}) |

Example 12, Table 3. AUCs and dataset parameters for microarray
datasets used to generate TFAC, FAC and cisplatin algorithms.

| | TFAC | FAC | Cisplatin |
|---|---|---|---|
| AUC | 0.746 | 0.939 | 0.950 |
| No. patients | 33 | 25 | 24 |
| pCR | 10 | 3 | 4 |
| RD | 23 | 22 | 20 |

pCR, pathological complete response (responders)
RD, residual disease (non-responders)

Application of the relative score system in the example of Example 12-Table 1 results in the selection of the highest score received for each individual patient. The highest scores for each patient are highlighted/shaded (Example 12-Table 1). These highlighted scores indicate the predicted best treatment for the patient. The RPT scores tabulated in Table 1 include scores for each of TFAC, FAC and cisplatin for each of the 24 patients. Since these patients were all treated with cisplatin only, only the cisplatin response was confirmed in this study. Cisplatin response is tabulated in the far right column (Example 12-Table 1). The taxol combination regimen TFAC is currently the preferred chemotherapy treatment for women with triple negative breast cancer. Approximately 70% of women respond well to taxol combination chemotherapy in large scale clinical trials (4). In agreement with this observed rate, the majority of the 24 patients (16 patients, 67%) were predicted to respond best to TFAC (Example 12-Table 1). Nearly one-third (7 of 24, 29%) were predicted to NOT benefit from the taxol combination TFAC more than the same chemotherapy combination without taxol, FAC. One patient was predicted to benefit equally from FAC and TFAC (patient 8). Five patients were predicted to have more benefit from FAC than TFAC. One (patient 24) was predicted to have more benefit from cisplatin than FAC or TFAC. These results show that the method can be applied to predict a response and predict a preferred treatment option for a subject having breast cancer. The breast cancer can be any breast cancer described herein.

The relative score approach exemplified herein requires that all predictors use the same scale. For example, the scale can be a probability scale that ranges from 1 to 100 and each value indicates the probability that a patient will experience a particular future event. If a scale runs from 1 to 50, or 1 to 5, all predictors to be compared must use the same scale. In the case of the application of the relative score system to the response prediction test, each of the predictors also uses the same system of measurement. For example, each of the algorithms that are compared was developed from the same set of parameters, which includes a set of 22 genes, a series of specified clinical parameters, and three classification control genes. This can be referred to as a 3-D Signature.

A surprising and unexpected result is that the use of “relative score approach” is not influenced by the actual magnitude of an individual patient's scores. As a result, all patients will receive information on the treatment option that is best for them. That is, no patient receives a report that there is no treatment that will be effective. The relative score method can be used to predict a preferred treatment option thereby allowing a patient to avoid a treatment option that is likely not to work as well as another treatment option. This advantage will greatly reduce the stress and strain of deciding on the best course of treatment, which cannot be underestimated. This advantage is surprising and unexpected and has not been previously reported.

### Example 13

### The Cell Organization Signature Predicts Prognosis in Subtypes of Breast Cancer

Using mRNA profiling, we have found that the 22 gene acinar organization signature accurately determines prognosis in subtypes of breast cancer. Previous work showed that the 22 gene signature accurately predicted prognosis for mixed groups that include all subtypes of breast cancer (Fournier et al 2006; Martin et al 2008). These studies used hierarchical clustering applied to three large independent dataset totaling 699 patients. However, these methods did not predict prognosis for homogeneous breast cancer subtypes, including ER-positive and triple negative breast cancers. It was not known why the approach did not extend to prediction in homogenous subtypes. Other research has shown that prediction in homogenous breast cancer subtypes presents a challenge for gene expression signatures (Hess et al, 2009, Popovici et al 2010). Apparently, genes that discriminate between ER-, PR- and HER2-status are abundant and readily separate ER-, PR- and HER2-status. These provide a first level of prognosis and prediction classification within a mixed group. However, identification of ER-, PR- and HER2-status is standard clinical practice (using antibody-based methods) and a current need is to more finely classify patients within the subtypes. It was previously not know how to apply the 22 gene signature to homogenous subtypes of breast cancer.

The acinar signature was discovered by using an approach based on normal breast cell biology by using a culture model in which non-malignant breast epithelial cells recapitulate the process of acinar organization. The acinar organization signature includes 22 genes involved in growth control signaling whose expression levels distinguish different stages of acinar organization (Fournier et al, 2006; Martin et al, 2008). These genes play roles at different points in the signaling network that controls breast cell growth and organization. Unlike other gene signatures that have been identified by using conventional supervised methods, this biologically defined signature is not linked to a particular classification of breast cancer. Rather, the signature includes a multi-functional set of genes from which one can generate different algorithms to accurately predict the behavior of breast cancer cells.

Triple negative breast cancer affects approximately 25,000 women annually in the US. Triple negative patients tend to be young women, under the age of 50, with aggressive tumors (reviewed by Carey et al 2010). The great majority of patients are aggressively treated with systemic conventional chemotherapy. This disease is currently viewed as one that is difficult to stratify. Unlike ER-positive, node-negative breast cancer for which tests exist that can determine a patient's long term prognosis and identify good prognosis patients that will not benefit from adding chemotherapy to their treatment, no prognostic tests exist specifically for triple negative patients. Due to the aggressive nature of the disease, it is especially important to provide triple negative patients with optimal information to guide treatment decisions. Since conventional systemic chemotherapy adversely impacts patient quality of life and is often associated with long term complications, a prognostic test would allow good prognosis patients to forgo treatment that would provide little or no benefit.

Here we address the ability of the signature to predict prognosis in homogeneous sets composed of a single breast cancer subtype, either ER+ or triple negative. Models that determine prognosis in breast cancer were developed by applying logistic regression to biopsy samples reported in the microarray dataset of Wang, et al., 2005. These patients were not treated with systemic chemotherapy and hence their time to relapse is independent of chemotherapy treatment and represents treatment-independent prognosis.

The Wang dataset includes a total of 286 patients, with 209 ER+, 20 HER2+/ER, and 56 triple negative patients. All patients were node negative, received no systemic chemotherapy, and records are annotated with 10 year relapse data. To build optimized models to predict prognosis (relapse), we applied logistic regression with three-fold cross-validation to the acinar signature gene expression levels. Patients were divided into three random equal-sized groups, each combination of two groups was used to train models and the holdout was used for validation. Model-building was manually performed testing all signature genes.

The genes defined for models for each condition are: Prediction of prognosis in ER+ breast cancer: AURKA, EIF4A1, PHA2; Prediction of prognosis in triple negative breast cancer: FGFBP1, ODC1, TUBG

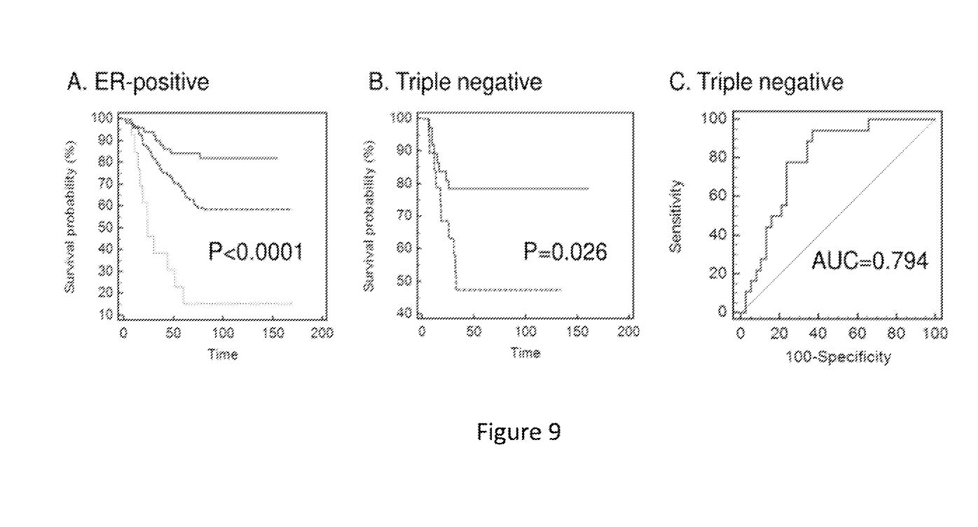

These models were applied to independent validation sets in parallel with the cell proliferation marker gene Ki67. Results show that the acinar signature accurately predicted prognosis (relapse) independent of systemic chemotherapy for both ER-positive and triple negative breast cancers (AUC>0.700) and outperformed the marker gene Ki67 (Table 19; FIG. 9).

TABLE 19
Optimized models using the acinar organization signature
predict prognosis in three breast cancer subtypes. Three-fold cross-
validated AUC values using Wang dataset are tabulated.

| | ER+ | Triple negative |
|---|---|---|
| Acinar signature | 0.707 | 0.717 |
| Ki67 | 0.556 | 0.637 |

FIG. 9 show the prediction of prognosis (relapse) using the acinar signature in patients from the dataset of Wang et al (2005) in breast cancer subtypes. A. Kaplan-Meier analysis for ER-positive (solid blue: p>0.8, dashed brown: 0.8>p>0.2, dotted yellow: p<0.2. B. Kaplan-Meier analysis for triple negative (solid blue: p>0.8, dashed brown: p<0.8). C. ROC graph for triple negative (AUC=0.794, p<0.0001, sensitivity=94.44, specificity=63.16, cutoff=0.2709)

### Example 14

### The Cell Organization Signature Predicts Survival Following Chemotherapy Treatment in Breast Cancer

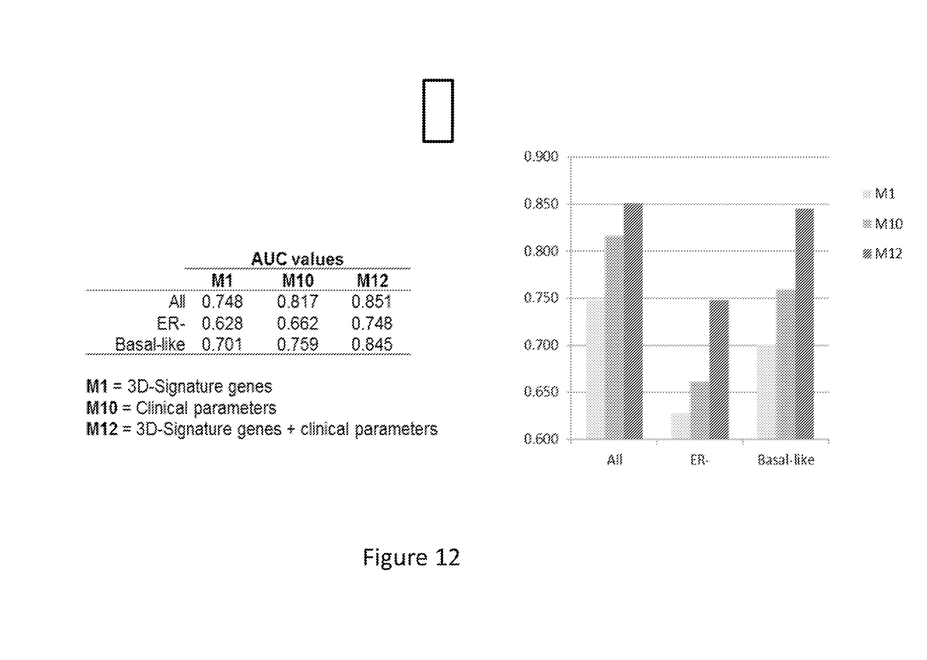

The tests described herein are able to not only predict whether a tumor will respond to chemotherapy, but can also predict a patient's likelihood of long term survival in response to a particular treatment. We have already shown that models derived from the combination of the organization signature genes and clinical parameters accurately predict response to TFAC chemotherapy using pathological complete response (pCR) as an endpoint. In particular, this is shown by the comparison of three optimized models. M12, an optimized model derived from the organization 3-D signature genes plus clinical parameters, outperforms either M1, optimized models derived from the organization genes alone, or M10, an optimized model derived from clinical parameters alone using ROC AUC as a metric (see, FIG. 12). In this example, all AUC values were determined by using logistic regression with three fold cross-validation and microarray data of Hess et al, 2006, which were obtained from fine needle aspirates collected prior to neoadjuvant treatment with TFAC in 133 breast cancer patients. Tumor response was evaluated post treatment by scoring pCR (pathological complete response) or RD (residual disease).

We applied the test to a clinical study that assessed patient survival following treatment with taxane combination chemotherapy. This clinical study was performed at the MD Anderson Cancer Center. We looked specifically at the 178 triple negative patients included in this study and used logistic regression to develop an optimized algorithm to apply the 3D signature genes. We then performed Kaplan-Meier analysis to determine whether the test could distinguish between patients who survived long term and those who did not.

In the current example we address a different endpoint. Here we show that models derived from the combination of the organization signature genes and clinical parameters accurately predict patient survival following treatment with TFAC chemotherapy. We use as an endpoint distant metastasis free survival (DMFS). Methods. Raw Affymetrix cel files were downloaded from Gene Expression Omnibus (GEO) public microarray data repository for data of Hatzis et al 2011. Files were uploaded to GeneSpring GX 11 software and processed by the robust multi-array average (RMA) method. Statistical analyses were performed by using Excel and MedCalc software.

Results.

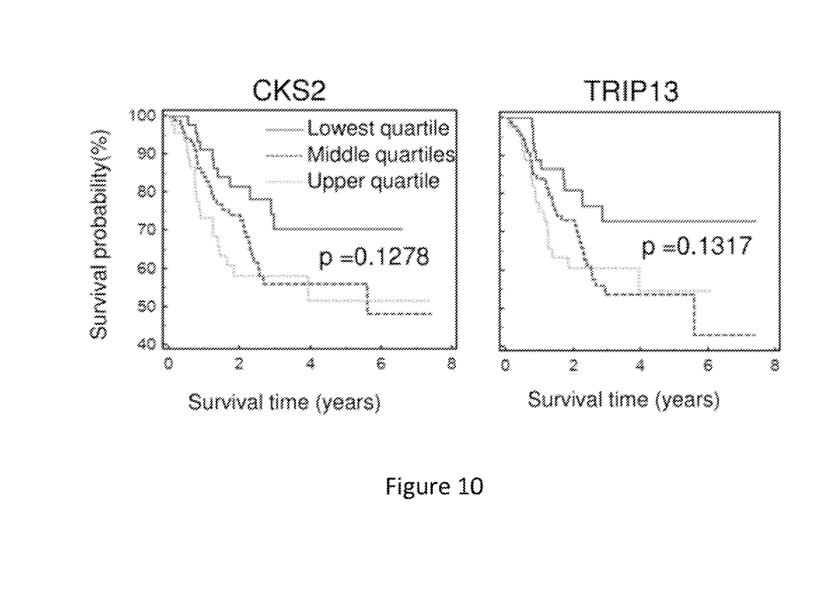

To assess the ability of individual genes in the cell organization signature to predict survival, we used the microarray dataset of Hatzis et al 2011, which includes a total of 178 independent patient biopsies. Results of univariate Kaplan-Meier survival analysis were tabulated for each of the signature genes. Results show signature contains a combination of genes that predicted survival in the heterogeneous set of all subtypes (All), as well as genes that predicted survival in the homogeneous sets of ER+ and triple negative breast cancer (Table 20). Genes that predicted survival only in the heterogeneous (All) set but not the homogenous sets include TUBG1, ACTN1, ACTB, and ODC1. Genes that predicted survival only in the homogeneous triple negative set include CKS2. Kaplan-Meier survival curves for the four genes with p-values less than 0.20 are shown (FIG. 10). These univariate results show that different genes are associated with prediction of survival in heterogeneous and homogeneous sets of breast cancer patients as well as ER+ and triple negative breast cancer. They further suggest that the organization signature has the potential to predict survival in multiple subtypes of breast cancer.

TABLE 20
Univariate Kaplan-Meier analysis of
prediction of survival following TFAC
treatment by the signature genes

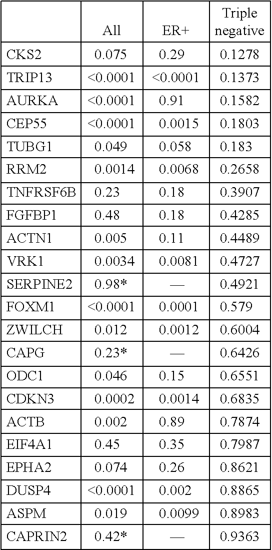

Values shown are p-values determined by univariate Kaplan-Meier analysis for quartile-grouped expression levels of the signature genes. Highlighted values represent top 5 best predictors for each specifed subtype.

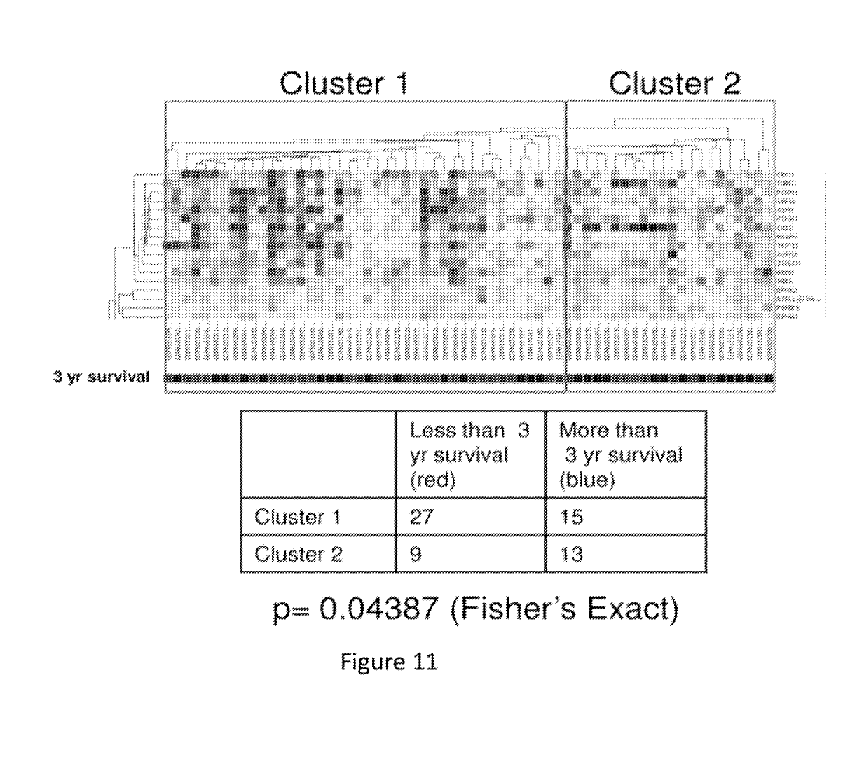

Using hierarchical cluster analysis, the organization signature stratified triple negative breast cancer patients into poor and good prognosis clusters (clusters 1, and 2, respectively). (see, for example, FIG. 11). Cluster analysis was performed using GeneSpring 11 software with a centered Pearson metric for 115 triple negative patients with 3 year survival information from the dataset of Hatzis et al. 2011.

A model that included signature genes out-performed clinical and control parameters and was significant in multivariate analyses. Area under the curve (AUC) statistics for the training set were 0.680 for signature genes alone, 0.738 for clinical and control parameters, and 0.756 for signature genes plus controls and clinical parameters. All (100%) of the eight patients predicted to have an excellent survival time (4.5% of patients) experienced a distant relapse free survival time of more than 3 years. This cell organization signature has the potential to represent a new diagnostic to identify triple negative breast cancer patients with an excellent long term survival following TFAC chemotherapy treatment.

We next applied unsupervised hierarchical cluster analysis to provide an initial visual assessment of the ability of the signature to stratify triple negative patients according to survival following TFAC treatment. Three year distant relapse free survival (DRFS) was used as an endpoint. The analysis included only those patients who either experienced an event (death or distant relapse) within three years or who were followed and experienced no event within 3 years. These data were available for 115 patients from the microarray dataset of Hatzis et al, 2011. The signature stratified the triple negative patients according to good and poor survival (p=0.04387, Fisher's Exact) (FIG. 11). These results indicate it may be feasible to apply a rigorous model-based classification method to optimize the signature.

To develop an optimized model to predict in triple negative breast cancer, we applied logistic regression. Optimized models were generated using expression levels of the organization signature genes, a series of three subtype classification genes, plus clinical parameters. The inclusion of the three subtype classifier genes—estrogen receptor (ESR1), human EGF receptor (HER2) and cadherin 3 (CDH3)—allows the model to adjust for any samples that may have been misclassified as triple negative. Optimized models were generated by selectively eliminating non-contributing genes as assessed by their p-value. Models were generated for each of seven conditions (Models A-G):
A. 22 genes alone,
B. 22 genes plus 3 classification genes,
C. 3 classification gene alone,
D. 22 genes plus clinical parameters,
E. clinical parameters alone,
F. 3 classification genes plus clinical parameters,
G. 22 genes plus 3 classification genes plus clinical parameters

Three year distant relapse free survival (DRFS) was used as a binary outcome for logistic regression, and the analysis included only those patients who either experienced and event (death or distant relapse) within three years or who were followed and experienced no event within 3 years. This data was available for 115 patients from the microarray dataset of Hatzis et al, 2011. Gene expression values were converted to quartile values for modeling. Models were reduced to include three to five elements. Algorithms for each model are shown (Table 21). Results were tabulated showing receiver operating characteristic (ROC) area under the curve (AUC) metrics, model significance (p-values) and genes included in the model (Table 22).

TABLE 21
Algorithms for each model.

| Model | Algorithm |
|---|---|
| A | 2.633 + CKS2*−0.7056 + DUSP4*−0.2883 + FGFBP*−0.9329 + |
| | TNFRSF6B*0.501 |
| B | 2.633 + CKS2*−0.7056 + DUSP4*−0.2883 + FGFBP*−0.9329 + |
| | TNFRSF6B*0.501 |
| C | 0.02882 + ESR1*−0.2282 + CDH3*−0.2072 + HER2*0.339 |
| D | 4.4749 + FGFBP*−0.9043 + nodes*−0.7416 + ODC1*−0.4822 + |
| | CKS2*−0.555 |
| E | 0.4512 + grade*0.5186 + nodes*−0.7361 + Ki67*−0.6195 |
| F | 1.2624 + grade*0.5654 + nodes*−0.7786 + ESR1*−0.3874 + |
| | Ki67*−0.6872 |
| G | 5.4837 + CEP55*−0.5585 + FGFBP*−0.8835 + ESR1*−0.4478 + |
| | ODC1*−0.5632 + nodes*−0.7473 |

TABLE 22
Tabulated logistic regression results and
optimized gene lists for models A-G.

| | | | | D | E | F | G |
|---|---|---|---|---|---|---|---|
| | | B | | Genes | | Controls | Genes plus |
| Model | A | Genes plus | C | plus | | plus | controls, |
| Conditions | Genes | controls | Controls | clinical | Clinical | clinical | clinical |
| AUC | 0.680 | 0.680 | 0.572 | 0.741 | 0.724 | 0.738 | 0.756 |
| p-value | 0.0078 | 0.0078 | 0.4618 | 0.0003 | 0.0034 | 0.0041 | 0.0004 |
| Model | CKS2 | CKS2 | ESR1 | Node | Node | Node | Node |
| features | DUSP4 | DUSP4 | CDH3 | status | status | status | status |
| | FGFBP | FGFBP | HER2 | FGFBP | Grade | Grade | FGFBP |
| | TNFRSF6B | TNFRSF6B | | ODC1 | Ki67 | Ki67 | ODC1 |
| | | | | CKS2 | | ESR1 | CEP55 |
| | | | | | | | ESR1 |

Comparison of the results of model optimization shows that the models that include the signature genes generated better test accuracy (higher AUC values) than the models without signature genes. The model generated from the signature genes plus controls plus clinical parameters performed the best (AUC=0.756) and outperformed clinical parameters (AUC=0.724) and controls plus clinical parameters (AUC=0.738). Statistical significance of the models that included signature genes also outperformed those that did not. Model G, which consists of five features including three signature genes (FGFBP, ODC 1 and CEP55), the clinical parameter node status, and the classification control gene ESR1 performed better than others.

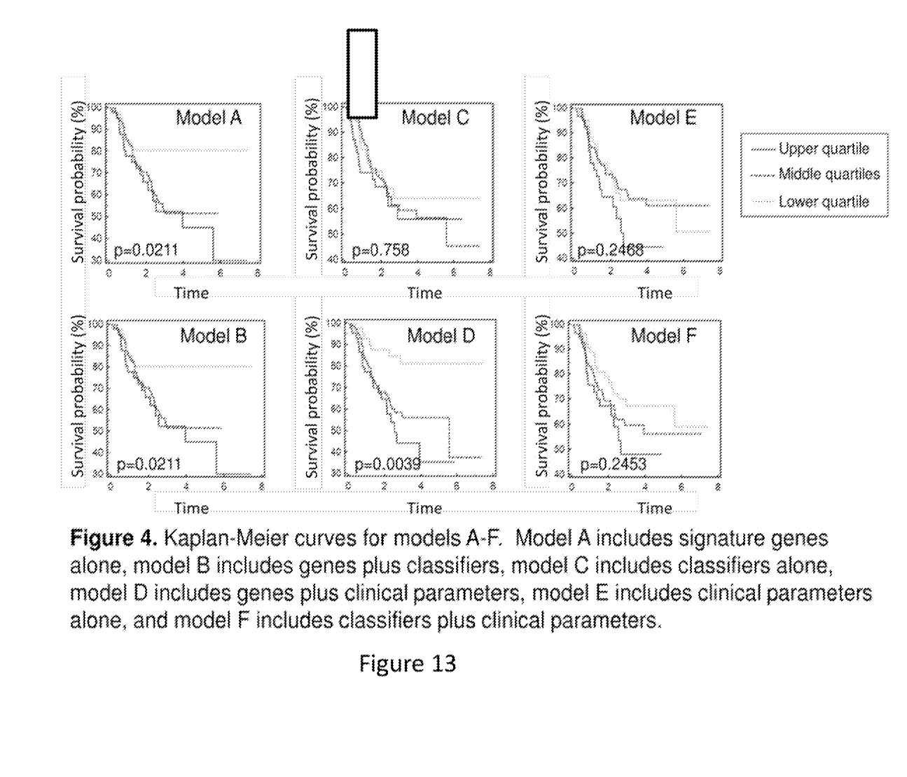

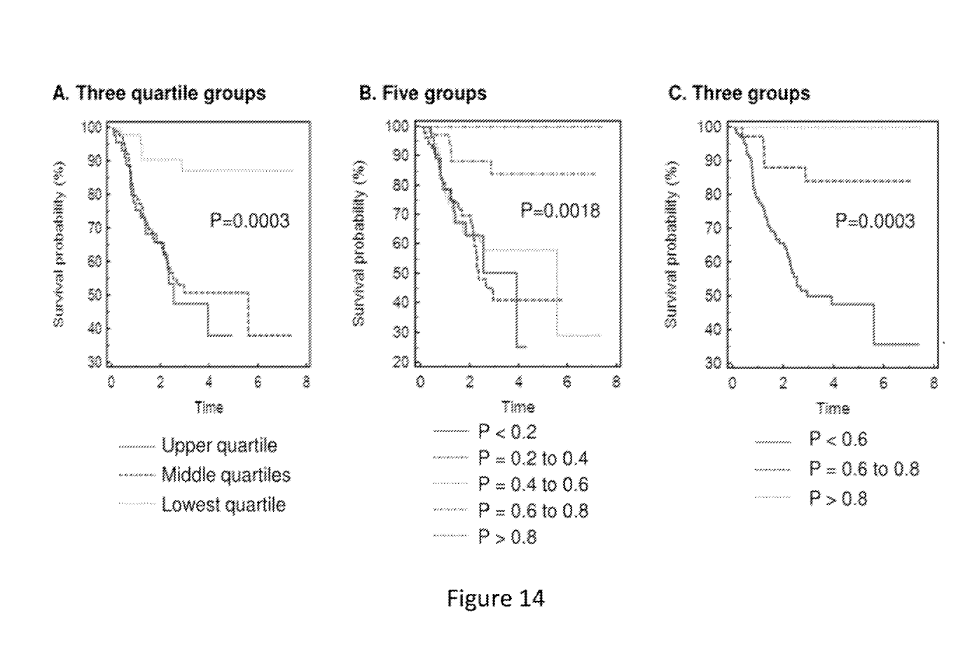

Kaplan-Meier survival analysis provides a highly accurate assessment of the ability of a model to predict survival outcome as it accounts for patients with both complete and incomplete follow up data. To perform Kaplan-Meier analysis of optimized logistic regression models, we divided the calculated probabilities into quartiles. This analysis used all 178 triple negative samples from the microarray dataset of Hatzis et al, 2011. Results show that Model G, which included signature genes plus clinical parameters plus classifier) outperformed by more than an order of magnitude all other tested models Table 23. Kaplan-Meier curves for each of the models are shown (FIGS. 13 and 14).

Example 14-Table 4. Kaplan-Meier significance for Models A-G.

| | | Significance of |
|---|---|---|
| | | Kaplan-Meier |
| Model | Parameters | (p-values) |
| A | Genes alone | 0.0211 |
| B | Genes plus classifiers | 0.0211 |
| C | Classifiers alone | 0.7580 |
| D | Genes plus clinical parameters | 0.0039 |
| E | Clinical parameters alone | 0.2468 |
| F | Classifiers plus clinical parameters | 0.2453 |
| G | Genes plus 3 classifiers plus clinical | 0.0003 |
| | parameters | |

Quartile, five group, and three group analyses were performed on Model G. For quartile analysis, probabilities were divided into quartiles and the middle two quartiles were combined. For five group analysis, probabilities were divided into groups: Group 1: 0-0.2, Group 2: 0.2-0.4, Group 3: 0.4-0.6, Group 4: 0.6-0.8 and Group 5: 0.8-1.0. For three group analysis, the three highest expressing groups (Groups 3-5) were combined. Results are shown (FIG. 14, Table 24). FIG. 14 shows, Kaplan-Meier curves for Model G, which includes signature genes plus classifier genes plus clinical parameters, show the stratification of triple negative breast cancers with short and long term survival following treatment with TFAC chemotherapy.

TABLE 24
Numbers of patients in prognosis groups of the five group
Kaplan-Meier analysis.

| | Bracket | No. | | |
|---|---|---|---|---|
| Interval | (scores) | patients | | |
| 1 | 0-0.2 | 28 | | |
| 2 | 0.2-0.4 | 52 | 75.3% | Short survival |
| 3 | 0.4-0.6 | 54 | | |
| 4 | 0.6-0.8 | 36 | 20.2% | Moderate survival |
| 5 | 0.8-1 | 8 | 4.5% | Excellent survival |

Result show that the majority of patients (75.3%) in this set of triple negative patients are predicted to have poor survival, while a small proportion of patients (4.5%) are predicted to have excellent survival. The remaining patients (20.2%) fell into a moderate survival group (Example 14-Table 5). These results are consistent with previous indications of triple negative breast cancer as a class with generally poor outcome. The identification of a group of patients, albeit small, with excellent survival has the potential to provide these patients with the option to forgo additional therapies that may not provide a significant benefit.

To assess the value of the gene signature test (Model G) in comparison with clinical parameters, we applied a COX multivariate proportional hazards regression analysis. Three analyses were performed (Table 25). In the upper panel, the covariate Model G and six clinical parameters including grade, node status, tumor size, tumor stage, Ki-67 expression level, and patient age were entered into the model. The hazard ratio for Model G was calculated as 0.6425 with a 95% confidence interval of 0.4605 to 0.8965, meaning that for an increase of 1 year of survival time, the hazard of recurrence decreases to 0.6425 times the original risk. After 2 years, the hazard ratio decreases to 0.6425 squared (i.e. 0.4128) times the original risk. In the upper panel, Model G was the only significant independent predictive factor (p<0.05). The middle and lower panels show additional comparisons. The middle panel compares prediction of survival by the gene signature (Model G) with two other tests, PAM50 and the genomic grade index (GGI). In this comparison, Model G was the only significant independent predictive factor. The lower panel compares the gene signature (Model G) with chemotherapy pathological complete response (pCR). In this comparison, both Model G (p=0.0006) and pCR (p=0.0001) are highly significant independent predictors of survival. This is an important comparison and indicates that the acinar gene signature test is a significant independent predictor of survival in response to chemotherapy.

TABLE 25
Comparison of signature-based test (Model G) with
clinical parameters in predicting survival following TFAC
treatment in triple negative breast cancer by using COX
proportional hazards analysis

| | | Hazard | |
|---|---|---|---|
| Covariate | P | Ratio | 95% CI |
| Model G | 0.0096 | 0.6425 | 0.4605 to 0.8965 |
| Grade | 0.1765 | 0.6313 | 0.3251 to 1.2258 |
| Nodes status | 0.4446 | 0.8501 | 0.5618 to 1.2865 |
| Tumor size | 0.1959 | 1.3199 | 0.8686 to 2.0057 |
| Tumor stage | 0.5529 | 1.3066 | 0.5427 to 3.1460 |
| Ki67 | 0.8537 | 1.0371 | 0.7055 to 1.5245 |
| Patient age | 0.5947 | 1.0673 | 0.8406 to 1.3552 |
| Covariate | P | Exp(b) | 95% CI of Exp(b) |
| Model G | 0.0011 | 0.671 | 0.5288 to 0.8514 |
| PAM50 | 0.2309 | 0.7301 | 0.4375 to 1.2183 |
| GGI | 0.8622 | 1.0991 | 0.3800 to 3.1791 |
| Covariate | P | Exp(b) | 95% CI of Exp(b) |
| Model G | 0.0006 | 0.6575 | 0.5186 to 0.8336 |
| pCR | 0.0001 | 0.1847 | 0.0796 to 0.4282 |

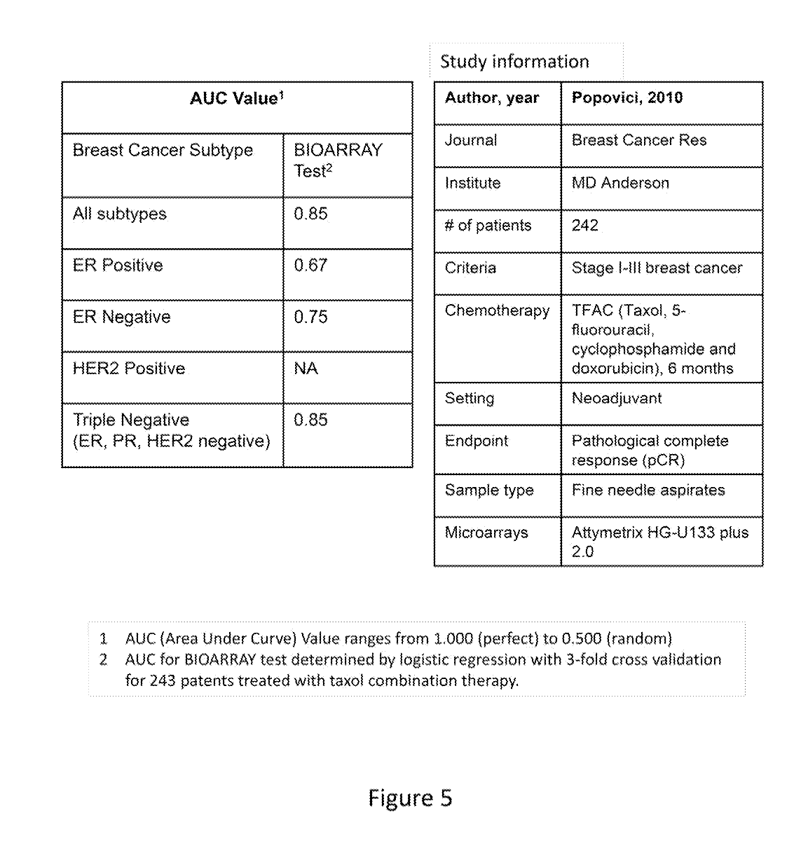

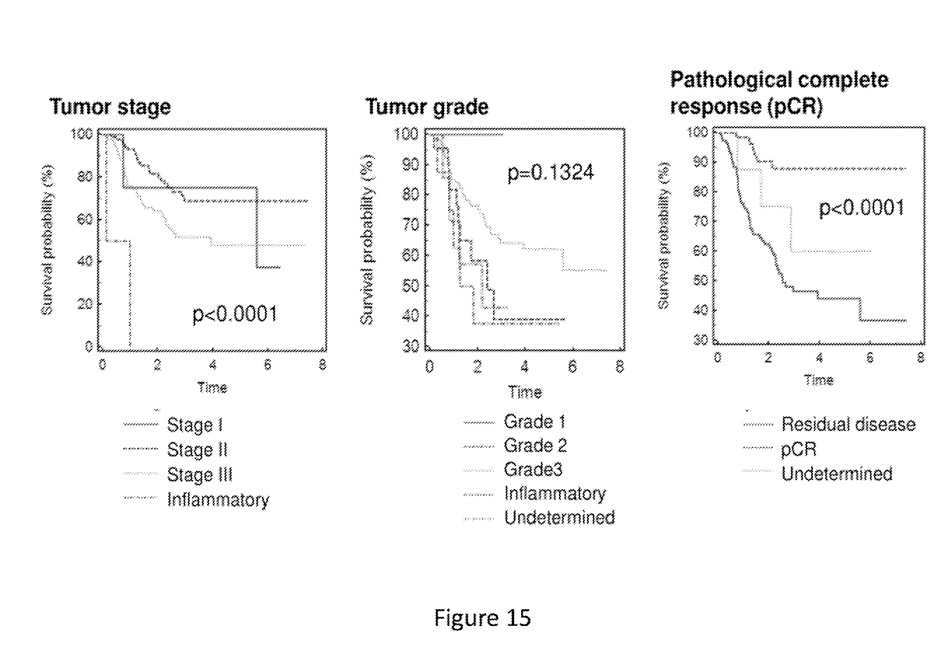

Kaplan-Meier curves provide a visual assessment of survival. To compare survival among the clinical parameters and the signature test, we prepared a series of Kaplan-Meier curves. The clinical parameters tested consist of tumor stage, tumor grade and pathological complete response (pCR). Results show that tumor stage and pCR are significant survival factors each of which stratify triple negative breast cancer patients into good and poor survival groups (P<0.0001) (FIG. 15). Tumor grade was not a significant factor (p=0.1324). In comparison with the signature based test (Model G) of FIG. 5, both tumor stage, pCR and the gene signature were highly statistically significant (p<0.0003). An important difference is that the signature test identified a group of patients with a 100% prediction of long term distant relapse free survival, while both tumor stage and pCR identified patients with lower levels, approximately 70% and 90%, of probability of long term distant relapse free survival. We note that pCR is a clinical parameter that is only available in the setting of neoadjuvant chemotherapy, while the signature test is not limited to a neoadjuvant chemotherapy setting.

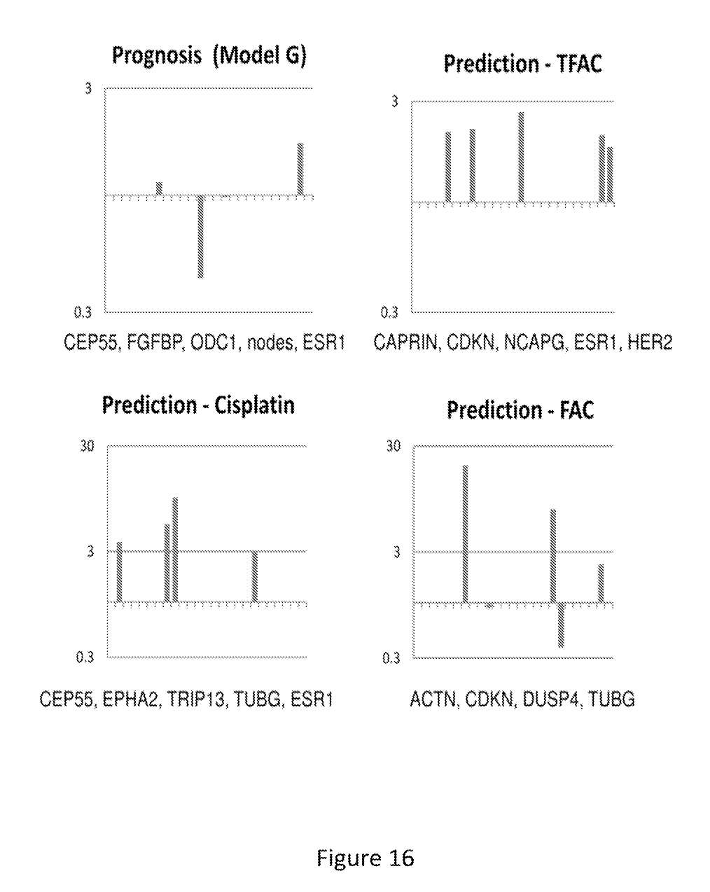

FIG. 16 compares the optimized prognosis model (Model G) with our three predictive models, each of which predict response of triple negative breast cancer patients to a different chemotherapy. Significantly, each of these models differs. From this observation we can conclude that different factors are involved in determining whether a patient responds to a given treatment and in determining whether patient has a particular long term prognosis, independent of treatment. FIG. 16 shows Different gene expression patterns distinguish the prediction of patient survival (DMFS) and tumor response (pCR) in triple negative breast cancer. Graphs show gene expression levels on the y-axis and the 22 signature genes plus three classifier controls on the x-axis. Genes and clinical parameters included in the optimized models are listed below the graphs.

In conclusion, the cell organization signature represents a new diagnostic to identify triple negative breast cancer patients with an excellent long term survival.

### Example 15

The data presented herein shows that co-regulated genes can substitute for one or more of the 22 3D signature genes in the predictive functions described herein and throughout. The co-regulated genes are listed in Tables 26A and 26B and were identified from data of 250 unique breast cancer biopsy samples from the microarray data sets of Popovici et al 2010 and Tabchy et al 2010 using GeneSpring version 7.3.1 software. Genes were selected that were co-regulated (Pearson correlation r>0.70) with each of the 22 3D signature genes. The resulting gene list included 58 unique genes, each of which were co-regulated with one of the 22 3D signature genes. Of these genes, 57 were co-regulated with 10 of the 22 3D signature genes. The 57 co-regulated genes and 10 3D signature genes were all part of a single “cell cycle” overlapping and co-regulated group. The following algorithm mA was applied to the microarray dataset of 250 samples.

Algorithm mA:
logit (P)=1.0045+age*0.0330+grade*−0.3292+ER-status*0.0214+node-status*0.1415+tumor-size*0.00527+CDH3*0.2715+ESR1*0.00469+HER2neu*−0.1510+ODC1*−0.5848+TRIP13*−0.4053+SERPINE2*−0.2126+FGFBP*0.2904

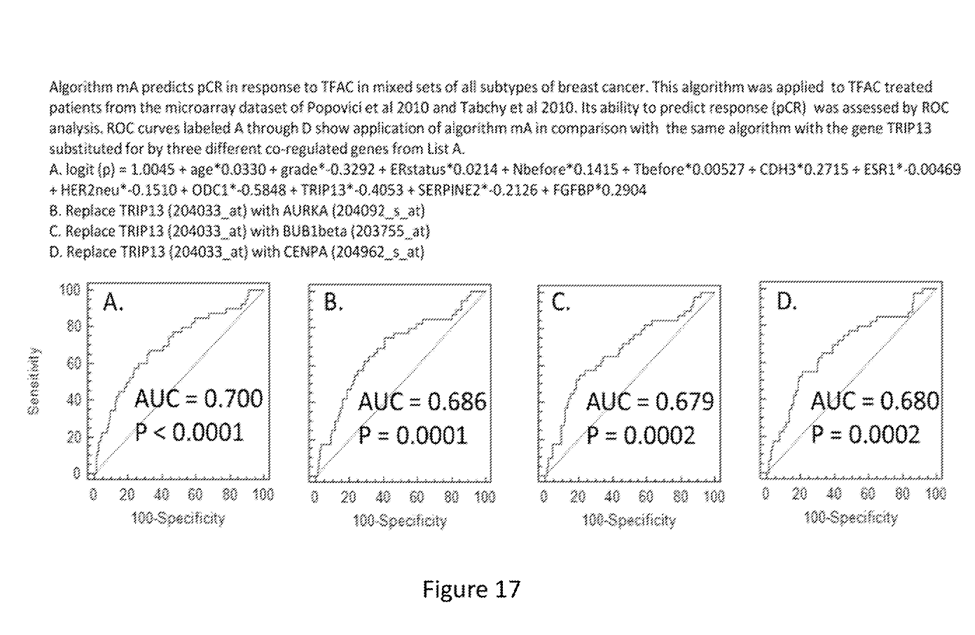

AUC and p-values for ROC curve analyses were calculated by using MedCalc software for prediction of response (pCR) to the taxane combination chemotherapy TFAC. Three different genes from list AA that were co-regulated with TRIP13 were substituted for TRIP 13 in the mA algorithm. The results show that the co-regulated genes accurately substituted for the 22 3D signature genes. p-values for each ROC analysis were significant at the level of p<0.05. (see, FIG. 17, showing that co-regulated genes from the Co-regulated Gene List below (Tables 26A or 26B) can substitute for one or more of the 3D-signature genes.)

The Co-Regulated Gene Lists described below was identified from the data of 508 breast cancer biopsy samples from the microarray data set of Hatzis et al 2011 using GeneSpring version 11 software. Genes were selected that were most highly co-regulated (Pearson correlation) with each of the 12 3D signature genes for which no co-regulated genes were identified using the methods described above. These genes include: ACTB, ACTN1, CAPRIN2, DUSP4, EIF4A1, EPHA2, FGFBP1, SERPINE2, TNFRSF6B, TUBG, VRK1, and ZWILCH. Three to five genes were identified for each of the 12 genes; the resulting gene list of 31 genes includes 29 unique genes. The co-regulated genes can be found in Tables 26A and 26B (see gene list below).

Co-Regulated Gene List (Table 26A):

ACTB, 200801_x_at:
TMSB10, Affymetrix No. 217733_s_at, r = 65177
ARPC2, Affymetrix No. 207988_s_at, r = 6400725
EEF1A1, Affymetrix No. 213477_x_at, r = 6250263
ACTN1, 208637_x_at:
FLNA, Affymetrix No. 200859_x_at, r = 0.620812
TAGLN, Affymetrix No. 205547_s_at, n = 0.614261
MYN9, Affymetrix No. 211926_s_at, 0.60011
CAPRIN2, 218456_at:
DDX11, Affymetrix No. 208149_x_at, r = 0.46238
NKTR, Affymetrix No. 202380_s_at, r = 0.36659
RAD52, Affymetrix No. 205647_at, r = 0.3595576
DUSP4, 204014_at:
KIF13B, Affymetrix No. 202962_s_at, r = 0.6140462
XBP1, Affymetrix No. 200670_at, r = 0.5929986
RHOB, Affymetrix No. 212099_at, r = 0.5826516
FOXA1, Affymetrix No. 204667_at, r = 0.5810432
EIF4A1, 214805_at:
TMEM63A, Affymetrix No. 214833_at, r = 0.48369
MPZL1, Affymetrix No. 210210_at, r = 4660022
MARS, Affymetrix No. 213672_at, r = 0.46352
DDX11, Affymetrix No. 208149_x_at, r = 0.45156
EPHA2, 203499_at:
PLD1, Affymetrix No. 177_at, r = 0.463738
SLC12A4, Affymetrix No. 209402_s_at, r = 0.46139
C15orf39, Affymetrix No. 204495_s_at, r = 0.44927
EDN1, Affymetrix No. 218995_s_at, r = 0.43848
FGFBP1, 205014_at:
C15orf49, 205014_at, r = 0.8185101
OCA2, 206498_at, r = 0.81723
MLANA, 206427_s_at, r = 0.81467
MYO15A, 220288_at, r = 0.8142
SERPINE2, 212190_at:
MFGE8, Affymetrix No. 210605_s_at, r = 0.600986
FAM171A1, Affymetrix No. 211771_at, r = 0.60819
GPM6B, Affymetrix No. 209170_s_at, r = 0.594846
TMEM158, Affymetrix No. 213338_at, r = 0.5899476
BCL11A, Affymetrix No. 219497_s_at, r = 0.5875688
TNFRSF6B, 206467_x_at:
SLC12A4, Affymetrix No. 209402_s_at, r = 0.5135761
STRA6, Affymetrix No. 221701_s_at, r = 0.5080768
FSD1, Affymetrix No. 219170_at, r = 0.500633
TUBG, 201714_at:
PSME3, Affymetrix No. 209853_s_at, r = 0.7037777
NMT1, Affymetrix No. 201157_s_at, r = 0.7019321
PSMC3IP, Affymetrix No. 213951_s_at, r = 0.70087653
MRPL17, Affymetrix No. 222216_s_at, r = 0.699139
VRK1, 203856_at:
PAPOLA, Affymetrix No. 209388_at, r = 0.7238693
SFRS3, Affymetrix No. 208672_s_at, r = 0.6740329
DBF4, Affymetrix No. 204244_s_at, r = 0.6672406

TABLE 26B
Co Regulated Gene List for Each 3-D Signature Gene

| | Co-Regulated Gene List (Pearson correlation |
|---|---|
| 3-D Signature Gene List | coefficient > 0.75) |
| asp (abnormal spindle) | BUB1 budding uninhibited by benzimidazoles 1 homolog |
| homolog, microcephaly | beta (yeast) |
| associated (Drosophila) | cell division cycle 2, G1 to S and G2 to M |
| | cell division cycle 20 homolog (S. cerevisiae) |
| | cell division cycle associated 3 |
| | cell division cycle associated 5 |
| | cell division cycle associated 7 |
| | centromere protein A |
| | centromere protein F, 350/400 ka (mitosin) |
| | centromere protein L |
| | centrosomal protein 55 kDa |
| | cyclin B1 |
| | cyclin B2 |
| | DEP domain containing 1 |
| | discs, large homolog 7 (Drosophila) |
| | family with sequence similarity 54, member A |
| | family with sequence similarity 83, member D |
| | helicase, lymphoid-specific |
| | kinesin family member 14 |
| | kinesin family member 20A |
| | kinesin family member 2C |
| | maternal embryonic leucine zipper kinase |
| | NDC80 homolog, kinetochore complex component |
| | (S. cerevisiae) |
| | NIMA (never in mitosis gene a)-related kinase 2 |
| | non-SMC condensin I complex, subunit G |
| | NUF2, NDC80 kinetochore complex component, homolog |
| | (S. cerevisiae) |
| | pituitary tumor-transforming 1 |
| | protein regulator of cytokinesis 1 |
| | RAD51 associated protein 1 |
| | SPC24, NDC80 kinetochore complex component, homolog |
| | (S. cerevisiae) |
| | suppressor of variegation 3-9 homolog 2 (Drosophila) |
| | thymidylate synthetase |
| | TPX2, microtubule-associated, homolog (Xenopus laevis) |
| | TTK protein kinase |
| aurora kinase A | family with sequence similarity 83, member D |
| | anillin, actin binding protein |
| | cell division cycle associated 3 |
| | cell division cycle associated 5 |
| | chromatin licensing and DNA replication factor 1 |
| CDC28 protein kinase | Rac GTPase activating protein 1 |
| regulatory subunit 2 | ATPase family, AAA domain containing 2 |
| | CDC28 protein kinase regulatory subunit 1B |
| | cell division cycle 2, G1 to S and G2 to M |
| | cyclin B1 |
| | H2A histone family, member Z |
| | karyopherin alpha 2 (RAG cohort 1, importin alpha 1) |
| | MAD2 mitotic arrest deficient-like 1 (yeast) |
| | mitochondrial ribosomal protein L47 |
| | nucleolar and spindle associated protein 1 |
| | replication factor C (activator 1) 4, 37 kDa |
| | structural maintenance of chromosomes 4 |
| | zinc finger protein 367 |
| | ZW10 interactor |
| centrosomal protein 55 kDa | anillin, actin binding protein |
| | asp (abnormal spindle) homolog, microcephaly associated |
| | (Drosophila) |
| | BUB1 budding uninhibited by benzimidazoles 1 homolog |
| | beta (yeast) |
| | cancer susceptibility candidate 5 |
| | cell division cycle 2, G1 to S and G2 to M |
| | cell division cycle associated 3 |
| | cell division cycle associated 5 |
| | cell division cycle associated 7 |
| | centromere protein A |
| | chromosome 1 open reading frame 135 |
| | cyclin B1 |
| | DEP domain containing 1 |
| | discs, large homolog 7 (Drosophila) |
| | family with sequence similarity 83, member D |
| | helicase, lymphoid-specific |
| | kinesin family member 11 |
| | kinesin family member 20A |
| | kinesin family member 2C |
| | kinesin family member 4A |
| | maternal embryonic leucine zipper kinase |
| | minichromosome maintenance complex component 10 |
| | NUF2, NDC80 kinetochore complex component, homolog |
| | (S. cerevisiae) |
| | pituitary tumor-transforming 1 |
| | RNA binding motif protein 17 |
| | suppressor of variegation 3-9 homolog 2 (Drosophila) |
| | TTK protein kinase |
| cyclin-dependent kinase | cell division cycle 2, G1 to S and G2 to M |
| inhibitor 3 (CDK2-associated | cyclin B1 |
| dual specificity phosphatase) | discs, large homolog 7 (Drosophila) |
| | nucleolar and spindle associated protein 1 |
| | pituitary tumor-transforming 1 |
| | ubiquitin-conjugating enzyme E2C |
| forkhead box M1 | cell division cycle associated 3 |
| | chromatin licensing and DNA replication factor 1 |
| non-SMC condensin I | cell division cycle 2, G1 to S and G2 to M |
| complex, subunit G | DEP domain containing 1 |
| | helicase, lymphoid-specific |
| | kinesin family member 14 |
| | meiotic nuclear divisions 1 homolog (S. cerevisiae) |
| | NDC80 homolog, kinetochore complex component |
| | (S. cerevisiae) |
| | NUF2, NDC80 kinetochore complex component, homolog |
| | (S. cerevisiae) |
| ornithine decarboxylase 1 | cell division cycle associated 7 |
| | desmocollin 2 |
| | T-box 19 |
| ribonucleotide reductase M2 | BUB1 budding uninhibited by benzimidazoles 1 homolog |
| polypeptide | beta (yeast) |
| | cell division cycle 2 |
| | cell division cycle associated 3 |
| | cell division cycle associated 5 |
| | centromere protein A |
| | cyclin B1 |
| | cyclin B2 |
| | discs, large homolog 7 (Drosophila) |
| | family with sequence similarity 83, member D |
| | maternal embryonic leucine zipper kinase |
| | nucleolar and spindle associated protein 1 |
| | pituitary tumor-transforming 1 |
| serpin peptidase inhibitor, | zinc finger protein 521 |
| clade E (nexin, plasminogen | |
| activator inhibitor type 1), | |
| member 2 | |
| tumor necrosis factor receptor | none |
| superfamily, member 6b, | |
| decoy | |
| thyroid hormone receptor | anillin, actin binding protein |
| interactor 13 | aurora kinase A |
| | BUB1 budding uninhibited by benzimidazoles 1 homolog |
| | beta (yeast) |
| | cell division cycle associated 3 |
| | cell division cycle associated 5 |
| | cell division cycle associated 7 |
| | centromere protein A |
| | centromere protein N |
| | chromatin licensing and DNA replication factor 1 |
| | cyclin B2 |
| | DEP domain containing 1 |
| | diaphanous homolog 3 (Drosophila) |
| | family with sequence similarity 83, member D |
| | kinesin family member 2C |
| | pituitary tumor-transforming 1 |
| | ubiquitin-conjugating enzyme E2C |

To evaluate the ability of these genes to substitute for the 22 3D signature genes, the following algorithm mC was applied to the microarray dataset of Hatzis et al 2011.

Algorithm mC:
logit (p)=0.850+EPHA2*1.215+ER-status*2.070+HER2*−0.356+ODC1*−0.462+SERPINE2*−0.196

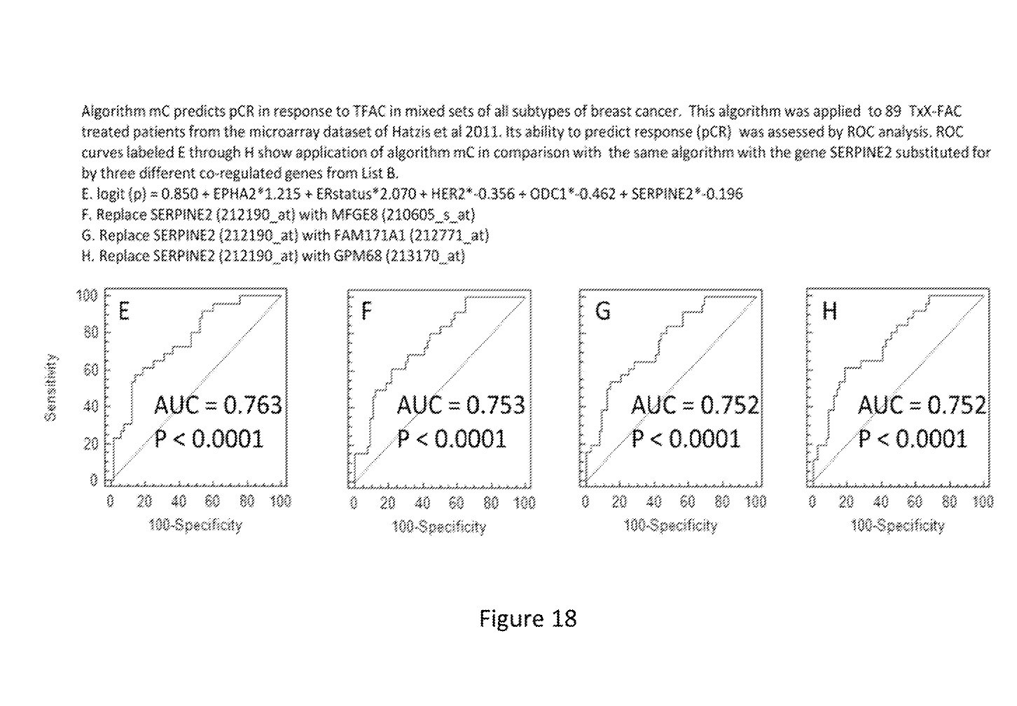

AUC and p-values for ROC curve analyses were calculated by using MedCalc software for prediction of response (pCR) to the taxane combination chemotherapy TFAC. Three different genes from the Co-Regulated Gene List that were co-regulated with SERPINE2 were substituted into the algorithm. The results show that the co-regulated genes accurately substituted. p-values for each ROC analysis were significant at the level of p<0.05. (see, FIG. 18 showing that co-regulated genes from the Co-regulated Gene List below can substitute for one or more of the 3D-signature genes.) Other co-regulated genes can be identified and determined using similar techniques as described herein.

### Example 17

The following table describes certain functions that can be used in the methods described herein.

TABLE 27

| | | BC | | |
|---|---|---|---|---|
| Treatment | Prediction | subtype | Parameters | optimized algorithm |
| TFAC | pCR | all | age, grade, ER- | logit (p) = 1.0045 + age*0.0330 + |
| | (response | | status, nodes, | grade*−0.3292 + ERstatus*0.0214 + |
| | to | | tumor-size, CDH3, | Nbefore*0.1415 + Tbefore*0.00527 + |
| | treatment) | | ESR1, HER2, | CDH3*0.2715 + ESR1*−0.00469 + |
| | | | FGFBP1, ODC1, | HER2neu*−0.1510 + ODC1*−0.5848 + |
| | | | SERPINE2, | TRIP13*−0.4053 + SERPINE2*−0.2126 + |
| | | | TRIP13 | FGFBP*0.2904 |
| TFAC | pCR | all | ER-status, tumor- | logit(p) = 1.4486 + ERstatus*2.0146 + |
| | | | size, HER2, | HER2*−0.3906 + ODC1*−0.4190 + |
| | | | ODC1, SERPINE2 | size*0.3136 + SERPINE2*−0.2433 |
| TFAC | pCR | all | ER-status, HER2, | logit (p) = 0.850 + EPHA2*1.215 + |
| | | | EPHA2, ODC1, | ERstatus*2.070 + HER2*−0.356 + |
| | | | SERPINE2 | ODC1*−0.462 + SERPINE2*−0.196 |
| TFAC | pCR | ER+ | grade, nodes, | logit (p) = 7.399 + EPHA2*−4.143 + |
| | | | HER2, EPHA2, | FGFBP1*3.168 + grade*−1.264 + |
| | | | FGFBP1 | HER2*−0.347 + nodes*0.947 |
| TFAC | pCR | HER2+ | tumor-size, ESR1, | logit(p) = −2.518 + ESR1*−18.864 + |
| | | | TUBG | size*0.997 + TUBG*1.556 |
| TFAC | pCR | Triple | ESR1, ODC1 | logit (p) = 1.441 + ESR1*2.036 + |
| | | negative | | ODC1*−0.716 |
| FAC | pCR | Triple | CEP55, EPHA2 | logit (p) = 6.176 + CEP55*2.3339 + |
| | | negative | | EPHA2*−10.9738 |
| cisplatin | pCR | Triple | HER2, ACTN, | logit (p) = −156 + ACTN*47 + |
| | | negative | CEP55, TRIP13, | CEP55*21 + HER2*55 + |
| | | | VRK1 | TRIP13*36 + VRK1*24 |
| cisplatin | pCR | Triple | ACTN, DUSP, | logit (p) = 5.1006 + ACTN*−1.7856 + |
| | | negative | TUBG | DUSP*−0.6077 + TUBG*−0.1361 |
| none | prognosis | ER+ | AURKA, EIF4A1, | logit (p) = −0.5319 + AURKA*1.39292 + |
| | | | EPHA2, ZWILCH | EIF4A1*1.01249 + EPHA2*−1.63425 + |
| | | | | ZWILCH*−0.84155 |
| none | prognosis | Triple | ACTB, ACTN1, | logit (p) = 16.424 + ACTB*−12.7574 + |
| | | negative | DUSP4, FGFBP1 | ACTN1*2.38947 + DUSP4*−4.71124 + |
| | | | | FGFBP1*−3.50831 |
| TFAC | pCR | all | ER-status, HER2, | logit (p) = −0.19510 + EPHA2*−1.1646 + |
| | | | EPHA2, ODC1, | ERstatus*−1.96686 + HER2*0.095982 + |
| | | | SERPINE2 | ODC1*0.35163 + SERPINE2*0.073974 |
| TFAC | pCR | ER+ | nodes, ASPM, | logit (p) = −5.34175 + ASP*1.450355 + |
| | | | CDKN3, EPHA2, | CDKN3*−2.72937 + EPHA2*2.154315 + |
| | | | RRM2 | nodes*−1.18795 + RRM2*2.15943 |
| TFAC | pCR | HER2+ | tumor-size, ESR1, | logit (p) = 2.889533 + ER1*15.78696 + |
| | | | TUBG | size*−1.13098 + TUBG*−1.29866 |
| TFAC | pCR | Triple | CDH3, CAPRIN, | logit (p) = −2.77893 + CAPRIN*0.975683 + |
| | | negative | CEP55, FOXM1, | CEP55*0.833133 + FOXM1*−0.65182 + |
| | | | ODC1, | ODC1*0.621863 + CAD3*−0.17729 |
| TFAC | pCR | all | grade, CDH3, | logit (p) = −1.9905 + CDH3*−0.29045 + |
| | | | SERPINE2, | grade*1.36852 + RTEL*−3.95216 + |
| | | | RTEL/TNFRSF6B, | SERPINE2*0.2931 + TUBG*1.31476 |
| | | | TUBG | |

The genes described herein can be substituted with co-regulated genes as described herein or described elsewhere or determined according to a method described herein.

### Example 18

A set of 60 genes were evaluated for their ability to predict response to chemotherapy in breast cancer. The 60 genes were modulated during a time course of growth arrest and morphogenesis of human mammary duct epithelial cells. In this time course, cells were cultured in a physiologically relevant, laminin-rich extracellular matrix. The entire group of 60 genes that were differentially regulated in this time course is are shown in Table 27.

TABLE 28

| | Gene list | Gene Symbol | Gene Alias | Gene description | Entrez Gene ID | Affymetrix ID |
|---|---|---|---|---|---|---|
| 1 | 22 Down late genes | CKS2 | CDC28 | CDC28 protein kinase regulatory subunit 2 | 1164 | 204170_s_at |
| 2 | 22 Down late genes | CDKN3 | CIP2 | cyclin-dependent kinase inhibitor 3 | 1033 | 209714_s_at |
| 3 | 22 Down late genes | FOXM1 | HFH-11 | forkhead box M1 | 2305 | 202580_x_at |
| 4 | 22 Down late genes | RRM2 | RR2 | ribonucleotide reductase M2 | 6241 | 209773_s_at |
| 5 | 22 Down late genes | VRK1 | PCH1 | vaccinia related kinase 1 | 7443 | 203856_at |
| 6 | 22 Down late genes | TRIP13 | 16E1BP | thyroid hormone receptor interactor 13 | 9319 | 204033_at |
| 7 | 22 Down late genes | ASPM | FLJ10517 | abnormal spindle homolog | 259266 | 219918_s_at |
| 8 | 22 Down late genes | CEP55 | FLJ10540 | centrosomal protein 55 kDa | 55165 | 218542_at |
| 9 | 22 Down late genes | ZWILCH | FLJ10036 | Zwilch, kinetochore associated, homolog | 55055 | 218349_s_at |
| 10 | 22 Down late genes | TUBG1 | TUBGCP1 | tubulin, gamma 1 | 7283 | 201714_at |
| 11 | 22 Down late genes | AURKA | STK6; STK15 | aurora kinase A | 6790 | 204092_s_at |
| 12 | 22 Down late genes | SERPINE2 | PN1; GDN | serpin peptidase inhibitor (nexin) 2 | 5270 | 212190_at |
| 13 | 22 Down late genes | CAPRIN2 | C1QDC1; EEG1 | caprin family member 2 | 65981 | 218456_at |
| 14 | 22 Down late genes | TNFRSF6B | DCR3 | TNF receptor family, 6b, decoy | 8771 | 206467_x_at |
| 15 | 22 Down late genes | NCAPG | hCAGP; MCP | non-SMC condensin I complex, subunit G | 64151 | 218663_at |
| 16 | 22 Down late genes | ACTN1 | FLJ54432 | actinin, alpha 1 | 87 | 208637_x_at |
| 17 | 22 Down late genes | ACTB | P51TP5BP1 | actin, beta | 60 | 200801_x_at |
| 18 | 22 Down late genes | DUSP4 | MKP-2 | dual specificity phosphatase 4 | 1846 | 204014_at |
| 19 | 22 Down late genes | EPHA2 | ECK | EPH receptor A2 | 1969 | 203499_at |
| 20 | 22 Down late genes | FGFBP1 | HBP17 | fibroblast growth factor binding protein 1 | 9982 | 205014_at |
| 21 | 22 Down late genes | EIF4A1 | DDX2A | eukaryotic translation initiation factor 4A1 | 1973 | 214805_at* |
| | | SNORA48 | ACA48 | small nucleolar RNA, H/ACA box 48 | 652965 | same* |
| 22 | 22 Down late genes | ODC1 | ODC | ornithine decarboxylase 1 | 4953 | 200790_at |
| 23 | 6 Down early genes | AMIGO2 | ALI1 | adhesion molecule with Ig-like domain 2 (ALI1) | 347902 | 222108_at |
| 24 | 6 Down early genes | THBS1 | TSP | thrombospondin 1 | 7057 | 201109_s_at |
| | | | | pleckstrin homology-like domain, family A, | | |
| 25 | 6 Down early genes | PHLDA1 | TDAG51 | member 1 | 22822 | 217997_at |
| 26 | 6 Down early genes | MPRIP | RIP3 | myosin phosphatase-Rho interacting protein | 23164 | 212197_x_at |
| 27 | 6 Down early genes | LRP8 | APOER2 | LDL receptor-related protein (APOER2) | 7804 | 208433_s_at |
| 28 | 6 Down early genes | SLC20A1 | PIT1; GLVR1 | solute carrier family 20, member 1 | 6574 | 201920_at |
| 29 | 11 Up late genes | SOX1 | SYR-box1 | SRY (sex determining region Y)-box 1 | 6656 | 201416_at |
| 30 | 11 Up late genes | KRT10 | CK10 | keratin 10 | 3858 | 213287_s_at |
| | | | | serpin peptidase inhibitor, clade A (alpha-1 | | |
| 31 | 11 Up late genes | SERPINA3 | ACT | antiproteinase, antitrypsin), member 3 | 12 | 202376_at |
| 32 | 11 Up late genes | APOE | LPG; AD2 | apolipoprotein E | 348 | 203382_s_at |
| 33 | 11 Up late genes | GPNMB | NMB; HGFIN | glycoprotein (transmembrane) nmb | 10457 | 201141_at |
| | | | | butyrobetaine (gamma), 2-oxoglutarate | | |
| 34 | 11 Up late genes | BBOX1 | BBH | dioxygenase (gamma-butyrobetaine | 8424 | 205363_at |
| 35 | 11 Up late genes | C14orf147 | SSSPTA | chromosome 14 open reading frame 147 | 171546 | 213508_at |
| 36 | 11 Up late genes | TCF4 | ITF2 | transcription factor 4 | 925 | 212386_at |
| 37 | 11 Up late genes | DSG3 | CDHF6 | desmoglein 3 | 1830 | 205595_at |
| 38 | 11 Up late genes | CRYAB | CYRA2 | crystallin, alpha B | 1410 | 209283_at |
| | | | | v-maf musculoaponeurotic fibrosarcoma | | |
| 39 | 11 Up late genes | MAFB | KRML | oncogene homolog B (avian) | 9935 | 218559_s_at |
| 40 | 21 Up early genes | EGR1 | AT225 | early growth response 1 | 1958 | 201694_s_at |
| 41 | 21 Up early genes | MACROD1 | LRP16 | MACRO domain containing 1 | 28992 | 219188_s_at |
| 42 | 21 Up early genes | SEPT10 | FLJ11619 | septin 10 | 151011 | 212698_s_at |
| 43 | 21 Up early genes | IGFBP2 | IBP2 | insulin-like growth factor binding protein 2, | 3485 | 202718_at |
| 44 | 21 Up early genes | GSN | Brevin | gelsolin | 2934 | 200696_s_at |
| | | | | EGF-containing fibulin-like extracellular matrix | | |
| 45 | 21 Up early genes | EFEMP1 | MTLV; FBLN3 | protein 1 | 2202 | 201842_s_at |
| 46 | 21 Up early genes | PPL | KIAA0568 | periplakin | 5493 | 203407_at |
| 47 | 21 Up early genes | SRCAP | DOMO1 | Snf2-related CREBBP activator protein | 10847 | 213667_at |
| | | | | steroid-5-alpha-reductase, alpha polypeptide 1 | | |
| 48 | 21 Up early genes | SRD5A1 | SR type 1 | (3-oxo-5 alpha-steroid delta 4-dehydrogenase | 6715 | 204675_at |
| 49 | 21 Up early genes | SEC4L | RAR | RAB40B, member RAS oncogene family | 10966 | 204547_at |
| 50 | 21 Up early genes | ZNF277 | NRIF4 | zinc finger protein 277 | 11179 | 218645_at |
| 51 | 21 Up early genes | PID1 | FLJ20701 | phosphotyrosine interaction domain | 55022 | 219093_at |
| 52 | 21 Up early genes | EIF4B | PRO1843 | eukaryotic translation initiation factor 4B | 1975 | 219599_at |
| 53 | 21 Up early genes | SUCLG2 | GBETA | succinate-CoA ligase, GDP-forming, beta | 8801 | 212459_x_at |
| 54 | 21 Up early genes | FKBP1B | PPlase | FK506 binding protein 18, 12.6 kDa | 2281 | 206857_s_at |
| 55 | 21 Up early genes | LEPR | OBR | leptin receptor | 3953 | 209894_at |
| 56 | 21 Up early genes | GOLPH3L | FLJ10687 | golgi phosphoprotein 3-like | 55204 | 218361_at |
| 57 | 21 Up early genes | DCAF10 | WDR32 | DDB1 and CUL4 associated factor 10 | 79269 | 219001_s_at |
| 58 | 21 Up early genes | CEP57 | Translokin | centrosomal protein 57 kDa | 27143 | 203494_s_at |
| 59 | 21 Up early genes | FOSL2 | FRA2 | FOS-like antigen 2 | 2355 | 218880_at |
| 60 | 21 Up early genes | BNIP3L | NIX | protein 3-like | 665 | 221478_at |

*This Affymetrix probe cross hybridizes to 2 genes: EIF4A1 and SNORA48

The Affymetrix probes of EIF4A1 and SNORA48 may cross-hybridize. This may result in SNORA48 gene as one of differentially regulated genes in the assay. Therefore, in some embodiments SNORA48 may not be differentially regulated.

A Student's t-tests was performed to address the association with chemotherapy response of expression levels of the 3D genes of in breast tumor biopsies obtained from patients treated with taxane-based chemotherapy (Table 28).

TABLE 29
Association of genes differentially regulated during mammary
morphogenesis with response to taxane chemotherapy.

| | | Genes | Genes | Ability to | |
|---|---|---|---|---|---|
| | | signif- | signif- | stratify by | |
| | | icantly* | icantly* | response** | Ability to |
| 3D | Total | associated | associated | (Chi-square | stratify by |
| Expression | genes | with | with pCR | contingency | response** |
| Pattern | (N) | pCR (N) | (%) | coefficient) | (p-value) |
| Down early | 6 | 3 | 50% | 0.248 | 0.0005 |
| Down late | 22 | 12 | 55% | 0.364 | <0.000001 |
| Up early | 21 | 1 | 5% | — | — |
| Up late | 11 | 2 | 18% | — | — |
| Down | 28 | 15 | 54% | 0.241 | 0.00059 |
| Up | 32 | 3 | 9% | — | — |
| Early | 27 | 6 | 22% | — | — |
| Late | 33 | 14 | 42% | 0.344 | <0.000001 |
| All | 60 | 22 | 37% | 0.283 | <0.000001 |

*t-Test, p < 0.05
**Hierarchical clustering was used to cluster patients from the taxol response microarray dataset of Hess et al. Fisher's Exact p-values are tabulated.

The results showed that all categories of the genes included at least one gene that was associated with chemotherapy response. A total of 28 genes were down modulated in the time course. More than 50% of these genes (15 out of 28) were predictive of response to chemotherapy. The 28 down modulated genes included 6 genes that were down-regulated early, and 22 genes that were down regulated late in the time course. The numbers of genes in each set that were significantly associated with response (p<0.05) are tabulated (Table 28).

It has been suggested that a possible link exists between genes that predict prognosis and genes that predict response to chemotherapy. Results presented here indicate that the link between genes that predict prognosis and genes that predict response to chemotherapy is very weak or non-existent. Rather, some of the genes that are studied here predicted prognosis only, some predicted chemotherapy response only, and some predicted both (Table 29).

The genes down modulated in the time course were further investigated by hierarchal cluster analysis for their ability to stratify patients by response to chemotherapy. Results show that the 22 down regulated late genes and the 6 down regulated early genes can stratify breast tumors into two main clusters with significantly different responses to chemotherapy (Table 28). Statistically significant p-values were obtained for cluster analyses performed for the 28 down regulated genes and the 6 down regulated early genes, as well as the 33 genes modulated late, and the entire set of all 60 genes (Table 28). In summary, all of the gene sets include at least one gene whose expression is associated with response to chemotherapy, while the 28 down, 33 late, 6 down early, and 22 down late regulated genes all include at least 30% response associated genes and are able to accurately stratify patients according to response by using cluster analysis.

A univariate analyses to study individual 28 down modulated genes (22 down late genes and 6 down early genes is performed). The association of these genes with both prognosis and chemotherapy response prediction in breast cancer was studied. Results are tabulated (Table 29). The association of gene expression with long term survival (prognosis) was determined from the microarray dataset of van de Vijver et al using univariate Kaplan-Meier analysis with survival as an endpoint. This dataset included 295 stage I and II breast cancer patients. The association of gene expression with prediction of response to taxane-based chemotherapy was determined from the microarray dataset of Hess et al using univariate logistic regression analysis with pathological complete response (pCR) as an endpoint. This dataset included 243 breast cancer patients treated with neoadjuvant taxane-based chemotherapy. Down late and down early genes are grouped separately and within these groups, genes are arranged by their biological functions. P-values are tabulated for both Kaplan-Meier (survival) and logistic regression (chemotherapy response prediction) analyses.

The cellular functions of the down late and down early genes differed. Down late genes included mostly cell cycle and signal transduction genes, while down early genes included cell adhesion and signal transduction genes. These cellular functions are in agreement with the biological processes known to occur at these respective time points of the 3D model system.

The genes whose expression was associated with both prognosis and chemotherapy response prediction were mostly represented by the functional classes of cell cycle genes. These genes tended to be in the group of down late genes and predicted both prognosis and chemotherapy response prediction in all patients and ER-positive patients. For example, these genes include FOM1, RRM2, TRIP13 and ASPM. In contrast, genes whose expression was associated with only chemotherapy response prediction were mostly represented by other functional classes of genes including signal transduction, cell adhesion and cell metabolism genes. These genes tended to predict response in specific subsets of breast cancer patients. For example, SERPINE2 predicted response only in HER2+ and basal-like patients, FGFBP1 predicted response only in Luminal B patients, TNFRSF6B predicted response only in basal-like patients, and CAPG predicted response only in HER2+ patients.

To optimize the signature-based tests, an iterative process was used that includes testing a signature in different patient datasets and then refining the algorithms used to link gene expression patterns to a responsive or non-responsive group. Optimization also includes potentially removing genes that do not make a significant contribution across multiple datasets and potentially adding other genes that do make a significant contribution across multiple datasets.

To assess test quality of our gene signature tests, we have used the receiver operating characteristic (ROC) method. ROC analysis is a graphical method that accounts for the trade off between the assay sensitivity and specificity. After graphing sensitivity versus-specificity, we calculate the “area under the curve” (AUC) and the statistical significance of the result (p-value). This method was applied to microarray data from a set of fine needle aspirate tumor biopsy samples obtained from women with breast cancer prior to neoadjuvant combination chemotherapy with TFAC (taxol, 5-fluorouracil, cyclophosphamide, and doxorubicin. Resulting AUC and p-values are tabulated (Tables 30-32). These results show the quality of the gene signatures used as tests to predict response to taxane-based chemotherapy in breast cancer.

TABLE 31
Signature optimization for all patients

| | | | STD | |
|---|---|---|---|---|
| | p value | AUC | Error | 95% CI |
| All 22 genes | <0.0001 | 0.834 | 0.0366 | 0.782 to 0.879 |
| 6 down early genes | 0.0093 | 0.713 | 0.0438 | 0.651 to 0.769 |
| Optimized 22 genes plus 3 | <0.0001 | 0.884 | 0.0317 | 0.837 to 0.921 |
| controls | | | | |
| Optimized signature 1 | <0.0001 | 0.888 | 0.0312 | 0.841 to 0.925 |

TABLE 32
Signature optimization for ER-positive patients

| | | | STD | |
|---|---|---|---|---|
| | p value | AUC | Error | 95% CI |
| All 22 genes | 0.0009 | 0.966 | 0.0454 | 0.922 to 0.989 |
| Optimized 22 genes | <0.0001 | 0.971 | 0.0418 | 0.929 to 0.992 |
| 6 down early genes | 0.5922 | 0.703 | 0.106 | 0.622 to 0.776 |
| 22 genes plus 3 control | nd | nd | nd | nd |
| genes | | | | |
| Optimized signature 2 | 0.0003 | 0.982 | 0.0333 | 0.945 to 0.997 |

TABLE 33
Signature optimization for ER-negative patients

| | | | STD | |
|---|---|---|---|---|
| | p value | AUC | Error | 95% CI |
| 22 genes | 0.0686 | 0.823 | 0.0443 | 0.732 to 0.893 |
| Optimized 22 genes | 0.0031 | 0.798 | 0.0479 | 0.692 to 0.863 |
| 6 down early genes | 0.6357 | 0.619 | 0.0578 | 0.515 to 0.716 |
| 22 genes plus 3 control genes | nd | nd | nd | nd |
| Optimized signature 3 | 0.0007 | 0.839 | 0.0425 | 0.750 to 0.906 |

All values represent result of discovery ROC analyses performed on training sets.

Evaluation of the 28-gene signature was first performed by eliminating non-contributing genes, an optimized version of the 28-gene signature was then evaluated. The 6 down early genes were then evaluated independently for comparison. These genes were then added to the optimized 22-gene signature and this combined list was then optimized by eliminating non-contributing genes. In the case of tests using all patients, the addition of three “control” genes that distinguish the major breast cancer subtypes, including estrogen receptor 1 (ESR1), v-erb B2 (Her2/neu), and cadherin 3 (CAD3) were evaluated. The identities of genes in one optimized lists are shown (Tables 33-35).

TABLE 34
Optimized signature 1 (All patients)

| | |
|---|---|
| DL | caprin_family_member_2 |
| DL | CDC28_protein_kinase_regulatory_subunit_2 |
| DL | cyclin_dependent_kinase_inhibitor_3_CDK2_associated_dual_specificity_phosphatase_ |
| DL | dual_specificity_phosphatase_4 |
| DL | EPH_receptor_A2 |
| control | estrogen_receptor_1 |
| DL | eukaryotic_translation_initiation_factor_4A_isoform_1 |
| DE | low_density_lipoprotein_receptor_related_protein_8_apolipoprotein_e_receptor |
| DL | fibroblast_growth_factor_binding_protein_1 |
| DL | non_SMC_condensin_I_complex_subunit_G |
| DL | ornithine_decarboxylase_1 |
| DE | pleckstrin_homology_like_domain_family_A_rnember_l |
| DL | ribonucleotide_reductase_M2_polypeptide |
| | serpin_peptidase_inhibitor, |
| DL | clade_E_nexin_plasminogen_activator_inhibitor_type_1_member_2 |
| DE | thrombospondin_1 |
| DL | thyroid_hormone_receptor_interactor_13 |
| DL | tubulin_gamma_1 |
| DL | tumor_necrosis_factor_receptor_superfamily_member_6b_decoy |
| control | v_erb_b2_erythroblastic_leukemia_viral_oncogene_homolog_2 |
| DL | vaccinia_related_kinase_1 |
| DL | Zwilch_kinetochore_associated_homolog_Drosophila |

TABLE 35
Optimized signature 2 (ER positive)

| | |
|---|---|
| DL | actin_beta |
| DL | actinin_alpha_1 |
| DE | adhesion_molecule_with_Ig_like_domain_2 |
| DL | asp_abnormal_spindle_homolog_microcephaly_associated__Drosophila_ |
| DL | caprin_family_member_2 |
| DL | cyclin_dependent_kinase_inhibitor_3_CDK2_associated_dual_specificity_phosphatase_ |
| DL | EPH_receptor_A2 |
| DL | eukaryotic_translation_initiation_factor_4A_isoform_1 |
| DE | fibroblast_growth_factor_binding_protein_1 |
| DE | low_density_lipoprotein_receptor_related_protein_8_apolipoprotein_e_receptor |
| DE | pleckstrin_homology_like_domain_family_A_member_1 |
| DL | ribonucleotide_reductase_M2_polypeptide |
| DE | thrombospondin_1 |
| DL | tubulin_gamma_1 |
| DL | tumor_necrosis_factor_receptor_superfamily_member_6b_decoy |
| DE | vaccinia_related_kinase_1 |
| DL | Zwilch_kinetochore_associated_homolog__Drosophila_ |

TABLE 36
Optimized signature 3 (ER negative)

| | |
|---|---|
| DL | actin_beta |
| DE | adhesion_molecule_with_Ig_like_domain_2 |
| DL | asp_abnormal_spindle_homolog_microcephaly_associated_Drosophila_ |
| DL | centrosomal_protein_55 kDa |
| DL | dual_specificity_phosphatase_4 |
| DL | eukaryotic_translation_initiation_factor_4A_isoform_1 |
| DL | fibroblast_growth_factor_binding_protein_1 |
| DE | low_density_lipoprotein_receptor_related_protein_8_apolipoproteine_receptor |
| DE | myosin_phosphatase_Rho_interacting_protein |
| DL | ornithine_decarboxylase_1 |
| | serpin_peptidase_inhibitor_clade_E_nexin_plasminogen_activator_inhibitor_type_1_ |
| DL | member_2 |
| DE | solute_carrier_family_20_phosphate_transporter_member_1 |
| DE | thrombospondin_1 |
| DL | tumor_necrosis_factor_receptor_superfamily_member_6b_decoy |
| DL | vaccinia_related_kinase_1 |

All logistic regression analyses were discovery analyses, meaning that the ROC statistics were calculated from the same dataset used to train the model. Hence, these results are for comparison purposes only and do not account for differences that will likely occur between different sets of patients.

Results show that, in all patient types, the final optimized gene lists were benefited by the addition of one or more of the down early genes. Inclusion of down early genes increased the performance AUC of the optimized 28-gene signature. For all patients, AUC increased from 0.884 to 0.888 (Table 34). For ER-positive patients, AUC increased from 0.971 to 0.982 (Table 35). For ER-negative patients, AUC increased from 0.798 to 0.939 (Table 36). While AUC values increased by adding down early genes, the magnitudes of the increases were not statistically significant.

### Example 19

### Cluster Analysis of Three Patient Treatment Subgroups Using the 22 Gene Signature

To determine whether the 22 gene signature, which was differentially expressed during human mammary acinar morphogenesis, predicts response to taxane-based chemotherapy in breast cancer, the gene expression microarray results were examined. Hierarchical cluster analysis was applied to three treatment subgroups, estrogen receptor-positive (ER+), HER2-positive (HER2+), and triple negative (ER−, PR−, HER−) breast cancer subgroups. The 22 gene signature accurately stratified all three groups according to chemotherapy response.

Gene expression data for each of the three treatment subgroups were obtained from the microarray data sets of Popovici et al, 2010, and Tabchy et al, 2010, both of which are publically available at Gene Expression Omnibus (GEO). This study included patients diagnosed with stage I to III breast cancer at the MD Anderson Cancer Center. Fine needle aspirate biopsies were collected prior to any treatment and analyzed on Affymetrix HG-U133 plus 2.0 microarrays to determine genome wide gene expression levels. After biopsy, patients were treated with the neoadjuvant combination chemotherapy TFAC (taxol, 5-fluorouracil, cyclophosphamide, and doxorubicin). Pathological complete response (pCR) was used as an endpoint.

To access the ability of the 22 gene signature to stratify ER+ patients by response to taxol-based chemotherapy, hierarchical cluster analysis was performed on microarray data from 146 ER-positive patients. The results of this analysis showed division of the patients into three main clusters: clusters 1, 2 and 3. Clusters 2 and 3 were grouped and analyzed together. Cluster 1 included visibly more down-regulated (blue) genes while clusters 2 and 3 included visibly more up-regulated (red) genes. The visibly differential genes were predominantly genes that play a role in the cell cycle. Cluster 1 included a low number of chemotherapy responsive patients (1%), while Clusters 2 and 3 included significantly more responsive patients (15%) (p=0.0018, Fisher's Exact). These clustering results are dependent on the entire 22 gene signature and the same results are not obtained if only cell cycle genes are used.

To access the ability of the 22 gene signature to stratify HER2+ patients by response to taxol-based chemotherapy, hierarchical cluster analysis was performed on microarray data from 41 HER2+ patients. The results of this analysis showed division of the patients into three main clusters: clusters 1, 2 and 3. Clusters 1 and 3 were grouped and analyzed together. Cluster 2 included visibly more down-regulated (blue) genes while clusters 1 and 3 included visibly more up-regulated (red) genes. The visibly differential genes were predominantly genes that play a role in the cell cycle. Reverse from the observation above for ER+ patients, the blue cluster with down regulated cell cycle genes, Cluster 2, included a high number of chemotherapy responsive patients (91%), while Clusters 1 and 3 included significantly less responsive patients (50%) (p=0.030, Fisher's Exact). These clustering results are dependent on the entire 22 gene signature and the same results are not obtained if only cell cycle genes are used.

To access the ability of the 22 gene signature to stratify triple negative patients by response to taxol-based chemotherapy, hierarchical cluster analysis was performed on microarray data from 90 triple negative patients (ER−, PR−, HER−). The results of this analysis showed division of the patients into two main clusters: Clusters 1 and 2. Cluster 1 included visibly more down-regulated (blue) genes while Cluster 2 included visibly more up-regulated (red) genes. The visibly differential genes were predominantly genes that play a role in the cell cycle. Similar to the ER+ patients, the blue cluster with down regulated cell cycle genes, Cluster 1, included a low number of chemotherapy responsive patients (19%), while Cluster 2 included significantly more responsive patients (44%) (p=0.018, Fisher's Exact). These clustering results are dependent on the entire 22 gene signature and the same results are not obtained if only cell cycle genes are used.

Data and results presented herein demonstrates that the 22 gene signature predicts chemotherapy response in breast cancer patients treated with neoadjuvant taxane-based chemotherapy. This gene signature was identified from non-malignant breast epithelial cells grown in a three dimensional culture system that accurately recapitulates normal mammary acini formation using a novel approach. To optimize the 22 gene signature, genes that were co-expressed with each of the individual 22 genes in a series of 353 fine needle aspirate tumor biopsy samples obtained from women with breast cancer prior to neoadjuvant combination chemotherapy with TFAC (taxol, 5-fluorouracil, cyclophosphamide, and doxorubicin) were selected. Genes with the same expression patterns as each of the individual 22 genes (Pearson correlation coefficient>0.75) were selected and included in studies directed toward the translation of the 22 gene test to a PCR-based format and optimization of this test. Identities of the co-expressed (co-regulated) genes are listed herein (Tables 26A and 26B).

1. A method for predicting a prognosis of a subject diagnosed with triple negative breast cancer, predicting a prognosis of a subject with breast cancer, selecting a treatment for a subject with breast cancer, or predicting a survival outcome of a subject with breast cancer comprising
obtaining a dataset associated with a sample derived from a patient diagnosed with cancer, wherein the dataset comprises:
expression data for a plurality of markers selected from the group consisting of CAPRIN2, ZWILCH, CKS2, CDKN3, FOXM1, RRM2, VRK1, TRIP13, ASPM, CEP55, TUBG1, AURKA, SERPINE2, TNFRSF6B, CAPG, ACTN1, ACTB, DUSP4, EPHA2, FGFBP1, EIF4A1, ESR1, ODC1 and optionally at least one clinical factor; and
determining a predictive score from the dataset using an interpretation function, wherein the predictive score is predictive of one of the following: the prognosis of a subject with triple negative breast cancer, the prognosis of a subject with breast cancer, the selection of a treatment for a subject with breast cancer, or prediction of a survival outcome of a subject with breast cancer,
wherein at least one of the plurality of markers is replaced with a co-regulated gene listed in Tables 26A or 26B.

2-3. (canceled)

4. The method of claim 1, wherein the treatment is:
TFAC, FAC, or Cisplatin; or
an alkylating agent, nitrogen mustard, nitrosourea, ethylenimine, antimetabolite anthracycline, anti-tumor antibiotic, topoisomerase I inhibitor, topoisomerase II inhibitor, corticosteroids, or mitotic inhibitor.

5. A method for predicting a prognosis of a subject diagnosed with triple negative breast cancer comprising
obtaining a dataset associated with a sample derived from a patient diagnosed with cancer, wherein the dataset comprises:
expression data for a plurality of markers selected from the group consisting of CAPRIN2, ZWILCH, CKS2, CDKN3, FOXM1, RRM2, VRK1, TRIP13, ASPM, CEP55, ZWILCH, TUBG1, AURKA, SERPINE2, CAPRIN2, TNFRSF6B, CAPG, ACTN1, ACTB, DUSP4, EPHA2, FGFBP1, EIF4A1, ESR1, ODC1 and optionally at least one clinical factor; and
determining a predictive score from the dataset using an interpretation function, wherein the predictive score is predictive of the prognosis of a subject with triple negative breast cancer.

6-10. (canceled)

11. The method of claim 5, wherein at least one clinical factor term is selected from the group consisting of age, gender, neutrophil count, ethnicity, race, disease duration, diastolic blood pressure, systolic blood pressure, a family history parameter, a medical history parameter, a medical symptom parameter, height, weight, a body-mass index, smoker/non-smoker status, tumor ER status, tumor HER2 status, tumor size, node status, tumor histology, tumor grade, tumor molecular class (including luminal A, luminal B, HER2-positive, basal-like, or normal-like), cancer treatment protocol, or the patient's or tumor mutation status of one or more genes.

12. The method of claim 5, wherein the predictive score is compared to a score derived from a sample from a patient with cancer that was known to have an excellent, good, moderate or poor prognosis,
wherein a sample whose score matches the predetermined predictive of sample derived from a patient that that was known to have an excellent, good, moderate or poor prognosis is predicted to have an excellent, good, moderate or poor prognosis, or
wherein a sample whose score matches the predetermined predictive of sample derived from a patient that was known to have an excellent, good, moderate or poor prognosis is predicted to have an excellent, good, moderate or poor prognosis.

13. The method of claim 5, wherein said prognosis is:
poor, moderate, good, or excellent;
at least 3, 5, 7, 10, 12 year survival;
a three year survival or a three year distant relapse free survival (DRFS); or
relapse-free.

14-16. (canceled)

17. The method of claim 5, wherein the interpretation function is based upon a predictive model.

18. The method of claim 17, wherein the predictive model is a logistical regression model, wherein the logistic regression model is applied to the dataset to interpret the dataset to produce the predictive score, wherein a predictive score above a specified cut-off value predicts a good prognosis and a predictive score below a specified cut-off predicts a poor prognosis.

19-26. (canceled)

27. The method of claim 5, further comprising rating the ability of the sample to respond to a specific treatment based on the predictive score.

28-31. (canceled)

32. A system for predicting prognosis of a subject with triple negative breast cancer comprising a storage memory for storing a dataset associated with a sample obtained from the subject, wherein the dataset comprises expression data for at least one marker selected from the group consisting of CAPRIN2, ZWILCH, CKS2, CDKN3, FOXM1, RRM2, VRK1, TRIP13, ASPM, CEP55, TUBG1, AURKA, SERPINE2, TNFRSF6B, CAPG, ACTN1, ACTB, DUSP4, EPHA2, FGFBP1, EIF4A1, ESR1, ODC1; and a processor communicatively coupled to the storage memory for determining a score with an interpretation function wherein the score is predictive of response to a cancer treatment in a subject diagnosed with cancer.

33. (canceled)

34. A method, the method comprising:
a method for predicting a prognosis of a subject with triple negative breast cancer comprising:
isolating a sample of the cancer from the patient with the triple negative breast cancer;
obtaining a dataset associated with a sample derived from a patient diagnosed with cancer, wherein the dataset comprises expression data for at least one marker selected from the group consisting of CKS2, CDKN3, FOXM1, RRM2, VRK1, TRIP13, ASPM, CEP55, ZWILCH, TUBG1, AURKA, SERPINE2, CAPRIN2, TNFRSF6B, CAPG, ACTN1, ACTB, DUSP4, EPHA2, FGFBP1, EIF4A1, ESR1, ODC1 and optionally at least one clinical factor; and
determining a predictive score from the dataset using an interpretation function,
wherein the interpretation function comprises is based upon a predictive model,
wherein the predictive model is a logistical regression model,
wherein the logistical regression model is applied to the dataset to interpret the dataset to produce the predictive score, and
wherein a predictive score above a specified cut-off value predicts a good prognosis and a predictive score below a specified cut-off predicts a poor prognosis; or
a method of selecting a treatment or for determining a preferred treatment for a subject with cancer comprising
obtaining a first dataset associated with a first sample derived from a subject diagnosed with cancer, wherein the dataset comprises:
expression data for a plurality of markers:
wherein the plurality of markers is:
selected from the group consisting of CAPRIN2, CKS2, CDKN3, FOXM1, RRM2, VRK1, TRIP13, ASPM, CEP55, ZWILCH, TUBG1, AURKA, SERPINE2, TNFRSF6B, CAPG, ACTN1, ACTB, DUSP4, EPHA2, FGFBP1, EIF4A1, ESR1, ODC1 and optionally at least one clinical factor; or
selected from the group consisting of: AC004010, ACTB, ACTN1, APOE, ASPM, AURKA, BBOX1, BIRC5, BLM, BM039, BNIP3L, C1QDC1, C14ORF147, CDC6, CDC45L, CDK3, CDKN3, CENPA, CEP55, CKS2, COL4A2, CRYAB, DC13, DSG3, DUSP4, EFEMP1, EGR1, EIF4A1, EIF4B, EPHA2, EPHA2, FEN1, FGFBP1, FKBP1B, FLJ10036, FLJ10517, FLJ10540, FLJ10687, FLJ20701, FOSL2, FOXM1, GPNMB, H2AFZ, HCAP-G, HBP17, HPV17, ID-GAP, IGFBP2, KIAA084, KIAA092, KNSL6, KNTC2, KRTC2, KRT10, LEPL, LOC51203, LOC51659, LRP16, LRP8, MAFB, MCM6, MELK, MTB, NCAPG, NUSAP1, ODC, ODC1, PHLDA1, PITRM1, PLK1, POLQ, PPL, PRC1, RAMP, RRM2, RRM3, SEC4L, SEPT10, SERPINE2, SERPINA3, SLC20A1, SMC4L1, SNRPA1, SOX4, SRCAP, SRD5A1, STK6, SUCLG2, SUPT16H, TCF4, THBS1, TNFRSF6B, TRIP13, TUBG1, UCHL5, VRK1, WDR32, ZNF227, and ZWILICH and optionally at least one clinical factor; or
selected from the group consisting of: CAPRIN2, ZWILCH, CKS2, FOXM1, RRM2, TRIP13, ASPM, CEP55, AURKA, TUBG1, CDKN3, VRK1, SERPINE2, FGFBP1, TNFRSF68, CAPG, ACTB, DUSP4, EPHA2, ACTN1, EIF4A1, ODC1, AMIGO2, PHLDA, THBS1, LRP8, MPRIP, and SLC20A1 and optionally at least one clinical factor;
determining a selection predictive score for a plurality of treatment options from the dataset using a one or more interpretation functions;
comparing the selection predictive scores for a plurality of treatment options;
selecting a treatment or determining a preferred treatment for a subject by selecting a treatment with the best selection predictive score based upon the comparison of the selection predictive scores for the plurality of treatment options.

35. (canceled)

36. The method of claim 34, wherein the plurality of treatment options is:
TFAC, FAC, or Cisplatin; or
an alkylating agent, nitrogen mustard, nitrosourea, ethylenimine, antimetabolite anthracycline, anti-tumor antibiotic, topoisomerase I inhibitor, topoisomerase II inhibitor, corticosteroids, or mitotic inhibitor.

37. The method of claim 34, wherein the cancer is breast cancer or triple negative breast cancer.

38. The method of claim 34, wherein the selection predictive score is a score that predicts response to TFAC, FAC, Cisplatin, or any combination thereof.

39. The method of claim 38,
wherein the one or more interpretation functions for determining the predictive score for TFAC comprises expression data for ESR1 and ODC1;
wherein the one or more interpretation functions for determining the predictive score for FAC comprises expression data for CEP55 and EPHA2; or
wherein the one or more interpretation functions for determining the predictive score for Cisplatin comprises expression data for ACTN, CEP55, HER2, TRIP13, VRK1.

40-57. (canceled)

58. The method of claim 34, further comprising determining the prognosis of the subject, wherein determining the prognosis of the subject comprises:
a) obtaining a second dataset associated with a sample derived from the patient diagnosed with cancer, wherein the dataset comprises:
expression data for a plurality of markers, wherein the plurality of markers is:
selected from the group consisting of CAPRIN2, ZWILCH, CKS2, CDKN3, FOXM1, RRM2, VRK1, TRIP13, ASPM, CEP55, TUBG1, AURKA, SERPINE2, TNFRSF6B, CAPG, ACTN1, ACTB, DUSP4, EPHA2, FGFBP1, EIF4A1, ESR1, ODC1 and optionally at least one clinical factor; or
selected from the group consisting of: AC004010, ACTB, ACTN1, APOE, ASPM, AURKA, BBOX1, BIRC5, BLM, BM039, BNIP3L, C1QDC1, C14ORF147, CDC6, CDC45L, CDK3, CDKN3, CENPA, CEP55, CKS2, COL4A2, CRYAB, DC13, DSG3, DUSP4, EFEMP1, EGR1, EIF4A1, EIF4B, EPHA2, EPHA2, FEN1, FGFBP1, FKBP1B, FLJ10036, FLJ10517, FLJ10540, FLJ10687, FLJ20701, FOSL2, FOXM1, GPNMB, H2AFZ, HCAP-G, HBP17, HPV17, ID-GAP, IGFBP2, KIAA084, KIAA092, KNSL6, KNTC2, KRTC2, KRT10, LEPL, LOC51203, LOC51659, LRP16, LRP8, MAFB, MCM6, MELK, MTB, NCAPG, NUSAP1, ODC, ODC1, PHLDA1, PITRM1, PLK1, POLQ, PPL, PRC1, RAMP, RRM2, RRM3, SEC4L, SEPT10, SERPINE2, SERPINA3, SLC20A1, SMC4L1, SNRPA1, SOX4, SRCAP, SRD5A1, STK6, SUCLG2, SUPT16H, TCF4, THBS1, TNFRSF6B, TRIP13, TUBG1, UCHL5, VRK1, WDR32, ZNF227, and ZWILICH and optionally at least one clinical factor; or
selected from the group consisting of: CAPRIN2, CKS2, FOXM1, RRM2, TRIP13, ASPM, CEP55, AURKA, TUBG1, ZWILCH, CDKN3, VRK1, SERPINE2, FGFBP1, TNFRSF68, CAPG, ACTB, DUSP4, EPHA2, ACTN1, EIF4A1, ODC1, AMIGO2, PHLDA, THBS1, LRP8, MPRIP, and SLC20A1 and optionally at least one clinical factor;
selected from the group consisting of CAPRIN2, CKS2, CDKN3, FOXM1, RRM2, VRK1, TRIP13, ASPM, CEP55, ZWILCH, TUBG1, AURKA, SERPINE2, TNFRSF6B, CAPG, ACTN1, ACTB, DUSP4, EPHA2, FGFBP1, EIF4A1, ESR1, ODC1 and optionally at least one clinical factor; and
determining a prognosis predictive score from the dataset using a second interpretation function, wherein the prognosis predictive score is predictive of the prognosis of a subject with cancer.

59. (canceled)

60. The method of claim 58, wherein the prognosis predictive score is compared to a score derived from a sample from a patient with cancer that was known to have an excellent, good, moderate or poor prognosis,
wherein a sample whose prognosis predictive score matches the predetermined predictive of sample derived from a patient that that was known to have an excellent, good, moderate or poor prognosis is predicted to have an excellent, good, moderate or poor prognosis, or
wherein a sample whose prognosis predictive score matches the predetermined predictive of sample derived from a patient that was known to have an excellent, good, moderate or poor prognosis is predicted to have an excellent, good, moderate or poor prognosis.

61. (canceled)

62. The method of claim 58, wherein the second interpretation function is based upon a predictive model.

63-64. (canceled)

65. The method of claim 58, wherein the cancer is triple negative breast cancer.

66. The method of claim 34, wherein the method further comprises a method for predicting a response to the selected cancer treatment comprising:
obtaining a third dataset associated with a sample derived from the subject, wherein the dataset comprises:
expression data for at least one marker selected from the group consisting of FLJ10517, HCAP-G, CDKN3, STK6, FOXM1, FLJ10540, TNFRSF6B, HBP17, C1QDC1, TUBG1, FLJ10036, RRM2, ACTB, ACTN1, EPHA2, TRIP13, CKS2, VRK1, DUSP4, EIF4A1, SERPINE2, and ODC 1 or a at least one clinical factor; and
determining a response predictive score from the dataset using a third interpretation function,
wherein the response predictive score is predictive of the response to the cancer treatment.

67. The method of claim 66, wherein the response predictive score is compared to a score derived from a sample from a patient with cancer that was known to have responded or not responded to chemotherapy, wherein a sample whose response predictive score matches the predetermined response predictive score of a sample derived from a patient that responded to treatment the patient diagnosed with cancer is predicted to respond to the cancer treatment, or
wherein a sample whose response predictive score matches the predetermined predictive of sample derived from a patient that did not respond to treatment the patient diagnosed with cancer is predicted to not to respond to the cancer treatment,
wherein the subject has:
an ER-positive cancer, an ER-negative cancer, a Luminal B positive cancer, Luminal A positive cancer, or Her2 positive cancer;
a cancer characterized as basal-like; or
a triple-negative breast cancer.

68-75. (canceled)

76. The method of claim 66, wherein the cancer is predicted to respond or not respond to:
TFAC (combination of taxol/fluorouracil/anthracycline/cyclophosphamide) TAC (taxol/anthracycline/cyclophosphamide with or without filgrastim support), ACMF (doxorubicin followed by cyclophosphamide, methotrexate, fluorouracil), ACT (doxorubicin, cyclophosphamide followed by taxol or docetaxel), A-T-C (doxorubicin followed by paclitaxel followed by cyclophosphamide), CAF/FAC (fluorouracil/doxorubicin/cyclophosphamide), CEF (cyclophosphamide/epirubicin/fluorouracil), AC (doxorubicin/cyclophosphamide), EC (epirubicin/cyclophosphamide), AT (doxorubicin/docetaxel or doxorubicin/taxol), CMF (cyclophosphamide/methotrexate/fluorouracil), cyclophosphamide (Cytoxan or Neosar), methotrexate, fluorouracil (5-FU), doxorubicin (Adriamycin), epirubicin (Ellence), gemcitabine, taxol (Paclitaxel), GT (gemcitabine/taxol), taxotere (Docetaxel), vinorelbine (Navelbine), capecitabine (Xeloda), platinum drugs (Cisplatin, Carboplatin), etoposide, and vinblastine. Other treatments include surgery, radiation, hormonal and targeted therapies;
a cancer treatment comprising a nitrogen mustard, a vinca alkaloid, an epothilones, a taxane, a mitotic inhibitor, a corticosteroid, a topoisomerase II inhibitor, a topoisomerase I inhibitor, an anti-tumor antibiotics, an anthracycline, an antimetabolite, an ethylenimine, an alkyl sulfonate, a nitrosourea, or any combination thereof; or
a cancer treatment comprising mechlorethamine chlorambucil, cyclophosphamide, ifosfamide, melphalan, streptozocin, carmustine, lomustine, busulfan, dacarbazine, temozolomide, thiotepa, altretamine, 5-fluorouracil (5-FU), capecitabine, 6-mercaptopurine (6-MP), methotrexate, gemcitabine, cytarabine, fludarabine, pemetrexed, daunorubicin, doxorubicin, epirubicin, idarubicin, actinomycin-D, bleomycin, mitomycin-C, topotecan, irinotecan (CPT-11), etoposide (VP-16), teniposide, mitoxantrone, prednisone, methylprednisolone, dexamethasone, paclitaxel, docetaxel, ixabepilone, vinblastine, vincristine vinorelbine, estramustine, and any combination thereof.

77-92. (canceled)
